(19) United States
(12) Patent Application Publication
(10) Pub. No.: US 2005/0002405 A1
(43) Pub. Date: Jan. 6, 2005

(54) Method system and data structure for multimedia communications

(76) Inventor: Hanzhong Gao, Rockville, MD (US)

Correspondence Address: JONES DAY, 555 WEST FIFTH STREET, SUITE 4600, LOS ANGELES, CA, 90013-1025, US

(21) Appl. No.: 10/494,480

(22) PCT Filed: Feb. 21, 2002
(86) PCT No.: PCT/US02/05457

Related U.S. Application Data
(60) Provisional application No. 60/348,350, filed on Oct. 29, 2001.

(51) Int. Cl. H04L 12/28

(52) U.S. Cl. 370/401

(57) ABSTRACT

The invention is based on a highly efficient protocol for the delivery of high-quality multimedia communication services, such as video multicasting, video on demand, real-time interactive video telephony, and high-fidelity audio conferencing over a packet-switched network. The invention can be expressed in a variety of ways, including methods, systems, and data structures. One aspect of the invention involves a method in which a packet (10) of multimedia data is forwarded through a plurality of logical links in a packet-switched network using a datagram address contained in the packet (i.e., datagram address-based routing). Address information in partial address subfields of the datagram address self-directs the packet through a plurality of top-down logical links (70). (The plurality of top-down logical links are a subset of the plurality of logical links.) The packet remains unchanged as it is transferred along multiple links in the plurality of logical links.

### FIELD OF THE INVENTION

The present invention relates to the field of multimedia communications. More particularly, the invention is based on a highly efficient protocol for the delivery of high-quality multimedia communication services, such as video multicasting, video on demand, real-time interactive video telephony, and high-fidelity audio conferencing over a packet-switched network. The invention can be expressed in a variety of ways, including methods, systems, and data structures.

### BACKGROUND OF THE INVENTION

Telecommunications networks (including the Internet) permit individuals and organizations to exchange information and other resources. Networks typically include access, transport, signaling, and network management technologies. These technologies have been extensively documented. For an overview, see Telecommunications Convergence by Steven Shepherd (McGraw-Hill, 2000), The Essential Guide to Telecommunications, 3rd Edition by Annabel Z. Dodd (Prentice Hall PTR, 2001), or Communications Systems and Networks, 2^{nd} Edition by Ray Horak (M&T Books, 2000). Prior advances in these technologies have substantially improved the speed, quality, and cost of information transmission.

Access technologies (i.e., end user devices and local loops at network edges) that connect a user to a wide area transport network have evolved from 14.4, 28.8, and 56K modems to include Integrated Services Digital Network (“ISDN”), T1, cable modems, Digital Subscriber Line (“DSL”), Ethernet, and wireless technologies.

Transport technologies used in wide area networks now include Synchronous Optical Network (“SONET”), Dense Wavelength Division Multiplexing (“DWDM”), frame relay, Asynchronous Transfer Mode (“ATM), and Resilient Packet Ring (“RPR”).

Of all the various signaling technologies (i.e., the protocols and methods used to establish, maintain, and terminate communications across a network), the Internet Protocol (“IP”) has become the most ubiquitous. Indeed, nearly all telecommunications and networking experts believe the convergence of voice (e.g., phone), video, and data networks into a single IP-based network (such as the Internet) is inevitable. As one writer explained, “[O]ne thing is clear: The IP convergence train has left the station. Some of the passengers are wildly enthusiastic about the journey, and others are being dragged along kicking and screaming as they enumerate IP's many flaws. But whatever its shortcomings, IP is a done deal—it's the standard that got adopted, period. It has so much momentum and development action there is nothing else on the horizon.” Susan Breidenbach, “IP Convergence: Building the Future,” Network World, Aug. 10, 1998.

Network management technologies such as Simple Network Management Protocol (“SNMP”) and Common Management Information Protocol (“CMIP”) have been developed that monitor, repair, and reconfigure computer networks.

Because of these advances, computer networks have progressed from transmitting simple text messages to providing audio, still images, and rudimentary multimedia services.

Recently, considerable effort has been put into extending existing technologies or creating new ones that attempt to enable computer networks to provide multimedia communication services with image and sound quality comparable to cable television (“CATV”), digital versatile disc (“DVD”), or high-definition television (“HDTV”). To provide these services, a multimedia network needs to have high bandwidth, low delay, and low jitter. To promote widespread use, a multimedia network should also have: 1) scalability; 2) interoperability with other networks; 3) minimal information loss; 4) management capabilities (e.g., monitoring, repair, and reconfiguration); 5) security; 6) reliability; and 7) accounting capabilities.

Recent efforts include the development of IP version 6 (“IPv6”) to replace IP version 4 (“IPv4”), the current version of the IP protocol. IPv6 includes Flow Label and Priority subfields in the IPv6 header that can be used by a host computer to identify data packets that need special handling by IPv6 routers, such as data packets used to provide real-time multimedia services. Quality of service (“QoS”) protocols and architectures are also under development, including the ReSerVation Protocol (“RSVP”), Differentiated Services (“DiffServe”), and Multi Protocol Labeling Switching (“MPL S”). In addition, network routers and servers continue to increase in speed and power as their silicon-based microprocessors continue to improve.

Despite these efforts, the prior art has failed to create a high-quality multimedia network that can be widely used. These failures can be traced to two main sources.

First, some networks were simply not designed to provide multimedia services. For example, the Public Switched Telephone Network (“PTSTN”) was designed to carry voice, not video. Similarly, the Internet was originally designed for transmitting text and data files, not video. As one computer networking text explained, “The service requirements of [multimedia] applications differ significantly from those of traditional data-oriented applications such as the Web text/image, e-mail, FTP, and DNS applications. . . . In particular, multimedia applications are highly sensitive to end-to-end delay and delay variation, but can tolerate occasional loss of data. These fundamentally different service requirements suggest that a network architecture that has been designed primarily for data communication may not be well suited for supporting multimedia applications. Indeed, . . . a number of efforts are currently underway to extend the Internet architecture to provide explicit support for the service requirements of these new multimedia applications.” James F. Kurose and Keith W. Ross, Computer Networking: A Top-Down Approach Featuring the Internet (Addison Wesley, 2001), p. 483. As noted above, these efforts to extend the Internet architecture include IPv6, RSVP, DiffServe, and MPLS.

Second and more importantly, no one has been able to develop a comprehensive solution to the “silicon bottleneck” problem. The speed of silicon-based integrated circuit chips has followed Moore's Law for the past three decades, i.e., the speed has doubled roughly every eighteen months. However, this increase in silicon speed pales in comparison with the increase in the bandwidth of fiber optic distribution systems, which has been doubling roughly every six months. Thus, the major bottleneck in overall network speed is the silicon processing speed, not bandwidth.

Previous solutions to the silicon bottleneck problem have simply focused on making more powerful switches and routers with faster silicon chips or making minor changes to existing network architectures and protocols. These prior solutions are interim measures at best. What is needed long term, and what the present invention provides, is a new multimedia-centric network architecture and protocol that address the silicon bottleneck problem, yet can coexist and interoperate with the existing data-centric networks (such as the Internet).

As shown in FIG. 1(a), telecommunications networks can be divided into several major categories. [For example, see James F. Kurose and Keith W. Ross, Computer Networking: A Top-Down Approach Featuring the Internet (Addison Wesley, 2001), Chapter 1.] The highest level distinction is between circuit-switched networks and packet-switched networks. Circuit-switched networks establish a dedicated end-to-end circuit between two (or more) hosts for the duration of their communications session. Examples of circuit-switched networks include the telephone network (PSTN) and ISDN.

Packet-switched networks do not use dedicated end-to-end circuits to communicate between hosts. Rather, packet-switched networks send data packets between hosts using either virtual circuit-based routing or datagram address-based routing.

In virtual circuit-based routing, the network uses a virtual circuit number associated with a data packet to forward the data packet through the network. The virtual circuit number is typically included in the data packet header and is typically changed at each intermediate node between the sender and the receiver(s). Examples of packet-switched networks with virtual circuit-based routing include SNA, X.25, frame relay, and ATM networks. We also include networks using MPLS, which adds a virtual circuit-like number (label) to a data packet to forward the data packet, in this category.

In datagram address-based routing, the network uses the destination address contained in a data packet to forward the data packet through the network. Datagram address-based routing can either be connectionless or connection oriented.

In connectionless networks, there is no set up phase prior to sending data packets, e.g., no control packets are sent prior to sending data packets. Examples of connectionless networks include Ethernet, IP networks using the User Datagram Protocol (UDP), and Switched Multi-megabit Data Service (SMDS).

Conversely, in connection-oriented networks, there is a set up phase prior to sending data packets. For example, in IP networks using the Transmission Control Protocol (TCP), control packets are sent as part of a handshaking procedure prior to sending data packets. The term “connection-oriented” is used because the sender and the receiver are only loosely connected. Packet-switched networks with virtual circuit-based routing are also connection oriented.

The silicon bottleneck in packet-switched networks is primarily caused by the numerous processing steps that are performed on a data packet as the packet travels through the network. For example, as shown schematically in FIG. 1(b), consider a data packet travelling from one Ethernet Local Area Network (LAN) via the Internet to a second Ethernet LAN.

Two types of addresses are involved in sending the packet from its source to its destination, network layer addresses and data link layer addresses.

A network layer address is typically used to send a packet anywhere in an internetwork (i.e., a network of networks). (Various references also refer to network layer addresses as “logical addresses” and “protocol addresses.”) In this example, the network layer address of interest is the IP address of the destination host [i.e., PC 2 on LAN 2 in FIG. 1(b)]. An IP address field is divided into two subfields, a network identifier subfield and a host identifier subfield.

A data link layer address is typically used to identify a physical network interface to a node. (Various references also refer to a data link layer address as a “physical address” and a “Media Access Control (MAC) address.”) In this example, the data link layer addresses of interest are the Ethernet (IEEE 802.3) MAC addresses of the destination host and the routers that the packet is sent to on its way to the destination host.

Ethernet MAC addresses are globally unique, 48-bit binary numbers that are permanently assigned to each Ethernet component (typically by the component manufacturer). Thus, if an Ethernet component is physically moved to a different Ethernet LAN, the Ethernet MAC address stays with the component. Consequently, Ethernet has a flat addressing structure, i.e., the Ethernet MAC address provides no information about the network topology that can be used to help route the packet. In general, however, data link layer addresses do not have to be globally unique and do not have to be permanently assigned to a particular node.

To transfer data from a source host (e.g., PC 1 on LAN 1) to destination host(s), the data is broken up into a number of data packets. Each data packet includes a header that contains the IP address of the destination host. This IP address remains unchanged as the data packet is forwarded through a number of logical links to the destination host. However, as explained below, numerous other parts of the data packet are changed as the packet is forwarded.

As shown in FIG. 1(b), the header of the data packet also initially contains the MAC address of the first router [i.e., “MAC Address of Router 1” in FIG. 1(b)] that the packet will be sent to as it travels towards the destination host. (As an aside, note that the “header” and “data packet” terminology used here is somewhat different from that used in the Open System Interconnection (OSI) model. Using OSI terminology, an IP data packet consists of an IP header that encapsulates payload data. In turn, an Ethernet frame consists of an Ethernet header and trailer that encapsulate the IP data packet. In the terminology used here, the IP header and Ethernet header and trailer are being lumped together and called the “header” and the Ethernet frame is being called the “data packet.”)

When Router 1 receives the data packet from the source host, Router 1 must determine the next hop in the path that the packet will take. To make this determination, Router 1 extracts the IP address of the destination host [i.e., “IP Address of PC 2” in FIG. 1(b)] from the packet and determines the IP network of the destination host from the network identifier subfield in the IP address. Router 1 looks up the destination IP network in a routing table. The routing table, which is typically calculated and updated in real time, contains a list of IP networks and corresponding IP addresses of the next hop that will send a packet towards these IP networks. Router 1 uses the routing table to identify the IP address of the next-hop (i.e., IP address of Router 2) that will send the packet towards the destination network. Router 1 strips off the current Ethernet MAC address on the packet [i.e., “MAC address of Router 1” in Figure 11(b)]; translates the IP address of the next hop into an Ethernet MAC address and adds this MAC address to the packet [i.e., “MAC address of Router 2” in FIG. 1(b)]; decrements a “time-to-live” field in the packet; recalculates and appends a new checksum to the packet; and sends the packet on its way towards Router 2.

The same extensive processing that occurred at Router 1 is repeated at Router 2 and at each intermediate router until the data packet arrives at a router, such as Router N in FIG. 1(b), that is directly connected to the destination IP network that includes the destination host. Router N strips off the current Ethernet MAC address on the packet [i.e., “MAC address of Router N” in FIG. 1(b)]; translates the destination IP address into an Ethernet MAC address and adds this MAC address to the packet [i.e., “MAC address of PC 2” in FIG. 1(b)]; decrements a “time-to-live” field in the packet; recalculates and appends a new checksum to the packet; and sends the packet to the destination host (e.g., PC 2 on LAN 2).

As this example illustrates, prior art packet-switched networks use numerous processing steps to transfer data packets, thereby creating the silicon bottleneck problem. This example describes the processing overhead with datagram address-based routing, but similar processing overhead occurs with virtual circuit-based routing. For example, as noted above, the virtual circuit number in a virtual circuit data packet is typically changed at each intermediate link between the source and the destination(s).

As will be discussed in more detail below, the invention disclosed herein concerns a new type of packet-switched network with datagram address-based routing that addresses the silicon bottleneck problem and enables high-quality multimedia services to be widely used.

### SUMMARY

The present invention overcomes the limitations and disadvantages of the prior art by providing a highly efficient protocol for delivery of high-quality multimedia communication services, such as video multicasting, video on demand, real-time interactive video telephony, and high-fidelity audio conferencing over a packet-switched network. The invention addresses the silicon bottleneck problem and enables high-quality multimedia services to be widely used. The invention can be expressed in a variety of ways, including methods, systems, and data structures.

One aspect of the invention involves a method in which a packet of multimedia data is forwarded through a plurality of logical links in a packet-switched network using a datagram address contained in the packet (i.e., datagram address-based routing). Address information in partial address subfields of the datagram address self-directs the packet through a plurality of top-down logical links. (The plurality of top-down logical links are a subset of the plurality of logical links.) The packet remains unchanged as it is transferred along multiple links in the plurality of logical links.

Another aspect of the invention involves a system which includes a packet-switched network containing a plurality of logical links. The system also includes a plurality of data packets passing through the plurality of logical links. Each of the packets includes a header field. The header field includes a datagram address that contains a plurality of partial address subfields. Address information in the partial address subfields self-directs each packet through a plurality of top-down logical links. Each of the packets also includes a payload field containing multimedia data. Each of the packets remains unchanged as it is transferred along multiple links in the plurality of logical links.

Another aspect of the invention involves a data structure for a packet that includes a header field and a payload field. The header field includes a datagram address that contains a plurality of partial address subfields. Address information in the partial address subfields self-directs the packet through a plurality of top-down logical links that forms a subset of a plurality of logical links in a packet-switched network. The payload field contains multimedia data. The packet remains unchanged as it is transferred along multiple links in the plurality of logical links in the network.

The foregoing and other embodiments and aspects of the present invention will become apparent to those skilled in the art in view of the subsequent detailed description of the invention taken together with the appended claims and the accompanying figures.

### BRIEF DESCRIPTION OF THE FIGURES

FIG. 1a is a diagram illustrating a switching taxonomy for telecommunications networks.

FIG. 1b is a block diagram illustrating prior art forwarding of a data packet from one Ethernet LAN to another Ethernet LAN using Internet Protocol (IP).

FIG. 1c is a block diagram illustrating exemplary forwarding of a data packet from one MediaNet LAN to another MediaNet LAN using MediaNetwork Protocol (MP).

FIG. 1d is a block diagram illustrating an exemplary MediaNetwork Protocol metro network.

FIG. 2 is a block diagram illustrating an exemplary MediaNetwork Protocol nationwide network.

FIG. 3 is a block diagram illustrating an exemplary MediaNetwork Protocol global network.

FIG. 4 is a diagram illustrating an exemplary network architecture of MediaNet Protocol.

FIG. 5 is a diagram illustrating an exemplary format of a MediaNet Protocol packet.

FIG. 6 is a diagram illustrating an exemplary format of a MediaNet Protocol network address.

FIG. 7 is a diagram illustrating another exemplary format of a MediaNet Protocol network address.

FIG. 8 is a diagram illustrating another exemplary format of a MediaNet Protocol network address.

FIG. 9a is a diagram illustrating another exemplary format of a MediaNet Protocol network address.

FIG. 9b is a diagram illustrating an exemplary format of a MediaNet Protocol network address mainly for components that are directly connected to an edge switch.

FIG. 9c is a diagram illustrating an exemplary format of a MediaNet Protocol network address mainly for multipoint-communication services.

FIG. 10 is a block diagram illustrating an exemplary service gateway.

FIG. 11a is a block diagram illustrating another exemplary service gateway.

FIG. 11b is a block diagram illustrating another exemplary service gateway.

FIG. 12 is a block diagram illustrating an exemplary server group.

FIG. 13 is a block diagram illustrating an exemplary server system.

FIG. 14 is a flow chart illustrating one workflow process that an exemplary server group performs.

FIG. 15 is a flow chart illustrating one workflow process that an exemplary server group follows to configure a MediaNet Protocol network.

FIG. 16 is a flow chart illustrating one workflow process that an exemplary server group follows to perform multiple call check processing.

FIG. 17a is a time sequence diagram illustrating the performance of multiple call check processing by multiple server systems in an exemplary server group.

FIG. 17b is a time sequence diagram illustrating the performance of multiple call check processing by multiple server systems in an exemplary server group.

FIG. 18 is a block diagram illustrating an exemplary edge switch.

FIG. 19 is a block diagram illustrating an exemplary switching core in an edge switch.

FIG. 20 is a flow chart illustrating one process that an exemplary color filter in an edge switch follows to respond to a packet from an interface of an exemplary switching core.

FIG. 21 is a flow chart illustrating one process that an exemplary color filter in an edge switch follows to respond to a packet from another interface of an exemplary switching core.

FIG. 22 is a flow chart illustrating one process that an exemplary color filter in an edge switch follows to respond to a packet from another interface of an exemplary switching core.

FIG. 23 is a block diagram illustrating an exemplary partial address routing engine in an edge switch.

FIG. 24 is a flow chart illustrating one process that an exemplary partial address routing unit in an edge switch follows to process exemplary MediaNet Protocol unicast packets.

FIG. 25 is a flow chart illustrating one process that an exemplary partial address routing unit in an edge switch follows to process exemplary MediaNet Protocol multipoint-communication packets.

FIG. 26a is a diagram illustrating an exemplary mapping table in an edge switch.

FIG. 26b is a diagram illustrating an exemplary lookup table in an edge switch.

FIG. 27 is a block diagram illustrating an exemplary packet distributor in an edge switch.

FIG. 28 is a block diagram illustrating an exemplary gateway.

FIG. 29 is a block diagram illustrating an exemplary access network configuration that includes a village switch and building switches.

FIG. 30 is a block diagram illustrating an exemplary access network configuration that include a village switch and curb switches.

FIG. 31 is a block diagram illustrating an exemplary access network configuration that include an office switch.

FIG. 32 is a block diagram illustrating an exemplary middle switch.

FIG. 33 is a block diagram illustrating an exemplary switching core in a middle switch.

FIG. 34 is a flow chart illustrating one process that an exemplary color filter in a middle switch follows to respond to a packet from an interface of an exemplary switching core.

FIG. 35 is a block diagram illustrating an exemplary partial address routing engine in a middle switch.

FIG. 36 is a flow chart illustrating one process that an exemplary partial address routing unit in a middle switch follows to process exemplary MediaNet Protocol multipoint-communication packets.

FIG. 37 is a diagram illustrating an exemplary lookup table in a middle switch.

FIG. 38 is a block diagram illustrating an exemplary packet distributor in a middle switch.

FIG. 39 is a diagram illustrating an exemplary Destination Address search table.

FIG. 40 is a flow chart illustrating one process that one embodiment of an uplink packet filter follows to perform uplink packet filter checks.

FIG. 41 is a flow chart illustrating one process that one embodiment of an uplink packet filter follows to perform traffic flow monitoring.

FIG. 42a is a block diagram illustrating one embodiment of a home gateway.

FIG. 42b is a block diagram illustrating an alternative embodiment of a home gateway.

FIG. 43 is a structural diagram illustrating an exemplary embodiment of a master user switch.

FIG. 44 is a block diagram illustrating an exemplary embodiment of a master user switch.

FIG. 45 is a flow chart illustrating one process that one embodiment of a user switch follows to forward a downstreaming packet.

FIG. 46 is a flow chart illustrating one process that one embodiment of a user switch follows to forward an upstreaming packet.

FIG. 47 is a block diagram illustrating an exemplary embodiment of a general purpose teleputer.

FIG. 48 is a block diagram illustrating an exemplary embodiment of a special purpose teleputer.

FIG. 49 is a block diagram illustrating an exemplary embodiment of a MediaNet Protocol set-top-box.

FIG. 50 is a block diagram illustrating an exemplary embodiment of media storage.

FIG. 53a is a time sequence diagram illustrating exemplary call setup and call communication stages of one media telephony service session between two user terminals that depend on a single service gateway.

FIG. 53b is a time sequence diagram illustrating an exemplary call clear-up stage of one media telephony service session between two user terminals that depend on a single service gateway.

FIG. 54a is a time sequence diagram illustrating an exemplary call setup stage of one media telephony service session between two user terminals that depend on two service gateways.

FIG. 54b is a time sequence diagram illustrating an exemplary call communication stage of one media telephony service session between two user terminals that depend on two service gateways.

FIG. 55a is a time sequence diagram illustrating an exemplary call clear-up stage of one media telephony service session between two user terminals that depend on two service gateways.

FIG. 55b is a time sequence diagram illustrating an exemplary call clear-up stage of one media telephony service session between two user terminals that depend on two service gateways.

FIG. 56 is a diagram illustrating a service window that an exemplary graphical user interface supports.

FIG. 57 is a diagram illustrating an exemplary series of windows that a user navigates through to respond to a service request.

FIG. 58a is a time sequence diagram illustrating exemplary call setup and call communication stages of one media on demand session between two MP-compliant components that depend on a single service gateway.

FIG. 58b is a time sequence diagram illustrating an exemplary call clear-up stage of one media on demand session between two MP-compliant components that depend on a single service gateway.

FIG. 59a is a time sequence diagram illustrating exemplary call setup and call communication stages of one media on demand session between two MP-compliant components that depend on two service gateways.

FIG. 59b is a time sequence diagram illustrating an exemplary call clear-up stage of one media on demand session between two MP-compliant components that depend on two service gateways.

FIG. 60 is a time sequence diagram illustrating an exemplary membership establishment process that involves a meeting informer for one media multicast session.

FIG. 61 is a time sequence diagram illustrating an exemplary membership establishment process for one media multicast session.

FIG. 62a is a time sequence diagram illustrating exemplary call setup and call communication stages of one media multicast session among a calling party, called party 1, and called party 2 that depend on a single service gateway.

FIG. 62b is a time sequence diagram illustrating an exemplary call clear-up stage of one media multicast session among a calling party, called party 1, and called party 2 that depend on a single service gateway.

FIG. 63a is a time sequence diagram illustrating the performance of multiple call check processing for a media multicast request by multiple server systems in an exemplary server group.

FIG. 63b is a time sequence diagram illustrating the performance of multiple call check processing for a media multicast request by multiple server systems in an exemplary server group.

FIG. 64 is a time sequence diagram illustrating exemplary party addition, party removal, and member query processes in a media multicast session.

FIG. 65 is a block diagram illustrating an exemplary MediaNetwork Protocol metro network.

FIG. 66a is a time sequence diagram illustrating an exemplary call setup stage of one media multicast session among a calling party, called party 1, and called party 2 that depend on different service gateways.

FIG. 66b is a time sequence diagram illustrating an exemplary call communication stage of one media multicast session among a calling party, called party 1, and called party 2 that depend on different service gateways.

FIG. 66c is a time sequence diagram illustrating an exemplary call clear-up stage of one media multicast session among a calling party, called party 1, and called party 2 that depend on different service gateways.

FIG. 66d is a time sequence diagram illustrating an exemplary call clear-up stage of one media multicast session among a calling party, called party 1 and called party 2 that depend on different service gateways.

FIG. 67a is a time sequence diagram illustrating the performance of multiple call check processing for a media multicast request by multiple server systems in different exemplary server groups.

FIG. 67b is a time sequence diagram illustrating the performance of multiple call check processing for a media multicast request by multiple server systems in different exemplary server groups.

FIG. 68 is a time sequence diagram illustrating an exemplary media broadcast session between a user terminal and a media broadcast program source within a single service gateway.

FIG. 69a is a time sequence diagram illustrating exemplary call setup and call communication stages of one media broadcast session between a user terminal and a media broadcast program source that depend on different service gateways.

FIG. 69b is a time sequence diagram illustrating an exemplary call clear-up stage of one media broadcast session between a user terminal and a media broadcast program source that depend on different service gateways.

FIG. 70 is a time sequence diagram illustrating exemplary call setup and call communication stages of one media transfer session between media storage devices and a program source within a single service gateway.

FIG. 71 is a time sequence diagram illustrating an exemplary call clear-up stage of one media transfer session between media storage devices and a program source within a single service gateway.

FIG. 72a is a time sequence diagram illustrating an exemplary call setup stage of one media transfer session between media storage devices and a program source that depend on different service gateways.

FIG. 72b is a time sequence diagram illustrating an exemplary call communication stage of one media transfer session between media storage devices and a program source that depend on different service gateways.

FIG. 73a is a time sequence diagram illustrating an exemplary call clear-up stage of one media transfer session between media storage devices and a program source that depend on different service gateways.

FIG. 73b is a time sequence diagram illustrating an exemplary call clear-up stage of one media transfer session between media storage devices and a program source that depend on different service gateways.

FIG. 73c is a time sequence diagram illustrating an exemplary call clear-up stage of one media transfer session between media storage devices and a program source that depend on different service gateways.

### DETAILED DESCRIPTION

A computer system, method, and data structure for providing high-quality multimedia communication services are described. In the following description, numerous specific details are set forth to provide a thorough understanding of the present invention. However, it will be apparent to one of ordinary skill in the art that the invention may be practiced without these particular details. In other instances, networking elements and technologies such as fiber optic cabling, optical signals, twisted pair wires, coaxial cables, the Open Systems Interconnection (“OSI”) model, Institute of Electrical and Electronics Engineers (“IEEE”) 802 standards, wireless technologies, in-band signaling, out-of-band signaling, leaky bucket model, Small Computer System Interface (“SCSI”), Integrated Drive Electronics (“IDE”), enhanced IDE and Enhanced Small Device Interface (“ESDI”), flash technology, disk drive technology, and Synchronous Dynamic Random Access Memory (“SDRAM”) are well known and thus do not need to be described in great detail.

1. Definitions

Different sources often give networking terms somewhat different meanings or scope. For example, the term “host” can mean: 1) a computer that allows users to communicate with other computers on a network; 2) a computer with a Web server that serves Web pages for one or more Web sites; 3) a mainframe computer; or 4) a device or program that provides services to some smaller or less capable device or program. THUS, IN THE SPECIFICATION AND CLAIMS, THE DEFINITIONS SET FORTH IN THIS SECTION FOR THE FOLLOWING TERMS SHALL BE CONTROLLING.

access network (“ACN”) An ACN generally refers to one or more middle switches (“MXs”), which collectively provide home gateways (“HGWs”) with access to service gateways (“SGWs”), the network backbone, and other networks that are connected to SGWs.

asynchronous Asynchronous means that nodes are not limited to sending/transmitting data to other nodes during a set time slot. Asynchronous is the opposite of synchronous.

(Note that there is a second sense in which “asynchronous” is sometimes used in networking, namely for describing a method of data transmission in which data is transmitted in small fixed-size groups, typically corresponding to a single character and containing between five and eight bits, and in which the timing of the bits is not directly determined by some form of clock. Each group of data is typically preceded by a start bit and followed by a stop bit. This second sense of asynchronous can be contrasted with a second sense of “synchronous,” namely a method of data transmission in which data is transmitted in larger blocks with accompanying clock information. For example, the actual data signal may be encoded by the transmitter in such a way that a clock signal can be recovered from the data signal at the receiver. The second sense of synchronous transmission, which permits much higher data rates than the second sense of asynchronous transmission, is used by the technologies disclosed herein. However, when the specification and claims use the terms synchronous and asynchronous, they are referring to whether or not nodes are limited to transmitting data to other nodes during fixed time slots.)

bottom-up logical links Bottom-up logical links are logical links that a data packet passes through between a source host and a switch associated with a server group that governs the source host. The switch and the server group are typically part of the service gateway that is logically closest to the source host.

circuit-switched network A circuit-switched network establishes a dedicated end-to-end circuit between two (or more) hosts for the duration of their communications session. Examples of circuit-switched networks include the telephone network and ISDN.

color subfield A color subfield is an address subfield in a packet that facilitates forwarding of the packet, for example by giving information about the type of service the packet is providing (e.g., unicast communication and multipoint communication) and/or the type of node that the packet is being sent to or sent from. The information in the color subfield helps direct the handling of a packet by nodes along the transmission path.

computer-readable medium A medium containing data in a form that can be accessed by an automated sensing device. Examples of computer-readable media include, without limitation: (a) magnetic disks, cards, tapes, and drums, (b) optical disks, (c) solid-state memory, and (d) a carrier wave.

connectionless A connectionless network is a packet-switched network in which there is no set up phase prior to sending data packets. For instance, no control packets are sent prior to sending data packets. Examples of connectionless networks include Ethernet, IP networks using the User Datagram Protocol (UDP), and Switched Multi-megabit Data Service (SMDS).

connection oriented A connection-oriented network is a packet-switched network in which there is a set up phase prior to sending data packets. For example, in IP networks using the Transmission Control Protocol (TCP), control packets are sent as part of a handshaking procedure prior to sending data packets. The term “connection-oriented” is used because the sender and the receiver are only loosely connected. Packet-switched networks with virtual circuit-based routing are also connection oriented.

control packet A packet whose payload includes control information that facilitates out-of-band signaling control.

datagram address-based routing In datagram address-based routing, the network uses the destination address contained in a data packet to forward the data packet through the network. Datagram address-based routing can either be connectionless or connection oriented.

datagram address An address within a packet that is used in a datagram address-based-routing system to route the packet from a source to a destination.

data link layer address A data link layer address is given its conventional meaning, i.e., an address that is used to carry out some or all of the functionality of the data link layer in the OSI model. A data link address is typically used to identify a physical network interface to a node. Various references also refer to a data link layer address as a “physical address” and a “Media Access Control (AC)” address. Note that a network need not implement the complete OSI model in order to implement some or all of the functionality of the data link layer in the OSI model. For example, a MAC address in Ethernet networks is a data link layer address, even though Ethernet does not implement the complete OSI model.

data packet A packet whose payload includes data, such as multimedia data or an encapsulated packet. The payload of a data packet may also include control information to facilitate in-band signaling control.

filter A filter separates or categorizes packets based on a set of terms and/or criteria.

flat addressing structure A flat addressing structure is organized into a single group (in a manner similar to U.S. Social Security numbers). Thus, it provides no information about the network topology that can be used to help route a packet. Ethernet MAC addresses are one example of a flat addressing structure.

forwarding (switching or routing) Forwarding means moving a packet from an input logical link to an output logical link. For the technologies disclosed and claimed herein, the terms forwarding, switching, and routing can be used interchangeably. Similarly, the terms switch and router (i.e., devices that perform packet forwarding) can be used interchangeably. On the other hand, in prior art technologies, switching refers to forwarding a frame at the data link layer, routing refers to forwarding a packet at the network layer, a switch refers to a device that forwards frames at the data link layer, and a router refers to a device that forwards packets at the network layer. In some contexts, routing refers to determining the packet's transmission path or some portion thereof (e.g., the next hop).

frame See packet.

header The portion of a packet preceding the payload, which typically contains a destination address and other fields.

hierarchical addressing structure A hierarchical addressing structure includes numerous partial address subfields that successively narrow an address until it points to a single node (in a manner similar to a street address). A hierarchical addressing structure may 1) reflect the topological structure of the network; 2) assist in forwarding a packet, and 3) identify the exact or approximate geographical locations of nodes on a network.

host A computer that allows users to communicate with other computers on a network.

interactive game box (“IGB”) An IGB generally refers to a game console that operates online games and allows its user to interact with other users on a network.

intelligent home appliance (“IHA”) An IHA generally refers to an appliance that has decision making capabilities. For instance, a smart-air-conditioner is an IHA that automatically adjusts its cold air output according to changes in room temperature. Another example is a smart meter reading system that automatically reads a water meter at a certain time each month and sends the meter information to the water supplier.

logical link A logical connection between two nodes. It will be understood that forwarding a packet through a logical link means that the packet is actually transferred through one or more physical links.

media broadcast (“MB”) MB in an MP network is a type of multicast in which a media program source sends the media program to any user that connects to the media program source. From the user's perspective, MB seems like traditional broadcasting technologies (e.g., television and radio). However, from a system perspective, MB is different from traditional broadcasting because the media program is not transmitted to a user unless the user requests a connection.

media multicast (“MM”) MM refers to transmission of multimedia data between a single source and multiple designated destinations.

MP-compliant MP-compliant refers to a component, device, node, or media program that adheres to the protocol requirements of MediaNetwork Protocol (“MP”).

multimedia data Multimedia data includes, without limitation, audio data, video data, or a combination of both audio data and video data. Video data includes, without limitation, static video data and streaming video data.

network backbone A network backbone broadly refers to a transmission medium that connects various nodes or endpoints. For example, an optical network that uses fiber optic cabling and optical signals for data transmission is a network backbone.

network layer address A network layer address is given its conventional meaning, i.e., an address that is used to carry out some or all of the functionality of the network layer in the OSI model. A network address is typically used to send a packet anywhere in an internetwork. Various references also refer to a network layer address as a “logical address” and a “protocol address.” Note that a network need not implement the complete OSI model in order to implement some or all of the functionality of the network layer in the OSI model. For example, an IP address in TCP/IP networks is a network layer address, even though TCP/IP does not implement the complete OSI model.

node (resource) A node is an addressable device attached to a network.

non-peer-to-peer “Non-peer-to-peer” means that two nodes at the same level in a hierarchical network cannot send packets to each other directly. Instead, the packets must pass through the parent node(s) of the two nodes. For example, two UTs that are attached to the same HGW must send packets to each other via the HGW, rather than sending packets to each other directly. Similarly, two MXs that are attached to the same SGW must send packets to each other via the SGW, rather than sending packets to each other directly. Two MXs that are attached to different SGWs must also send packets to each other via their parent SGWs, rather than sending packets to each other directly.

packet A small block of data used for transmission in a packet-switched network. A packet includes a header and a payload. For the technologies disclosed and claimed herein, the terms packet, frame, and datagram can be used interchangeably. On the other hand, in prior art technologies, a frame refers to a data unit at the data link layer and packet/datagram refers to a data unit at the network layer.

packet-switched network A packet-switched network sends data packets between hosts using either virtual circuit-based routing or datagram address-based routing. A packet-switched network does not use dedicated end-to-end circuits to communicate between hosts.

physical link A real connection between two nodes.

resource See node.

routing See forwarding.

self-direct A packet is self-directed over a series of logical links if the packet contains information that directs the packet to be forwarded over the series of logical links. For some of the technologies disclosed herein, the information in the partial address subfields directs the packet to be forwarded over a series of top-down logical links. In contrast, in conventional routing, a packet address is used to look up a next hop entry in a routing table. By analogy to a cross country road trip, the former case is like having a set of directions from the last exit on a freeway to your final destination, whereas the latter case is like having to stop and ask directions at every intersection. Also note that for some of the technologies disclosed herein, the series of top-down logical links over which a packet is self-directed may not include all of the top-down logical links, e.g., the packet may reach the destination node via a local broadcast on an MP LAN. Nevertheless, the packet is still self-directed over a series of top-down logical links and a routing table is still not required over the top-down logical links.

server group A collection of server systems.

server system A system on a network that provides one or more services to other systems connected to the network.

switching See forwarding.

synchronous Synchronous means that nodes are limited to sending/transmitting data to other nodes during a set time slot. Synchronous is the opposite of asynchronous. (See asynchronous for a second context in which these two terms are used.)

teleputer A teleputer generally refers to a single apparatus that can process both MP packets and non-MP packets, such as IP packets.

top-down logical links Top-down logical links are logical links that a data packet passes through between a switch associated with a server group that governs a destination host and the destination host. The switch and the server group are typically part of the service gateway that is logically closest to the destination host.

transmission path A transmission path is the set of the logical links that a packet travels on between a source node and a destination node.

unchanged packet A packet remains unchanged as it is transferred along a first logical link and a second logical link if the packet has the same bits in the second logical link as it had in the first logical link. Note that the packet would still be unchanged along these logical links if it was altered and then restored as it traveled through a switch/router between the first and second logical links. For example, the packet could have an internal tag added to it as it entered the switch/router that was removed when the packet left the switch router, thereby leaving the packet with the same bits on the second logical link as it had on the first logical link. Also, the packet would still be unchanged if any physical layer headers and/or trailers (e.g., start-of-stream and end-of-stream delimiters) were different on the first and second logical links because the physical layer headers and/or trailers are not part of the packet.

unicast Unicast refers to transmission of multimedia data between a single source and a single designated destination.

user terminal (“UT”) A UT includes, without limitation, a personal computer (“PC”), a telephone, an intelligent home appliance (“IHA”), an interactive game box (“IGB”), a set-top box (“STB”), a teleputer, a home server system, media storage, or any other device used by an end user to send or receive multimedia data over a network.

virtual circuit-based routing In virtual circuit-based routing, the network uses a virtual circuit number associated with a data packet to forward the data packet through the network. The virtual circuit number is typically included in the data packet header and is typically changed at each intermediate node between the sender and the receiver(s). Examples of packet-switched networks with vial circuit-based routing include SNA, X.25, frame relay, and ATM networks. We also include networks using MPLS, which adds a virtual circuit-like number (label) to a data packet to forward the data packet, in this category.

wirespeed A switch operates at wirespeed if it can forward packets as fast as the packets arrive at the switch.

2. Overview

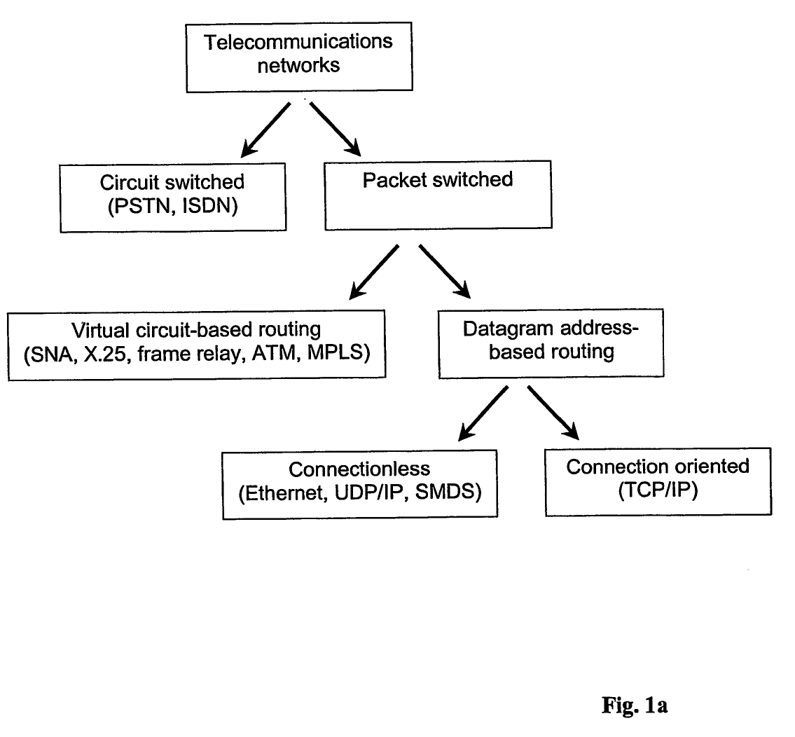

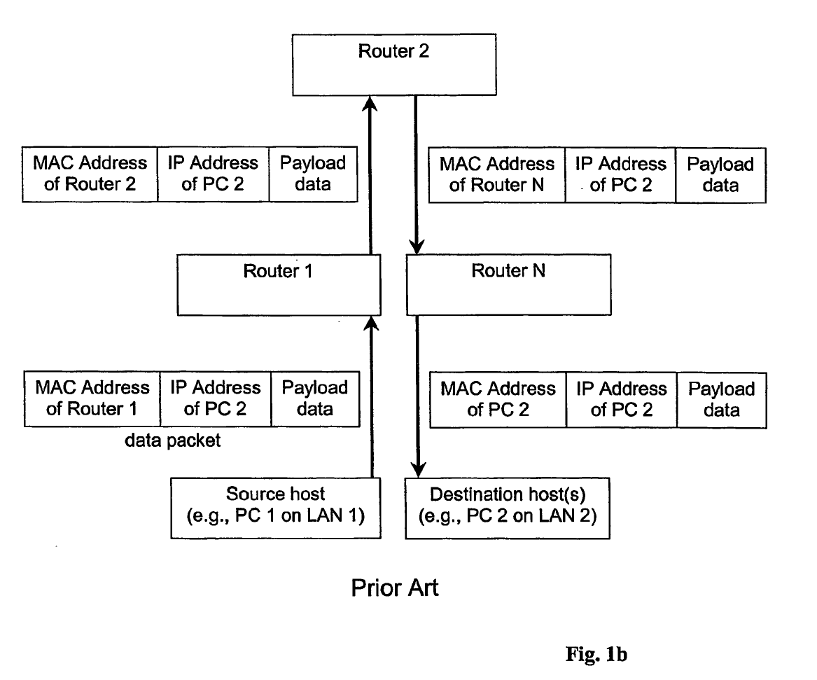

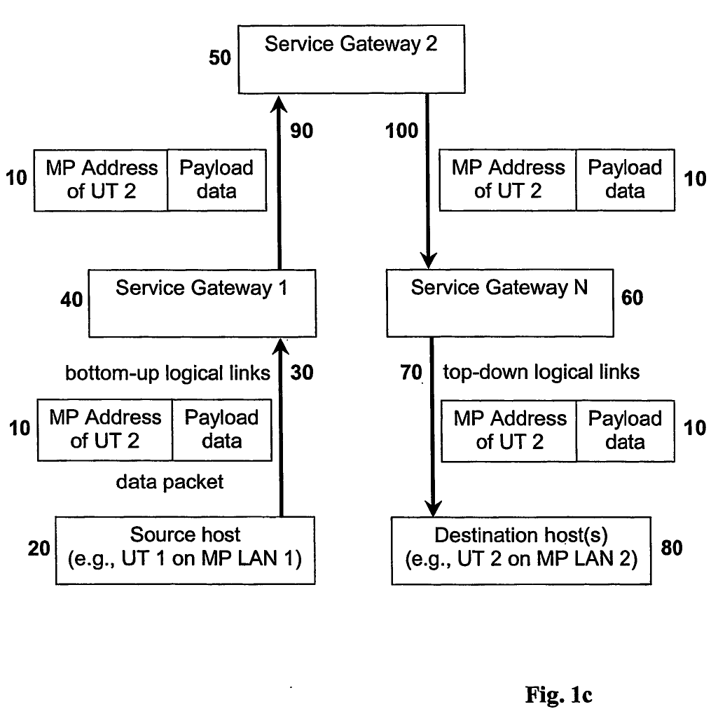

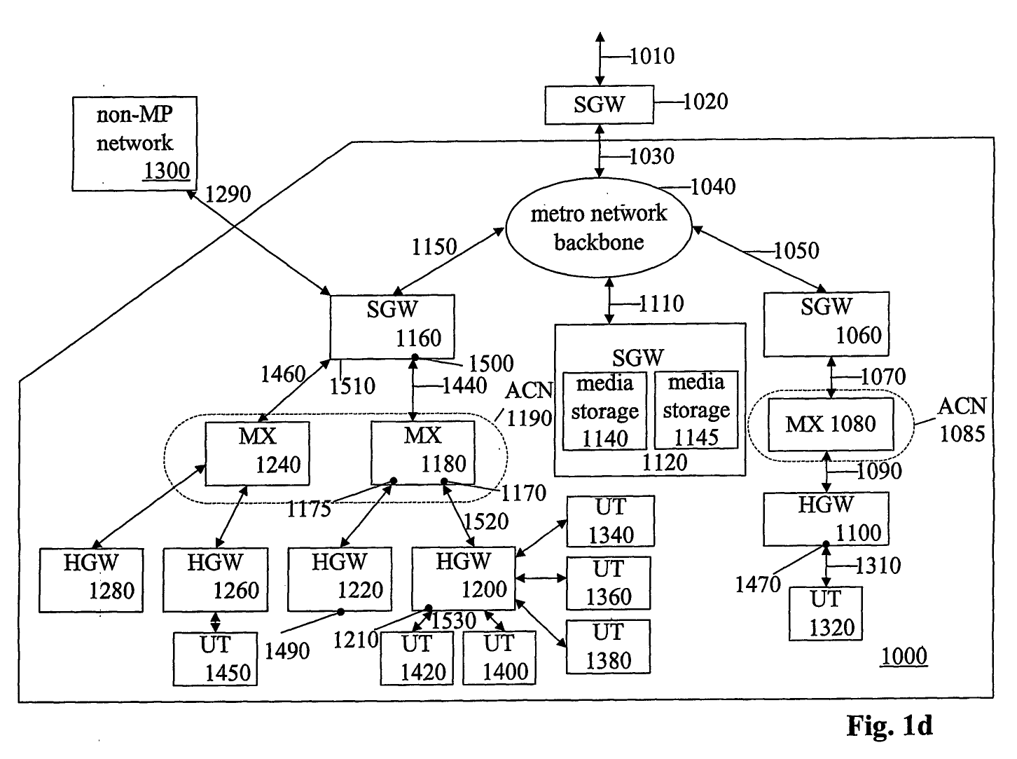

MP networks address the silicon bottleneck problem by using systems, methods, and data structures that reduce the amount of processing that needs to be performed on a data packet as the packet travels through the MP networks. For example, as shown schematically in FIG. 1(c), consider an MP data packet 10 traveling from one MP LAN [e.g., an MP home gateway (HGW) and its associated user switches (UXs) and user terminals (UTs)] to a second MP LAN.

To send an MP packet of multimedia data from its source to its destination, MP networks use a single datagram address that operates as both a data link layer address and a network layer address. An MP datagram address can be used to send MP packets anywhere in an MP global network, MP nationwide network, or MP metro network. An MP datagram address is also used to identify a physical network interface to a node. In this example, the MP datagram address of interest is the MP address of the destination host 80 [e.g., UT 2 on LAN 2 in FIG. 1(c)].

An MP datagram address uniquely identifies the network attachment point (port) of an MP-compliant component in an MP network. Thus, if the MP-compliant component bound to a port is physically moved to a different part of the MP network, the MP address stays with the port, not the component. (However, an MP-compliant component may optionally include a globally unique hardware identifier that is permanently bound to the component and which may be used for network management purposes, accounting, and/or addressing in wireless applications.)

An MP address field includes partial address subfields that represent a hierarchy of regions served by an MP network. As explained below, this hierarchical addressing structure is used to self-direct the MP data packet through a plurality of top-down logical links towards the destination host(s) because some of the partial address subfields correspond to a top-down path that leads to a network attachment point.

An MP address field optionally includes one or more color subfields. A color subfield facilitates forwarding of an MP packet, for example by providing information about the type of service the MP packet is providing and/or the type of node that the packet is being sent to or sent from.

To transfer data from a source host 20 (e.g., UT 1 on MP LAN 1) to destination host(s) 80, the data is broken up into a number of MP data packets. Each MP data packet includes a header that contains the MP address of the destination host (e.g., UT 2 on MP LAN 2). This MP address usually remains unchanged as the MP data packet 10 is forwarded through a plurality of logical links to the destination host 80. Moreover, as explained below, in sharp contrast to the prior art data packet considered in the Background section [FIG. 1(b)], the entire MP data packet 10 remains unchanged as it is transferred along multiple links in a plurality of logical links between the source host 20 and the destination host 80.

As shown in FIG. 1(c), the MP data packet 10 initially makes its way to a switch in Service Gateway 1 40. For simplicity and ease of comparison with FIG. 1(b), FIG. 1(c) represents a plurality of bottom-up logical links 30 that the MP packet 10 will pass through (i.e., logical links between UT 1, a home gateway, an access control network of middle switches, and a switch in Service Gateway 1) as a single arrow between the source host 20 and Service Gateway 1 40. Because of the non-peer-to-peer nature of the user terminals, home gateways, and access control networks, this bottom-up packet transmission through a series of switches can be done without using any forwarding/switching/routing tables. In other words, because of the MP network topology, an MP packet created by a UT will automatically be forwarded for routing to a switch in the service gateway governing the UT (unless the packet is destined for another UT in the same home gateway).

After Service Gateway 1 40 receives the MP data packet from the source host 20, Service Gateway 140 determines the next hop in the path that the MP packet will take. To make this determination, Service Gateway 140 extracts some of the partial address subfields from the MP address and uses these subfields to look up the next-hop switch (e.g., a switch in Service Gateway 2) in a forwarding table. This forwarding table can be calculated off-line because of the predictable traffic flow in an MP network. The traffic flow is predictable in part because the video streams that typically comprise the bulk of the traffic have predictable flows and in part because an MP network may include components (packet equalizers) that smooth the flow of packets (e.g., by adding packets or holding back packets).

After identifying the next hop, Service Gateway 1 40 sends the MP packet, usually unchanged, on its way towards Service Gateway 2 50. There is typically no need to change the packet because the MP datagram address operates as both a network layer address and a data link layer address. (As explained below, there is no need to change the packet in unicast services, but there are a few instances in multipoint communication services where a session number in an MP packet may be changed at a switch in a service gateway. Even in these few instances, however, the MP packet will still pass through multiple logical links without being changed.) Moreover, an MP packet does not need to include a “time-to-live” field, so there is no need to decrement this field at each hop. In addition, if the packet is unchanged, there is no need to recalculate the MP packet checksum.

The same type of processing that occurred at Service Gateway 1 40 is repeated at Service Gateway 2 50 and at each intermediate service gateway until the MP data packet 10 arrives at a service gateway, such as Service Gateway N 60 in FIG. 1(c), that governs the destination host 80. For simplicity and ease of comparison with FIG. 1(b), FIG. 1(c) represents a plurality of top-down logical links 70 that the MP packet 10 will pass through (i.e., logical links between a switch in Service Gateway N, an access control network of middle switches, a home gateway, and UT 2) as a single arrow between Service Gateway N 60 and the destination host 80. The address information in some of the partial address subfields of the MP datagram address self-directs the MP packet 10 through a plurality of these top-down logical links 70, without using routing tables. Thus, an MP packet 10 can be transferred along a majority of the logical links between a source and destination without using or calculating routing tables. Moreover, this transfer may optionally be done at wirespeed.

As this example illustrates, numerous prior art processing steps are simplified or eliminated in MP networks, thereby addressing the silicon bottleneck problem.

These and other aspects of the methods, systems, and data structures used in the present invention will be described in more detail below.

3. Network Architecture

3.1 MediaNetwork Protocol Metro Network

FIG. 1d is a block diagram of an exemplary MediaNetwork Protocol (“MP”) metro network, or MP metro network 1000. An MP metro network generally encompasses a network backbone, a number of MP-compliant service gateways (“SGWs”), a number of MP-compliant access networks (“ACNs”), a number of MP-compliant home gateways (“HGWs”) and a number of MP-compliant endpoints, such as media storage units and user terminals (“UTs”). For discussion purposes, the illustrated connections among the mentioned network backbone, SGWs, ACNs, HGWs and MP-compliant endpoints in FIG. 1d, such as 1290, 1460, 1440, 1150, 1010, 1030, 1110, 1050, 1070, 1090 and 1310 are logical ink. Although the following discussions assume that each of these logical links uses a single physical link, they can also use multiple physical links. For example, one embodiment of logical link 1030 uses multiple physical connections between SGW 1020 and metro network backbone 1040.

Moreover, an MP-compliant component has one or more network attachment points (or “ports”) that connect to these logical links. For instance, UT 1320 connects to HGW 1100 as shown in FIG. 1d via port 1470. Similarly, HGW 1200 connects to MX 1180 via port 1170.

“MP-compliant” refers to a component, device, node, or media program that adheres to the protocol requirements of MP. An ACN generally refers to one or more middle switches (“MXs”), which collectively provides the HGWs with access to the aforementioned SGWs, the network backbone, and other networks that are connected to the SGWs. The subsequent MediaNetwork Protocol section and the Operational Examples section provide more detailed discussions of MP.

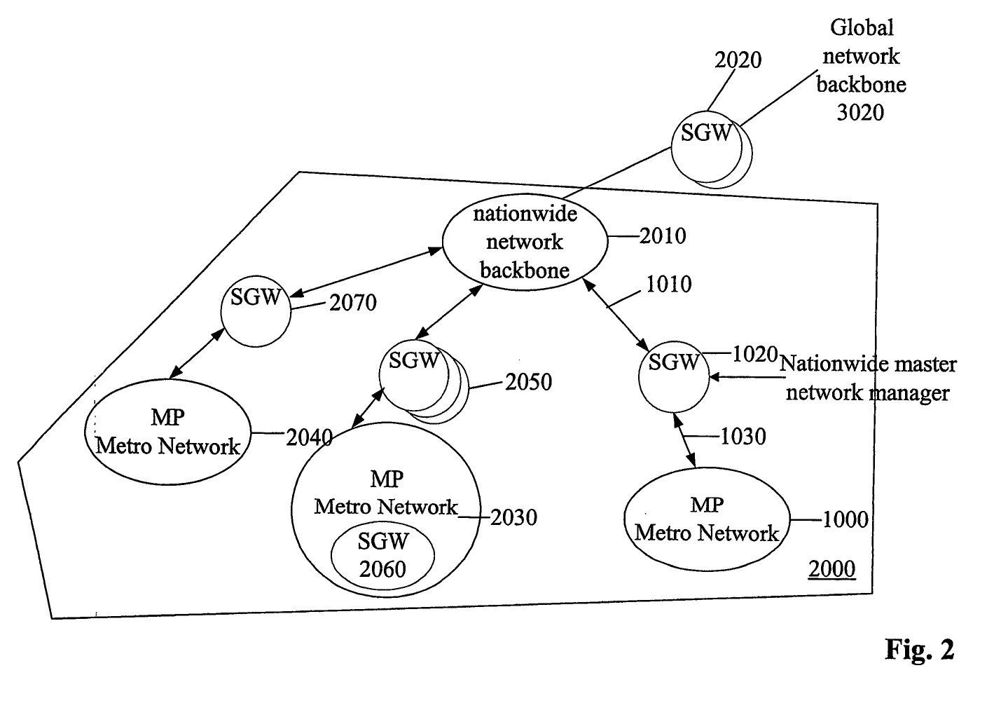

In MP metro network 1000, SGW 1060, SGW 1120 and SGW 1160 are some exemplary nodes that are connected to metro network backbone 1040. These SGWs possess the intelligence at the edge of metro network backbone 1040 to deliver data and services in accordance with MP within MP metro network 1000 and/or to other non-MP networks such as non-MP network 1300. Some examples of non-MP network 1300 include, without limitation, any IP-based network, PSTN, or any wireless technology-based network, such as Global System for Mobile Communications (“GSM”), General Packet Radio Service (“GPRS”), Code-Division Multiple Access (“CDMA”) or Local Multipoint Distribution Services (“LMDS”) based networks. In addition, SGW 1020 facilitates communication between MP metro network 1000 and other MP metro networks such as MP metro network 2030 as shown in FIG. 2. Although FIG. 1d and FIG. 2 illustrate SGW 1020 to be an SGW within MP nationwide network 2000 but not within MP metro network 1000 for discussion purposes, it will be apparent to a person of ordinary skill in the art to describe SGW 1020 in other manners (e.g., SGW 1020 is part of MP metro network 1000) without exceeding the scope of the present invention.

One embodiment of MP metro network 1000 further distributes the “intelligence at the edge” to two types of SGWs in particular, one of the SGWs becomes a “metro master network manager”, whereas the other SGWs that are on metro network backbone 1040 become “slaves” to the metro master network manager. Thus, if SGW 1160 serves as the metro master network manager, SGWs 1060 and 1120 would then become the “metro slave network managers” to SGW 1160. While the slave SGWs remain in charge of controlling and responding to their dependent ACNs, HGWs and UTs, master SGW 1160 can execute functions that are not available to the slave SGWs. Some examples of these functions include, without limitation, configuration of the slave SGWs, and examination, maintenance, and management of the bandwidth and processing resources of MP metro network 1000.

In addition to the connections to network backbone (e.g., 1040, 2010 and 3020) and non-MP network (e.g., 1300), the SGWs also support connections to various types of MP-compliant components and access networks. For example, as shown in FIG. 1d, SGW 1060 connects with MX 1080 in ACN 1085 through logical link 1070. Similarly, SGW 1160 connects with MX 1180 and MX 1240 in ACN 1190 through logical links 1440 and 1460, respectively. The subsequent Service Gateway section provides more detailed discussion of the SGWs.

The activities of the MXs in exemplary ACN 1085 and ACN 1190 in MP metro network 1000 include, without limitation, examining, switching, and transmitting packets towards appropriate destinations. In addition to the connections to SGWs, the MXs in ACNs can also connect to one or more HGWs. As illustrated in FIG. 1d, MX 1080 in ACN 1085 connects to HGW 1100 via logical link 1090. In ACN 1190, MX 1180 connects to HGW 1200 and HGW 1220, whereas MX 1240 connects to HGW 1260 and HGW 1280. The subsequent Access Network section provides more detailed discussion of the ACNs and the Mxs.

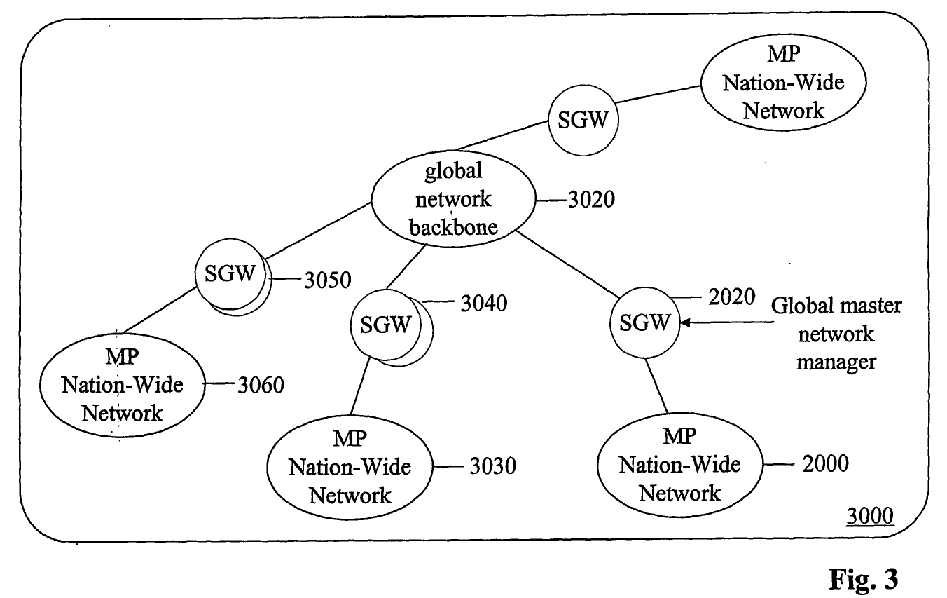

The exemplary HGW 1100, HGW 1200, HGW 1220, HGW 1260 and HGW 1280 broadly provide a common platform for UTs to attach to and for the attached UTs to communicate with one another or to communicate with other end systems. For example, UT 1320 is attached to HGW 1100 and thus is capable of communicating with any of UT 1340, UT 1360, UT 1380, UT 1400, UT 1420 and UTs that reside in MP global network 3000 (as shown in FIG. 3). Also, UT 1320 has access to media storage devices 1140 and 1145. The UTs generally interact with users, respond to user requests, process packets from the HGWs, and deliver and present user-requested data and/or services to end users. The subsequent Home Gateway and User Terminal sections provide more detailed discussions on the HGWs and the UTs, respectively.

The exemplary media storage devices 1140 and 1145 broadly refer to a cost-effective storage technology that stores multimedia content. Such content may include, without limitation, movies, television programs, games, and audio programs. The subsequent Media Storage section provides more detailed discussion of the media storage units.

Although MP metro network 1000 in FIG. 1d includes a specific number of MP-compliant components in one exemplary configuration, it will be apparent to one of ordinary skill in the art that MP metro network 1000 can be designed and implemented with a different number and/or with a different configuration of MP-compliant components without exceeding the scope of the present invention.

3.2 MediaNetwork Protocol Nationwide Network

FIG. 2 is a block diagram of an exemplary MP nationwide network 2000. Similar to master and slave SGWs on MP metro network 1000, MP nationwide network 2000 also divides up the intelligence of its SGWs on nationwide network backbone 2010 by designating SGW 1020 as a “nationwide master network manager.” The activities of SGW 1020 include, without limitation, configuring other SGWs on nationwide network backbone 2010, and examining, maintaining, and managing the bandwidth and processing resources of nationwide network 2000.

3.3 MediaNetwork Protocol Global Network

FIG. 3 is a block diagram of an exemplary MP global network 3000. MP global network 3000 designates SGW 2020 as a “global master network manager.” The activities of SGW 2020 include, without limitation, configuring other SGWs on global network backbone 2010, and examining, maintaining, and managing the bandwidth and processing resources of MP global network 3000.

Although each of the discussed MP networks (i.e., MP metro network 1000, MP nationwide network 2000, and MP global network 3000) has one designated master network manager, it will be apparent to one of ordinary skill in the art to further distribute the intelligence at the edge of a network backbone to more than one master SGW without exceeding the scope of the present invention. In addition, if a master SGW malfunctions, a backup SGW can replace the broken master SGW.

4. MediaNetwork Protocol (“MP”)

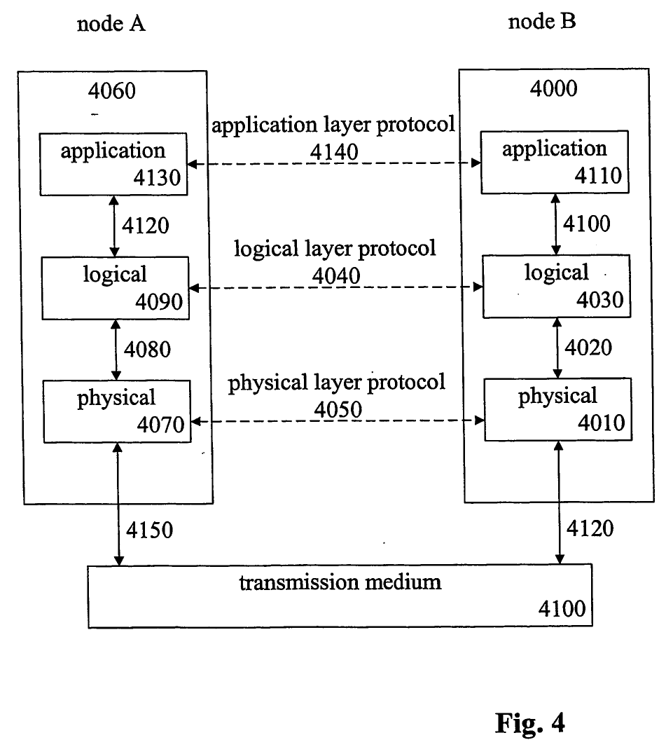

FIG. 4 illustrates an exemplary network architecture of MP. Specifically, MP has three independent layers: a physical layer, a logical layer, and an application layer. The rules and conventions that enable a physical layer such as physical layer 4070 on host A 4060 to communicate with another physical layer such as physical layer 4010 on host B 4000 are collectively known as physical layer protocol 4050. Similarly, logical layer protocol 4040 and application layer protocol 4140 facilitate communications between logical layers 4090 and 4030 and application layers 4130 and 4110, respectively.

In addition, between each pair of adjacent layers, such as physical layer 4070 and logical layer 4090 or logical layer 4090 and application layer 4130, there exists an interface, such as logical-physical interface 4080 and application-logical interface 4120, respectively. These interfaces define the primitive operations and services the lower layers offer to the upper layers.

4.1 Physical Layer

An MP physical layer, such as physical layer 4010, offers certain services to an MP logical layer, such as logical layer 4030, and shields logical layer 4030 from the implementation details of physical layer 4010. In addition, physical layers 4010 and 4070 are also responsible for providing interfaces to transmission medium 4100, such as physical-layer-to-transmission-medium interfaces 4150 and 4120, and for transmitting unstructured bits over transmission medium 4100. Some examples of transmission medium 4100 include, without limitation, twisted pair wires, coaxial cables, fiber optic cables, and carrier waves.

In one embodiment of an MP network, such as MP metro network 1000 (FIG. 1d), the physical links used by logical links 1010, 1030, 1040, 1050, 1070, 1090, 1310, 1110, 1440, 1460, 1150, 1520, 1530, and 1290 may have different transmission mediums. For instance, the transmission medium that supports logical link 1310 can be a coaxial cable, and the transmission medium for logical link 1050 can be a fiber optic cable. It will be apparent to one of ordinary skill in the art to implement MP metro network 1000 with other combinations of transmission mediums that have not been discussed and yet still remain within the scope of the present invention.

When MP metro network 1000 utilizes different transmission mediums, the MP-compliant components on the network will also have distinct sets of physical layers to interface with these mediums. For example, if the transmission medium that supports logical link 1310 is a coaxial cable and the transmission medium for logical link 1070 is a fiber optic cable, HGW 1100 and UT 1320 would share one set of physical layers that differs from the set SGW 1060 and MX 1080 would share. Although a physical layer that interfaces with a coaxial cable may specify different physical properties of the interface to the cable, different representation of bits, and different bit transmission procedures than a physical layer that interfaces with a fiber optic cable, these physical layers still facilitate transmission of unstructured bits. In other words, the various types of transmission mediums (e.g., coaxial and fiber optic cables) in an MP network all transmit unstructured bits.

4.2 Logical Layer

Logical layers 4030 and 4090 of MP (FIG. 4) include functions that are typically performed by the data link layer, the network layer, the transport layer, the session layer and the presentation layer of the OSI model. These functions include, without limitation, organizing bits into packets, routing packets, and establishing, maintaining, and terminating connections among systems.

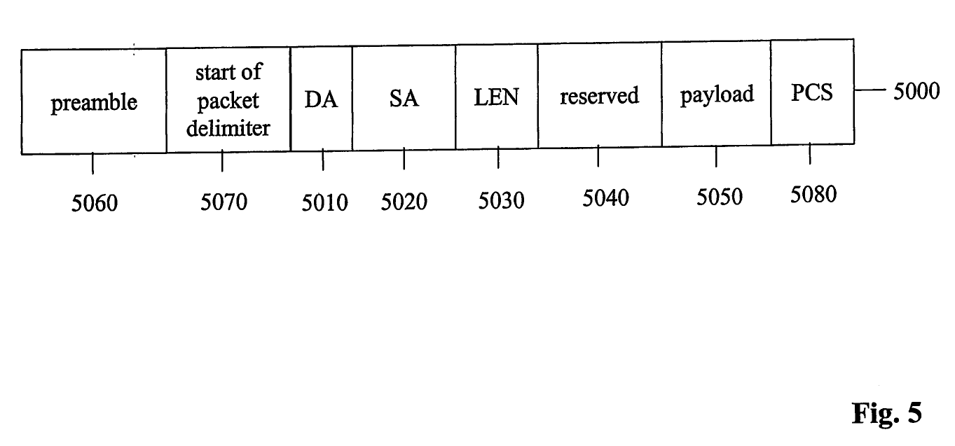

One of the functions of an MP logical layer is to organize unstructured bits from an MP physical layer into packets. FIG. 5 illustrates an exemplary format of MP packet 5000. MP packet 5000 includes preamble 5060, start of packet delimiter 5070, and packet check sequence (“PCS”) 5080. Preamble 5060 contains a specific bit pattern that allows the clock of host B 4000 to synchronize with (recover) the clock of host A 4060. Start of packet delimiter 5070 contains another bit pattern to denote the start of the packet itself

PCS field 5050 contains a cyclic redundancy check value to detect errors in a received MP packet.

MP packet 5000 can be a variable-length packet and has destination address (“DA”) field 5010, source address (“SA”) field 5020, length (“LEN”) field 5030, reserved field 5040 and payload field 5050.

DA field 5010 contains destination information for MP packet 5000, and SA field 5020 contains source information for MP packet 5000. LEN field 5030 contains length information of MP packet 5000. Payload field 5050 contains either multimedia data or control information. It will be apparent to one of ordinary skill in the art to implement MP with a different packet format than the discussed formats of MP packet 5000 and yet remain within the scope of MP (e.g., rearranging the field sequences or adding new fields).

An exemplary embodiment of the MP logical layer defines two types of MP packets: MP control packets and MP data packets. MP control packets carry control information in payload field 5050 (FIG. 5), whereas MP data packets carry data, such as multimedia data or an encapsulated packet, in payload field 5050. However, some MP data packets may also include control information along with the data in payload field 5050. Such MP data packets thus facilitate in-band signaling control, as opposed to MP control packets that facilitate out-of-band signaling control. Some exemplary MP packets are shown in the following MP Packet Table:

MP Packet Table

| | MP Packet | |
|---|---|---|
| MP Packet Name | Type | General Functionality |
| Bulletin packet | Control | A server group uses this packet to |
| | | deliver information (e.g., network |
| | | addresses of server systems) to MP- |
| | | compliant components |
| Network status query packet | Control | A server group sends this packet to |
| | | obtain status (e.g., bandwidth usage) of |
| | | an MP-compliant component |
| Network status response packet | Control | An MP-compliant components sends |
| | | this packet, which contains the requested |
| | | information, back to the requesting |
| | | component |
| Media Telephony Service | Control | An MP-compliant component sends this |
| (“MTPS”) request packet | | packet to request an MTPS session |
| MM/MB/MD/MT request | Control | Analogous to the MTPS request packet, |
| packet | | an MP-compliant component sends this |
| | | packet to request a particular type of |
| | | session/service |
| MTPS request response | Control | A server group sends this packet, which |
| packet | | indicates the status of the request, back |
| | | to the requesting component |
| MM/MB/MD/MT request | Control | Analogous to the MTPS request |
| response packet | | response packet, a server group sends |
| | | this packet, which indicates the status of |
| | | the request, back to the requesting |
| | | component |
| MTPS/MD/MT setup packet | Control | A server group sends this packet, which |
| | | sets up the uplink packet filters |
| | | (“ULPFs”) in one or more switches |
| | | along the transmission path |
| MM/MB setup packet | Control | Analogous to the MTPS/MD/MT setup |
| | | packet, a server group sends this packet, |
| | | which sets up the uplink packet filters |
| | | (“ULPFs”) and the lookup tables in the |
| | | switches along the transmission path |
| MTPS maintain packet | Control | A server group sends this packet to the |
| | | switches along the transmission path to |
| | | maintain the status of a call. |
| MM/MB/MD/MT maintain | Control | Analogous to the MTPS maintain |
| packet | | packet, a server group sends this packet |
| | | to the switches along the transmission |
| | | path to maintain the status of a particular |
| | | type of session/service |
| MTPS clear-up packet | Control | An MP-compliant component sends this |
| | | packet to terminate an MTPS session |
| MM/MB/MD/MT clear-up | Control | Analogous to the MTPS clear-up packet, |
| packet | | an MP-compliant component sends this |
| | | packet to terminate a particular type of |
| | | session/service |
| Address mapping query | Control | An MP-compliant component sends this |
| packet | | packet to the address mapping server |
| | | system of a server group to inquire about |
| | | addressing mapping information |
| Address mapping response | Control | The address mapping server system |
| packet | | responds to the query of the MP- |
| | | compliant component via this packet |
| Accounting status query | Control | An MP-compliant component sends this |
| packet | | packet to the accounting server system |
| | | of a server group to inquire about the |
| | | relevant accounting status of the |
| | | participating parties in a requested |
| | | session (e.g., the accounting status of the |
| | | payor for the session) |
| Accounting status response | Control | The accounting server system responds |
| packet | | to the MP-compliant component's query |
| | | with this packet |
| Indication | Control | One server system uses this packet to |
| (connection/setup/maintain/ | | send information to another server |
| clearup) packet | | system |
| Indication response (or | Control | A response to the indication packet |
| acknowledgement) packet | | above |
| Network resource approval | Control | A call processing server system sends |
| query packet | | this packet to the network management |
| | | server system in a server group to ask |
| | | for approval to process a requested |
| | | service |
| Network resource approval | Control | The network management server system |
| query response packet | | responds to the approval request of the |
| | | call processing server system with this |
| | | packet |
| Meeting inform packet | Control | A party sends relevant meeting |
| | | information (e.g., time, topic and subject |
| | | matter of the meeting) via this packet to |
| | | a list of invited parties to an MM session |
| Meeting member | Control | A party uses this packet to send a list of |
| | | the invited parties to an MM session to a |
| | | meeting informer (discussed in the |
| | | Operational Examples section below) |
| Member packet | Control | This packet contains membership |
| | | information of the participants in an |
| | | MM session |
| Data packet | Data | This packet contains audio, video, a |
| | | combination of audio and video |
| | | information, or an encapsulated non-MP |
| | | packet |
| Manipulation | Data | A UT uses this in-band signaling packet |
| | | to manipulate (e.g., pause, rewind and |
| | | stop) multimedia services (e.g., MD) |
| Menu packet | Data | This in-band signaling packet contains |
| | | audio and/or video information for |
| | | presenting a selectable “menu” to a user |
| | | and also the control information that |
| | | corresponds to the selections in the |
| | | menu |

The subsequent sections will describe some of these MP packets further. However, it will be apparent to a person of ordinary skill in the art that the table above includes an exemplary, but not exhaustive, list of MP packet types.

To interoperate with non-MP networks, one embodiment of MP logical layer encapsulates non-MP data, or data that non-MP networks (e.g., IP, PSTN, GSM, GPRS, CDMA, and LMDS) support, into MP-encapsulated packets. An MP-encapsulated packet still follows the same format as MP packet 5000, but its payload field 5050 contains non-MP data. For packet-switched non-MP networks, payload field 5050 contains a non-MP packet, either in whole or in part.

Another function of the MP logical layer is to support addressing schemes that enable packet delivery: 1) within MP networks, 2) among MP networks, and 3) between MP networks and non-MP networks. Some supported address types include, without limitation, user name, user address and network address. In addition, one embodiment of MP logical layer also supports hardware identification (“hardware ID”). Hardware ID can be used for addressing (e.g., wireless applications), but is more typically used for accounting or network management purposes (see below).

In an exemplary MP network, each MP-compliant component has a unique hardware ID, which is typically generated and assigned by industry groups and MP-compliant component manufacturers. In one implementation, both the discussed “master network manager” and “slave network managers” of this MP network can use this hardware ID to ensure that the components on the network are: 1) manufactured by authorized MP-compliant manufacturers and/or 2) permitted to be on the network.

In addition to hardware ID, an exemplary MP logical layer supports multiple types of identifiers for users on an MP network. Specifically, the identifiers include user names, user addresses and network addresses. A user name corresponds to one or more user addresses, and a user address maps to a network address. For example, the user name “WWW.MediaNet_Support.com” could correspond to the user address “650-470-0001” of employee 1, “650-470-0002” of employee 2 and “650470-0003” of employee 3 in the support department of a company. The user address “650-470-0001”, in turn, maps to a network address that identifies the network attachment point (port) that corresponds to the UT that employee 1 uses. Similarly, the user addresses “650-470-0002” and “650470-0003” map to the network addresses that identify the ports that correspond to the UTs that employee 2 and employee 3 use, respectively.

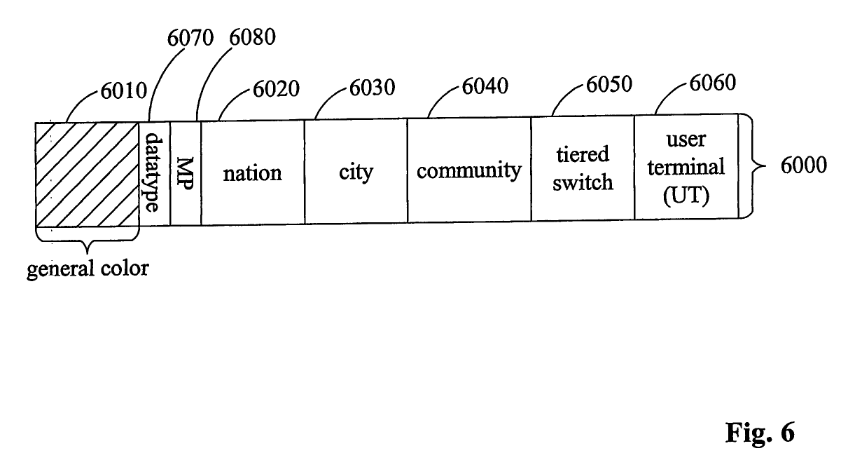

The network address of an MP-compliant component in one embodiment of an MP network is bound to a port used by the MP-compliant component. The network address identifies the MP-compliant component that directly connects to the port. Suppose SGW 1160 assigns a network address, “0/1/111123/45178/2 (general color subfield 6010/data type subfield 6070/MP subfield 6080/nation subfield 6020/city subfield 6030/community subfield 6040/tiered switch subfield 6050/user terminal subfield 6060)”, to port 1210 of HGW 1200. “0/1/1/1/23/45/78/2” becomes the assigned network address of UT 1420, because UT 1420 is directly connected to HGW 1200 via port 1210. Thus, if employee 1 in the above example uses UT 1420, the aforementioned user address “650-470-0001” then maps to the network address “0/1/1/23/45/78/2”. [Note that the partial address subfields in the network address are described in more detail below. See FIG. 6 as well.]

User addresses are assigned to other network components besides the UTs. For example, the aforementioned industry groups and manufacturers may generate, assign and store user addresses in other NP-compliant components, such as the MXs in the ACNs. Similarly, media program operators, such as television programmers and operators of media-on-demand services, may generate and assign user addresses to media programs.

User names and user addresses are typically assigned by a network operator or an independent third-party organization that the network operator uses. Network addresses are assigned by the SGWs during network configuration (described in the Service Gateway section below). As an illustration, suppose a network operator wants the UTs connected to HGW 1200 in FIG. 1d to be known collectively as WWW.MediaNet Support.com. To do this, the network operator configuring SGW 1160 can create the user name “WWW.MediaNet_Support.com” and map this user name to the user addresses of the UTs connected to HGW 1200.

Unlike network addresses, which are bound to the ports, the assigned user name and the user addresses can remain unchanged even if modifications to the underlying MP network topology occur (e.g., reconfiguration of the network, including addition, removal, or transfer of one or more MP-compliant components). For example, assuming the UT that employee 1 uses is UT 1320 and the network operator managing MP metro network 1000 decides to connect UT 1320 to HGW 1220 (instead of HGW 1100) through port 1490, the network address identifying UT 1320 would change to the network address that binds port 1490 (instead of the network address that binds port 1470). Despite this network address change, the user name and the user address of employee 1 could remain the same.

As discussed above, an MP logical layer maps layers of identifiers, such as user name and user addresses, to network addresses. An MP network address provides several functions. It identifies a physical network interface to a node, such as an MP-compliant component on an MP network. It can be used to send packets anywhere in an MP internetwork. Because of its hierarchical structure, which reflects the topological structure of an MP network, an MP network address may also assist in forwarding a packet and identifying the exact or approximate geographical locations of nodes on an MP network. The MP network address can also specify tasks for the nodes to execute (e.g., using the partial address subfields to direct the packet through a series of logical links or using the color subfield to select a packet delivery mechanism).

FIG. 6 illustrates an exemplary network address 6000 that identifies the network attachment point (port) of an MP-compliant UT on MP global network 3000, such UT 1320 in FIG. 1d. Network address 6000 includes general color subfield 6010, data type subfield 6070, MP subfield 6080, and a hierarchy of partial address subfields, such as nation subfield 6020, city subfield 6030, community subfield 6040, tiered switch subfield 6050 and UT, subfield 6060. This hierarchical addressing structure reflects the network topology of MP global network 3000. Although some of these network address subfields are given geographic connotations (e.g., nation subfield 6020, city subfield 6030 and community subfield 6040), it will be apparent to one of skill in the art that these subfields merely represent a hierarchy of regions served by an MP network.

General color subfield 6010 of network address 6000 contains “color information” about the MP packet that facilitates forwarding of the packet. A recipient of an MP packet can process the packet based in part on the color information without having to inspect and/or analyze the entire packet. (As an aside, note that a “recipient” is not limited to the final recipient of the MP packet, such as a UT, but also includes the intermediate network components, such as, without limitation, the Mxs that handle the MP packet.) Some exemplary types of color information are shown in the following MP color table. Although the examples given in the MP color table describe color information for various types of service (e.g., unicast communication and multipoint communication), it will be apparent to a person of ordinary skill in the art to use the color information for other purposes, such as identifying the type of device that a packet is being sent from (source node) or sent to (destination node). As will be discussed below, color information helps direct the handling of packets by switches, thereby enabling simpler switches to be used.

MP Color Table

| Types of color information | General functionality |
|---|---|
| Unicast-setup | Sets up the uplink packet filters (“ULPFs”) |
| | in one or more switches along the |
| | transmission path |
| Unicast-data | Indicates that the packet is a data packet in |
| | a unicast communication session |
| Unicast-clearup | Resets the ULPFs in one or more switches |
| | along the transmission path |
| Multipoint-communication- | Sets up the lookup tables and the ULPFs in |
| setup | one or more switches along the |
| | transmission path |
| Multipoint-communication- | Indicates that the packet is a data packet in |
| data | a multipoint communication session |
| Multipoint-communication- | Maintains the values stored in the lookup |
| maintain | tables of the switches along the |
| | transmission path and/or collects call |
| | connection status information (e.g., error |
| | rate and number of packets lost) of a |
| | multipoint communication session |
| Multipoint-communication- | Resets the lookup tables and the ULPFs in |
| clearup | one or more switches along the |
| | transmission path; releases the reserved |
| | session number |
| Query | Indicates an inquiry from a requesting |
| | component and the recipient of the packet |
| | sends a response to the inquiry back to the |
| | requesting component |

Network address 6000 optionally has data type subfield 6070 and MP subfield 6080. In one implementation, data type subfield 6070 indicates the type of data that are to be exchanged. The types include, without limitation, audio data, video data, or a combination of the two. MP subfield 6080 indicates the type of packet that carries network address 6080. For instance, the packet can either be an MP packet or an MP-encapsulated packet. Alternatively, the information provided in data type subfield 6070 and/or MP subfield 6080 can be incorporated in general color subfield 6010 or in payload field 5050.

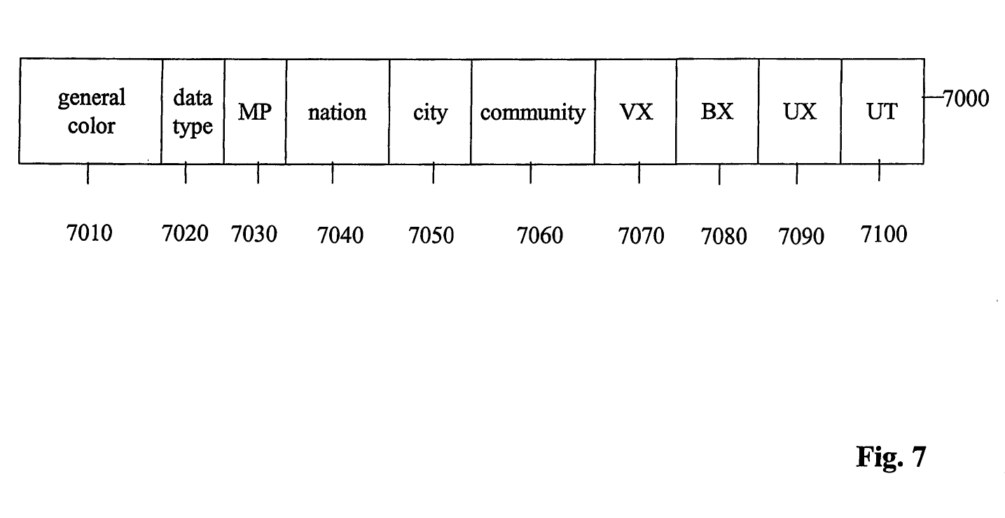

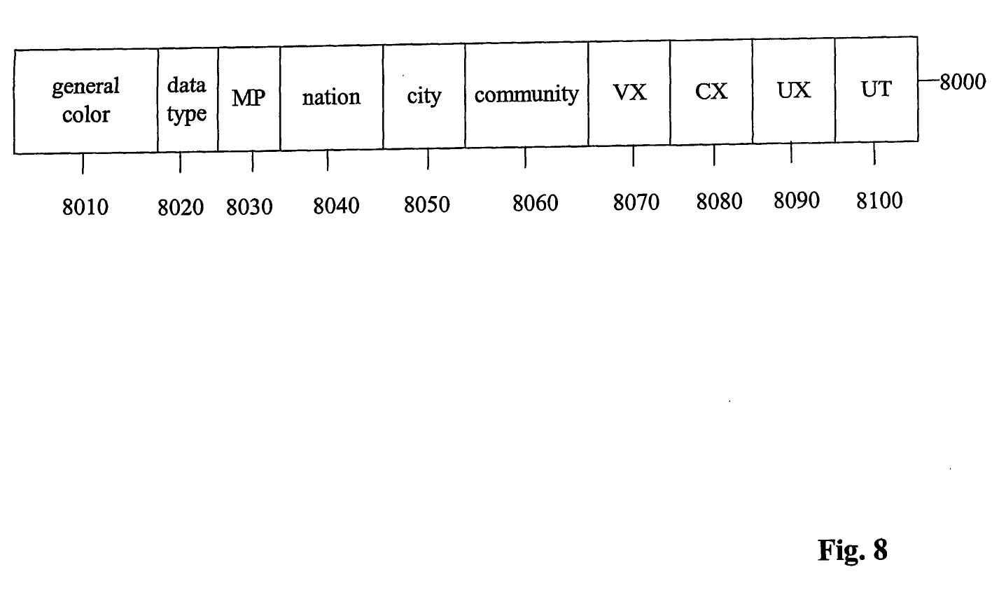

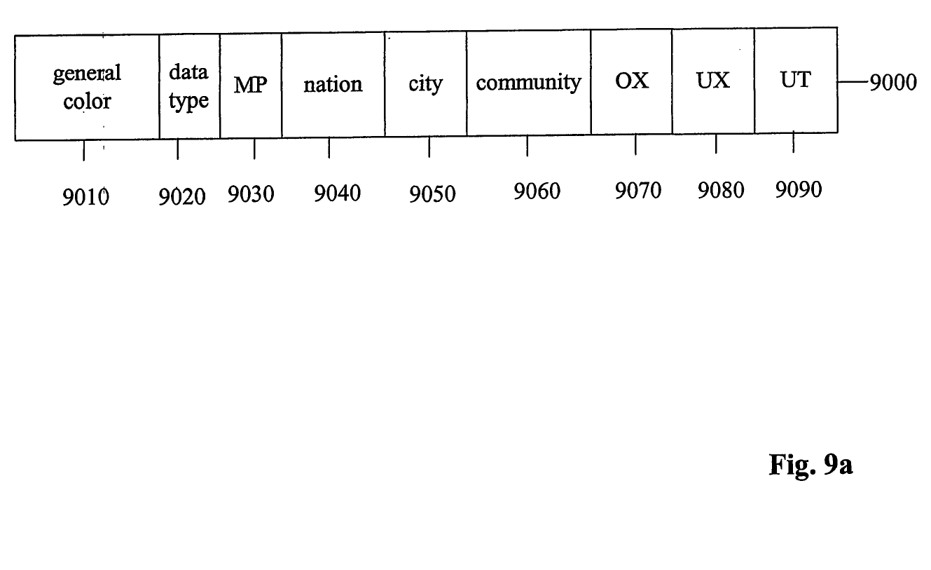

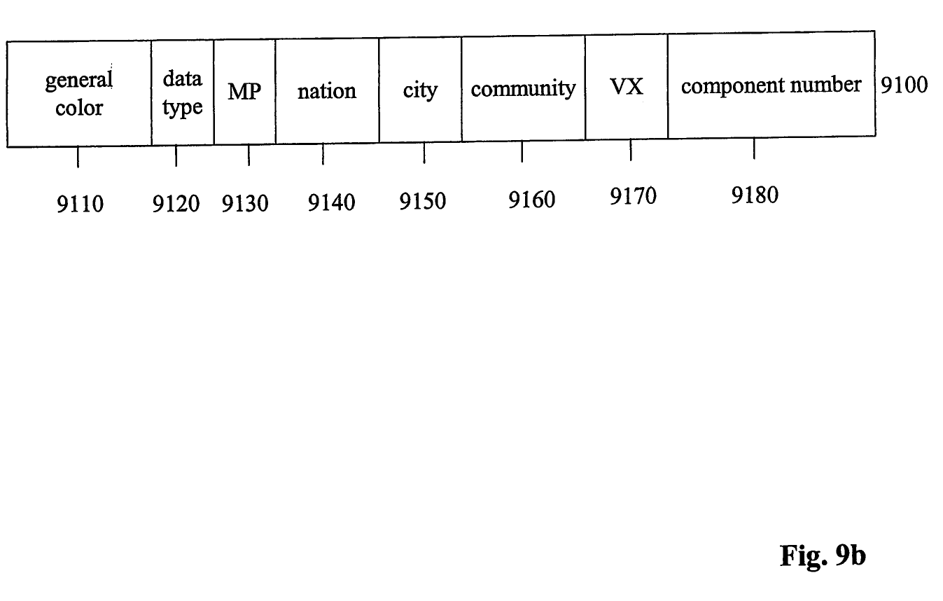

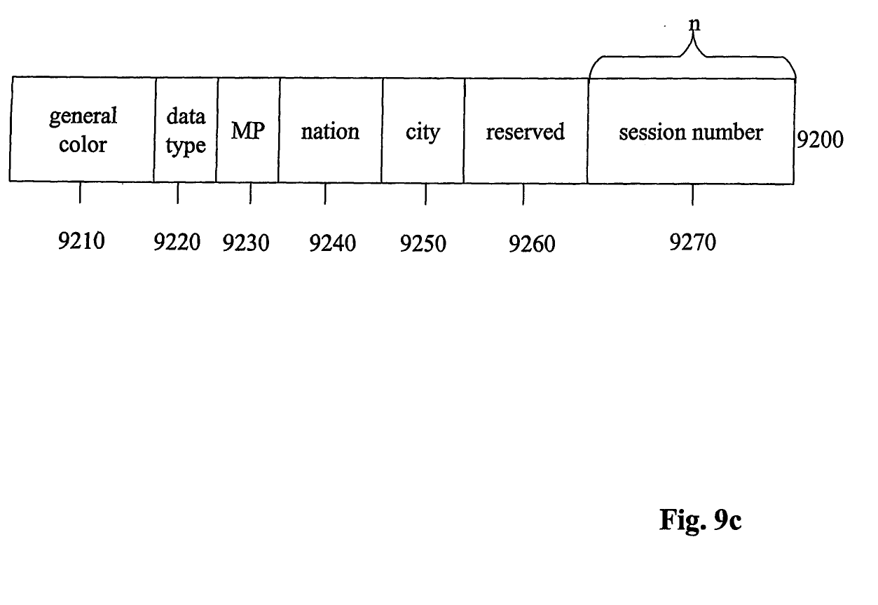

FIG. 7 illustrates a variant of exemplary network address 6000 that further divides tiered switch subfield 6050. Network address 7000 identifies the network attachment point (port) of a UT in an MP network that encompasses ACNs with multiple tiers of MXs. Specifically, tiered switch subfield 6050 in FIG. 6 has been further divided to village switch (“VX”) subfield 7070, building switch (“BX”) subfield 7080, and user switch (“UX”) subfield 7090 to reflect the tiered VX, BX and UX structure. FIGS. 8 and 9a illustrate other variants with different divisions of tiered switch subfield 6050. In FIG. 8, similar to network address 7000, network address 8000 has VX subfield 8070, curb switch (“CX”) subfield 8080 and UX 8090 that correspond to tiered switch subfield 6050 of network address 6000. In FIG. 9a, network address 9000 has office switch (“OX”) 9070 and UX 9080.

Subsequent mention of network address 6000 generally includes its derivative formats (i.e., network addresses such as 7000, 8000 and 9000 that further divide tiered switch subfield 6050), unless specifically stated otherwise. Also, subsequent Access Network and Home Gateway sections provide more detailed discussions of these derivative formats.

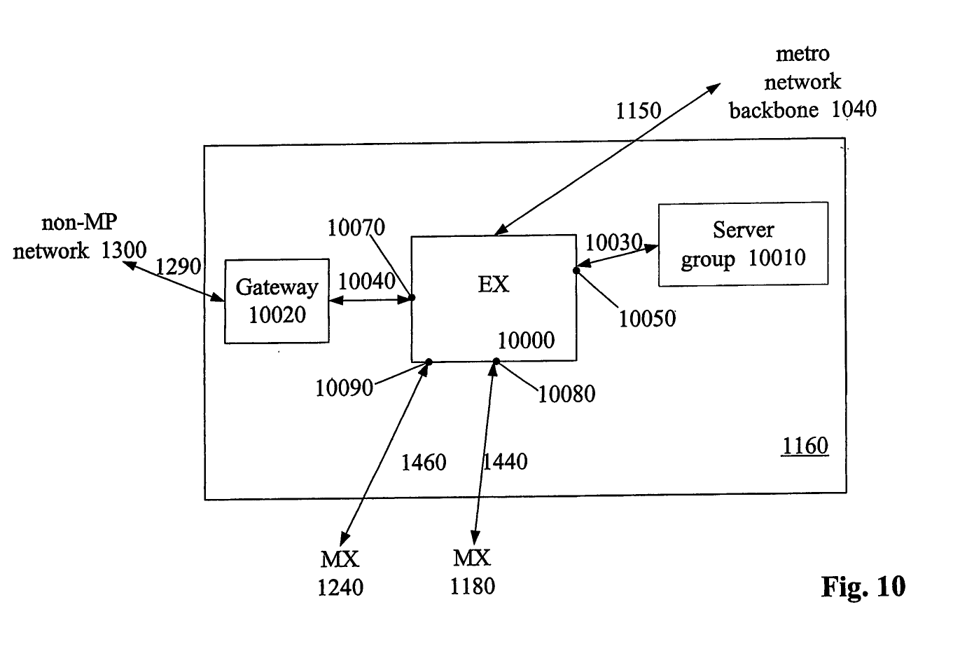

Although the aforementioned VX and OX subfields are primarily used to identify the village switches and office switches that an SGW governs, they can also be used to identify MP compliant components within an SGW. FIG. 9b illustrates an exemplary network address format (i.e., 9100) that identifies MP-compliant components (e.g., EX server group, gateway, and media storage) within an SGW. To signify that an MP packet is directed to a component other than media storage within an SGW, VX subfield 9170 of network address 9100 contains all zeros (“0000”). The remaining bits (component number subfield 9180) are used to identify a specific component within the SGW. Using SGW 1160 (FIG. 10) as an illustration, the network addresses that identify EX 10000, server group 10010 and gateway 10020 adhere to the format of network address 9100. These network addresses share the identical information in nation subfield 9140, city subfield 9150, community subfield 9160 and VX subfield 9170 (“0000”), but contain different information in component number subfield 9180 to identify these components. For example, EX 10000 may correspond to a component number of 1 in component number subfield 9180, whereas server group 10010 corresponds to 2, and gateway 10020 corresponds to 3.

On the other hand, to signify that an MP packet is directed to media storage within an SGW, VX subfield 9170 of network address 9100 contains “0001”. The remaining bits (component number subfield 9180) are used to identify a specific media storage within the SGW. Using SGW 1120 (FIG. 10) as an illustration, the network addresses that identify media storage 1140 and media storage 1145 adhere to the format of network address 9100. These two network addresses share the identical information in nation subfield 9140, city subfield 9150, community subfield 9160 and VX subfield 9170 (“0001”), but contain different information in component number subfield 9180 to identify the two media storage components. For example, media storage 1140 may correspond to a component number of 1 in component number subfield 9180, whereas media storage 1145 corresponds to 2. However, if the media storage corresponds to a UT (i.e., the media storage is not within an SGW), the network address that identifies this UT media storage follows the format of network address 6000 instead of the format of network address 9100 as discussed above.

It will be apparent to a person of ordinary skill in the art that the flags used to address components within an SGW can have a different bit sequence (i.e., other than either “0000” or “0001”), different length (i.e., more or less than the 4-bit length) and/or different location in an MP packet without exceeding the scope of the disclosed network addressing scheme.

In some types of multipoint communication [e.g., Media Multicast (“MM”) and Media Broadcast (“MB”)], three network address formats are used. Specifically, the formats of network address 6000 and 9100 are used to forward MP control packets towards their destinations. The format of network address 9200 is used to forward MP data packets towards their destinations. To signify that an MP packet is a data packet for multipoint communication, general color subfield 9210 of network address 9200 contains a specific bit sequence. Session number field 9270 identifies a specific session that the MP packet belongs to within an MP metro network. Suppose session number field 9270 has a length of n bits. The MP metro network that adopts the format of network address 9200 then supports 2ⁿ different multipoint communication sessions. It will be apparent to a person of ordinary skill in the art that session subfield 9270 can have a different length (e.g., include reserved subfield 9260) and/or different location in an MP packet without exceeding the scope of the disclosed network addressing scheme.

Although several network address formats have been demonstrated, a person of ordinary skill will recognize that the scope of MP covers other variant formats besides the discussed formats if the variant format identifies a physical network interface to a node and can be used to send a packet anywhere in an internetwork and/or uses a hierarchical address structure to help direct a packet towards its destination. Optionally, color subfield(s) may assist in forwarding a packet, too. It will also be apparent to one of ordinary skill in the art to apply the discussed network address formats for UTs to other MP-compliant components, such as MXs. For instance, the network address of MX 1080 follows the format of network address 6000, but UT subfield 6060 is filled with a particular bit pattern, such as either all 0's or all 1's. Alternatively, if the network address identifying UT 1420 (“UT_network_address”) follows the format of network address 6000, one possible network address for identifying MX 1080 has the same information as the UT_network_address, except that its general color subfield 6010 contains MX device type information (instead of UT device type information).

Another function of an MP logical layer is to provide for the transfer of MP packets or MP-encapsulated packets in a predictable, secure, accountable, and expeditious manner. An exemplary MP logical layer facilitates this type of transfer by setting up a multimedia service (i.e., call setup stage) prior to providing the service (i.e., call communication stage). During the call setup stage, the transmission paths among the parties involved are determined for the purpose of admission control (resource management). The MP-compliant components along the transmission paths provide current bandwidth usage data to the server group(s) managing the service. The MP-compliant components along the transmission paths are also set up to help implement policy controls (e.g., permissible traffic type, traffic flow, and qualifications of the parties) in the subsequent call communication stage. The subsequent Service Gateway, Access Network, and Home Gateway sections will further explain some implementations of admission control and policy controls.

After the call setup stage, an exemplary MP logical layer supports traffic policing, for example, by regulating the flow of MP packets on an MP network using minimum rate delay equalization (“MDRE”) and by rejecting or admitting packets according to the parameters specified by the aforementioned admission control and/or policy controls. Traffic policing ensures the predictability and integrity of the traffic on an MP network during the call communication stage. More specifically, in one implementation, the source hosts (e.g., UTs, media storage devices, and server groups) that generate and send data packets into an MP network first pass the data packets through MDRE modules. One embodiment of MDRE follows the well-known leaky bucket model and as a result outputs evenly spaced data packets into the MP network. If the number of MP data packets that the MDRE module receives exceeds the buffer capacity of the MDRE, the MDRE module discards the overflow MP data packets. On the other hand, if the MP data packets arrive at the MDRE module at a rate lower than a preset value, the MDRE module sends “filler” MP data packets into the MP network to maintain a constant and predictable data rate.

In addition, other MP-compliant components on the MP network filter these evenly spaced MP data packets from the source hosts during the call communication stage to prevent unwanted packets from reaching the server groups of the SGWs. The subsequent Uplink Packet Filter section provides details of a filter that performs the aforementioned traffic policing functionality.

An exemplary MP logical layer also supports accounting policies that measure usage information during the call communication stage. The subsequent Server Group section and the Operational Examples section further explain implementations of the accounting functionality.

An exemplary MP logical layer facilitates rapid transfer of MP data packets through a plurality of logical links during the call communication stage. For example, suppose UT 1320 transmits unicast MP data packets to UT 1420. As explained below, because of the non-peer-to-peer structure of the MP network, MP data packets can be transmitted from UT 1320 to SGW 1060 along logical links 1310, 1090, and 1070 without calculating or using routing tables. The logical links between the source host (UT 1320) and the SGW logically closest to the source host (SGW 1060 here) are referred to as bottom-up logical links. Then, because of the predictable nature of multimedia data (e.g., the video streams that should comprise the bulk of MP network traffic have predictable flows) and the regulation of traffic flow on an M? network (discussed above), SGW 1060 can transmit the MP data packets to SGW 1160 along logical links 1050, 1040, and 1150 using a forwarding table that can be calculated off-line. Finally, the SGW closest to UT 1420 (i.e., SGW 1160) can transmit the MP data packets to UT 1420 along logical links 1440, 1520, and 1530 using partial address routing (explained below) to self direct the packet.

The logical links between the destination host (UT 1420 here) and the SGW logically closest to the destination host (SGW 1160 here) are referred to as top-down logical links. The use of partial address routing along top-down logical links also avoids the use of routing tables. Thus, the MP data packets can be transferred along a majority of the links between UT 1320 and UT 1420 without calculating or using routing tables. Moreover, for those few links that use forwarding tables, the forwarding tables can be calculated off-line. (Of course, the routing calculations could be done in real time, too.)

To further illustrate data transmission, consider the example just given (UT 1320 sending an MP data packet to UT 1420) in more detail. Assume the network address in the DA field of the MP data packet contains the following information (in accordance with the format of network address 6000, as shown in FIG. 6):
Nation subfield 6020—identifies SGW 2020 and indicates that UT 1420 belongs to MP nationwide network 2000 (FIG. 2).
City subfield 6030—identifies SGW 1020 and indicates that UT 1420 belongs to MP metro network 1000, as shown in FIG. 1d.
Community subfield 6040—identifies SGW 1160 and indicates that SGW 1160 governs UT 1420.
Tiered switch subfield 6050—is broken into two subfields, one subfield corresponds to port 1500 and identifies MX 1180, and the other subfield corresponds to port 1170 and identifies HGW 1200 to deliver the packet.
UT subfield 6060—corresponds to port 1210 and identifies UT 1420 to be the destination of the packet.

Data transmission in this unicast example can be separated into three different stages: bottom-up transmission of the packet through a plurality of logical links (bottom-up logical links) from the source host (UT 1320) to the SGW (SGW 1060) governing the source host (i.e., the SGW logically closest to the source host); transmission of the packet from the SGW governing the source host to the SGW (SGW 1160) governing the destination host (i.e., the SGW logically closest to the destination host); and top-down transmission of the packet through a plurality of logical links (top-down logical links) from the SGW governing the destination host to the destination host (UT 1420).

For bottom-up transmission, UT 1320 places its outgoing MP data packet on logical link 1310. If this outgoing MP packet is not for another UT that is connected to HGW 1100, HGW 1100 forwards this outgoing MP data packet to the next upstream MP-compliant component, namely MX 1080. In one implementation, this forwarding of the outgoing MP packet from HGW 1100 to MX 1080 does not involve analyzing the DA in the packet because of the non-peer-to-peer architecture among the HGWs (i.e., two HGWs that are attached to the same MX cannot directly communicate with one another and bypass the MX). In other words, HGW 1100 has no choice but to forward the packet upstream in order to reach another UT under a different HGW. Similarly, because the MXs in the ACNs are also non-peer-to-peer (i.e., two MXs that are attached to the same SGW cannot directly communicate with one another and bypass the SGW), MX 1080 also forwards the packet to SGW 1060 without examining the DA in the packet.

For transmission between SGWs, the SGW governing the source host (SGW 1060) examines nation 6020, city 6030, and community 6040 subfields in the DA of the MP data packet. If all three subfields match the corresponding subfields in the network address of SGW 1060, then the destination host is governed by SGW 1060 and top-down transmission commences. If nation 6020 and city 6030 subfields match the corresponding subfields in the network address of the SGW 1060, but the community subfields do not match, then the destination host resides in the same MP metro network, but is governed by a different SGW. If the nation subfields match, but the city subfields do not match, then the destination host resides in the same MP nationwide network, but is governed by an SGW in a different MP metro network. If the nation subfields do not match, then the destination host is governed by an SGW in a different MP nationwide network.

In this example, the nation and city subfields would match, but the community subfields would not match. Thus, SGW 1060 would send the packet to the SGW in MP metro network 1000 whose community subfield matches the community subfield in the DA of the packet (SGW 1160). To send the packet, SGW 1060 looks in a forwarding table for the set of partial address subfields for the nation, city, and community of the DA to determine the next hop in the path leading to SGW 1160. SGW 1060 then sends the packet to the next hop specified by the forwarding table. The process of analyzing the partial address subfields and using a forwarding table to forward the packet to the next hop is continued until the packet arrives at the SGW (SGW 1160) whose nation, city, and community subfields match the corresponding subfields in the DA of the packet. Then, top-down transmission commences.

For top-down transmission, SGW 1160 sends the MP data packet to MX 1180 (which can be at wirespeed) based on the partial address information in the tiered switch subfield 6050 and the color information. More specifically, SGW 1160 simplifies its packet routing decision by using portions of the DA to self-direct the packet. SGW 1160 also utilizes the color information to select a packet delivery mechanism (i.e., the packet delivery mechanisms for unicast addressing mode and multicast addressing mode may differ). In other words, an exemplary SGW 1160 achieves wirespeed efficiency by using some of the partial address subfields to self direct the packet and by utilizing an effective packet delivery mechanism.

In a similar manner, MX 1180 also relays the MP data packet to HGW 1200 using the partial address information in tiered switch subfield 6050. In turn, HGW 1200 sends the packet to its final destination, UT 1420, using the partial address information in UT subfield 6060. The entire transmission of the MP data packet through the plurality of top-down logical links (e.g., logical links 1440, 1520 and 1530) can be done without calculating or using routing tables.

The preceding example considers the unicast transfer of an MP data packet between two UTs in the same MP metro network. It is also convenient to consider here two other possibilities, namely 1) the unicast transfer of an W data packet between two MP metro networks (e.g., between a source UT in MP metro network 2030 and UT 1420 in MP metro network 1000) and 2) the unicast transfer of an MP data packet between two MP nationwide networks (e.g., between a source UT in MP nationwide network 3030 and UT 1420 in MP nationwide network 2000). The bottom-up and top-down transmission stages for these two possibilities are analogous to those described in the preceding example and need not be repeated here. However, the transmission between SGWs is different than the preceding example, as explained below.

The first scenario, MP packet transmission between two different MP metro networks in the same MP nationwide network, corresponds to the case where the nation subfields match, but the city subfields do not match. In this case, the destination host resides in the same MP nationwide network (MP nationwide network 2000) as the source host, but is governed by an SGW in a different MP metro network (MP metro network 1000). Here, the SGW governing the source host sends the MP packet to the metro access SGW (SGW 2050) that connects MP metro network 2030 to nationwide network backbone 2010. SGW 2050 then sends the packet towards the metro access SGW (SGW 1020) that connects another MP metro network (MP metro network 1000) to nationwide network backbone 2010 and whose city subfield matches the city subfield in the DA of the MP packet. More specifically, SGW 2050 looks in a forwarding table for the set of partial address subfields for the nation and city of the DA to determine the next hop in the path leading to SGW 1020. SGW 2050 then sends the packet to the next hop specified by the forwarding table. The process of analyzing the partial address subfields and using a forwarding table to forward the packet to the next hop is continued until the packet arrives at SGW 1020.

Then, SGW 1020 looks in a forwarding table for the set of partial address subfields for the nation, city, and community of the DA to determine the next hop in the path leading to the SGW (SGW 1160) governing the destination host. SGW 1020 then sends the packet to the next hop specified by the forwarding table. The process of analyzing the partial address subfields and using the forwarding table to forward the packet to the next hop is continued until the packet arrives at SGW 1160. Then, the top-down transmission commences.

The second scenario, MP packet transmission between two different MP nationwide networks in the same MP global network, corresponds to the case where the nation subfields do not match. In this case, the destination host resides in the same MP global network (MP global network 3000) as the source host, but is governed by an SGW in a different MP nationwide network (MP nationwide network 2000). Here, the SGW governing the source host sends the MP packet to a metro access SGW in MP nationwide network 3030. The metro access SGW then sends the packet to the nationwide access SGW (SGW 3040) that connects MP nationwide network 3030 to global network backbone 3020.

SGW 3040 then sends the packet to the nationwide access SGW (SGW 2020) that connects another MP nationwide network (MP nationwide network 2000) to global network backbone 3020 and whose nation subfield matches the nation subfield in the DA of the MP packet. More specifically, SGW 3040 looks in a forwarding table for the nation subfield of the DA to determine the next hop in the path leading to SGW 2020. SGW 3040 then sends the packet to the next hop specified by the forwarding table. The process of analyzing the partial address subfields and using a forwarding table to forward the packet to the next hop is continued until the packet arrives at SGW 2020.

Then, SGW 2020 looks in a forwarding table for the set of partial address subfields for the nation and city of the DA to determine the next hop in the path leading to the metro access SGW (SGW 1020) that connects MP metro network 1000 to nationwide network backbone 2010. SGW 2020 then sends the packet to the next hop specified by the forwarding table. The process of analyzing the partial address subfields and using the forwarding table to forward the packet to the next hop is continued until the packet arrives at SGW 1020.

Then, SGW 1020 looks in a forwarding table for the set of partial address subfields for the nation, city, and community of the DA to determine the next hop in the path leading to the SGW (SGW 1160) governing the destination host. SGW 1020 then sends the packet to the next hop specified by the forwarding table. The process of analyzing the partial address subfields and using the forwarding table to forward the packet to the next hop is continued until the packet arrives at SGW 1160. Then, the top-down transmission commences.

It should be noted that the aforementioned access SGWs (e.g., metro access SGW 1020 and nationwide access SGW 2020) may also serve as the master network managers. Although specific details are given above to describe one embodiment of an MP logical layer that facilitates unicast transmission of an MP data packet between two UTs in three stages, it will be apparent to a person of ordinary skill in the art to recognize that the scope of the disclosed MP logical layer is not limited to the details.

Other rules that an MP logical layer may establish for MP-compliant components to follow to deliver MP-packets or MP-encapsulated packets in a predictable, secure, accountable and expeditious manner include, without limitation:
a) Each MP network has one or more SGWs (e.g., one SGW can serve as a backup to the other SGW) that collectively serve as a “master network manager” as has been described above, where the master network manager has certain control over the “slave network managers” (e.g., the master network manager can collect information from all slave network managers and selectively distribute the collected information to the slave network managers);
b) SGWs are responsible for assigning network addresses to some of their own ports (e.g., ports 10080 and 10090 as shown in FIG. 10) and the ports of the MP-compliant components that depend on the SGWs (e.g., ports 1170, 1175 and 1210 as shown in FIG. 1d). The subsequent Service Gateway section further explains this network address assignment process;
c) The network address that is bound to a network attachment point (port) to an MP-compliant component “stays with” (“follows”) the port, rather than staying with (following) the component. For example, if server group 10010 of SGW 1160 in FIG. 10 assigns a network address to port 1210, this assigned network address follows port 1210. After UT 1420 connects to HGW 1200 and after server group 10010 accepts UT 1420, the network address that is bound to port 1210 becomes the assigned network address of UT 1420. Thus, if UT 1420 was removed from MP metro network 1000 and instead installed in MP metro network 2030 (FIG. 2), UT 1420 at the new location would no longer have the network address that is bound to port 1210;
d) SGWs are responsible for monitoring network resources and handling service requests. SGWs ensure that adequate resources (e.g., bandwidth, packet processing capability) are available on the pre-determined transmission paths prior to approving the requested services;
e) SGWs are responsible for verifying the accounting status of the parties involved in the requested service; and
f) SGWs establish policy controls that restrict entry of a packet into an MP network according to, without limitation: 1) the source of the packet, to ensure that the packet comes from an authorized port and from an authorized component; 2) the destination of the packet, to ensure that the packet goes to an authorized port; 3) certain flow parameters, to ensure that the packet does not carry traffic in excess of the flow parameters and 4) the data content of the packet, to ensure the packet does not carry content that violates the intellectual property rights of a third party. The enforcement of these policy controls is typically outsourced to a number of MP-compliant components, such as, without limitation, the MXs in the ACNs and/or the EXs in the SGWs.
   The subsequent discussions on various MP-compliant components and operational examples will elaborate on implementation details of these rules.

As discussed at the beginning of this Logical Layer section, another function of an MP logical layer is to establish, maintain, and terminate connections among systems. The subsequent Operational Examples section will provide further details on call setup, call communication and call clear-up procedures.

4.3 Application Layer

Application layers 4130 and 4110 of MP (FIG. 4) make use of the services of the MP physical layers and MP logical layers and also supply application data down to the lower layers. An exemplary MP application layer includes a set of application programmable interfaces (“APIs”) that enable a developer to easily design and implement applications for an MP network. Such applications include, without limitation, media services (e.g., media telephony, media on demand, media multicast, media broadcast, media transfer), interactive gaming, etc. It will however be apparent to a person of ordinary skill in the art to develop applications that directly invoke the services of the MP logical layer without exceeding the scope of the disclosed MP technologies.

5. Network Components

5.1 Service Gateway (“SGW”)

As discussed above, SGWs possess the requisite intelligence to manage and control access to, without limitation, home networks, media storage, legacy services and wide area networks from the edge of a network backbone. Using FIG. 1d as an illustration, the aforementioned home networks refer to HGWs, media storage corresponds to media storage unit 1140, and legacy services refer to the services that non-MP network 1300 offers. Lastly, metro backbone network 1040 is one example of a wide area network.

FIG. 10 is a block diagram of an exemplary SGW, such as SGW 1160 in FIG. 1d. SGW 1160 includes EX 10000 that connects to network backbone 1040 via link 1150, connects to non-MP network 1300 via gateway 10020 and connects to a number of UTs via ACNs and HGWs. Gateway 10020 enables communications between an MP network, such as MP metro network 1000 (FIG. 1d), and a non-MP network, such as non-MP network 1300, by translating non-MP packets into MP packets and vice versa. The subsequent Gateway section further describes this packet translation process. Server group 10010, on the other hand, processes information that it receives from EX 10000 and formulates and sends instructions and/or responses through EX 10000 to devices that are either directly or indirectly attached to EX 10000.

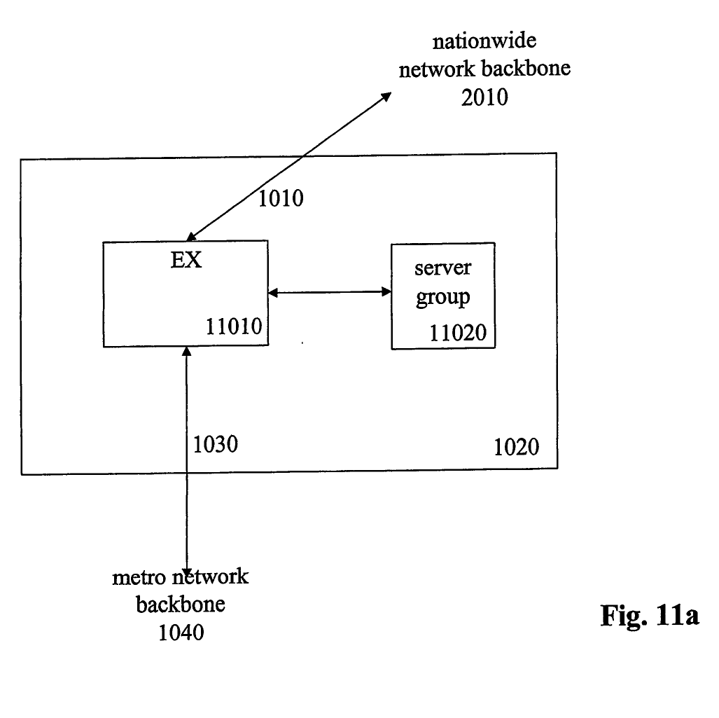

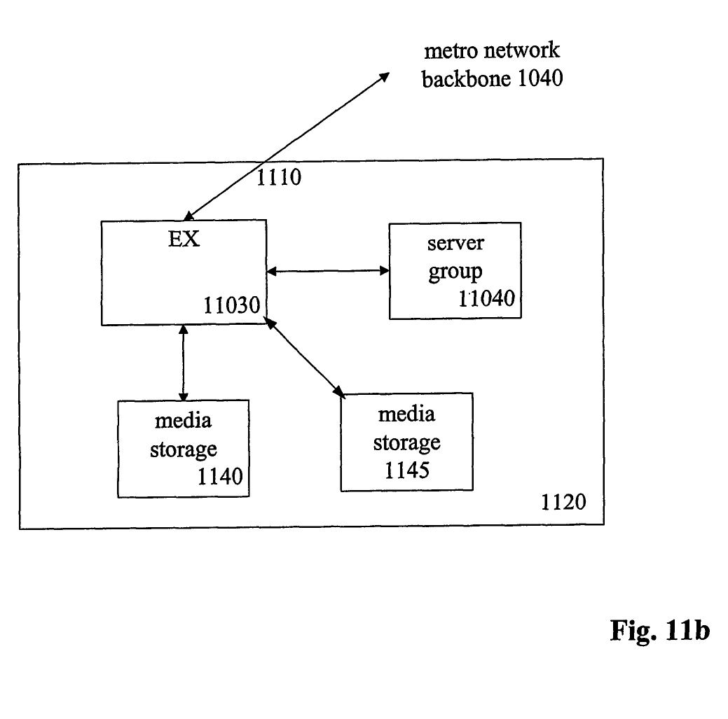

FIG. 11a is a block diagram of a second type of SGW, such as SGW 1020. SGW 1020 utilizes EX 11010 and server group 11020 to interact with MP-compliant components. However, SGW 1020 does not provide direct access to home networks. In addition to the connection to nationwide network backbone 2010 (FIG. 2) via logical link 1010, EX 11010 in SGW 1020 also connects via logical link 1030 to metro network backbone 1040.

FIG. 11b is a block diagram of a third type of SGW, such as SGW 1120. SGW 1120 does not provide direct access to home networks, either. In addition to the connection to metro network backbone 1040 via logical link 1110, EX 11030 in SGW 1120 also connects to media storage 1140.

Although three embodiments of an SGW have been described, it will be apparent to one of ordinary skill in the art to combine or further divide up the illustrated functional blocks without exceeding the scope of the disclosed SGWs. For example, an alternative embodiment of SGW 1160 further includes MP-compliant media storage. Moreover, instead of utilizing different types of SGWs in an MP metro network, it will be apparent to one of ordinary skill in the art to deploy one type of SGW that combines the functionality of the aforementioned SGW 1160, SGW 1020 and SGW 1120 throughout the MP network and yet still remain within the scope of the present invention.

5.1.1 Server Group

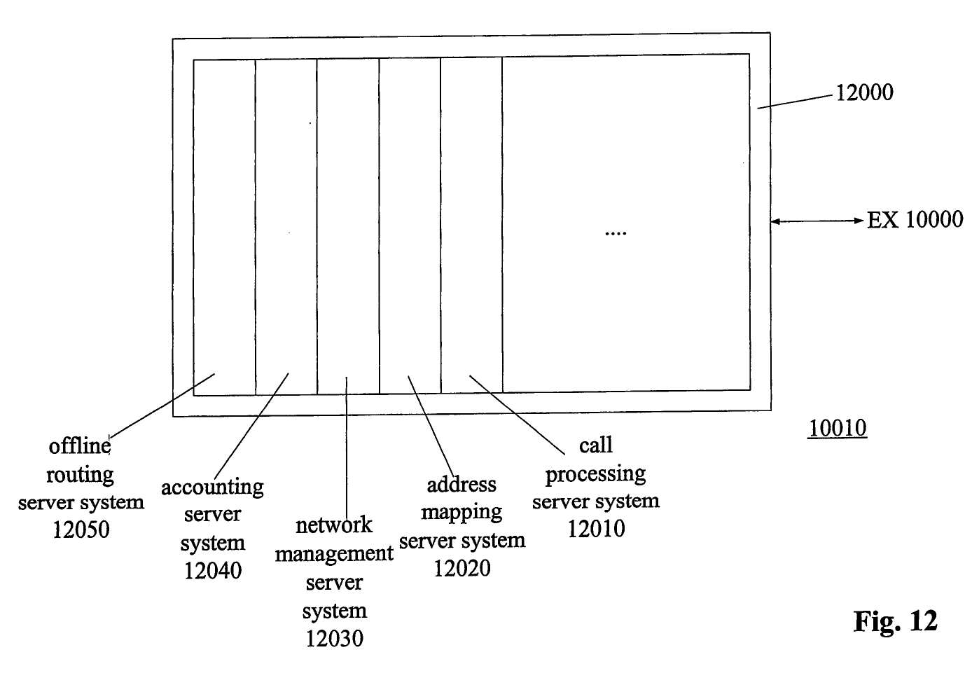

FIG. 12 is a block diagram of an exemplary server group, such as server group 10010. This embodiment includes communication rack chassis 12000 and a number of add-in circuit boards. Each circuit board is a server system. Some examples of these server systems include, without limitation, call processing server system 12010, address mapping server system 12020, network management server system 12030, accounting server system 12040 and offline routing server system 12050. It will be apparent to a person of ordinary skill in the art to implement server group 10010 with a different number and/or different types of server systems than the embodiment shown in FIG. 12 without exceeding the scope of the disclosed server group.

In one implementation, in addition to the aforementioned server systems, communication rack chassis 12000 also includes one or more “unprogrammed” add-in circuit boards. Suppose server group in SGW 1020 (FIG. 2) governs server group 10010 in SGW 1160. Thus, in response to failure of one of the server systems in server group 10010, such as call processing server system 12010, the server group in SGW 1020 programs one of these unprogrammed add-in circuit boards to operate as the call processing server system. It will however be apparent to a person of ordinary skill in the art to use numerous other known methods to back up the described server systems and yet still remain within the scope of the disclosed server group technologies.

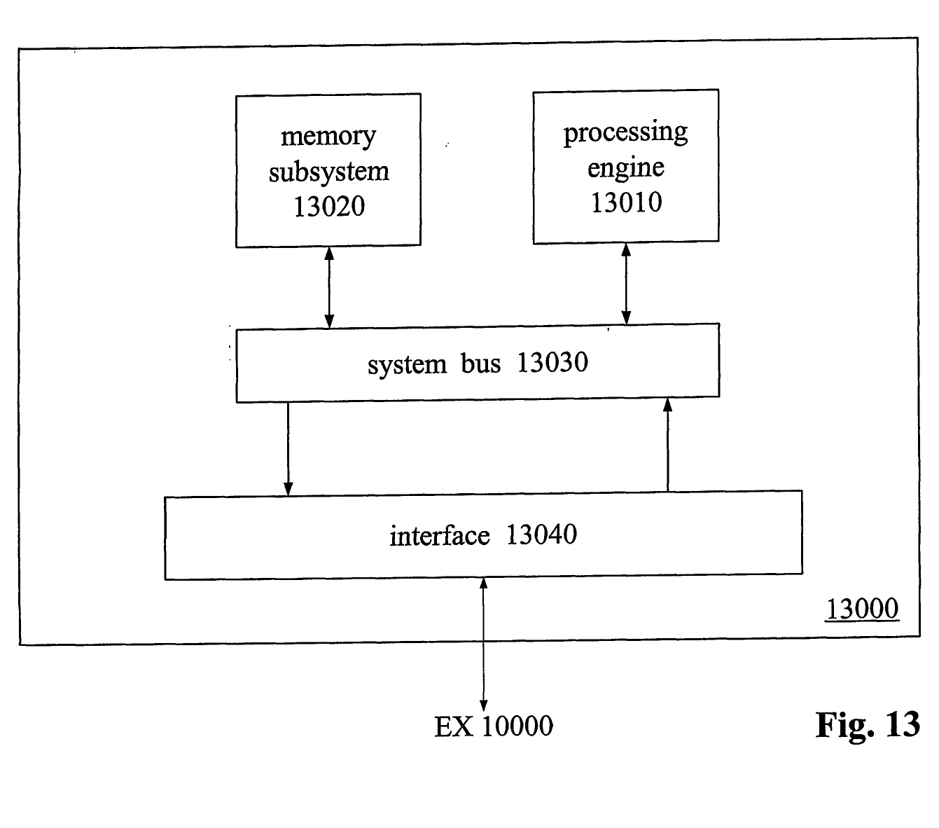

FIG. 13 is a block diagram of an exemplary server system. Specifically, server system 13000 includes processing engine 13010, memory subsystem 13020, system bus 13030 and interface 13040. Processing engine 13010, memory subsystem 13020 and interface 13040 are coupled to system bus 13030. Alternatively, memory element 13020 may be indirectly connected to system bus 13030 through a system controller (not shown in FIG. 13).

These server system elements perform their conventional functions that are well known in the art. Moreover, it will be apparent to one of ordinary skill in the art to design server system 13000 with multiple processing engines and with more or less components than that which are shown. Some examples of processing engine 13010 include, without limitation: a digital signal processor (“DSP”), a general purpose processor, a programmable logic device (“PLD”), and an application specific integrated circuit (“ASIC”). Also, memory subsystem 13020 maybe used to store network information, identification information of server system 13000, and/or the instructions that processing engine 13010 executes.

In one embodiment of server group 10010, because every add-in circuit board can have its own processing and input/output capabilities, each of the aforementioned server systems can operate independently from the other server systems. This implementation further distributes specific functions to specific server systems. Consequently, no one server system is overburdened with the management and control of an entire MP network, and the task of designing these server systems is greatly simplified as compared to the task of designing a general-purpose server system. Communication rack chassis 12000 provides housing for these add-in circuit boards and also provides physical connections among the boards and between the boards and EX 10000.

Alternatively, as the price-to-performance ratio of general-purpose server systems continues to decrease, it will be apparent to one of ordinary skill in the art to implement server group 10010 with a general-purpose server system if its price-to-performance ratio falls within the design parameters of an MP network. In one such implementation, one of ordinary skill in the art can develop individual software modules that operate on the general-purpose server system and independently carry out specific functions of server group 10010.

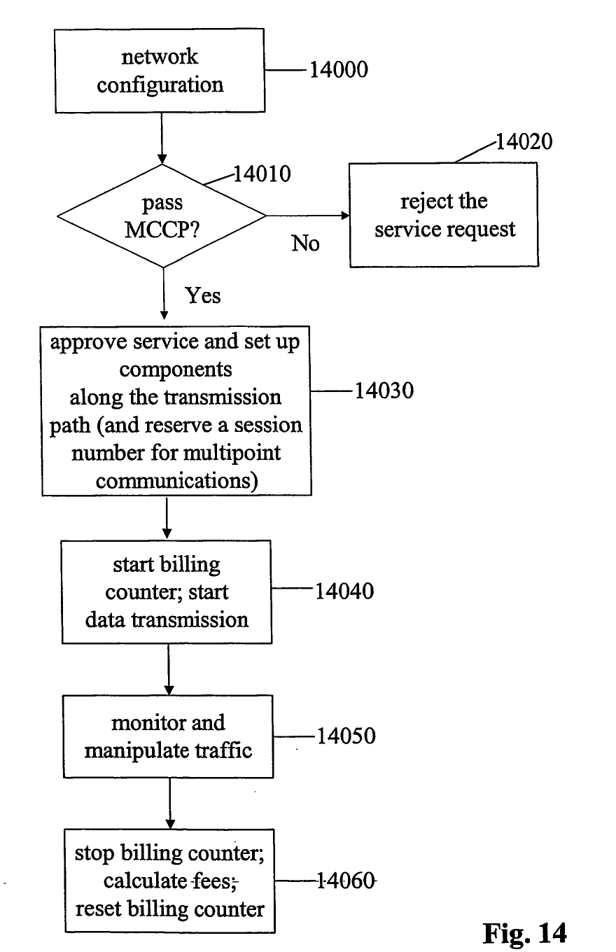

FIG. 14 is a flow chart of one workflow process that an exemplary server group, such as server group 10010 (FIG. 10), performs. In particular, server group 10010 is responsible for performing functions that enable an MP network to delivery multimedia services to end users. Such functions include, without limitation, network configuration in block 14000, multiple call check processing (“MCCP”) and admission control in block 14010, set up in block 14030, billing for services in blocks 14040 and 14060, and traffic monitoring and manipulation in block 14050.

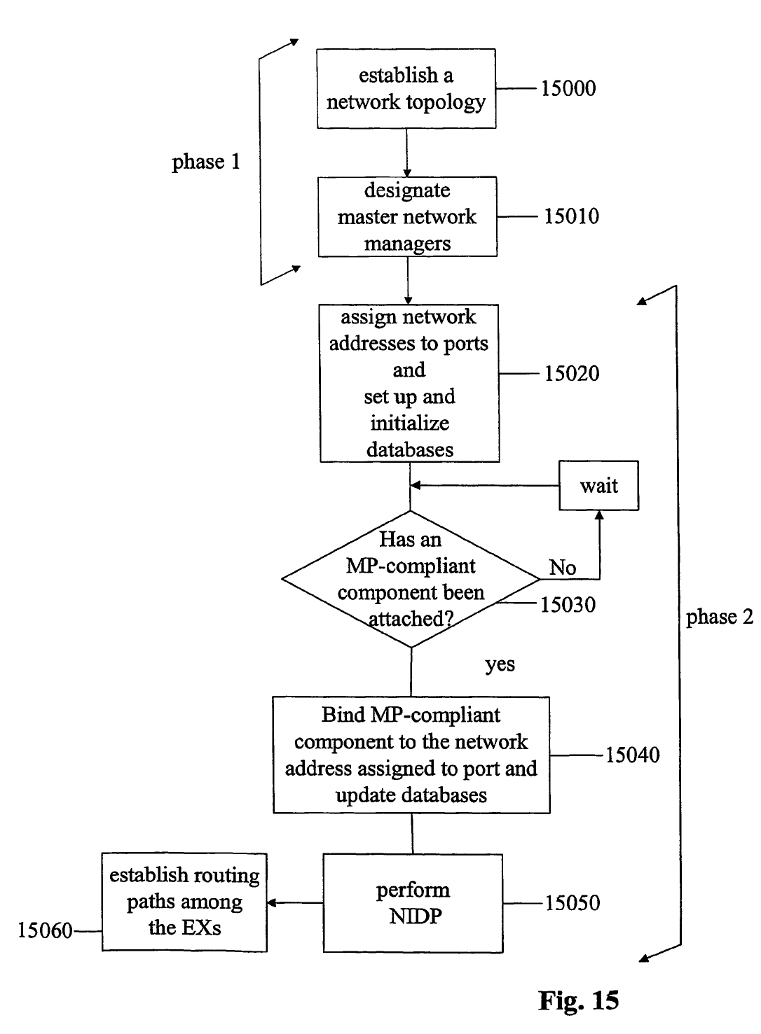

However, before server group 10010 executes its tasks in block 14000, a network operator (e.g., a local exchange carrier, a telecommunication service provider, or a group of network operators) follows a network establishment and initialization process that is shown as phase one in FIG. 15. Specifically, the network operators in phase one establish a network topology and designate appropriate master network managers to manage and control this topology.

In block 15000, the network operators design an MP metro network topology that supports a certain number of SGWs, each of which supports a certain number of end users. For example, based on their internal financial projections, the network operators may decide to first deploy sufficient equipment to serve 1000 end users in a densely populated community. Depending on the cost, capacity and availability of the equipment (e.g., the number of MXs that an SGW can support; the number of HGWs that can be connected to an MX; the number of UTs that an HGW can support; the number of end users that each UT can support; and the amount that the network operators can spend on the equipment), the network operators can configure a network that satisfies their needs. The network operators can further expand this network topology by establishing a number of MP metro networks that an MP nationwide network will support and a number of MP nationwide networks that an MP global network will support.

In block 15010, the network operators then designate appropriate master network managers for the MP metro networks, the MP nationwide networks, and the MP global network that have been defined in the aforementioned network topology. In one network establishment and initiation process, the network operators also configure the designated master network managers to carry out the operations of phase 2, which corresponds to block 14000 in FIG. 14. The configuration of the master network managers involves, without limitation, pre-assigning network addresses to the ports of the master and the slave managers and storing these pre-assigned network addresses and software routines to carry out phase two operations in the local memory subsystems of the two types of managers.

Phase 2 in FIG. 15 illustrates one process that an exemplary server group 10010 follows to perform its network configuration tasks. For illustration purposes, the following discussion assumes that the network operators have adopted the network topologies of MP metro network 1000 and MP nationwide network 2000 as shown in FIGS. 1d and 2 and have also designated SGW 1160 and SGW 1020 to be the metro master network manager and the nationwide master network manager, respectively. Also, Although this particular example mainly describes network configuration done by a master network manager in an MP metro network, analogous procedures are followed by the master network managers that configure MP nationwide networks and an MP global network.

In block 15020, Because SGW 1020 is the nationwide master network manager on MP nationwide network 2000, the server group of SGW 1020 assigns network addresses to ports 10050 and 10070 of EX 10000 in SGW 1160 as shown in FIG. 10. It will be apparent to a person of ordinary skill in the art to recognize that the disclosed MP technology is not limited to the illustrated number of ports. For instance, EX 10000 of SGW 1160 as shown in FIG. 10 may also connect to media storage and thus have another port to support the connection.

One embodiment of server group 10010 of SGW 1160 assigns network addresses to the ports of EX 10000 that can have direct connections to SGW dependent MP-compliant components, regardless of whether or not components are currently connected to such ports. For SGW 1160, MX 1180 and MX 1240 of ACN 1190 are exemplary SGW dependent MP-compliant components that are currently connected to ports 10080 and 10090, respectively, as shown in FIG. 10. EX 10000 may have other ports (not shown in FIG. 10) that are assigned network addresses, but do not currently have MP-compliant components connected to them.

As a metro master network manager, server group 10010 of SGW 1160 also assigns network addresses to certain ports of the EXs in the metro slave network managers (e.g., SGW 1060 and SGW 1120). For example, server group 10010 assigns the network address to the EX port in SGW 1060, which the server group in SGW 1060 directly connects to.

After server group 10010 assigns network addresses to the ports of EX 10000 and the ports of other EXs in the metro slave network managers, the network addresses remain bound to these ports unless the network operator changes the network topology.

In addition to network address assignment, server group 10010 also sets up and initializes SGW databases in block 15020. These SGW databases represent entries of information that server group 10010 maintains either in memory subsystem 13020 (FIG. 13) or in an external memory subsystem (not shown) that the server group has access to. Server group 10010 stores mapping relationships between the registration information and the user address of an MP-compliant component, between the user name and the user address of the component, and/or between the user address and the network address of the component in the SGW databases.

In some instances, server group 10010 derives some of the aforementioned mapping information through its own inquiry mechanism. The subsequent discussion of block 15030 will further elaborate on this mechanism. In other instances, server group 10010 obtains some of the mapping information from other servers and databases. For example, independent industry groups or MP-compliant component manufacturers can have their own servers and databases generate and maintain unique identification information (such as hardware IDs) for each component that has been built with proper authorizations. If these authorized components are properly registered, the mentioned servers and databases may further generate and maintain a “registered list,” which in one implementation contains user addresses and registration status information that correspond to the components. Proper registration of a component involves finding an entry in the databases of the industry groups or manufacturers that matches the identification information that is stored locally in the component.

One embodiment of server group 10010 obtains this “registered list” information from the servers and databases of the industry groups or manufacturers and stores this obtained information in appropriate SGW databases. This registration information and its related mapping information enables server group 10010 to prevent unauthorized and/or unregistered components from using an MP network.

As to the aforementioned inquiry mechanism of server group 10010, server group 10010 in block 15030 sends status query packets to each of the configured ports (i.e., ports that have been assigned network addresses) that the SGW governs in an effort to detect whether an MP-compliant component has come online. The transmission interval of these query packets can be either a fixed or an adjustable period of time. If an MP-compliant component is connected to one of the configured ports, the component sends a response packet in response to the status query packet back to server group 10010. In one implementation, the response packet contains some identification information of the component. The identification information can be a hardware ID, a user name, a user address, or even a network address that is associated with the component. In addition, one embodiment of server group 10010 includes its network address in the status query packets, so that an MP-compliant component can retrieve and use the server group network address as the DA of its response packet.

In block 15040, in response to a response packet from an MP-compliant component, server group 10010 proceeds to retrieve the identification information of the component from the packet, binds the component to the network address of the port, and updates the SGW databases accordingly. For example, after MX 1180 attaches to EX 10000 (FIG. 10) for the first time, MX 1180 responds to inquiries of server group 10010 by sending the server group a response packet. The response packet contains the user address of MX 1180. As discussed with respect to block 15020 above, server group 10010 has already assigned a network address to port 10080. After receiving the response packet, server group 10010 proceeds to bind MX 1180 to the network address of port 10080, and updates the SGW databases to reflect the new mapping relationship between the user address and the network address of MX 1180.

Server group 10010 generally follows the procedures just described for updating SGW databases and for assigning network addresses to the ports of other types of newly attached MP-compliant components besides MX 1180. Moreover, because of these procedures, an MP-compliant device that is simply “plugged” into an MP network will be automatically authenticated and configured to operate on the MP network.

In other instances, server group 10010 performs certain address mapping functions prior to updating the SGW databases. For example, if server group 10010 receives a user name instead of a user address from a newly attached MP-compliant component, server group 10010 would first identify the appropriate user addresses that correspond to the user name before updating the appropriate SGW databases (e.g., the databases of the network management server system in an SGW).

After authorizing MP-compliant components to be on MP metro network 1000 (FIG. 1d), server group 10010 collects resource information on MP metro network 1000 and distributes relevant information to the authorized components through Network Information Distribution Procedures (“NIP”) in block 15050. More specifically, one part of NIDP involves server group 10010 sending resource query packets to the authorized components in MP metro network 1000 for resource information. In response, server group 10010 may receive information concerning, without limitation, switch bandwidth usage from EXs, MXs of ACNs and HGWs and media bandwidth usage from media storage units. Server group 10010 stores and organizes this collected information in appropriate SGW databases.

Another part of NIDP involves distribution of information to the MP-compliant components. Based on the component type, one embodiment of server group 10010 selects information from the SGW databases that is relevant to the component and distributes this selected information to the components with a bulletin packet. For instance, because MXs 1180 and 1240, HGWs 1200, 1220, 1260, and 1280, and UTs 1340, 1360, 1380, 1400, 1420, and 1450 may send MP control packets to server group 10010 (FIG. 10), server group 10010 sends its assigned network address to these Mxs, HGWs, and UTs via bulletin packets. The server group in the metro master network manager (SGW 1160 here) can further distribute information to MP-compliant components that do not directly depend on SGW 1160. For example, server group 10010 can distribute its assigned network address to other metro slave network managers, such as SGW 1120 and SGW 1060.

It is important to note that server groups other than the discussed server group 10010, such as the server groups of SGWs 1120 and 1060 (FIG. 1d), also follow the aforementioned NIDP to collect resource information from and to distribute relevant information to the MP-compliant components that the server groups manage. In addition, it will be apparent to one of ordinary skill in the art to implement NIDP in a different manner than the discussed manner and yet still remain within the scope of the present invention.

In addition to configuring the ports and collecting the resource information, the server group of the metro master network manager (SGW 1160 here) of MP metro network 1000 also establishes routing paths among the EXs on the MP network in block 15060. In particular, this server group sends resource query packets to the EX of SGW 1160 and to the EXs of the slave SGWs, such as SGW 1120 and 1160. Based on the responses from the EXs, this server group determines the available switching capabilities of the EXs, identifies appropriate transmission paths to transport packets among the EXs within MP metro network 1000, and maintains this packet transportation information in an EX forwarding table. This EX forwarding table may be stored within the SGW or stored at an external location that communicates with the SGW.

An exemplary server group of a metro master network manager SGW performs the tasks of block 15060 when it is idle or when its processing capacity is below a certain threshold. Alternatively, this server group may rely on another server or server group to carry out the tasks of block 15060. It will be apparent to one of ordinary skill in the art to use means other than the ones that have been discussed to compute the routing paths among the EXs, as long as such means do not slowdown the packet and service delivery of server group 10010.

In addition to configuring an MP network in block 14000 (FIG. 14), server group 10010 is also responsible for responding to service request packets. A service request packet can request services such as video telephony, video multicasting, video-on-demand, multimedia transfer, multimedia broadcasting, or virtually any other type of multimedia service. The subsequent Operational Examples section will provide detailed discussions of exemplary multimedia services. A service request packet is an MP control packet and typically includes information on the type of service, priority, and addresses of the parties involved in the requested service.

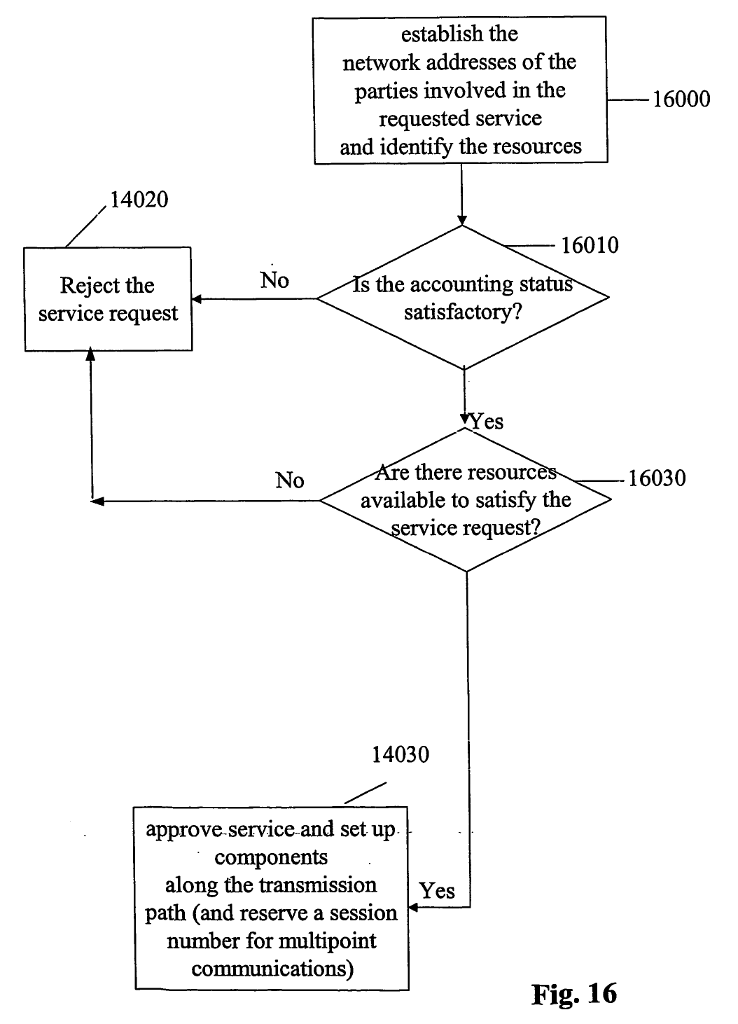

After server group 10010 receives a service request packet, it follows the MCCP procedure in block 14010 to verify certain accounting information of the parties involved and to determine resource availability to carry out the requested service. FIG. 16 is a flow chart of one workflow process that server group 10010 follows to perform MCCP.

In block 16000, server group 10010 retrieves network addresses of the parties involved from the service request packet. The parties involved generally refers to a calling party, a called party, a paying party, and a paid party. Using the network addresses of the parties and the transmission path information in the forwarding table discussed above, server group 10010 can identify the resources along a plurality of logical links needed to perform the requested service.

As an illustration, assume UT 1420 is both the calling party and the paying party and UT 1320 is the called party (FIG. 1d). Based on the network address of the calling party, which is retrieved from the service request packet, server group 10010 identifies SGW 1160, MX 1180, HGW 1200 and UT 1420 along the bottom-up logical links to perform the requested service. Based on the network address of the called party, which is also retrieved from the service request packet, server group 10010 identifies SGW 1060, MX 1080, HGW 1100 and UT 1320 along the top-down logical links to perform the requested service. In addition, server group 10010 consults a forwarding table to identify the nodes along the logical links between the EX of SGW 1160 (EX 10000 in FIG. 10) and the EX of SGW 1060 (FIG. 1d) to perform the requested service. Thus, server group 10010 identifies the nodes (resources) along an end-to-end transmission path from UT 1420 to UT 1320, and can proceed to apply admission controls and policy controls to the requested service.

Server group 10010 inspects the accounting status of the parties in block 16010 and verifies the financial standing of the paying party. Server group 10010 can establish criteria for obtaining satisfactory accounting status based on a number of well-known factors, such as the debit or credit balance of the paying party and the past payment patterns. If the paying party fails to meet the criteria, server group 10010 rejects the service request in block 14020 FIG. 14). Alternatively, server group 10010 may ask a third party, such as the paying party's credit card company, to pay before rejecting the request.

In addition, server group 10010 examines the resources needed for the requested service and ensures that the resources are sufficient. Server group 10010 determines the demands of a requested service based on information that it maintains internally or information that it receives externally. Server group 10010 maintains a pre-determined list of services that it supports and the corresponding demands on network resources for these services. Thus, after a service request packet is received, server group 10010 can identify the service type from the packet and establish the network resource requirements from the pre-determined list. Alternatively, server group 10010 may rely on the party requesting the service to include the network resource requirements in the service request packet.

As discussed above, server group 10010 possesses network resource information from the process of NIDP as shown in block 15050 of FIG. 15. Examples of network resources include, without limitation, the paths among the EXs and the switching capacities of the SGWs, ACNs, HGWs and any other nodes.

After identifying the MP-compliant components needed to provide the requested service, server group 10010 compares the capabilities of these components with the demands of the requested service in block 16030 to decide whether or not to proceed to block 14030. An exemplary server group 10010 applies the following equations to the identified MP-compliant components:
A=priority of the requested service (server group 10010 obtains this value from the service request packet) Equation 1:
B=maximum capacity of an MP-compliant component Equation 2:
C=the capacity of the same MP-compliant component that is currently being used (the MP-compliant component typically updates and tracks this current usage value) Equation 3:
D=capacity required for the requested service Equation 4:
E=(A*B)−C−D Equation 5:
A is a number between zero and one, with exemplary values being 0.8 for low priority, 0.9 for normal priority and 1.0 for high priority. If E is less than zero for any of the MP-compliant components needed to provide the service, server group 10010 rejects the service request in block 14020. Otherwise, server group 10010 proceeds to approve the service request and set up components (e.g., set up ULPFs and multipoint-communication lookup tables, see below) along the transmission path(s) to perform the service in block 14030, as shown in FIG. 14 and FIG. 16. For multipoint communications, one embodiment of server group 10010 also reserves a session number in block 14030. Specifically, server group 10010 has a pool of unique session numbers to choose from. After a session number is chosen to represent a multipoint communication session, the chosen session number becomes unavailable until the represented session is terminated. If the service request asks for an unavailable session number, server group 10010 maps the reserved session number to an available session number and notifies the components along the transmission paths of the mapping.

It will be apparent to one of ordinary skill in the art to use different equations, different parameters, and/or different mechanisms than the ones disclosed and yet still remain within the scope of MCCP. For example, although the discussed server group 10010 manages resources (i.e., approving or disapproving a service request based on the availability of resources) yet does not actively reserve resources, server group 10010 could reserve resources by increasing the value of C in the equation beyond the actual measured usage without exceeding the scope of the disclosed server group technologies. Moreover, in an alternative embodiment, server group 10010 may reallocate resources from some of the ongoing operations to meet the demands of the requested operation, provided a lower priority service is not terminated to free up resources for a higher priority service. If reallocation of resources is feasible (i.e., the demands of both the ongoing services and the present service request can be met), server group 10010 may reallocate by adjusting the value of C.

It will also be apparent to one of ordinary skill in the art to rearrange the sequence of the discussed MCCP procedure without exceeding the scope of MCCP technologies. For example, an alternative implementation of MCCP may check resource availability as in block 16030 before it verifies accounting status as in block 16010.

If the MCCP procedure indicates that the network resources are available and the accounting status of the relevant party(s) are satisfactory, server group 10010 then proceeds to approve the service request and set up components (via unicast/multipoint-communication setup packets) along the appropriate transmission path(s) in block 14030. For multipoint communications, one embodiment of server group 10010 also reserves a session number. This MCCP procedure is part of the aforementioned admission control policies of the server group.

With the service approved and the components along the transmission path set up, server group 10010 instructs the involved parties' UTs or other MP-compliant components, such as media storage 1140, to start exchanging data packets in block 14040. Depending on its billing model, server group 10010 also begins its billing counter. For instance, if the monetary valuation of the requested service depends on the amount of time that the parties spend on the service, the billing counter is a timer. On the other hand, if the valuation depends on the number of bits that are transported during a session of the service, the billing counter is a bit counter. It will be apparent to one of ordinary skill in the art that many other well-known billing models besides the ones discussed above may be used and still remain within the scope of the present invention.

During the call communication stage, server group 10010 may monitor and manipulate the packet traffic in block 14050. In one implementation, server group 10010 monitors the traffic by sending the calling party and the called party connection status request packets. If the calling party and the called party do not respond to the request, server group 10010 proceeds to block 14060. Otherwise, server group 10010 makes appropriate adjustment to the connection based on the responses from the parties. For instance, server group 10010 may monitor the signal quality of the data transmission. If server group 10010 determines that the signal quality has deteriorated below a threshold value, it may discount the monetary charges for the connection by a certain amount.

Also, server group 10010 can manipulate the packet traffic by issuing command packets to the calling party and the called party. As an illustration, server group 10010 may issue a “stop” command packet to the called party in a media-on-demand service and cause the called party to stop sending the requested media In another example, server group 10010 may issue a command packet to the calling party to throttle the outgoing transmission rate of its data packets. It will be apparent to one of ordinary skill in the art to implement numerous other traffic manipulation mechanisms or utilize other types of command packets than the ones discussed above without exceeding the scope of the present invention.

Either as a result of monitoring packet traffic in block 14050 or as result of receiving a termination request packet, server group 10010 stops the aforementioned billing counter, determines the monetary charges from the billing counter, adds the monetary charges to the paying party's bill (or deducts the charges if the paying party has a debit account), and resets the billing counter in block 14060.

Although the preceding server group discussions mainly describe the functionality of a server group as a single entity, it will be apparent to one of ordinary skill in the art to implement a server group with distinct server systems as shown in FIG. 12 and yet still remain within the scope of the disclosed server group technologies. Each of these server systems performs one or a selected few of the functions that have been discussed above.

For example, offline routing server system 12050 is mainly responsible for establishing routing paths among the EXs. Accounting server system 12040 performs part of the MCCP procedure and also calculates monetary charges associated with a requested service. Address mapping server system 12020 is mainly responsible for mappings amongst user names, user addresses and network addresses. Call processing server system 12010 is mainly responsible for processing service requests and for performing part of the MCCP procedure. Network management server system 12030 is mainly responsible for configuring an MP network, managing network resources, and setting up connections.

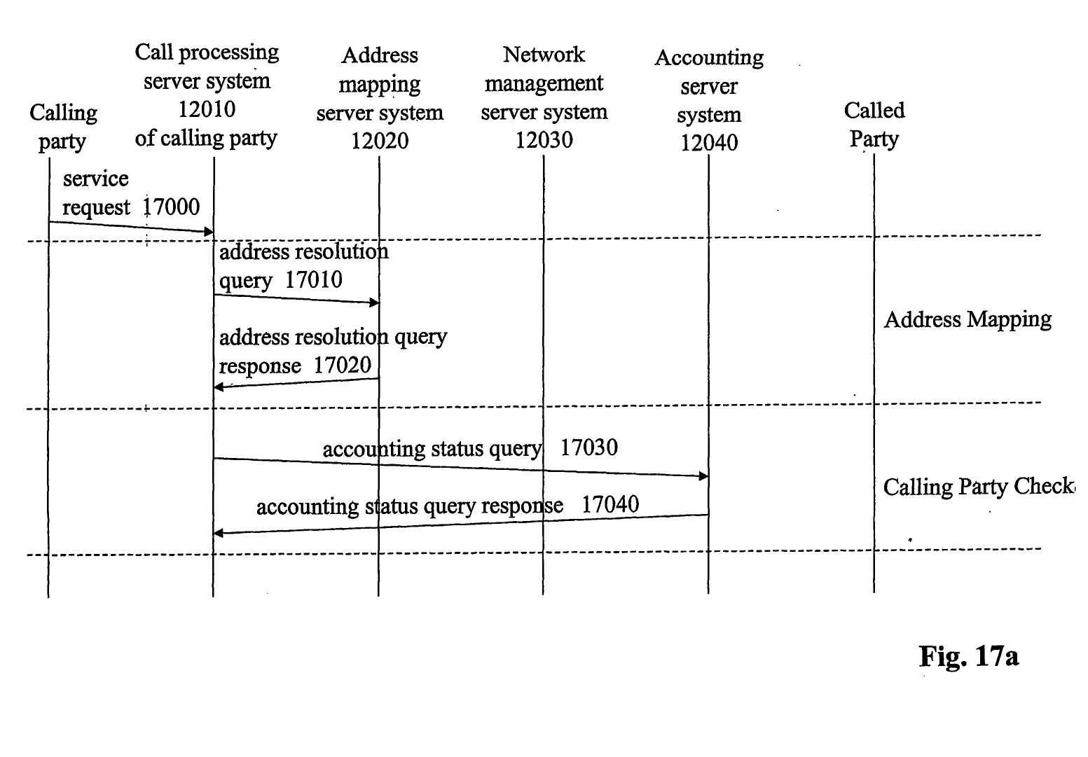

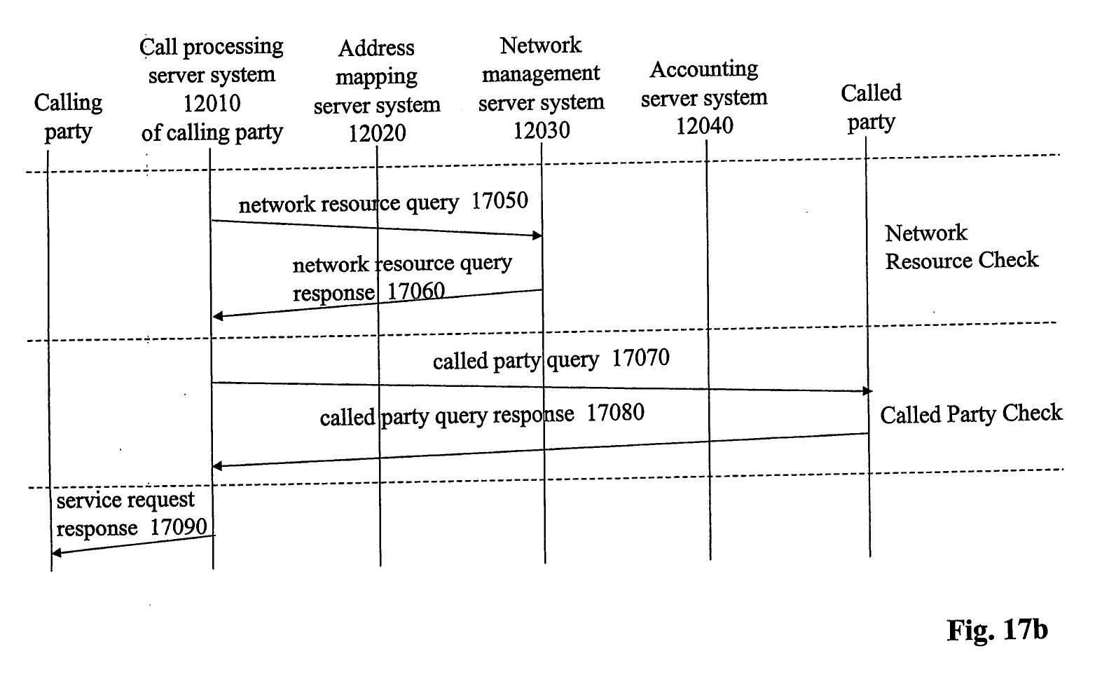

Moreover, because each of these server systems has an assigned network address, the server systems can communicate with one another using their assigned network addresses. To illustrate the interactions among the server systems, FIGS. 17a and 17b demonstrate one time sequence diagram of the server systems shown in FIG. 12, which perform MCCP in a video telephone call. Specifically:
1. The calling party sends service request packet 17000 to the call processing server system 12010 of the calling party.
2. Service request packet 17000 includes information such as the user addresses of the paying party and the called party, the network addresses of the calling party and call processing server system 12010, the priority of the requested service, and the network resource requirement of the requested service.
3. Call processing server system 12010 sends address resolution query packet 17010 to address mapping server system 12020. This packet 17010 includes the user address of the paying party and the network address of address mapping server system 12020.
4. Address mapping server system 12020 returns the network address of the paying party to call processing server system 12010 in address resolution query response packet 17020.
5. Call processing server system 12010 sends accounting status query packet 17030 is to accounting server system 12040. The packet includes the network address of the paying party and the network address of accounting server system 12040.
6. Accounting server system 12040 returns accounting status query response packet 17040 to call processing server 12010. This response packet indicates the accounting status of the paying party.
7. Call processing server system 12010 sends network resource status query packet 17050 to network management server system 12030.
8. Network management server system 12030 sends back network resource status query response packet 17060 to call processing server system 12010. This packet indicates whether the network resources are sufficient (based on the outcome of block 16030 discussed above) to carry out the video telephone call.
9. Call processing server system 12010 of the calling party sends called party query packet 17070 to the called party.
10. The called party responds with called party query response packet 17080.
11. Then, call processing server 12010 responds to service request 17000 by sending service request response packet 17090 to the calling party.

The discussed packets 17000, 17010, 17020, 17030, 17040, 17050, 17060, 17070, 17080 and 17090 are MP control packets. By communicating with one another through these MP control packets, different server systems that are responsible for distinct functions are able to collectively perform the MCCP procedure as shown in FIG. 16. Having each server system in a server group perform specialized tasks provides several benefits. The hardware in each server system can be tailored to its specialized tasks. The modular design of the server group makes it easy to expand capacity, upgrade the functionality in each server system, and/or add server systems with new functionality. The subsequent Operational Examples section will provide other examples that describe the interactions among different server systems in a server group in carrying out tasks other than the MCCP procedure.

5.1.2 Edge Switch (“EX”)

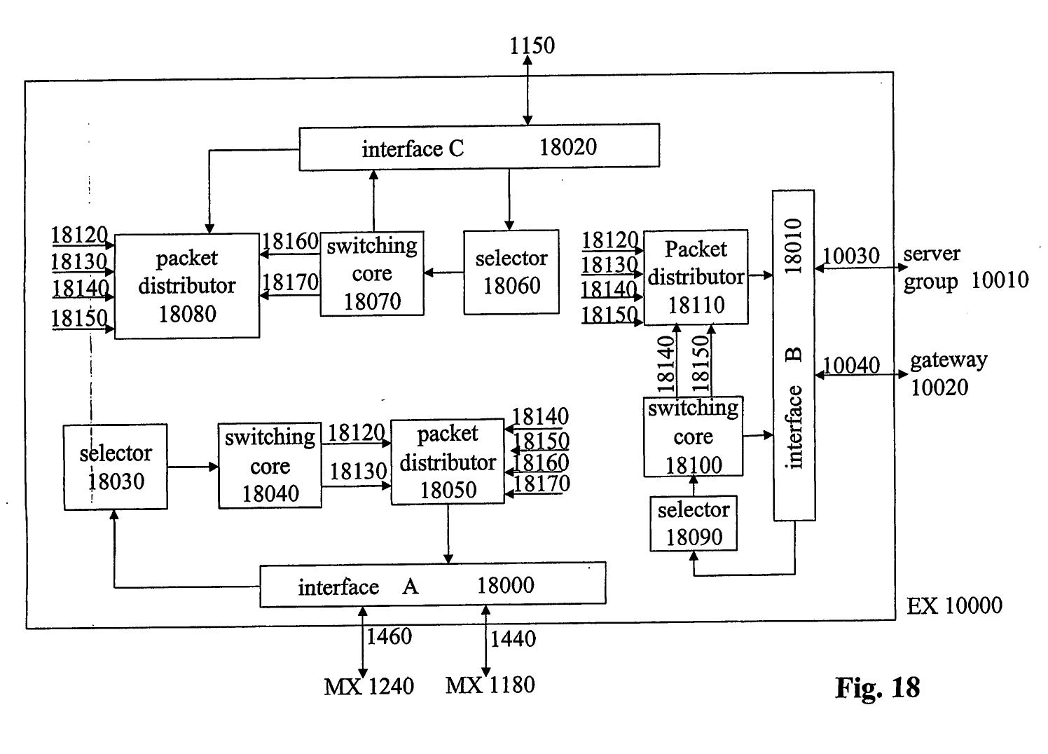

FIG. 18 illustrates a block diagram of an exemplary edge switch, such as EX 10000 in SGW 1160 as shown in FIG. 10. EX 10000 includes four types of components: switching cores, selectors, packet distributors and interfaces. This embodiment of EX 10000 includes three types of interfaces: interface A 18000 to allow communication with MX 1180 and MX 1240 of ACN 1190, interface B 18010 to allow communication with server group 10010 and gateway 10020 and interface C 18020 to allow communication with metro network backbone 1040. These interfaces provide signal conversion from one type of signal to another. For instance, interface C 18020 in one embodiment of EX 10000 converts between fiber optic signals and electronic signals.

5.1.2.1 Selector

One embodiment of a selector, such as selector 18030, 18060 or 18090 in FIG. 18, selects the order in which packets received from multiple physical links are passed on to a switching core, such as switching core 18040, 18070 or 18100. Using selector 18030 as an illustration, if logical link 1440 occupies three physical links and logical link 1460 occupies two physical links, one embodiment of selector 18030 selects the physical link that has an active signal using well-known methods (e.g., round-robin and first-in-first-out) and directs packets on the selected physical link to switching core 18040. If each of logical links 1440 and 1460 corresponds to a single physical link, selector 18030 also directs packets on the link with an active signal to switching core 18040. Selectors 18060 and 18090 similarly perform the many-to-one multiplexing functionality just described. It should be apparent, however, to a person of ordinary skill in the art to incorporate the functionality of these selectors into the interfaces (e.g., make selector 18030 a part of interface A 18000) without exceeding the scope of the disclosed EX technologies.

5.1.2.2 Switching Core

One embodiment of EX 10000 employs a set of common switching cores, such as switching cores 18040, 18070, and 18100. This common switching core architecture is capable of directing a received packet towards its final destination based on its color information, its partial address information, or a combination of these two types of information. In one implementation, when one of the switching cores in EX 10000 places a packet on a logical link (such as logical link 18130, 18150, or 18170 for switching core 18040, 18100, or 18070, respectively), the switching core also asserts a control signal via another logical link (such as logical link 18120, 18140, or 18160 for switching core 18040, 18100 or 18070, respectively). The asserted control signal causes one of the packet distributors (such as packet distributor 18050, 18110 or 18080) to process the packet. It should be emphasized that this implementation is exemplary. A person of ordinary skill in the art will recognize the scope of the disclosed EX and switching core technologies covers many other designs.

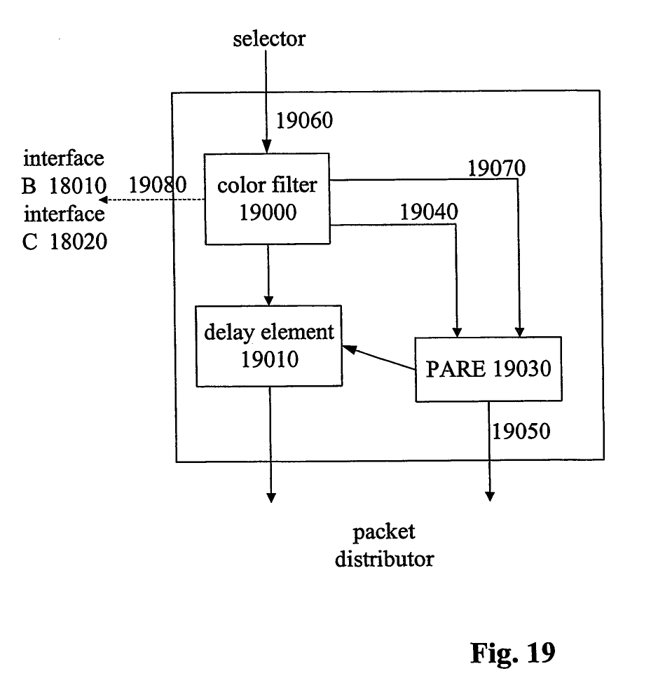

FIG. 19 illustrates a block diagram of an exemplary switching core. The switching core includes color filter 19000, delay element 19010 and partial address routing engine (“PARE”) 19030.

5.1.2.2.1 Color Filter

Color filter 19000 receives an MP packet or an MP-encapsulated packet from a physical link selected by one of the aforementioned selectors. Based on the color information of the received packet, one embodiment of color filter 19000 typically sends a command (“color-filter-issued command”) through logical link 19070 and sends the received packet to PARE 19030 via logical link 19040. In some instances, however, color filter 19000 sends an MP control packet to another MP-compliant component via logical link 19080 without going through PARE 19030 (e.g., color filter 19000 responds to a query packet with the requested information).

The MP Color Table (above) lists exemplary types of color information. Color filter 19000 can recognize and process all of these types of color information or some subset thereof. The types of color information that color filter 19000 recognizes and processes may depend on the type of interface that color filter 19000 is associated with. In one example discussed below, the color filter associated with interface A, an interface that sends and receives packets from MXs in ACNs, processes two types of color information. In a second example discussed below, the color filter associated with interface C, an interface that sends and receives packets from the network backbone, recognizes six types of colored packets. Moreover, the types of color information listed in MP Color Table are exemplary, not exhaustive.

In one implementation, the color-filter-issued command causes PARE 19030 to select an appropriate packet forwarding mechanism (i.e., partial address routing or lookup table routing) and a port to forward the received packet on. Using the selected mechanism and port information, PARE 19030 asserts control signal 19050 to trigger packet delivery by a packet distributor.

The switching core utilizes delay element 19010 to postpone the arrival of a packet at a packet distributor until PARE 19030 completes the generation of control signal 19050 using partial address and color information extracted from the same packet (or a copy thereof). In other words, the amount of time for PARE 19030 to generate control signal 19050 in this switching core is equal to or less than the length of delay that delay element 19010 introduces.

It will be apparent to one of ordinary skill in the art to design an EX that includes a different number of interfaces than the three that have been described without exceeding the scope of the disclosed EX technologies. A person of ordinary skill can also design the interfaces to communicate with components other than the ones shown in FIG. 18. For example, in addition to server group 10010 and gateway 10020, one embodiment of interface B 18010 also provides EX 10000 with access to media storage. Additionally, although the illustrated EX 10000 includes three sets of switching cores, packet distributors and selectors, it will be apparent to a person of ordinary skill to implement an EX with a different combination of switching cores, packet distributors and selectors and yet still remain within the scope of the disclosed EX. For instance, one possible implementation of EX 10000 has a single switching core and three interfaces, where each interface includes functionality similar to the aforementioned selectors (i.e., many-to-many multiplexing as opposed to many-to-one multiplexing) and the aforementioned packet distributors.

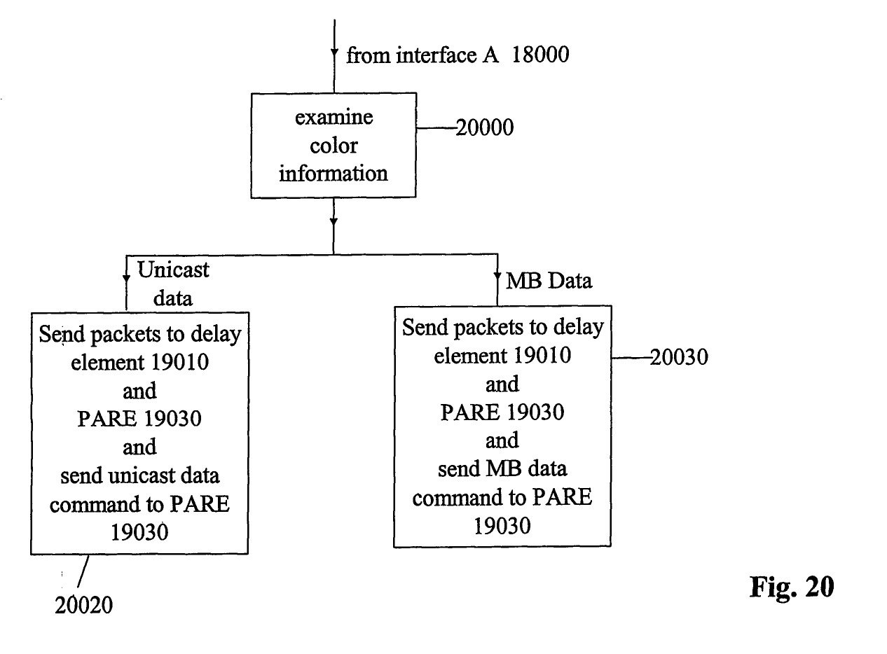

FIG. 20 illustrates a flow chart of one process that color filter 19000 follows to respond to a packet from interface A 18000 (“packet-from-18000”). If packet-from-18000 follows the packet format of MP packet 5000 (FIG. 5), then color filter 19000 examines the color information that resides in DA 5010 of the packet in block 20000. Specifically, as discussed in the Logical Layer section above, DA 5010 contains a destination network address. Some possible formats for this destination network address includes the formats of network address 6000, 7000, 8000, 9000, 9100 and 9200. Each of these network addresses includes a general color subfield. Color filter 19000 performs a bit-wise comparison between a predefined bit mask and this general color subfield to identify a recognized service.

In this illustration, color filter 19000 in switching core 18040 recognizes two types of colored packets from interface A 18000: unicast-data-colored and multipoint-data-colored packets (e.g., MB-data-colored and MM-data-colored packets). For illustration purposes, the following discussions use MB-data-colored packets to represent multipoint-data-colored packets and assume that color filter 19000 recognizes the following bit masks:

| Bit mask: | Corresponding service: |
|---|---|
| 00000 | Unicast data |
| 11000 | MB data |

A unicast-data-colored packet and an MB-data-colored packet, which are also MP data packets, include the general color information “00000” and “11000” in their respective general color subfields.

If the comparison between the bit mask of “0000” and the general color subfield of packet-from-18000 indicates a match, color filter 19000 relays the packet to delay element 19010 and PARE 19030, and sends a unicast data command to PARE 19030 in block 20020. Similarly, if the general color subfield of packet-from-18000 contains “11000”, color filter 19000 also relays the packet to delay element 19010 and PARE 19030, and sends an MB data command to PARE 19030 in block 20030. In other words, the color information in these different colored packets serves as instructions for color filter 19000 to initiate distinct operations.

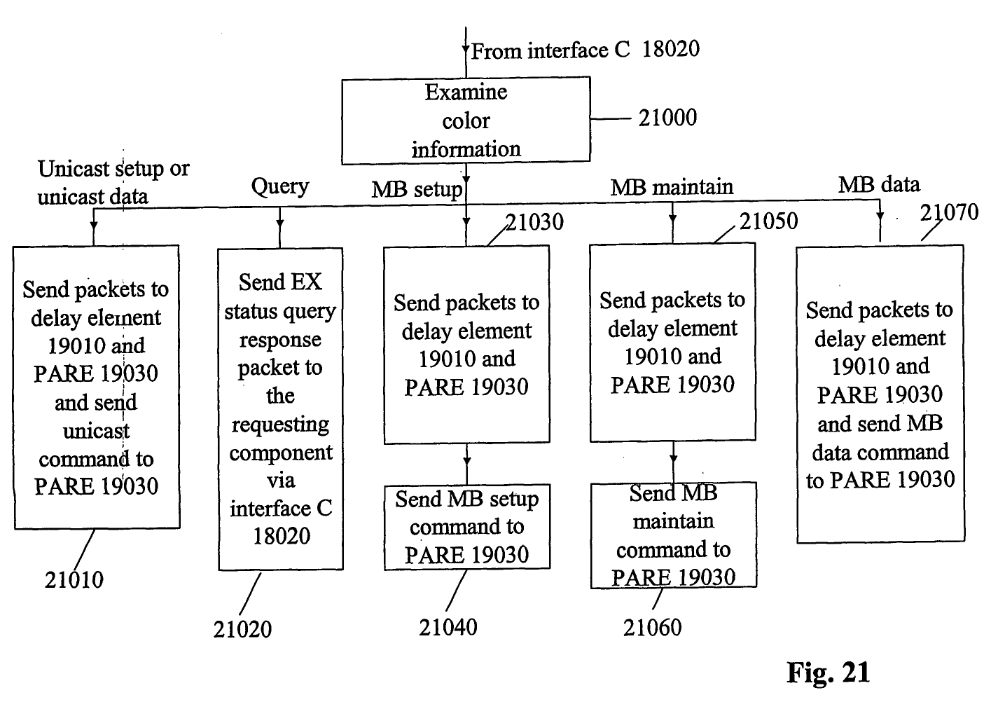

FIG. 21 illustrates a flow chart of one process that another implementation of color filter 19000, such as color filter 19000 in switching core 18070, follows to respond to a packet from interface C 18020 (“packet-from-18020”). Analogous to the discussions above, color filter 19000 examines the color information of packet-from-18020 by performing a bit-wise comparison between a predetermined bit mask and the general color subfield of the packet's DA in block 21000.

In this example, color filter 19000 recognizes six types of colored packets: unicast-setup-colored, unicast-data-colored, query-colored, MB-setup-colored, MB-maintain-colored and MB-data-colored packets. A unicast-setup-colored packet, a query-colored packet, an MB-maintain-colored packet and an MB-setup-colored packet are MP control packets. The setup packets generally set up the MP-compliant components along the transmission path (e.g., configuring the ULPFs and/or the lookup tables) to perform the requested service. The inquiry packets generally query these components for their availability to carry out the requested service. The maintain packets generally ensure that the lookup table accurately reflects the status of a communication session. Sometimes the maintain packets are used to collect call connection status information (e.g., error rate and number of packets lost) of a communication session. On the other hand, an MB-data-colored packet is an MP data packet. The use of these packets is discussed below and in the subsequent Operational Examples section.

In response to either a unicast-setup-colored packet or a unicast-data-colored packet, color filter 19000 relays the packet to delay element 19010 and PARE 19030, and sends either a unicast setup command or a unicast data command to PARE 19030 in block 21010, respectively. In response to an MB-data-colored packet, filter 19000 relays the packet to delay element 19010 and PARE 19030, and sends an MB data command to PARE 19030 in block 21070. On the other hand, in response to a query-colored packet from another MP-compliant component, color filter 19000 sends another MP control packet, such as a status query response packet, back to the component that requested the status via logical link 19080 in block 21020. This MP control packet contains information such as, without limitation, egress traffic information of logical link 1150 of EX 10000. In response to an MB-setup-colored packet or an MB-maintain-colored packet, color filter 19000 relays the packet to delay element 19010 and PARE 19030, and sends appropriate commands, such as MB setup command or MB maintain command, to PARE 19030.

Furthermore, one embodiment of color filter 19000 considers an MP packet as an error packet and discards the packet if it does not recognize the color information contained in the packet.

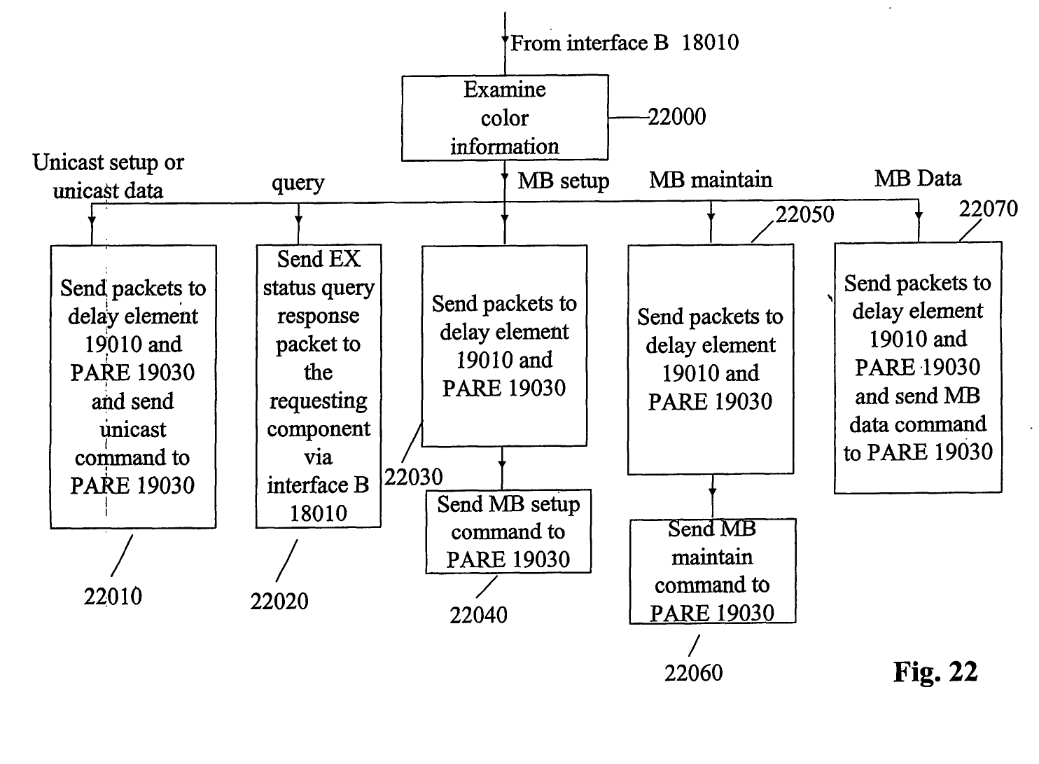

FIG. 22 illustrates a flow chart of one process that another embodiment of color filter 19000, such as color filter 19000 of switching core 18100, follows to respond to a packet from interface B 18010. This process is the same as the process shown in FIG. 21. However, in response to a query-colored packet, color filter 19000 sends an MP control packet that contains information such as, without limitation, egress and ingress traffic information of logical links 10030, 10040 and 1150 through interface B 18010 or interface C 18020 to the source host of the query-colored packet. In other words, DA field 5050 of this MP control packet contains the assigned network address of the source host (e.g., a server system in a server group).

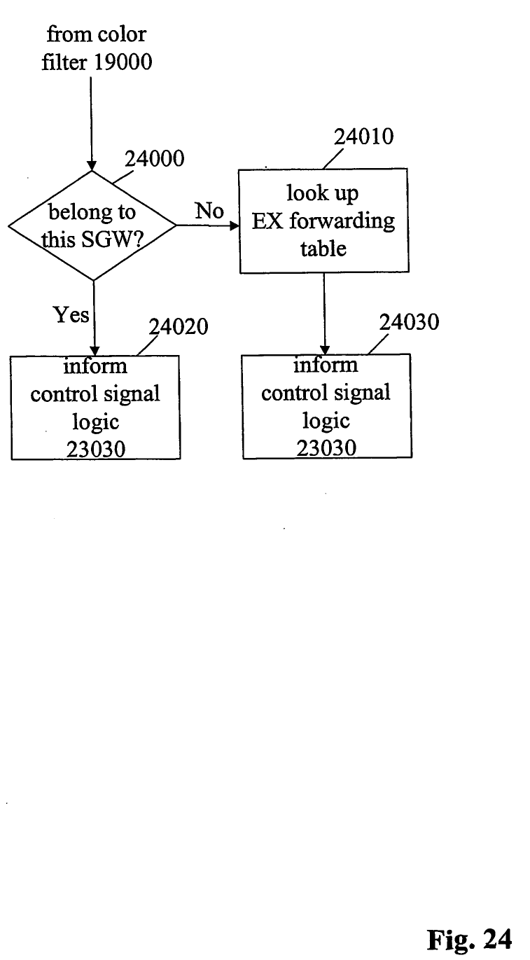

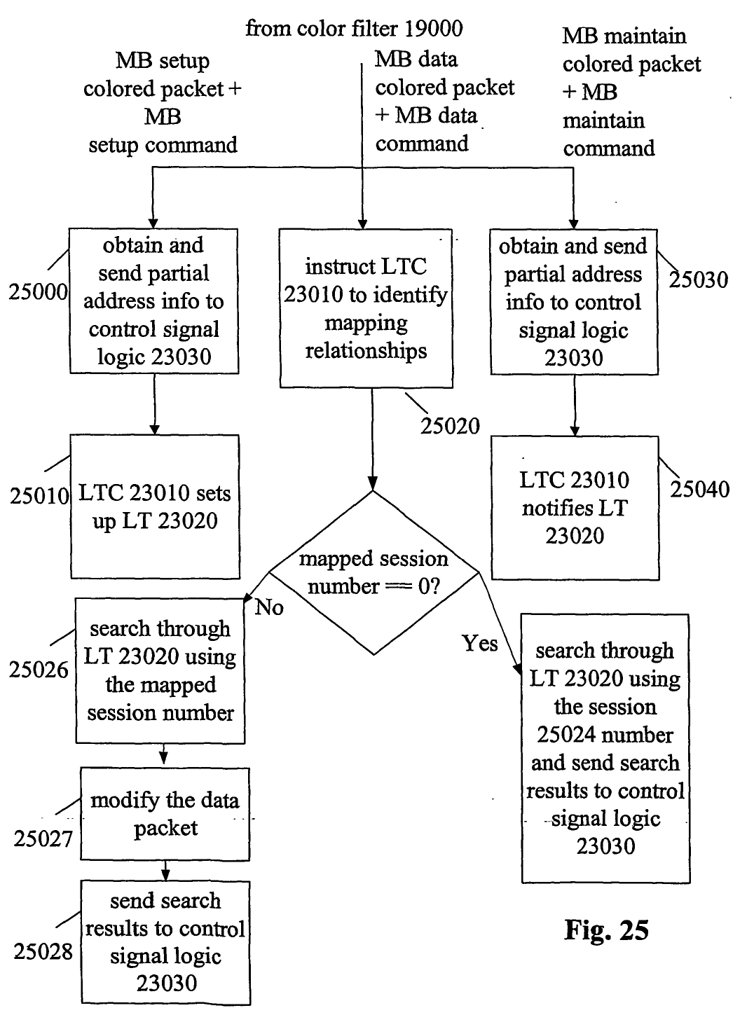

The aforementioned unicast command, MB data command, MB setup command and MB maintain command control PARE 19030. FIGS. 24 and 25 and the is accompanying description in the subsequent Partial Address Routing Engine section provide further exemplary types of control these commands exert on PARE 19030.

In the examples discussed above, the commands that color filter 19000 generates correspond to distinct control signals that the color filter asserts. However, a person of ordinary skill will recognize that numerous mechanisms facilitating the communication between two logical components, such as color filter 19000 and PARE 19030, could be used to implement these commands.

Although the above discussions use a specific set of colored packets and bit masks to describe some functionality of color filter 19000, it will be apparent to a person of ordinary skill to implement a color filter that responds to other types of colored packets and invokes operations other than the ones described without exceeding the scope of the disclosed color filtering technologies. The subsequent Operational Examples section will provide further details on utilizing the aforementioned colored packets in call setup, call communication, and call clear-up procedures.

5.1.2.2.2 Partial Address Routing Engine

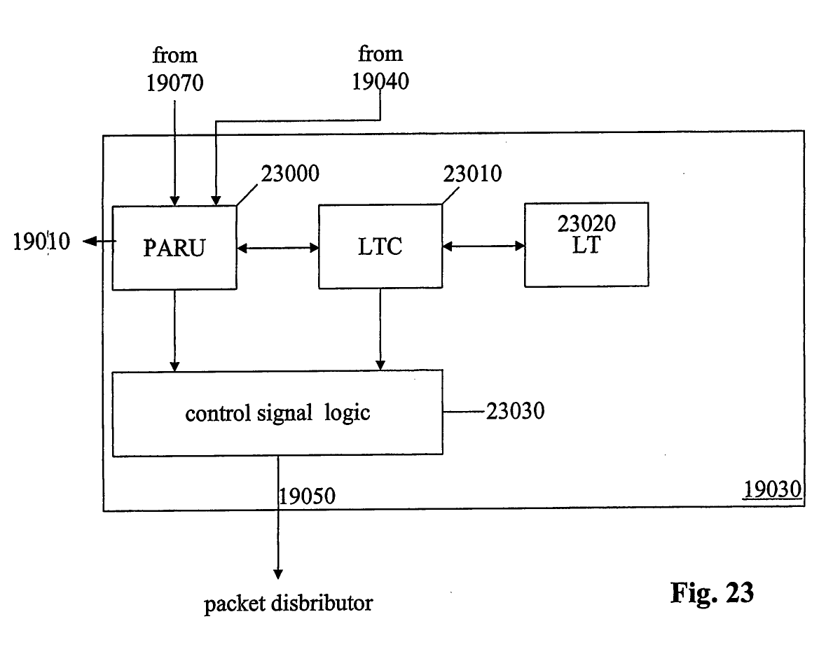

Based on the command and the packet that it receives, one embodiment of PARE 19030 asserts control signal 19050 to a packet distributor. If PARE 19030 resides in switching core 18040, control signal 19050 travels on logical link 18120 as shown in FIG. 18. Similarly, if PARE 19030 resides in switching core 18100 or switching core 18070, its asserted control signal 19050 travels on logical link 18140 or 18160, respectively. FIG. 23 illustrates a block diagram of one embodiment of a PARE, such as PARE 19030 in FIG. 19. PARE 19030 includes partial address routing unit (“PARU”) 23000, lookup table controller (“LTC”) 23010, lookup table (“LT”) 23020, and control signal logic 23030. PARU 23000 receives and processes commands and packets from color filter 19000 via logical link 19070 and logical link 19040, respectively. Then PARU 23000 conveys the processed results to control signal logic 23030 and/or to LTC 23010.

In one implementation, PARU 23000 provides LTC 23010 with pertinent packet delivery information (e.g., partial addresses, session numbers, and mapped session numbers) from the received packets and enables LTC 23010 to maintain the information in LT 23020. In other instances, PARU 23000 causes LTC 23010 to retrieve and pass along information from LT 23020 to control signal logic 23030. It should be noted that LT 23020 may reside in memory subsystem 13020 as shown in FIG. 13 and may be shared by other LTCs in other PAREs.

The following examples use unicast and MB sessions among UTs 1320, 1380, 1400 and 1420 (FIG. 1d) to further explain the operations among the components within PARE 19030 in switching core 18040. The following discussions of these examples refer to FIGS. 1d, 10, 5, 6, 18, 19 and 23 and assume certain implementation details for simplicity of the discussions (given below). However, it will be apparent to a person of ordinary skill that the PARE 19030 is not limited to these details and the subsequent discussions relating to MB also apply to other multipoint communications (e.g., MM). The details include:
Because UTs 1380, 1400 and 1420 are physically coupled to the same HGW (HGW 1200), the same ACN (MX 1180) and the same SGW (SGW 1160), they share the same partial addresses in nation subfield 6020, city subfield 6030, community subfield 6040 and tiered switch subfield 6050 as shown in FIG. 6. In other words, suppose UT 1380 includes the following information in its assigned network address:
   Nation subfield 6020: 1
   City subfield 6030: 23
   Community subfield 6040: 45
   Tiered switch subfield 6050: 78
   User terminal subfield 6060: 1
Thus, the assigned network addresses of UT 1400 and UT 1420 would contain the same information as UT 1380, except for the partial address in user terminal subfield 6060. On the other hand, because UT 1320 is coupled to a different HGW (HGW 1100), a different MX (MX 1080) and a different SGW (SGW 1060), its assigned network address would include at least a partial address in community subfield 6040 different from 45, the partial address in community subfield 6040 for UTs 1380, 1400, and 1420.
A portion of the assigned network address of UT 1400 is 1/23/45/78/2 (nation subfield 6020/city subfield 6030/community subfield 6040/tiered switch subfield 6050/user terminal subfield 6060).
A portion of the assigned network address of UT 1420 is 1/23/45/78/3.
A portion of the assigned network address of UT 1320 is 1/23/23/90/1.
A portion of the assigned network address of SGW 1160 is 1/23/45.
A portion of the assigned network address of SGW 1060 is 1/23/123.
A portion of the assigned network address of MX 1180 is 1/23/45/78.
A portion of the assigned network address of MX 1240 is 1/23/45/89.
A portion of the assigned network address of MX 1080 is 1/23/123/90.
The amount of time that PARE 19030 takes to assert control signal 19050 is less than or equal to the amount of time either an MP packet or an MP-encapsulated packet from color filter 19000 remains in delay element 19010.
PARE 19030 and the components within PARE 19030 are part of EX 10000, which is part of SGW 1160.
Color filter 19000 in one embodiment of EX 10000 issues commands. As discussed in detail above, color filter 19000 derives these color-filter-issued commands from a number of recognized colored MP packets and sends the commands to PARU 23000 via logical link 19070. Color filter 19000 also forwards these colored MP packets to PARU 23000 via logical link 19040 and to delay element 19010. Some of the recognized colored MP packets are described in the MP Color Table in the Logical Layer section above.
The network addresses in the packets mentioned above generally follow the formats of network address 9200, 9100, or 6000 (also 7000, 8000 and 9000). Data packets for multipoint communication adopt the format of network address 9200. Control and data packets for unicast communication and control packets for multipoint communication adopt either the format of network address 9100 or 6000. The format of network address 9100 is adopted if the destination of the packet is directly attached to an EX (e.g., server group and media storage devices). Otherwise, the format of network address 6000 is adopted.
Generally, after approving an MB service request from a UT (e.g., UT 1380), server group 10010 of SCGW 1160 reserves an available session number to identify the requested MB service as discussed in the Server Group section above and places this reserved session number in payload field 5050 of an MB-setup-colored packet. Server group 10010 then distributes this session number to the LTs of the switches along the transmission path via this MB-setup-colored packet. An exemplary MB-setup-colored packet follows the format of network address 6000.
It should be noted that the MB service request from a UT generally does not include a reserved session number. However, when server group 10010 of SGW 1160 receives an MB service request from another SGW, the service request includes a reserved session number (reserved by the SGW governing the source host). As discussed in the Server Group section above, server group 10010 may map this reserved session number to an available session number and places this mapped session number in payload field 5050 of an MB-setup-colored packet. As an illustration, if server group 10010 receives a service request from another SGW for an MB session with session number “2” and session number “2” is available for server group 10010 to reserve, one embodiment of server group 10010 reserves session number “2” and places reserved session number “2” and mapped session number “0” in payload field 5050 of an MB-setup-colored packet. On the other hand, if a service request is for session number “2” but session number “2” is unavailable, one embodiment of server group 10010 searches for an available session number (“3” in this example), reserves the available session number “3” and places both the reserved session number “2” and mapped session number “3” in payload field 5050 of an MB-setup-colored packet. For simplicity, UT 1380 requests an MB service from server group 10010 in the following example unless stated otherwise. Server group 10010 approves the requested MB service and reserves session number “1”, which represents an MB program source (e.g., a live television show from a television studio, a movie, or interactive game from media storage) that UT 1380, UT 1400 and UT 1420 retrieve information from. Also, the mapped session number is “o” in the following example unless stated otherwise.
An exemplary MB-maintain packet follows the format of network address 6000 and contains the reserved session number in payload field 5050.

In a unicast session between two UTs, if PARU 23000 receives either a unicast setup command or unicast data command from color filter 19000, PARU 23000 follows the process shown in FIG. 24. In particular, in block 24000, PARU 23000 checks whether the partial address of the packet matches the partial address of the assigned network address of SGW 1160. If UT 1380 requests to establish a unicast session with UT 1400, then the packet would contain partial addresses “45” and “78”, because the network address of the called party, UT 1400, has “45” in its community subfield 6040 and “78” in its tiered switch subfield 6050. Moreover, because the community subfield 6040 of the assigned network address of SGW 1160 is also “45”, PARU 23000 proceeds to inform control signal logic 23030 of the partial address information “78” in block 24020.

As control signal logic 23030 determines a proper control signal 19050 to assert in response to the partial address “78”, delay element 19010 forwards the temporarily delayed packet, such as a unicast-setup-colored packet, to packet distributor 18050 via logical link 18130. The asserted control signal 19050 causes packet distributor 18050 to forward this packet towards its destination through logical link 1440. The discussed process of forwarding a unicast-setup-colored packet also applies to forwarding a unicast-data-colored packet. The subsequent Packet Distributor section will further elaborate on implementation details of one embodiment of a packet distributor, such as packet distributor 18050.

On the other hand, if UT 1380 requests a unicast session with UT 1320, the partial address derived from the unicast-setup-colored packet would not match the relevant partial addresses of SGW 1160 in block 24000. Specifically, the packet would contain partial addresses of “123” and “90,” which correspond to community subfield 6040 and tiered switch subfield 6050 of the assigned network address of UT 1320, respectively. Because partial address “123” does not match partial address “45” of SGW 1160 in block 24000, PARU 23000 proceeds to search the EX forwarding table of SGW 1160 for the next hop on an appropriate path to reach SGW 1060 in block 24010. As discussed in the Server Group section above, one embodiment of server group 10010 of SGW 1160 has already configured the EX forwarding table during its network configuration phase. (As an aside, note that the forwarding table may have been updated after its initial configuration, because updating is performed from time to time.) PARU 23000 then passes on the forwarding table search results to control signal logic 23030 in block 24010, so that control signal logic 23030 and packet distributor 18080 can coordinate forwarding of the unicast-setup-colored packet through link 1150 to the next hop. The aforementioned process of sending a unicast-setup-colored packet from one UT under the management of one SGW to another UT under the management of another SGW also applies to sending a unicast-data-colored packet and an MB-setup-colored packet.

FIG. 25 illustrates a flow chart of one process that PARU 23000 follows to manage an MB session, which involves UT 1380, UT 1400 and UT 1420 and one MB program source in the current example. Similar to the aforementioned establishment of a unicast session, in response to MB-setup-colored packets from server group 10010 of SGW 1160 to establish the aforementioned MB session, color filter 19000 sends the packets and the corresponding MB setup commands to PARU 23000. PARU 23000 retrieves the partial address “78” from each of the packets in block 25000. The MB-setup-colored packets include “78” because each participant in the session has a partial address of “78” in its tiered switch subfield 6050. PARU 23000 passes along “78” to control signal logic 23030 in block 25000, so that control signal logic 23030 and packet distributor 18050 can coordinate forwarding of an MB-setup-colored packet towards its destination through link 1440.

Note that in the example described above, color filter 19000 asserts an MB setup command for each MB-setup-colored packet that it receives from server group 10010. Thus, for an MB session that involves three participants (excluding program sources), one embodiment of PARU 23000 would receive three MB setup commands and thus execute block 25000 three times.

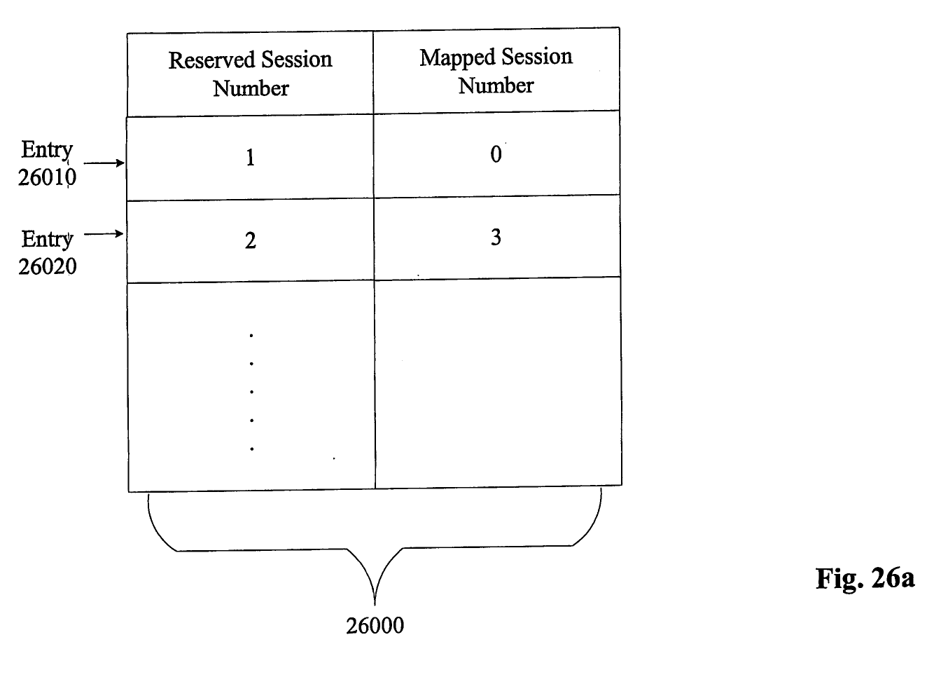

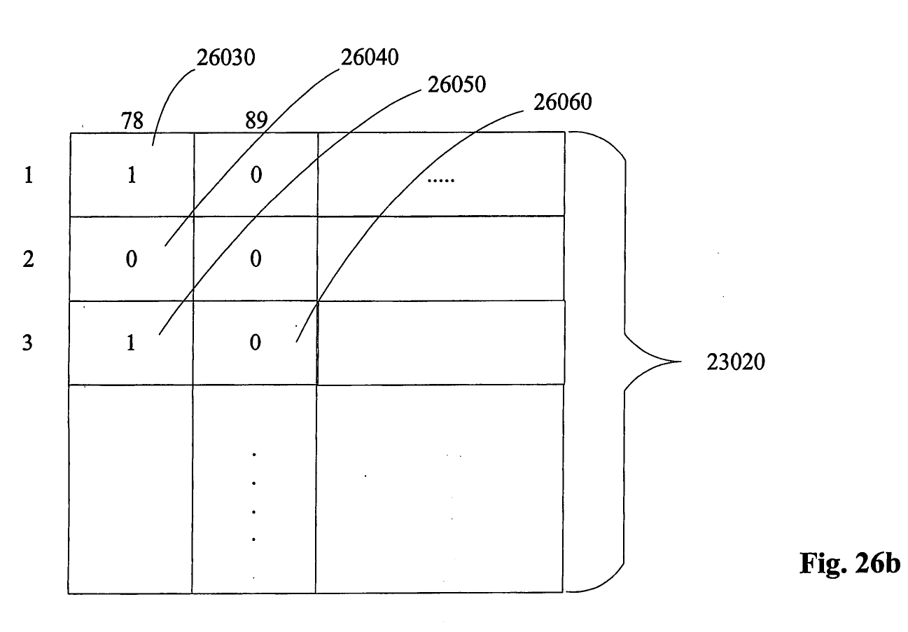

In addition, PARU 23000 supplies LTC 23010 with the derived “78” partial address information, session number “1”, and mapped session number “0” from the MB-setup-colored packet. One embodiment of LTC 23010 maintains mapping table 26000 (FIG. 26a) that tracks the relationship between a reserved session number and a mapped session number. Here, LTC 23010 places “1” and “0” in the reserved session number column and the mapped session number column of entry 26010, respectively. Moreover, because the mapped session number is “0”, LTC 23010 uses session number “11” and partial address “78” to set up LT 23020 cell 26030 in block 25010.

However, if PARU 23000 supplies LTC 23010 with the derived “78” partial address information, session number “2”, and mapped session number “3” from the MB-setup-colored packet, LTC 23010 places “2” and “3” in the reserved session number column and the mapped session number column of entry 26020, respectively. Because the mapped session number has a non-zero value (e.g., “3”), one embodiment of LTC 23010 uses mapped session number “3” (instead of “2”) and partial address “78” to set up LT 23020 cell 26050 (instead of cell 26040) in block 25010.

FIG. 26b illustrates a sample table of LT 23020. The size of LT 23020 depends on the number of MXs and the number of multipoint-communication (e.g., MM and MB) sessions that SGW 1160 supports. In the present example, because SGW 1160 supports at least two MXs (MX 1180 and MX 1240) and assuming SGW 1160 supports three MB program sources, LT 23020 contains at least six cells. Also, this embodiment of LT 23020 indexes its cells in accordance with relevant partial addresses and session numbers. For example, coordinate (78, 1) corresponds to cell 26030 and (89, 2) corresponds to cell 26060.

All cells in one implementation of LT 23020 initially begin with zeros. As LTC 23010 receives appropriate session numbers, such as session number “1”, and partial addresses, such as “78”, from PARU 23000, LTC 23010 modifies the content of appropriate cells in LT 23020, such as cell 26030 (78, 1), to one, thereby indicating a UT with partial address “78” will be participating in MB session 1. In one implementation, LTC 23010 is also responsible for resetting the modified cells back to zeros when the UT is no longer a participant in the MB session. Alternatively, LT 23020 relies on timers to reset its modified cells. In particular, when LT 23020 detects modification to one of its cells, it starts a timer. If LT 23020 does not receive any notification to preserve the content of the modified cell within a certain amount of time, LT 23020 automatically resets the cell back to zero.

An MB maintain command provides one form of this notification. In response to an MB-maintain-colored packet from server group 10010 of SGW 1160 to maintain the aforementioned MB session, color filter 19000 sends the packet and the corresponding MB maintain command to PARU 23000. Similar to the discussions of block 25000 above, PARU 23000 passes along “78” to control signal logic 23030 in block 25030, so that control signal logic 23030 and packet distributor 18050 can coordinate forwarding of an MB-maintain-colored packet towards its destination through link 1440.

PARU 23000 also supplies LTC 23010 with the derived “78” partial address information and session number “1” from the MB-maintain-colored packet. LTC 23010 looks for a match between this derived session number “1” and the entries in the reserved session number column of mapping table 26000. After identifying a match, LTC 23010 examines the corresponding mapped session number column and finds “0” in this example. LTC 23010 then resets the timer for cell 26030 and thus effectively provides LT 23020 with the aforementioned notification in block 25040. Alternatively, LTC 23010 can set the content of cell 26030 to 1.

On the other hand, if PARU 23000 supplies LTC 23010 with the derived “78” partial address information and session number “2” from the MB-maintain-colored packet, LTC 23010 would find a match in entry 26020 of mapping table 26000. Because the corresponding mapped session number column contains a non-zero value (e.g., “3”), one embodiment of LTC 23010 uses mapped session number “3” (instead of “2”) and partial address “78” to reset the timer for cell 26050 (instead of cell 26040) in block 25040. Alternatively, LTC 23010 can set the content of cell 26050 to 1.

In one embodiment of an MP network, an EX maintains the aforementioned mapping table 26000, but the other switches (e.g., Mxs in ACNs and UXs in HGWs) do not maintain mapping table 26000. As these other switches receive an MP multipoint communication control packet (e.g., an MB-setup-colored packet or an MB-maintain-colored packet), the LTCs of these switches set up their LTs using the reserved session number (if the mapped session number is zero) or the mapped session number (if the mapped session number is not zero). It will however be apparent to a person of ordinary skill in the art to implement other setup schemes without exceeding the scope of the disclosed multipoint communication technologies.

In response to an MB-data-colored packet from the MB program source, color filter 19000 sends the packet and the corresponding MB data command to PARU 23000. PARU 23000 retrieves a session number from session number subfield 9270. If session number subfield 9270 of the DA of the MB-data-colored packet contains “1”, PARU 23000 instructs LTC 23010 to search through the reserved session number column in mapping table 26000 for session number “1” in block 25020. After identifying a match, because the mapped session number column of entry 26010 contains “0” in block 25022, LTC 23010 uses session number “1” to search LT 23020. Specifically, LTC 23010 searches through row 1 (which corresponds to MB session 1) of LT 23020 for cells with an active value of one, such as cell 26030, in block 25024.

This search identifies ports that lead to the UTs participating in MB session 1. After LTC 23010 successfully locates cell 26030, which contains a one, LTC 23010 is able to obtain the partial address of “78” in accordance with the aforementioned indexing scheme of LT 23020. LTC 23010 then passes “78” to control signal logic 23030 in block 25024, which then instructs packet distributor 18050 to send the MB-data-colored packet to MX 1180 via logical link 1440. However, if LTC 23010 fails to identify any cells with an active value of one in LT 23020, one embodiment of LTC 23010 does not communicate with control signal logic 23030 and does not trigger packet delivery by any of the packet distributors, such as packet distributors 18050, 18060 and 18110 as shown in FIG. 18.

However, if session number subfield 9270 of the DA of the MB-data-colored packet contains “2”, LTC 23010 identifies a match in entry 26020 of mapping table 26000. Because the mapped session number column of entry 26020 contains a non-zero value (e.g., “3”), LTC 23010 uses session number “3” to search LT 23020 in block 25026. Specifically, LTC 23010 searches through row 3 (instead of row 2) of LT 23020 for cells with an active value of one in block 25020. Furthermore, before one embodiment of LTC 23010 passes the search result to control signal logic 23030 in block 25028, LTC 23010 sends mapped session number “3” to PARU 23000. PARU 23000 modifies session number subfield 9270 of the MB-data-colored packet in delay element 19010 (FIG. 19) from “2” to “3” in block 25070 before the packet is forwarded to a packet distributor.

The process used in this MB example generally applies to other types of multipoint communication, such as MM.

Processes analogous to those used in the unicast examples discussed above also apply to communications between an MP network and a non-MP network. Thus, if PARU 23000 receives a unicast-data-colored packet that contains a DA with a VX subfield 9170 (FIG. 9b) of “0000” and component number subfield 9180 indicating gateway 10020, PARU 23000 notifies control signal logic 23030 of packet delivery information that it derives from the packet. This information, in combination with the unicast data command from color filter 19000, triggers packet distributor 18110 (FIG. 18) to direct this packet to gateway 10020.

Although the preceding two sections (i.e., Color Filter section and Partial Address Routing Engine section) describe exemplary functional blocks that perform color filtering and partial address routing, it will be apparent to a person of ordinary skill in the art to further combine or divide the functional blocks without exceeding the scope of the disclosed technologies. For example, the functionality of the aforementioned PARE can be combined with the aforementioned color filter. On the other hand, the functionality of the aforementioned PARU can be further divided and distributed to the aforementioned LTC.

5.1.2.2.3 Packet Distributor

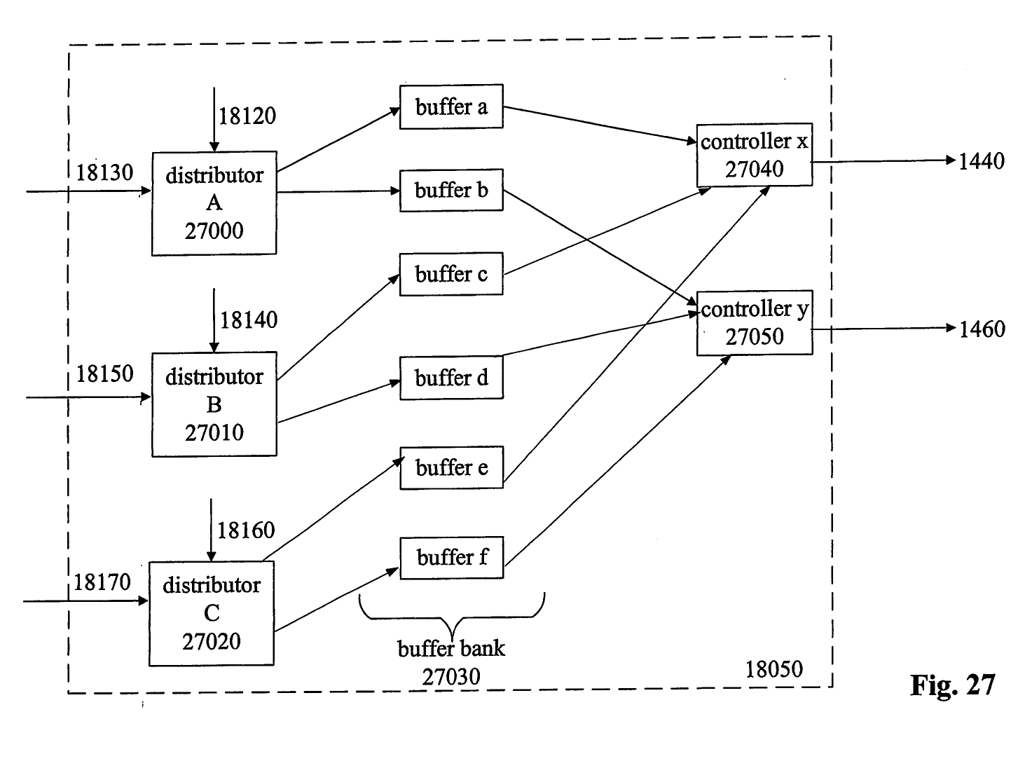

A packet distributor, such as packet distributor 18050 as shown in FIG. 18, is mainly responsible for delivering packets to appropriate output logical links according to control signal 19050 from control signal logic 23030. FIG. 27 illustrates a block diagram of one embodiment of packet distributor 18050. This embodiment of packet distributor 18050 includes distributors, such as distributor A 27000, distributor B 27010 and distributor C 27020, buffer bank 27030 and controllers, such as controller x 27040 and controller y 27050.

Also, the number of buffers in buffer bank 27020 equals the product of the number of distributors and the number of controllers. Thus, because packet distributor 18050 has 3 distributors to accept packets from the 3 switching cores in this example (i.e., 18040, 18100 and 18070) and 2 controllers for forwarding the packets to the two logical links (i.e., 1440 and 1460), packet distributor 18050 has (3*2) buffers in buffer bank 27030. These buffers in buffer bank 27030 temporarily store the packets from the switching cores. To minimize delay and avoid traffic congestion that buffer bank 27030 may introduce, controllers in one embodiment of packet distributor 18050 poll and clear buffer bank 27030 at a fixed or adjustable time interval. As an illustration of this mechanism, in conjunction with FIGS. 18, 19 and 27, assume the following:
control signal 19050 from switching core 18100 invokes distributor B 27010 to forward a packet on logical link 18150 to buffer c, because the-packet is destined to go to MX 1180 via logical link 1440 (e.g., server group 10010 of SGW 1160 sends an MP control packet to UT 1400); and
control signal 19050 from switching core 18070 invokes distributor C 27020 to forward a packet on logical link 18170 to buffer e, because the packet is also destined to go to MX 1180 via logical link 1440 (e.g., UT 1320 sends an MP data packet to UT 1400).
   Instead of sending their packets directly to the intended logical links, distributor B 27010 and distributor C 27020 forward their packets to buffer c and buffer e, where the packets are temporarily stored. Before distributor B 27010 and distributor C 27020 forward additional packets to buffer bank 27030 or before any overflow condition at buffer bank 27030 occurs, controller x 27040 polls each buffer that it manages. If controller x 27040 detects packets in any of the buffers, such as buffer c and buffer e in the current example, it forwards the packets in the buffers to logical link 1440 and clears the buffers. In the same manner, controller y 27050 also polls each buffer that it manages.

Although a 3-by-2 (i.e., 3-distributor-by-2-controller) packet distributor has been described, it will be apparent to a person of ordinary skill in the art to implement a packet distributor in other configurations and with a different-sized buffer bank without exceeding the scope of the disclosed packet distribution technologies. It will also be apparent to a person of ordinary skill in the art to practice the disclosed switching core technologies with other types of packet distribution mechanisms than the mechanism described above.

It will be apparent to a person of ordinary skill in the art to include components in an EX besides the components discussed above without exceeding the scope of the disclosed EX technologies. For example, an EX may include a ULPF to prevent a component directly connected to the EX (e.g., media storage 1140) from sending unwanted packets to a directly connected server group (e.g., the server group of SGW 1120). The subsequent Uplink Packet Filter section will further explain the ULPF technologies.

5.1.3 Gateway

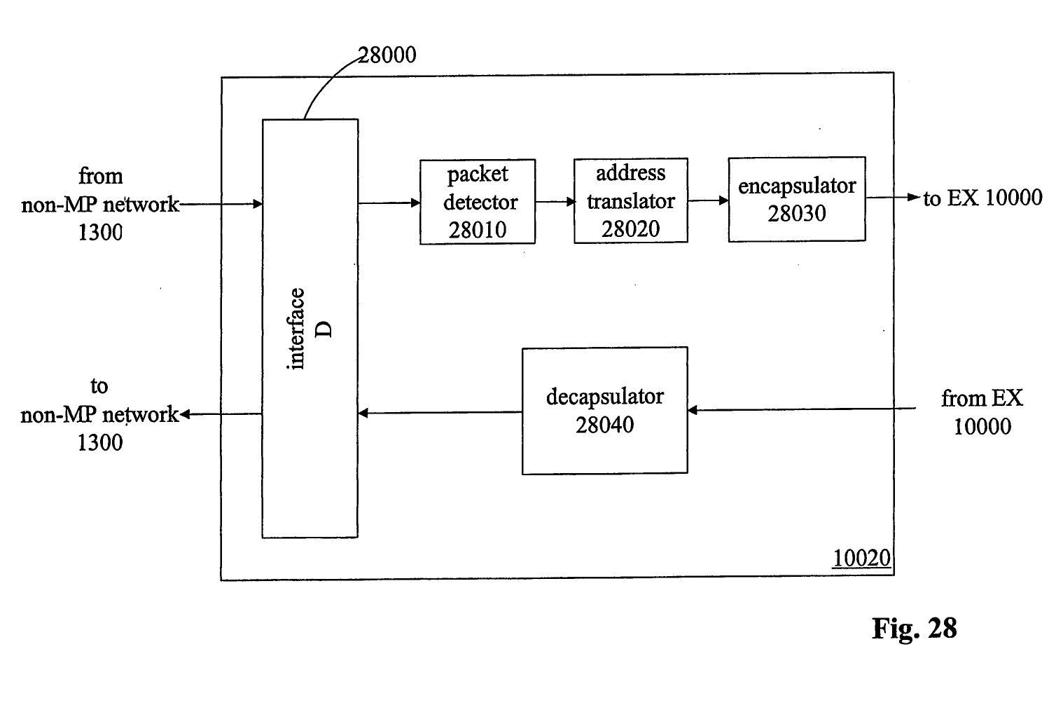

FIG. 28 illustrates a block diagram of one embodiment of a gateway in an SGW, such as gateway 10020 in SGW 1160 (FIG. 10). Gateway 10020 includes interface D 28000, packet detector 28010, address translator 28020, encapsulator 28030 and decapsulator 28040. Interface D 28000 provides signal conversion from one type of signal to another. For instance, interface D 28000 in one embodiment of gateway 10020 converts between fiber optic signals and electronic signals.

Packet detector 28010 determines the type of an incoming packet and retrieves relevant information from the packet for constructing an MP packet. For instance, if an incoming packet is an IP packet, packet detector 28010 is responsible for recognizing the IP packet format and obtaining information such as source address information and destination address information from the IP packet. Then packet detector 28010 passes these obtained addresses to address translator 28020.

Address translator 28020 is responsible for translating non-MP addresses to MP addresses. As an illustration, if an incoming IP packet is for UT 1420 (FIG. 1d), after packet detector 28010 retrieves and passes on the 32-bit destination address from the IP packet, address translator 28020 then maps this retrieved address into an MP DA. As discussed in the Logical Layer section above, the MP DA includes hierarchical address subfields that correspond to the topology of MP network 1000.

Encapsulator 28030 then places the translated MP DA in DA field 5010 and the entire non-MP packet in the variable length payload field 5050 as shown in FIG. 5. In addition, Encapsulator 28030 is responsible for preparing and placing appropriate values in LEN field 5030 and PCS field 5050. After constructing an MP packet, encapsulator 28030 then sends the MP packet to the appropriate EX, such as EX 10000, based on the translated MP DA.

On the other hand, when one embodiment of decapsulator 28040 receives a packet, it verifies whether the packet is an MP packet by checking a particular bit (i.e., MP bit subfield 6080) in DA field 5010 (FIG. 5 and FIG. 6). For example, decapsulator 28040 examines MP bit 9130 in network address 9100. If the MP bit is not set, decapsulator 28040 then extracts the entire non-MP packet from payload field 5050 and sends the extracted non-MP packet to non-MP network 1300 via interface D 28000.

5.2 Access Network

An ACN collectively filters and forwards MP packets or MP-encapsulated packets between an SGW and an HGW. An exemplary ACN, such as ACN 1190, contains Mxs, such as MX 1180 and MX 1240, to simultaneously handle downstreaming packets from an SGW to HGWs and upstreaming packets from HGWs to an SGW. Additionally, one embodiment of ACN 1190 includes non-peer-to-peer MXs. For example, MX 1180 communicates with MX 1240 through SGW 1160 (instead of communicating with MX 1240 directly) and communicates with MX 1080 through SGW 1160 and SGW 1060.

Note that the packets that MX 1180 receives are typically not SGW 1160-generated packets. Except for a few instances in multipoint communication services (discussed in the Partial Address Routing Engine section above), SGW 1160 forwards packets that it receives from other sources to MX 1180 without modifying the packets.

ACN 1190 may have a tiered structure, which further distributes packet processing tasks to tiers of components. Some possible configurations to connect this tiered-structured ACN with an SGW and an HGW are, without limitation:
Fiber To The Building plus LAN (“FTTB+LAN”);
Fiber To The Curb plus Cable Modem (“FTTC+Cable Modem”);
Fiber To The Home (“FTTH”); and
Fiber To The Building+xDSL (“FTTB+xDSL”).

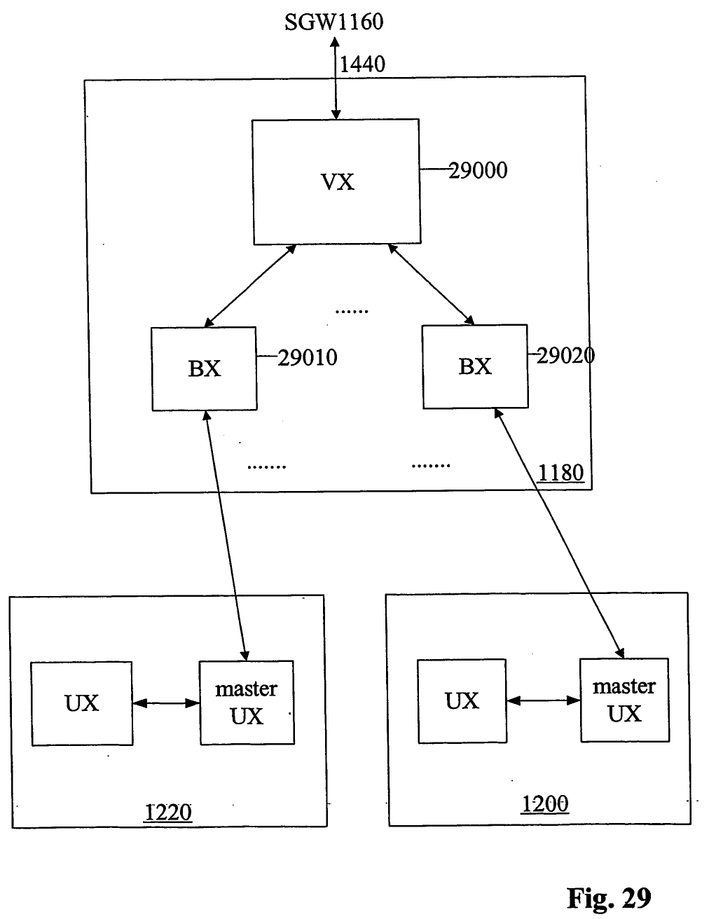

FIG. 29 illustrates one configuration of MX 1180, which includes VX 29000 and a number of BXs, such as BX 29010 and 29020. In an exemplary configuration, VX 29000 communicates with the BXs through fiber optic cables. It will be apparent to a person of ordinary skill in the art that VX 29000 can support any number of BXs in an MP network, as long as the number is consistent with the network addressing scheme. For example, suppose SGW 1160 (FIG. 1d) adopts the format of network address 7000 FIG. 7), VX 29000 on MP metro network 1000 then supports up to 8 BXs, because network address 7000 includes a 3-bit length BX subfield 7080.

In addition, the illustrated BXs are connected to the master UXs in HGW 1200 and HGW 1220 as shown in FIG. 29. The subsequent Home Gateway section will provide further details on HGWs. In one implementation, the connections between the UXs and the HGWs are Category-5 (“CAT-5”) Unshielded Twisted Paired (“UTP”) cables and/or coaxial cables. Similar to the design of VX 29000, it will be apparent to a person of ordinary skill in the art to design a BX that supports any number of UXs, as long as the number is consistent with the MP network addressing scheme. If SGW 1160 adopts the format of network address 7000, BX 29010 and BX 29020 each supports up to 32 UXs because network address 7000 includes a 5-bit length UX subfield 7090.

The connections among SGW 1160, VX 29000, the BXs, such as BX 29010 and 29020, and the UXs of HGWs, such as HGW 1200 and 1220, form the aforementioned FTTB+LAN configuration. A network operator can deploy this type of network configuration to serve cities (e.g., Shanghai, Tokyo, and New York City) and other densely populated areas.

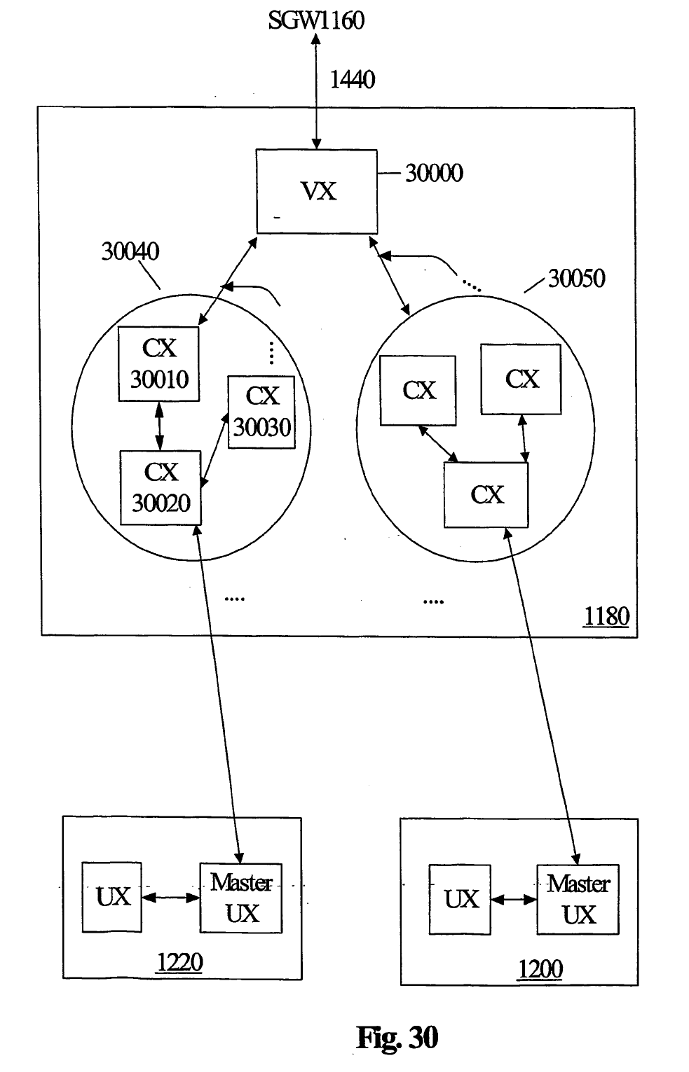

FIG. 30 illustrates another configuration of MX 1180, which includes VX 30000 and a number of CXs, such as CX 30010, 30020 and 30030. The connections of the CXs are referred to as CX loops, such as CX loop 30040 and 30050. In one embodiment, when a UT directly connected to CX 30010 communicates with a UT directly connected to CX 30020, the MP data packets from the UT connected to CX 30010 still go up to SGW 1160 before reaching the UT connected to CX 30020. Moreover, CX loop 30040 does not bypass VX 30000 to directly communicate with CX 30050. In an exemplary configuration, VX 30000 communicates with the CXs through fiber optic cables, and the CXs communicate with one another through coaxial cables, fiber optic cables or a combination of these two types. It will be apparent to a person of ordinary skill in the art that VX 30000 can support any number of CXs in an MP network, as long as the number is consistent with the network addressing scheme of the network. For example, suppose SGW 1160 adopts the format of network address 8000 (FIG. 8). Then, VX 30000, which is governed by SGW 1160, will support up to 32 CXs because network address 8000 includes a 5-bit length CX subfield 8080.

Similar to the above discussions on the BXs, the illustrated CXs are also connected to master UXs in HGW 1200 and HGW 1220 as shown in FIG. 1d. In one implementation, the connections between the CXs and the HGWs are CAT-5 UTP cables and/or coaxial cables. An alternative implementation uses fiber optic cables for the connections. Similar to the design of VX 30000, it will be apparent to a person of ordinary skill in the art to also design a CX that supports any number of UXs that is consistent with the addressing scheme of an MP network. One embodiment of CX 30020 on MP metro network 1000 supports up to 8 UXs, because network address 8000 includes a 3-bit length UX subfield 8090.

The connections among SGW 1160, VX 30000, the CXs such as CX 30010, 30020 and 30030, and the UXs of HGWs such as HGW 1200 and 1220, form either the aforementioned FTTC+Cable Modem configuration or the FTTH configuration depending on the type of connections between the CXs and the HGWs. Specifically, if the connections are CAT-5 UTP cables and/or coaxial cables, the network configuration is referred to as the FTTB+Cable Modem configuration. If the connections are fiber optic cables, the network configuration is referred to as the FTTH configuration. A network operator can deploy these types of network configurations to serve spread-out residential areas (e.g., suburban areas).

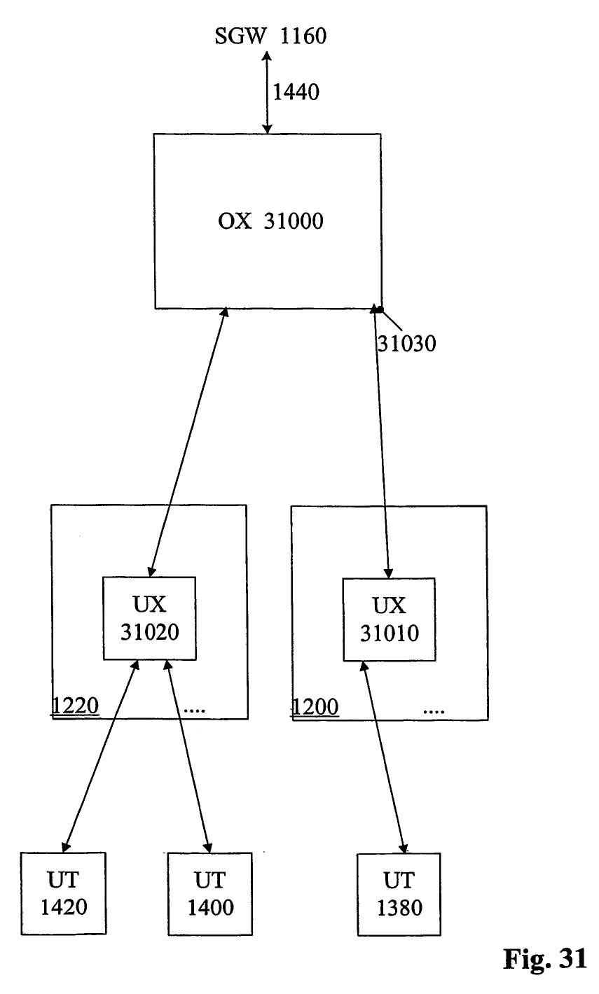

FIG. 31 illustrates yet another configuration of MX 1180, wherein OX 31000 is MX 1180 and the illustrated configuration is a subset of the configuration shown in FIG. 1d. In one implementation, OX 31000 communicates with the UXs through copper wires using various modulation technologies, such as, without limitation, xDSL technologies. It will be apparent to one of ordinary skill in the art that OX 31000 supports any number of UXs in an MP network, as long as the number is consistent with the MP network addressing scheme. For example, suppose SGW 1160 adopts the format of network address 9000 as shown in FIG. 9a, one embodiment of OX 31000 on MP metro network 1000 then supports up to 256 UXs, because network address 9000 includes an 8-bit length UX subfield 9080. A network operator can deploy this FTTB+xDSL network configuration to serve buildings and hotels with many rooms, where each room has access needs.

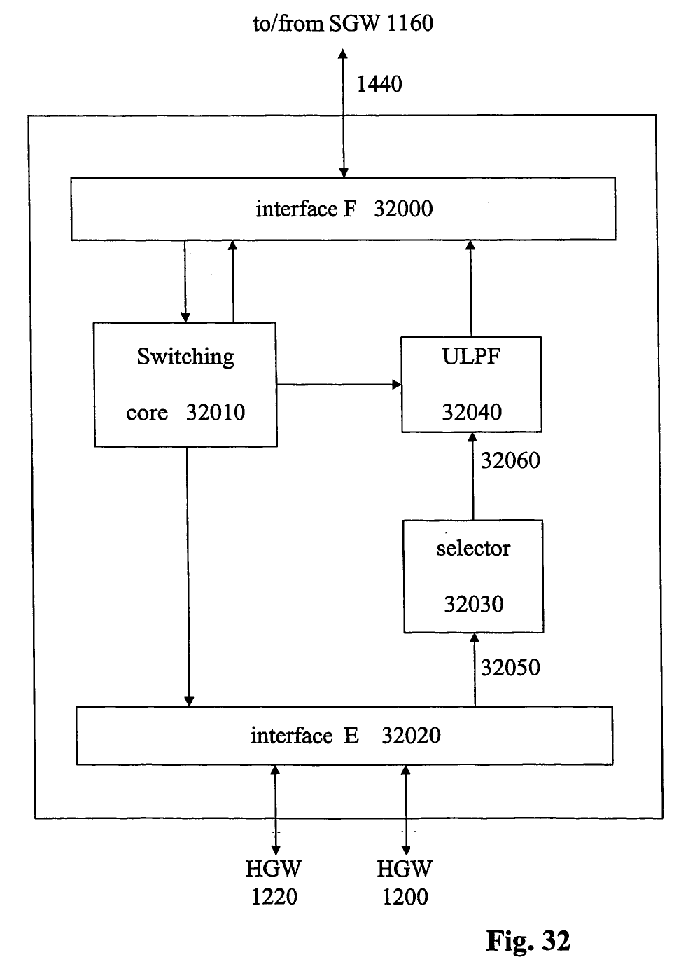

FIG. 32 illustrates a block diagram of one embodiment of an MX, such as MX 1180, MX 1080 or MX 1240 as shown in FIG. 1d. The block diagram also applies to VX 29000, a BX, VX 30000, a CX and OX 31000 as shown in FIGS. 29, 30 and 31. Using MX 1180 for discussion purposes, this embodiment of MX 1180 includes a switching core, a selector, a ULPF and two interfaces. Specifically, MX 1180 includes two types of interfaces: interface E 32020 to allow communication with HGW 1200 and HGW 1220 and interface F 32000 to allow communication with SGW 1160. These interfaces convert signals from one type to another. For instance, interface E 32020 and interface F 32000 in one embodiment of MX 1180 convert between fiber optic signals and electronic signals. The interfaces can also translate from analog electronic signals to digital electronic signals and vice versa Moreover, the interfaces support multiple logical links. For example, interface E 32020 in MX 1180 supports at least two logical links: one for communicating with HGW 1200 and the other for HGW 1220.

5.2.1 Selector

One embodiment of a selector in MX 1180, such as selector 32030 in FIG. 29 selects the order in which packets received from multiple physical links are passed on to an ULPF, such as ULPF 32040. For example, if MX 1180 connects to HGW 1200 through a single physical link and also connects to HGW 1220 through another physical link, selector 32030 uses well-known methods (e.g., round-robin and first-in-first-out) to select a link and direct packets on the selected link to ULPF 32040. It will, however, be apparent to a person of ordinary skill in the art to incorporate the functionality of the selector into the interface (e.g., make selector 32030 part of interface E 32020) without exceeding the scope of the disclosed MX technologies.

5.2.2 Switching Core

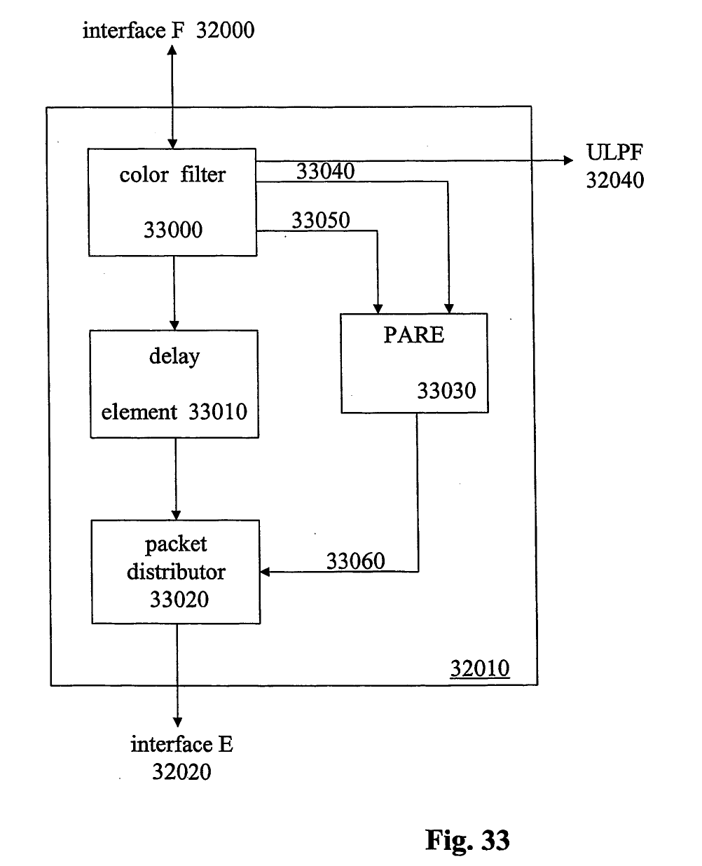

FIG. 33 illustrates a block diagram of an exemplary switching core. The switching core includes color filter 33000, delay element 33010, packet distributor 33020 and PARE 33030. This switching core is responsible for directing an incoming packet towards its final destination based on its color information, its partial address information or a combination of these two types of information. The switching core is capable of forwarding packets to multiple logical links. For example, switching core 32010 processes and sends packets to HGW 1200 and HGW 1220 via interface E 32020.

5.2.2.1 Color Filter

Color filter 33000 receives an MP packet or an MP-encapsulated packet from any of the interfaces that switching core 32010 supports, such as interface F 32000 in FIG. 32. Based on the color information of the received packet, color filter 33000 generally sends a color-filter-issued command through logical link 33040 and sends the received packet to PARE 33030 via logical link 33050 and to delay element 33010. In some instances, however, color filter 33000 sends a command to ULPF 32040 (e.g., color filter 33030 sends a setup command to ULPF 32040 in response to a setup-colored packet) or sends an MP control packet to another MP-compliant component via interface F 32000 without going through PARE 33030 (e.g., color filter 33000 responds to a query packet with the requested information).

As noted in the Edge Switch section above, The MP Color Table above lists exemplary types of color information. Color filter 33000 can recognize and process all of these types of color information or some subset thereof.

In one implementation, the color-filter-issued command causes PARE 33030 to select an appropriate packet forwarding mechanism (i.e., partial address routing or lookup table routing) and a port to forward the received packet on. Using the selected mechanism and port information, PARE 33030 asserts control signal 33060 to trigger packet delivery by packet distributor 33020.

The switching core utilizes delay element 33010 to postpone the arrival of a packet at packet distributor 33020 until PARE 33030 completes the generation of control signal 33060 using partial address and color information extracted from the same packet (or a copy thereof). In other words, the amount of time for PARE 33030 to generate control signal 33060 in this switching core is equal to or less than the length of delay that delay element 33010 introduces.

It will be apparent to one of ordinary skill in the art to design an MX that includes a different number of components than the ones that have been described above without exceeding the scope of the disclosed MX technologies. For example, one embodiment of an MX may have multiple switching cores and/or multiple ULPFs. Alternatively, some functionality of a switching core, such as the packet distributor, can be part of the interface of an MX.

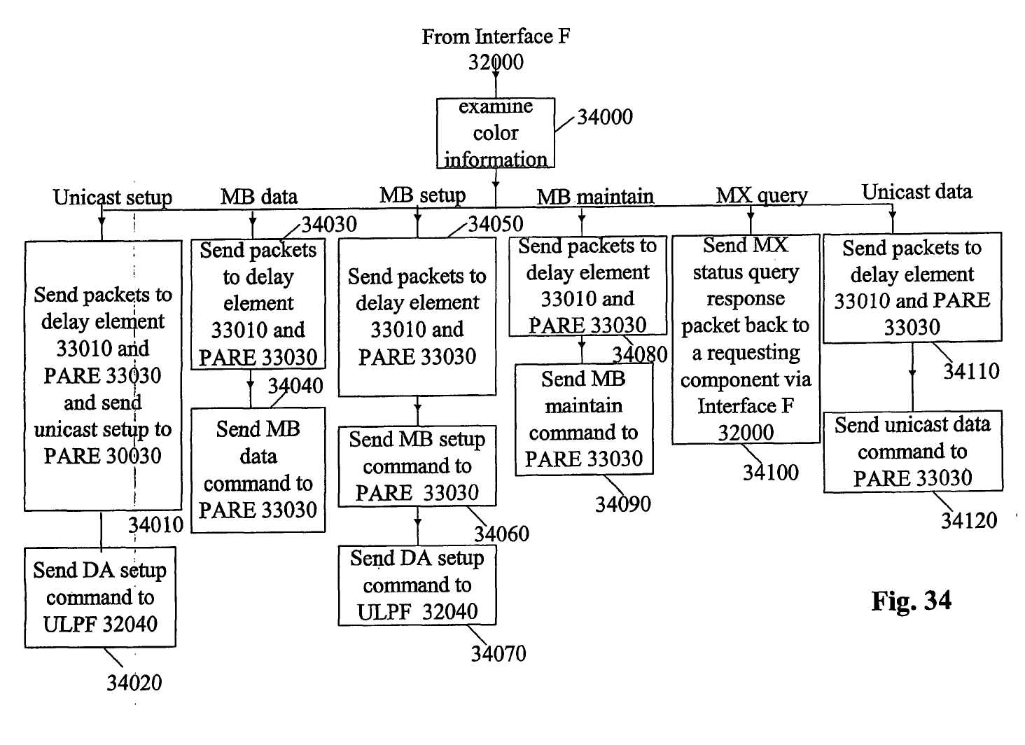

FIG. 34 illustrates a flow chart of one process that color filter 33000 follows to respond to a packet from interface F 32000 (“packet-from-32000”). If packet-from-32000 follows the packet format of MP packet 5000 (FIG. 5), then color filter 33000 examines the color information that resides in DA 5010 of the packet in block 34000. Specifically, as discussed in the Logical Layer section above, DA 5010 contains a destination network address, which further includes a general color subfield. Color filter 33000 performs a bit-wise comparison between a predefined bit mask and the general color subfield to identify a recognized service.

In this illustration, color filter 33000 recognizes the following colored packets from interface F 32000: unicast-setup-colored, unicast-data-colored, MB-setup-colored, MB-data-colored, MB-maintain-colored and MX query-colored packets. The following discussions assume that color filter 33000 recognizes the following bit masks:

| Bit mask: | Corresponding service: |
|---|---|
| 00000 | Unicast data |
| 00010 | MB setup |
| 00011 | Unicast setup |
| 00100 | MX query |
| 11000 | MB data |
| 00110 | MB maintain |

In one implementation, a unicast-setup-colored packet, an MX query-colored packet, an MB-maintain-colored packet and an MB-setup-colored packet are MP control packets. The setup packets generally initialize the MP-compliant components along the transmission path (e.g., configuring the ULPF and/or the lookup table of an MX) to perform the requested service. The inquiry packets generally query these components for their availability for carrying out the requested service. The maintain packets generally ensure that the lookup table accurately reflects the status of a communication session. On the other hand, a unicast-data-colored packet and an MB-data-colored packet are MP data packets. The use of these packets is discussed below and in the subsequent Operational Examples section.

If the comparison between the bit mask of “00011” and the general color subfield of packet-from-32000 indicates a match, color filter 33000 relays the packet to delay element 33010 and PARE 33030, and sends a unicast setup command to PARE 33030 in block 34010. Moreover, color filter 33000 also sends a DA setup command to ULPF 32040 to configure the ULPF in block 34020. Similarly, if the general color subfield of packet-from-32000 contains “00010”, color filter 33000 relays the packet to delay element 33010 and PARE 33030 in block 34050 and sends an MB setup command to PARE 33030 in block 34060. In block 34070, color filter 33000 configures ULPF 32040 through the DA setup command.

In response to either a unicast-data-colored packet or an MB-data-colored packet, color filter 33000 relays the packet to delay element 33010 and PARE 33030, and sends appropriate commands, such as a unicast data command or an MB data command, to PARE 33030. In response to an MB-maintain-colored packet, color filter 33000 relays the packet to delay element 33030 and PARE 33030 in block 34080 and sends an MB maintain command to PARE 33030 in block 34090. On the other hand, in response to an MX query-colored packet from another MP-compliant component, such SGW 1160 (FIG. 1d), color filter 33000 sends another MP control packet, such as a status query response packet, back to SGW 1160 via interface F 32000 in block 34100. This MP control packet contains information such as, without limitation, egress traffic information for MX 1180. In other words, the color information in these different colored packets serves as instructions for color filter 33000 to initiate distinct operations.

Furthermore, one embodiment of color filter 33000 considers packet-from-32000 an error packet and discards the packet if it does not recognize the color information contained in the packet.

Although the above discussions use a specific set of colored packets and bit masks to describe some functionality of color filter 33000, it will be apparent to a person of ordinary skill in the art to implement a color filter that responds to other types of colored packets and invokes other operations than the ones described without exceeding the scope of the disclosed color filtering technologies. The subsequent Operational Examples section will provide further details on utilizing the aforementioned colored packets in call setup, call communication, and call clear-up procedures.

5.2.2.2 Partial Address Routing Engine

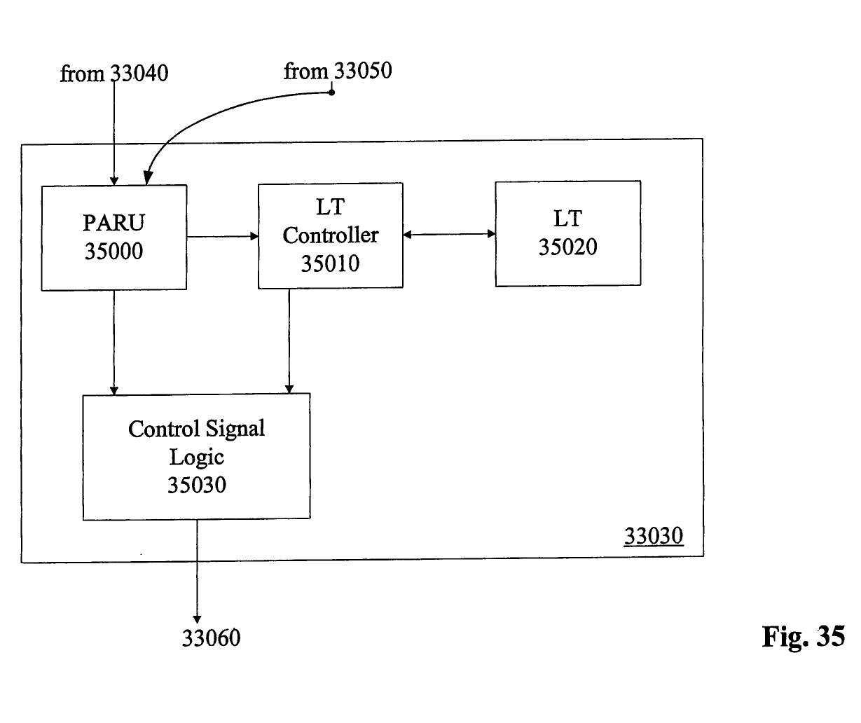

Based on the command and the packet that it receives, one embodiment of PARE 33030 asserts control signal 33060 to packet distributor 33020. FIG. 35 illustrates a block diagram of one embodiment of a PARE, such as PARE 33030 in FIG. 33. PARE 33030 includes partial address routing unit (“PARU”) 35000, lookup table controller (“LTC”) 35010, lookup table (“LT”) 35020 and control signal logic 35030. PARU 35000 receives and processes commands and packets from color filter 33000 via logical link 33040 and logical link 33050, respectively. Then PARU 35000 conveys the processed results to control signal logic 35030 and/or to LTC 35010.

In one implementation, PARU 35000 provides LTC 35010 with pertinent packet delivery information (e.g., partial address information and session numbers) from the received packets and enables LTC 35010 to maintain the obtained information in LT 35020. In other instances, PARU 35000 causes LTC 35010 to retrieve and pass along information from LT 35020 to control signal logic 35030. It should be noted that LT 35020 may reside in a local memory subsystem in MX 1180.

The following examples use unicast and MB sessions among UTs 1380, 1400 and 1420 (FIG. 31) and between UTs 1380 and 1450 (FIG. 1d) to further explain the operations among the components within PARE 33030. For clarity, the discussions of these examples refer to FIGS. 1d, 5, 9a, 33 and 35 and assume certain implementation details (given below). However, it will be apparent to one of ordinary skill in the art that PARE 33030 is not limited to these details and the subsequent discussions relating to MB also apply to other multipoint communications (e.g., MM). The details include:
MX 1180 corresponds to OX 31000 in the FTTB+XDSL configuration as shown in FIG. 31. MX 1240 also has a network topology like OX 31000.
Because UTs 1380, 1400 and 1420 are physically coupled to the same HGW (HGW 1200), the same MX (MX 1180) and the same SGW (SGW 1160), they share the same partial addresses in nation subfield 9040, city subfield 9050, community subfield 9060 and OX subfield 9070 as shown in FIG. 9a In other words, suppose UT 1380 includes the following information in its assigned network address:
   Nation subfield 9040: 1
   City subfield 9050: 23
   Community subfield 9060: 45
   OX subfield 9070: 7
   UX subfield 9080: 3
   UT subfield 9090: 1
Then, the assigned network addresses of UT 1400 and UT 1420 would contain the same information as UT 1380, except for the partial addresses in UX subfield 9080 and UT subfield 9090. On the other hand, because UT 1450 is coupled to a different HGW (HGW 1260) and a different MX (MX 1240), its assigned network address would contain at least a partial address in OX subfield 9070 different from 7, the partial address in OX subfield 6040 for UTs 1380, 1400, and 1420.
A portion of the assigned network address of UT 1400 is 1/23/45/7/2/1 (nation subfield 9040/city subfield 9050/community subfield 9060/OX subfield 9070/UX subfield 9080/UT subfield 9090).
A portion of the assigned network address of UT 1420 is 1/23/45/7/2/2.
A portion of the assigned network address of UT 1450 is 1/23/945/8/1/1.
A portion of the assigned network address of MX 1180 is 1/23/45/7.
A portion of the assigned network address of MX 1240 is 1/23/45/8.
The amount of time that PARE 33030 takes to assert control signal 33060 is less than or equal to the amount of time either an MP packet or an MP-encapsulated packet from color filter 33000 remains in delay element 33010;
PARE 33030 and the components within PARE 33030 are part of MX 1180.
Color filter 33000 of one embodiment of MX 1180 issues commands. As discussed in detail above, color filter 33000 derives these commands from a number of recognized colored MP packets and sends the commands to PARU 35000 via logical link 33040. Color filter 33000 also forwards these colored MP packets to PARU 35000 via logical link 33050 and to delay element 33010. Some of the recognized colored MP packets are described in the MP Color Table in the Logical Layer section above.
The network addresses in the packets mentioned above follow the format of network address 9000 in unicast communication and the format of network address 9200 in multipoint communication.
Similar to the example given in the Partial Address Routing Engine section in the Edge Switch section above, server group 10010 here has approved the requested MB service and reserved session number “1”, which represents an MB program source (e.g., a live television show from a television studio, a movie, or interactive game from media storage) that UT 1380, UT 1400 and UT 1420 retrieve information from. Also, the mapped session number is “0” in the following example unless stated otherwise. Server group 10010 has placed the session number “1” and the mapped session number “0” in payload field 5050 of an MB-setup-colored packet.

In a unicast session between two UTs, if PARE 33030 receives either a unicast setup command or unicast data command from color filter 33000, PARU 35000 provides control signal logic 35030 with relevant partial address information to generate control signal 33060. In particular, if UT 1380 requests a unicast session with UT 1400, PARU 35000 of MX 1180 then provides control signal logic 35030 with the partial address of “2”, because the network address of the called party, UT 1400, has “2” in its UX subfield 9080.

As control signal logic 35030 determines a proper control signal 33060 to assert in response to the partial address “2”, delay element 33010 forwards a temporarily delayed packet, such as a unicast-setup-colored packet, to packet distributor 33020. The asserted control signal 33060 then causes packet distributor 33020 to forward this packet towards its destination. The discussed process of forwarding a unicast-setup-colored packet from an MX to a (master) UX in an HGW also applies to forwarding a unicast-data-colored packet. The subsequent Packet Distributor section will further elaborate on implementation details of one embodiment of a packet distributor, such as packet distributor 33020.

On the other hand, if UT 1380 requests a unicast session with UT 1450, SGW 1160 would deliver the unicast-setup-colored packet to MX 1240 (instead of MX 1180) because the network address of the called party, UT 1450, has “8” in its OX subfield 9070. Suppose MX 1240 has a similar architecture to the architecture of MX 1180 (FIGS. 32, 33, and 35). After receiving the MP colored packet, color filter 33000 of MX 1240 forwards the MP colored packet to delay element 33010 and PARU 35000 of MX 1240 and asserts a corresponding unicast setup command to the PARU of MX 1240. The packet contains the partial address “1”, which corresponds to UX subfield 9080 in the network address of UT 1450. PARU 35000 provides control signal logic 35030 with “1”, so that control signal logic 35030 and packet distributor 33020 can coordinate forwarding of the unicast-setup-colored packet to the master UX in HGW 1260. The aforementioned process of delivering a unicast-setup-colored packet from one UT under the management of one MX to another UT under the management of another MX also applies to delivery of a unicast-data-colored packet.

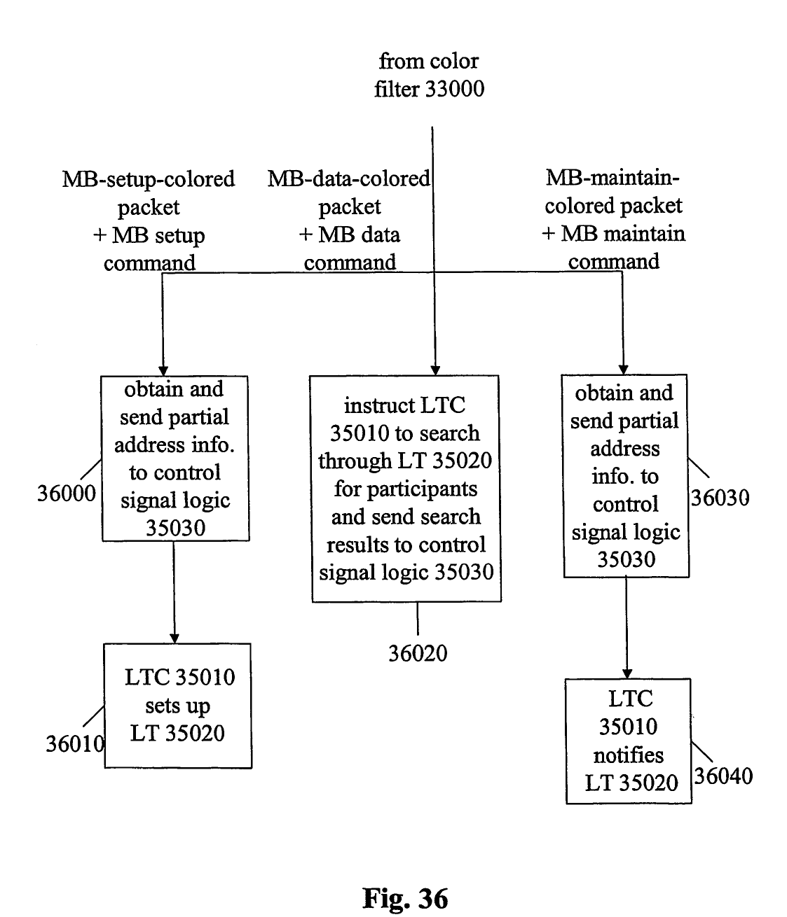

FIG. 36 illustrates a flow chart of one process that PARU 35000 follows to manage an MB session, which involves UT 1380, UT 1400 and UT 1420 and one MB program source in the current example. Similar to the aforementioned establishment of a unicast session, in response to MB-setup-colored packets from server group 10010 of SGW 1160 to establish the aforementioned MB session, color filter 33000 sends the packets and the corresponding MB setup commands to PARU 35000. PARU 35000 retrieves the partial addresses “3” or “2” from each of the packets in block 36000. One MB-setup-colored packet includes “3”, because the network address of UT 1380 contains “3” in its UX subfield 9080. The other two MB-setup-colored packets include “2” because UT 1400 and UT 1420 share one UX and contain “2” in UX subfield 9080 of their network addresses. PARU 35000 also passes along “2” or “3” to control signal logic 35030 in block 36000, so that control signal logic 35030 and packet distributor 33020 can coordinate forwarding of the MB-setup-colored packets towards their destinations.

Note that in the example described above, color filter 33000 asserts an MB setup command for each MB-setup-colored packet that it receives from server group 10010 via EX 10000 of SGW 1160. Thus, for an MB session that involves three participants (excluding program sources), one embodiment of PARU 35000 would receive three MB setup commands and thus execute block 36000 three times.

In addition, PARU 35000 supplies LTC 35010 with the derived partial address information (e.g., “2” and “3” in the UX subfields), the session number “1”, and mapped session number “0” from the MB-setup-colored packets. Because mapped session number is “0”, LTC 35010 then sets up LT 35020 cells 37000 (2,1) and 37020 (3,1) with “1” in block 36010. The session number “1” identifies the MB program source discussed above.

However, if PARU 35000 supplies LTC 35010 with a session number, a non-zero mapped session number, and partial address information, one embodiment of LTC 35010 then uses the non-zero mapped session number and the partial address information to set up LT 35020.

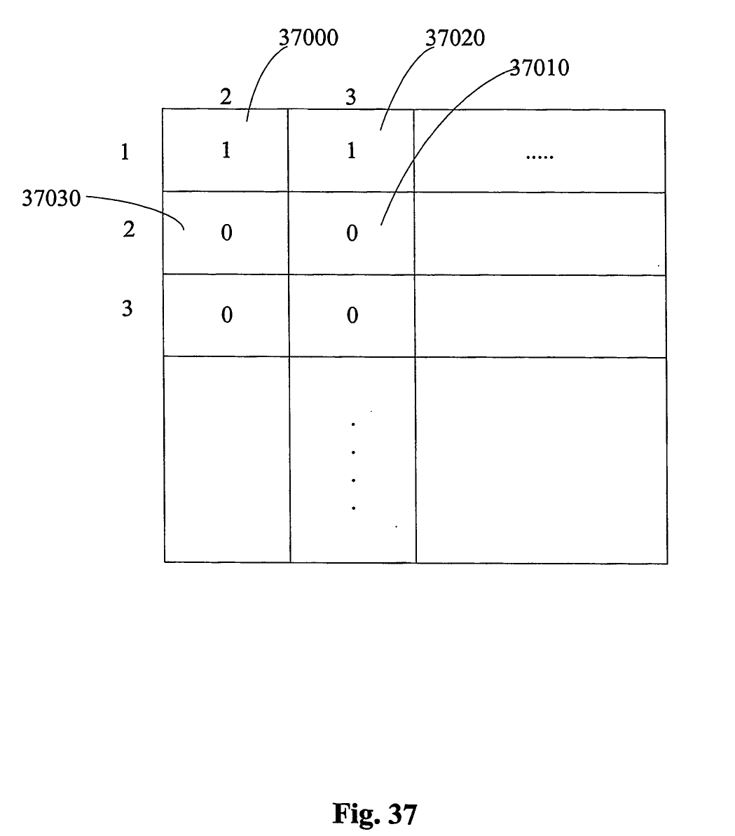

FIG. 37 illustrates a sample table of LT 35020. The size of LT 35020 depends on: 1) the number of ports in OX 31000 that UXs in HGWs can attach to and 2) the number of multipoint-communication (e.g., MM and MB) sessions that SGW 1160 supports. In the present example, because OX 31000 supports at least two master UXs (UX 31010 and UX 31020) and assuming SGW 1160 supports three MB program sources, LT 35020 contains at least six cells. Also, this embodiment of LT 35020 indexes its cells in accordance with relevant partial addresses and session numbers. For example, coordinate (2, 1) corresponds to cell 37000, and (3, 2) corresponds to cell 37010. Cell 37000 represents status information of a UX with partial address “2” that receives information from an MB program source identified by session number “1”. On the other hand, cell 37010 represents a UX with partial address “3” that receives information from another MB program source identified by session number “2.”

All cells of one implementation of LT 35020 initially begin with zeros. As LTC 35010 identifies matching session numbers, such as session number “1”, and partial addresses, such as “2”, in LT 35020, LTC 35010 then modifies the content of appropriate cells in LT 35020, such as cell 37000 (2, 1), to one, thereby indicating that a UT with partial address “2” will be participating in MB session 1. In one implementation, LTC 35010 is also responsible for resetting the modified cells back to zero when the UT is no longer a participant in the MB session. Alternatively, LT 35020 relies on timers to reset its modified cells. In particular, when LT 35020 detects modification to one of its cells, it starts a timer. If LT 35020 does not receive any notification to preserve the content of the modified cell within a certain amount of time, LT 35020 automatically resets the cell back to zero.

An MB maintain command provides one form of this notification. Specifically, in response to MB-maintain-colored packets from server group 10010 of SGW 1160 to maintain the aforementioned MB session, color filter 33000 sends the packets and the corresponding MB maintain commands to PARU 35000. PARU 35000 retrieves the partial address of either “2” or “3” from each of the packets in block 36030. Similar to the discussions of block 36000 above, PARU 35000 passes along the partial address information to control signal logic 35030 in block 36030, so that control signal logic 35030 and packet distributor 33020 can coordinate forwarding of an MB-maintain-colored packet towards its destination.

In addition, PARU 35000 supplies LTC 35010 with the derived partial address information (either “2” or “3”) and the session number “1” from the MB-maintain-colored packets. With the partial address “2” or “3” and the session number “1”, LTC 35010 is then able to reset the timer for cell 37000 or 37020, respectively, and thus effectively provide LT 35010 with the mentioned notification in block 36040. Alternatively, LTC 35010 can set the content of cell 37000 or 37020 to 1.

In response to an MB-data-colored packet from the MB program source, color filter 33000 sends the packet and the corresponding MB data command to PARU 35000. PARU 35000 retrieves a session number from session number subfield 9270. Then, PARU 35000 instructs LTC 35010 to search through row 1 (which corresponds to MB session 1) of LT 35020 for cells with an active value of one, such as cells 37000 and 37020, in block 36020.

This search identifies ports that lead to the UTs participating in MB session 1. After LTC 35010 successfully locates cells 37000 and 37020, which contain ones, LTC 35010 is able to obtain the partial addresses “2” and “3” in accordance with the aforementioned indexing scheme of LT 35020. LTC 35010 then passes “2” and “3” to control signal logic 35030, which then instructs packet distributor 33020 to forward the MB-data-colored packet to the appropriate UXs (e.g., “2” corresponds to UX 31020 and “3” corresponds to UX 31010). However, if LTC 35010 fails to identify any cells with an active value of one in LT 35020, one embodiment of LTC 35010 does not communicate with control signal logic 35030 and does not trigger packet delivery by packet distributor 33020.

The process used in this MB example generally applies to other types of multipoint communication, such as, without limitation, MM. Also, it will be apparent to a person of ordinary skill in the art to design or implement the disclosed color filtering and PARE technologies without employing all the details set forth above. For example, the functionality of the aforementioned PARE can be combined with the aforementioned color filter. On the other hand, the functionality of the aforementioned PARU can be further divided and distributed to the aforementioned LTC.

5.2.2.3 Packet Distributor

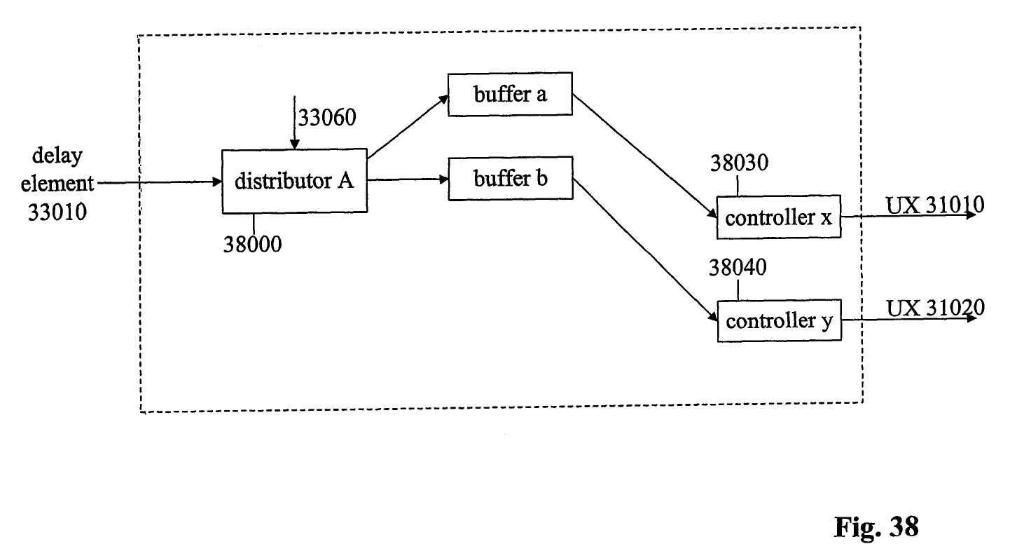

A packet distributor, such as packet distributor 33020 as shown in FIG. 33 is mainly responsible for delivering packets to appropriate output logical links according to control signal 33060 from control signal logic 35030. FIG. 38 illustrates a block diagram of one embodiment of packet distributor 33020. This embodiment of packet distributor 33020 includes a distributor, such as distributor A 38000, buffer bank 38020 and controllers, such as controller x 38030 and controller y 38040. In one implementation, the number of buffers in buffer bank 38020 equals the product of the number of distributors and the number of controllers. Thus, because packet distributor 33020 has 1 distributor to accept packets from delay element 33010 and 2 controllers for forwarding the packets to the UXs that OX 31000 supports (e.g., UX 31010 and UX 31020), packet distributor 33020 would then have (1*2) buffers in buffer bank 38020. These buffers in buffer bank 38020 temporarily store packets that are to be sent to UX 31010 and UX 31020.

To minimize delay and avoid traffic congestion that buffer bank 38020 may introduce, controllers in one embodiment of packet distributor 33020 poll and clear buffer bank 38020 at a fixed or adjustable time interval. As an illustration of this mechanism, assume control signal 33060 invokes distributor A 38000 to forward its packet (which is from the output of delay element 33010) to either buffer a or buffer b, depending on whether the packet is being forwarded towards UX 31010 or UX 31020.

Instead of sending its packet directly to the intended logical link, distributor A 38000 forwards its packet to either buffer a or buffer b, where the packet is temporarily stored. Before distributor A 38000 forwards additional packets to buffer bank 38020 or before any overflow condition at buffer bank 38020 occurs, controller x 38030 polls each buffer that it manages. If controller x 38030 detects packets in any of the buffers, such as buffer a in the current example, it forwards the packets in the buffers to UX 31010 and clears the buffers. In the same manner, controller y 38040 also polls each buffer that it manages.

Although a 1-by-2 (i.e., 1-distributor-by-2-controller) packet distributor has been described, it will be apparent to a person of ordinary skill in the art to implement an MX without the 1-by-2 packet distributor, especially if including the packet distributor introduces delay and congestion. It will also be apparent to a person of ordinary skill in the art to implement a packet distributor in other configurations and with a different-sized buffer bank without exceeding the scope of the disclosed packet distribution technologies. It will also be apparent to a person of ordinary skill in the art to practice the disclosed switching core technologies with other types of packet distribution mechanisms than the mechanism described above.

5.2.2.4 Uplink Packet Filter (“ULPF”)

After selector 32030 (FIG. 32) selects a physical link, ULPF 32040 then filters out certain packets on the selected physical link based on “entry criteria”, which prevent certain packets from reaching and/or entering SGWs. Specifically, switching core 32010 dynamically establishes these entry criteria for ULPF 32040 by sending setup commands (e.g., DA setup command). If a packet fails any of the entry criteria, ULPF 32040 discards the packet. Thus, an ULPF is able to remove unwanted packets from an MP network and thus strengthen the security and integrity of the network.

One embodiment of ULPF 32040 applies a set of entry criteria to a received packet by checking whether the received packet contains permissible source address, destination address, traffic flow and data content. Based on the results of these checks, ULPF 32040 decides whether to send the packet to interface F 32000 or to reject and discard the packet.

In one embodiment of an MP network, the aforementioned EXs, BXs, OXs and CXs contain ULPFs. It will be apparent to a person of ordinary skill in the art to distribute various entry criteria to the ULPFs of different switches without exceeding the scope of the disclosed technologies of a ULPF. For example, in the FT+xDSL configuration in FIG. 31, the ULPF in the EX of SGW 1160 can have an entry criterion that checks for permissible data content, while the ULPF in OX 31000 has entry criteria that check for permissible source address, destination address and traffic flow. It will also be apparent to one of ordinary skill in the art to recognize that the scope of the disclosed ULPF is not limited to the four entry criteria discussed above. These four entry criteria are exemplary, not exhaustive.

For clarity, the following discussions describe one embodiment of ULPF 32040 in three phases: ULPF setup, ULPF checks and ULPF clear-up. Also, the discussions assume the following:
ULUF 32040 resides in MX 1180; and
SGW 1160, which governs MX 1180, includes server group 10010 that uses independently operating server systems as shown in FIG. 12.
   5.2.2.4.1 ULPF Setup

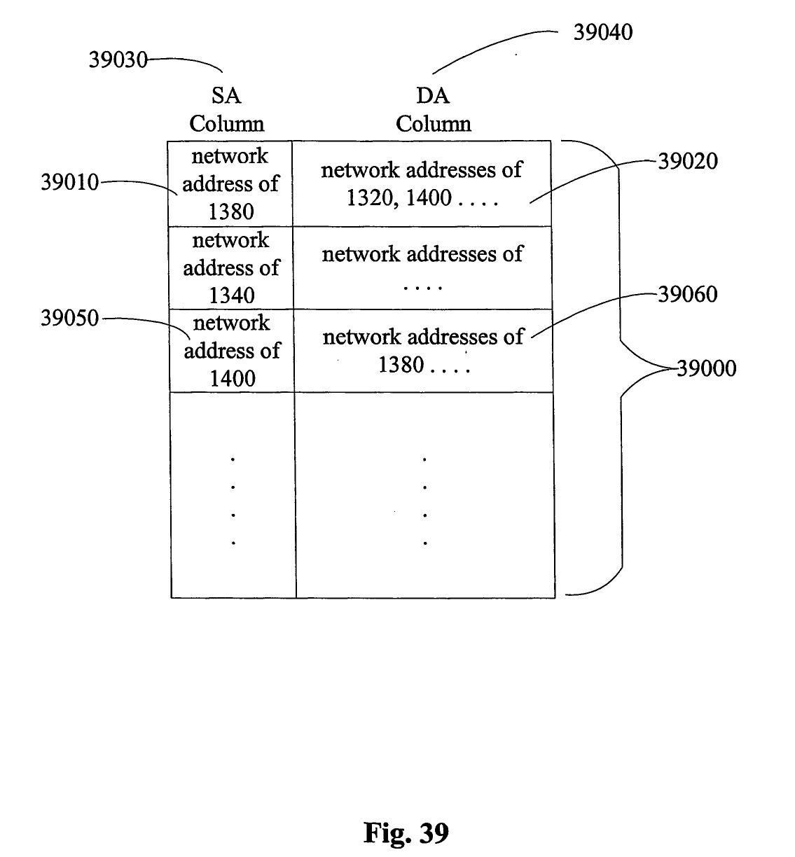

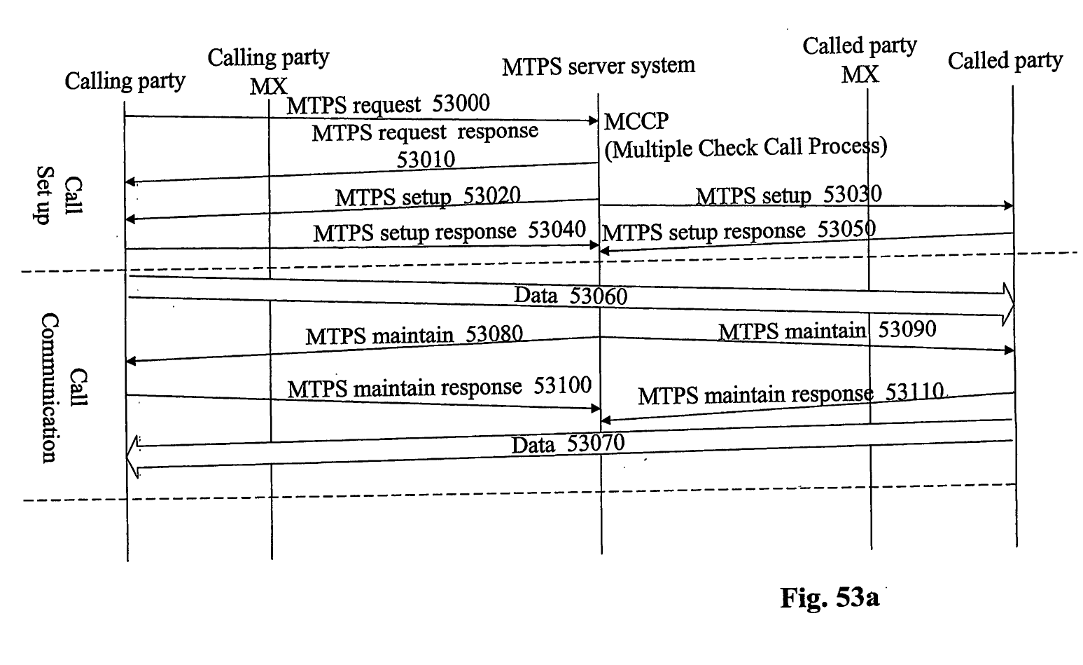

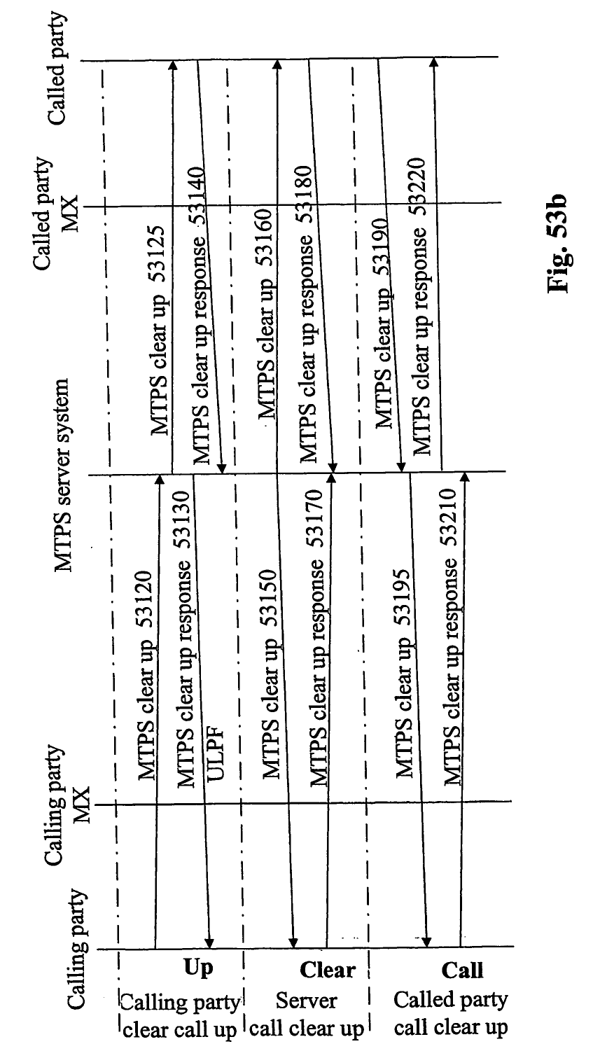

Switching core 32010 sets up ULPF 32040 based on information that it receives from server group 10010 of SGW 1160, as described below.
1. After performing the MCCP procedure discussed in the Server Group section above, one embodiment of call processing server system 12010 (FIG. 12) sends MP control packets to the calling party and/or the called party of a requested service. These control packets include entry criteria information for ULPFs (e.g., ULPF 32040) such as, without limitation, a list of permissible network addresses for packet delivery, permissible traffic flow information and permissible types of data content.
   As an illustration, if UT 1380 requests media telephony service (“MTPS”) with UT 1450 (FIG. 1d), call processing server system 12010 responds to the request by sending an “MTPS setup” packet to both the calling party, UT 1380, and the called party, UT 1450, as shown in FIG. 53. The MTPS setup packet is an MP control packet. The subsequent Operational Examples section will further elaborate on the operational details of MTPS.
   Payload field 5050 (FIG. 5) in both the MTPS setup packet for the calling party and the MTPS setup packet for the called party includes information on the permissible traffic flow for the requested MTPS session and the permissible type of data content in the session. The MTPS setup packet for the calling party further includes the network address of the called party in its payload field 5050, whereas the MTPS setup packet for the called party contains the network address of the calling party in its payload field 5050. In this illustration, the MTPS setup packet for the calling party travels through MX 1180, and the MTPS setup packet for the called party travels through MX 1240 before reaching their destinations.
2. After MX 1180 receives its MTPS setup packet, based on the color information (e.g., unicast setup color) that resides in the DA field of the packets, its switching core 32010 (FIG. 32) proceeds to extract the aforementioned entry criteria from the packets and dynamically configure ULPF 32040 with the extracted information. One embodiment of ULPF 32040 includes a local memory subsystem to store this configuration information.
   More specifically, one implementation of ULPF 32040 includes a DA search table in its local memory subsystem. FIG. 39 illustrates one sample DA search table 39000, which contains multiple two-item entries, an item for an SA and the other item for the DAs corresponding to the SA. The SA is the network address of one MP-compliant component under MX 1180, such as UT 1380, and the DAs are the network addresses of the MP-compliant components (e.g., UTs, media storage, gateway, and server group) that UT 1380 is approved (by the MCCP procedure) to communicate with.
   Initially, DA search table 39000 of ULPF 32040 in MX 1180 contains the network addresses of the UTs that depend on MX 1180, such as UT 1340, 1360, 1380, 1400 and 1420, in SA column 39030. After switching core 32010 receives the MTPS setup packet from the server group of SGW 1160 for the calling party, it extracts the network address of the calling party from DA field 5010 (FIG. 5) and extracts the network address of the called party from payload field 5050. If switching core 32010 identifies SA item 39010 in DA search table 39000 due to a match to the calling party's network address, switching core 32010 adds the network address of the called party in DA item 39020. Suppose MX 1240 has a similar architecture to MX 1180 (FIGS. 32, 33, and 35) and also maintains a DA search table similar to DA search table 39000 FIG. 39). In a similar fashion, in response to the MTPS setup packet for the called party, switching core 32010 of MX 1240 updates DA item 39060 to include the network address of the calling party.
   Switching cores 32010 of MX 1180 and MX 1240 also retrieve the aforementioned traffic flow and data content information from payload field 5050 of the MTPS setup packet and then stores the retrieved information in its local memory subsystem in ULPF 32040. Some examples of traffic flow information include, without limitation, a permissible number of bits in a session of the requested service, a maximum number of bits for the requested service, permissible packet arrival rate, and a permissible packet length for each packet. Data content information may include, without limitation, copyright information and/or other intellectual property rights information. In one implementation, before a content provider of copyrighted data places its data on an MP network, the provider packetizes its data into MP data packets and sets one or more bits in either payload field 5050 or one of the header fields of these packets to indicate the provider's ownership of copyright to the data.
3. As the MTPS setup packets are sent from call processing server system 12010 to the calling and called parties, the ULPFs of the switches along the transmission path that receive and forward the MTPS setup packets are configured with entry criteria information in accordance with the process discussed above. Note that not all of the switches along the transmission path contain ULPFs and, as noted above, the UPLF entry criteria can be distributed over several switches that include ULPFs.

Although the above example updates DA search table 39000 as shown in FIG. 39 with DAs of two UTs under one SGW, switching core 32010 can also update DA column 39040 with DAs of MP-compliant components that are anywhere in an MP network. Additionally, it will be apparent to one of ordinary skill in the art to design DA search table 39000 to also store permissible traffic flow information and permissible data content information. Furthermore, it should be noted that the local memory subsystem discussed above can either be a dedicated memory subsystem for ULPF 32040 or a shared memory subsystem for various components within MX 1180. This local memory subsystem can either reside within MX 1180 or connect to MX 1180 as an external device.

5.2.2.4.2 ULPF Checks

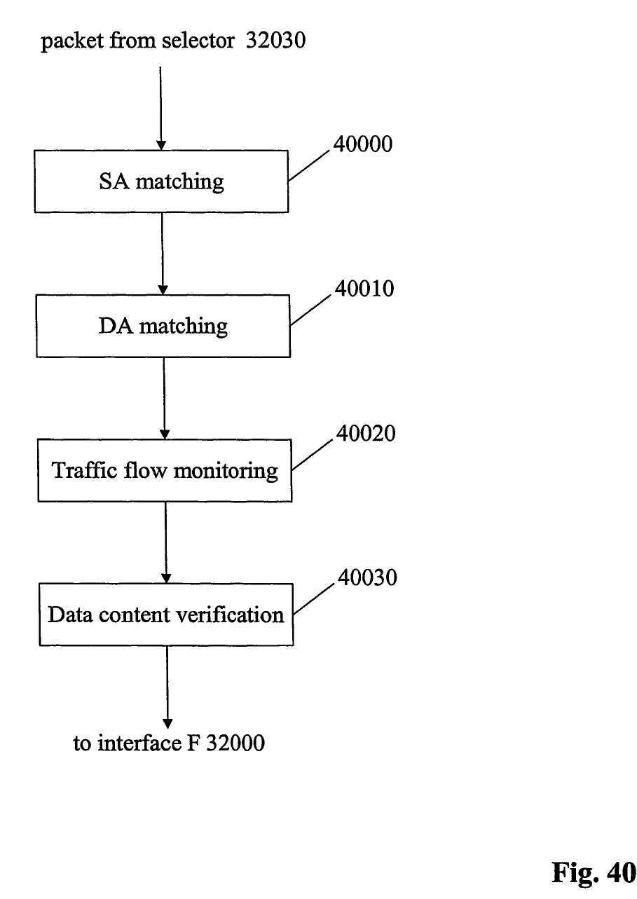

After switching core 32010 configures ULPF 32040 with entry criteria as discussed above, ULPF 32040 filters the packets that it receives based on the entry criteria. FIG. 40 illustrates a flow chart of one process that one embodiment of ULPF 32040 follows to perform the ULPF checks. Continuing with the preceding example, UT 1380 is the source of the packets and UT 1450 is the destination of the packets.

Specifically, ULPF 32040 receives an MP packet from selector 32030 (FIG. 32). In block 40000, one embodiment of ULPF 32040 conducts SA matching to check whether the partial address of the SA (e.g., nation, city, community, and tiered switch subfields) of this received packet matches the partial address of the assigned network address of MX 1180; and 2) whether the partial address of the SA (e.g., nation, city, community, and tiered switch subfields) of this received packet matches the network address bound to port 1170 as shown in FIG. 1d. These checks ensure that the packet ULPF 32040 receives originates from an authorized component and comes through an authorized logical link.

One scenario that these checks address involves an “unauthorized” HGW that connects to MX 1180 and attempts to send a packet to SGW 1160 in MP metro network 1000 (FIG. 1d). Because this HGW does not have an assigned network address from server group 10010 of SGW 1160 (FIG. 10), the SA of the packet that MX 1180 receives would not match the assigned network address of MX 1180. Thus, the aforementioned SA matching check allows ULPF 32040 of MX 1180 to prevent this packet from reaching SGW 1160.

Another scenario these checks address involves the same “unauthorized” HGW connecting to MX 1180 but attempting to assume the identity of HGW 1200 by arbitrarily altering its network address to match the network address of HGW 1200. This “unauthorized” HGW connects to MX 1180 through a different port than port 1170 and attempts to send a packet to SGW 1160 in MP metro network 1000 (FIG. 1d). Because the SA of this packet that MX 1180 receives would not match the network address that is bound to port 1170, ULPF 32040 of MX 1180 discards the packet-and-prevents the packet from reaching SGW 1160.

Using the FTTB+xDSL configuration as shown in FIG. 31 and the format of network address 9000 as shown in 9a as an illustration, ULPF 32040 retrieves the SA from SA field 5020 of the received packet (FIG. 5) and compares the partial address of the SA (e.g., nation subfield 9040, city subfield 9050, community subfield 9060, and OX subfield 9070) to the corresponding portion of the network address of OX 31000. As discussed in the Server Group section above, OX 31000 obtains its network address from server group 10010 of SGW 1160 (FIG. 10) during network configuration. One embodiment of OX 31000 further stores this assigned network address in its local memory subsystem. If the comparison of ULPF 32040 yields a match, ULPF 32040 proceeds to the next check. Otherwise, ULPF 32040 discards the packet.

Also, ULPF 32040 compares the partial address of the SA (e.g., nation subfield 9040, city subfield 9050, community subfield 9060, OX subfield 9070, and UX subfield 9080) to the corresponding portion of the network address of port 31030 to ensure that the MP packets from UT 1380 arrive at OX 31000 via port 31030.

In block 40010 of FIG. 40, ULPF 32040 performs DA matching on the packet. Specifically, ULPF 32040 searches through DA item 39020 of DA search table 39000 for a DA that matches the content of DA field 5010 of the packet. As discussed above, switching core 32010 sets up these DA items, such as DA item 39020, during the setup phase of ULPF 32040. If ULPF 32040 successfully identifies a matching DA, ULPF 32040 proceeds to the next check. Otherwise, ULPF 32040 discards the packet.

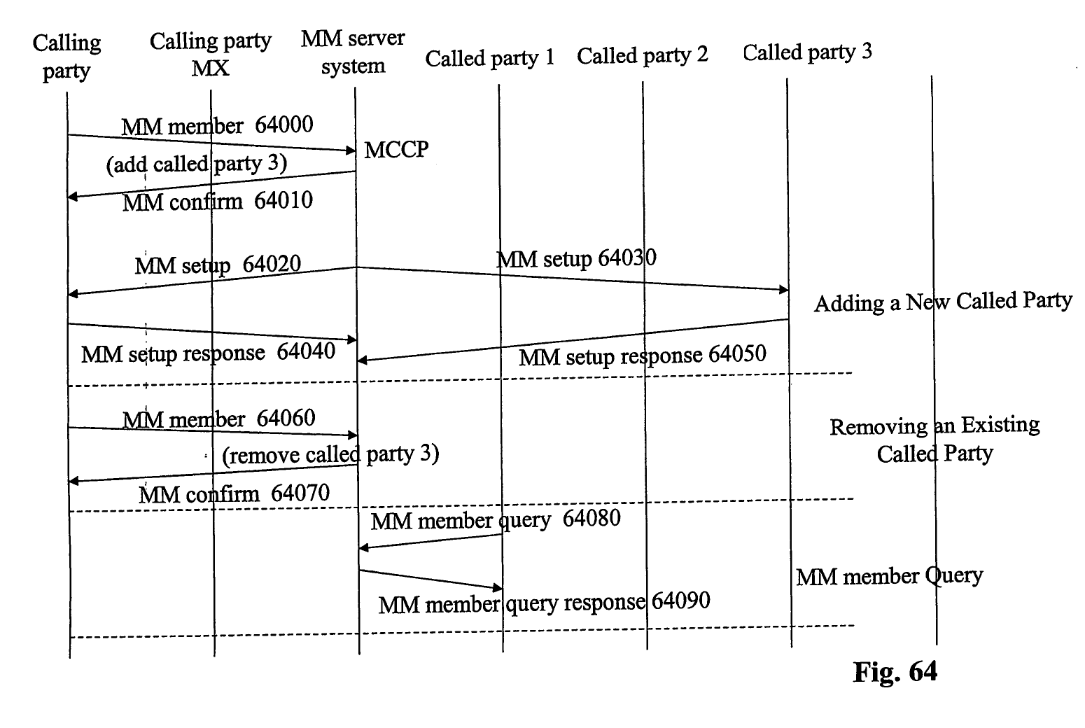

This check ensures that the intended destination is an authorized network address. In other words, in conjunction with FIGS. 10, 32 and 39, after server group 10010 approves a requested service among approved parties, switching core 32010 sets up DA search table 39000 for ULPF 32040 according to the network addresses of these parties. Consequently, ULPF 32040 of MX 1180 can filter out packets that are not destined for approved parties. However, it should be noted that one embodiment of switching core 32010 is capable of modifying DA search table 39000 even during communication among the approved parties (e.g., to add new participants to an ongoing multipoint communication). In particular, switching core 32010 performs the modification in response to an MP setup packet (e.g., MM setup 64020 in FIG. 64) from server group 10010 of SGW 1160.

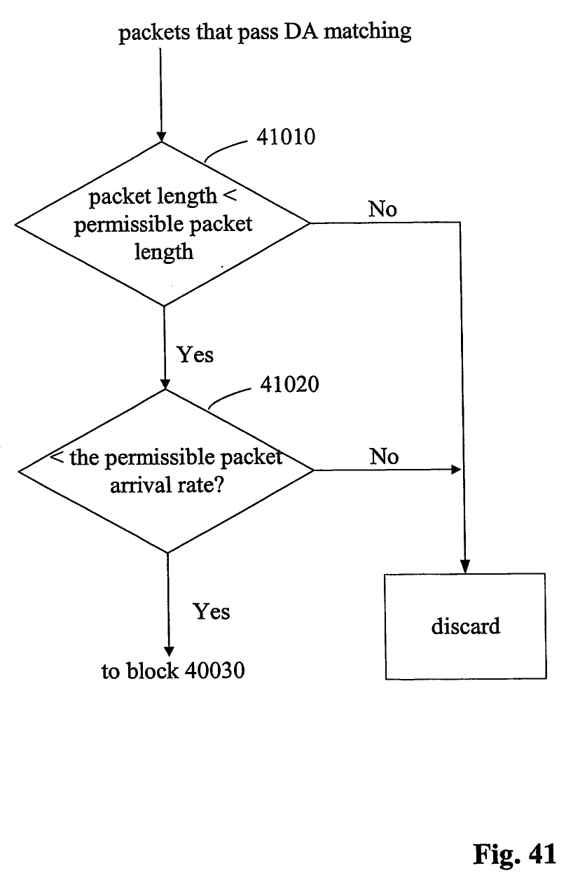

In block 40020 of FIG. 40, ULPF 32040 conducts traffic flow monitoring to ensure the packet meets certain traffic flow standards. As mentioned above, some examples of these standards include, without limitation, a permissible number of bits in a session of the requested service, a maximum number of bits for the requested service, permissible packet arrival rate, and a permissible packet length for each packet. FIG. 41 further illustrates a flow chart of one process that one embodiment of an ULPF, such as ULPF 32040, follows to execute block 40020. If ULPF 32040 determines that the packet passes the traffic flow monitoring check, then ULPF 32040 proceeds to the next check. Otherwise, ULPF 32040 discards the packet. It will be apparent to one of ordinary skill in the art to check for multiple traffic flow standards in block 40020 and yet still remain within the scope of the disclosed ULPF technologies.

The traffic flow check helps to maintain a predictable traffic flow on an MP network. For instance, if ULPF 32040 prevents any packet that exceeds the permissible packet length from entering an MP network, components on the MP network can then operate under the assumption that the packet length of a packet, which they encounter on the network, will fall within an anticipated range. As a result, the packet processing that takes place in these components is simplified, which also permits simplified designs and/or implementations of the components.

As shown in FIG. 41, one embodiment of ULPF 32040 performs two traffic flow checks. Specifically, ULPF 32040 obtains packet length of the packet from LEN field 5030 as shown in FIG. 5 and determines whether the packet length exceeds the permissible packet length in block 41010. If the length of packet is less than the permissible packet length, ULPF 32040 continues to the next check. Otherwise, ULPF 32040 discards the packet.

In block 41020, ULPF 32040 separately calculates the number of packets that enter each port of MX 1180 (e.g., port 1170 and 1175) during a certain time period. In one implementation, server group 10010 (FIG. 10) or call processing server system 12010 (FIG. 12) establishes this time period for ULPF 32040 through either an MP control packet or an MP data packet with in-band signaling. Similarly, server group 10010 or call processing server system 12010 also establishes a permissible packet arrival rate per port for ULPF 32040, which specifies a maximum number of packets that each port of MX 1180 should receive within the time period discussed above. If ULPF 32040 finds that its calculated number of packets is less than the maximum number (i.e., the packet arrival rate at MX 1180 is within the permissible packet arrival rate), then ULPF 32040 proceeds to block 40030 as shown in FIG. 40. Otherwise, ULPF 32040 discards the packet.

In block 40030 of FIG. 40, ULPF 32040 performs data content verification. Using one implementation discussed above as an illustration, suppose a content provider packetizes its copyrighted data into MP data packets and sets one or more bits in payload field 5050 (FIG. 5) of these packets to indicate the provider's ownership of copyright to the data. In addition, assume the bit sequence and/or the placement of these special bit(s) is kept confidential by the copyright owner and is not known by other users. To prevent a UT from illegally distributing these copyrighted data into an MP network, one embodiment of ULPF 32040 searches for these specific bit(s) that are indicative of copyright ownership in payload field 5050 of the packet to identify questionable data packets. (Alternatively, this intellectual property ownership information can be part of an MP packet header.) ULPF 32040 will reject data packets from a UT (other than UTs that the content provider uses) that have these bit(s) set.

If an MP packet is able to pass these four checks, ULPF 32040 then relays the packet to interface F 32000 (FIG. 32). It should be emphasized that FIG. 40 is one of many possible implementations of the aforementioned ULPF checks. It will be apparent to one of ordinary skill to configure ULPF 32040 with other entry criteria and perform checks other than the four shown in FIG. 40 without exceeding the scope of the disclosed ULPF technologies. In addition, an alternative embodiment of ULPF 32040 can also perform the four checks in a different sequence than the illustrated sequence. Moreover, one embodiment of ULPF 32040 is capable of performing the checks before the setup phase of the ULPF is completed. More specifically, this embodiment of ULPF 32040 stores default entry criteria and special rules in its local memory subsystem. The special rules allow particular types of packets, such as certain MP control packets, to bypass some or all of the four checks and reach interface F 32000.

5.2.2.4.3 ULPF Clear-Up

At the conclusion of the requested service, server group 10010 (FIG. 10) or call processing server system 12010 (FIG. 12) in one implementation sends an MP control packet to switching core 32010 of MX 1180 (FIG. 32) to initiate ULPF clear-up.

In response to the control packet, switching core 32010 directs ULPF 32040 to delete destination addresses that are involved in the requested service from its DA search table 39000 and also reset other parameters of the entry criteria, such as, without limitation, the traffic flow information, back to their default values.

The disclosed ULPF technologies can strengthen the integrity and the security of an MP network and also help maintain predictability in the performance of the network. Although the above discussions use numerous details to illustrate the ULPF technologies, it will be apparent to one of ordinary skill in the art that the scope of the ULPF technologies is not limited by these details. Also, although the preceding discusses ULPFs in MXs, it will be apparent to one of ordinary skill in the art to use ULPFs in other switches in an MP network (e.g., an EX) without exceeding the scope of the disclosed ULPF technologies.

5.3 Home Gateway (“HGW”)

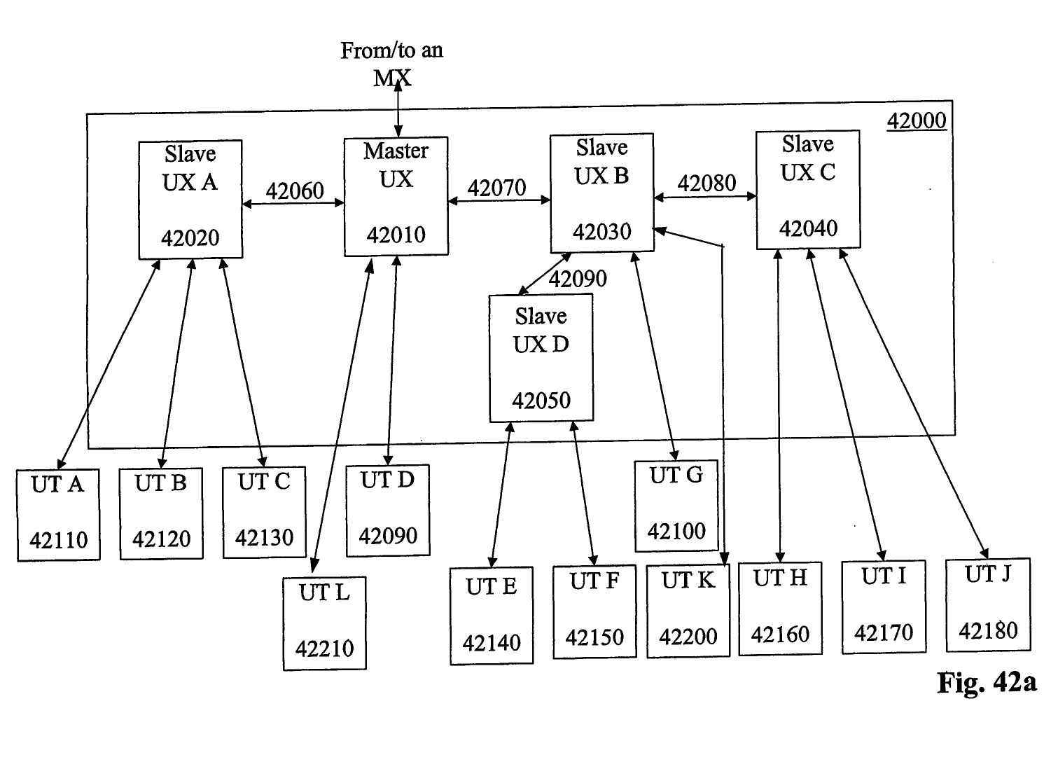

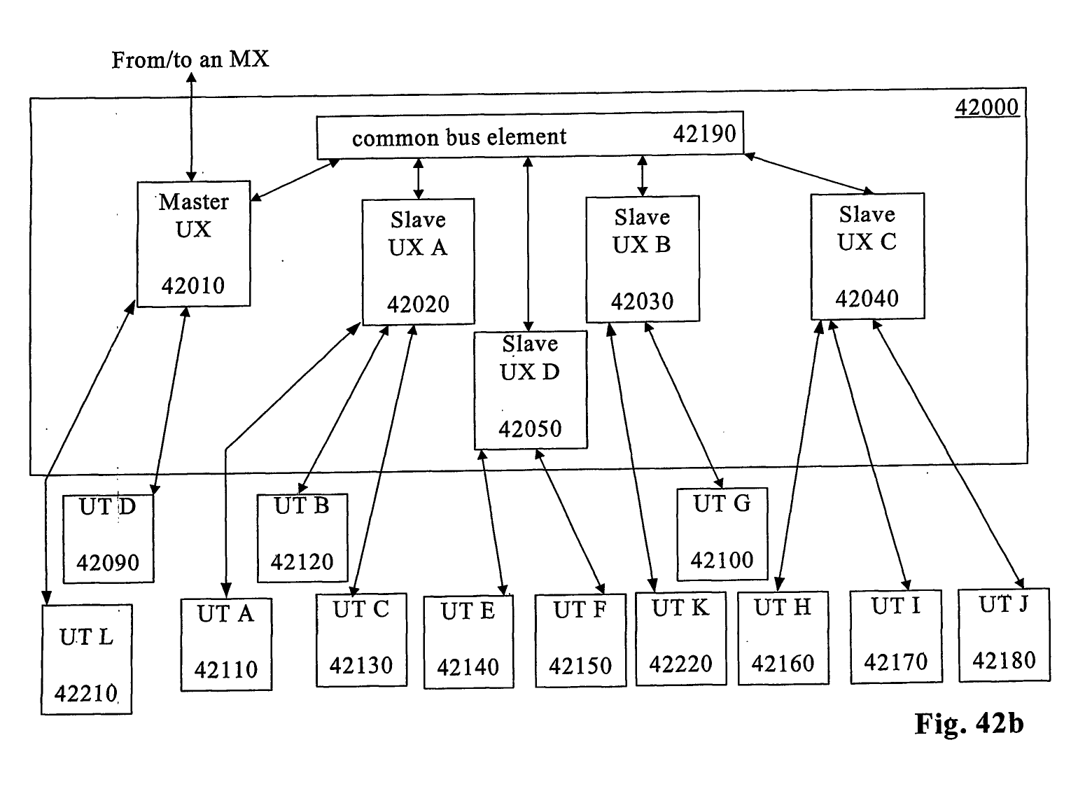

An HGW provides distinct types of UTs access to an MP network. FIG. 42a illustrates a block diagram of one configuration of an HGW, HGW 42000, which includes one master UX 42010 and a number of slave UXs, such as UXs 42020, 42030, 42040 and 42050. These UXs connect to one another via links 42060, 42070, 42080 and 42090. FIG. 42b illustrates a block diagram of an alternative configuration of HGW 42000, where master UX 42010 and slave UXs 42020, 42030, 42040 and 42050 connect to one another via common bus 42190. Additionally, each of the UXs is capable of supporting a certain number of UTs. One embodiment of master UX 42010 is responsible for limiting the total number of slave UXs and UTs that HGW 42000 supports (e.g., based on the total bandwidth usage of the HGW).

5.3.1 User Switch

5.3.1.1 Master User Switch

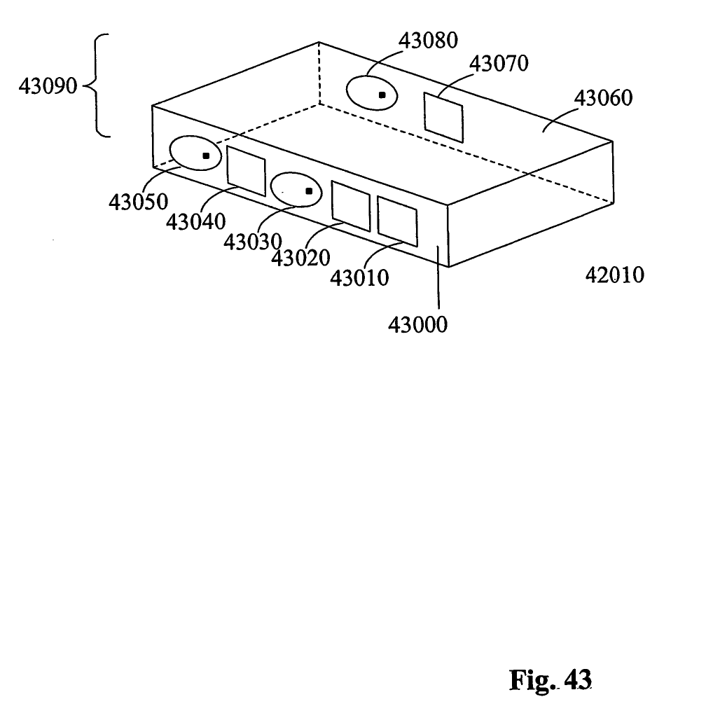

FIG. 43 illustrates one structural embodiment of a master UX, such as master UX 42010. Specifically, master UX 42010 includes rectangular housing member 43090 with a number of connectors on its side 43000 and side 43060. Connectors on side 43000, such as connectors 43010, 43020, 43030, 43040 and 43050, connect UTs and slave UXs to master UX 42010. Either connector 43070 or 43080 on side 43060 connects an MX to master UX 42010. Some examples of these connectors include, without limitation, connectors to twisted pair cables, coaxial cables and fiber optic cables. The connectors operate like power sockets and help accomplish plug-and-play ease of use in an MP network. In other words, just as electronic appliances obtain power by plugging into power sockets, UTs or other MP-compliant components gain access to the MP network by “plugging” into these connectors. This plug-in-and-gain-access procedure does not require manual configuration or rebooting of the UTs or other MP-compliant components.

It will be apparent to a person of ordinary skill in the art to implement master UX 42010 without being limited to the structural embodiment shown in FIG. 43. For example, a person of ordinary skill can design and build master UX 42010 with a differently shaped housing member. A person of ordinary skill can also include a different number of connectors and/or rearrange the placements of the connectors on the housing member.

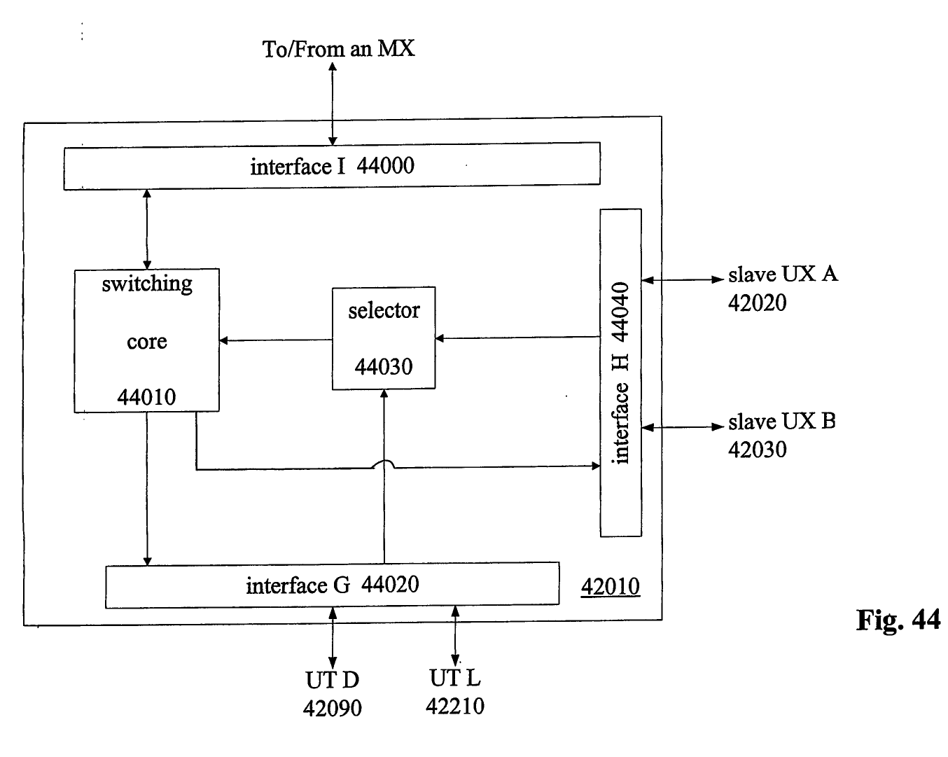

FIG. 44 illustrates a block diagram of an exemplary embodiment of master UX 42010. Master UX 42010 includes a switching core, a selector, and interfaces. Specifically, master UX 42010 includes three types of interfaces: interface G 44020 to allow communication with UT D 42090 and UT L 42210, interface H 44040 to allow communication with slave UX A 42020 and slave UX B 42030 and interface 144000 to allow communication with an MX. These three interfaces convert one type of signal to another. For instance, interface 144000 in one embodiment of master UX 42010 converts between fiber optic signals and electric signals. In this example, if master UX 42010 communicates with the slave UXs through the same physical transmission medium, interface H 44040 does not perform signal conversion.

5.3.1.2 Slave User Switch

Because a slave UX does not communicate with an MX directly, one structural embodiment of a slave UX is the same as the illustrated embodiment in FIG. 43 but without the connectors on side 43060.

Furthermore, similar to a master UX, a slave UX also includes a switching core, a selector, and interfaces. The switching core of the slave UX supports a subset of functions that switching core 44010 of master UX 42010 supports, and the selector of the slave UX supports the same set of functions as selector 44030. However, unlike a master UX, a slave UX does not have an interface to communicate directly with an MX and does not have an assigned network address from a server group. (Note, the “UX subfield” in the partial address subfields is actually a “master UX subfield.” However, for simplicity, this subfield is just called the UX subfield.) For clarity, the subsequent discussions mainly focus on master UX 42010. However, unless otherwise indicated, the discussions also apply to a slave UX, such as slave UX A 42020, slave UX B 42030, slave UX C 42040 or slave UX D 42050.

5.3.1.3 Selector

One embodiment of a selector, such as selector 44030 in FIG. 44 passes on packets that travel on selected physical links to switching core 44010. Specifically, selector 44030 selects physical link(s) that have an active signal using well-known methods (e.g., round-robin and first-in-first-out) and directs packets on the selected physical link(s) to switching core 44010. These packets may come from directly connected UTs, such as UT D 42090 and UT L 42210, and/or directly connected UXs, such as slave UX A 42020 and slave UX B 42030 It will be apparent to a person of ordinary skill in the art to incorporate the functionality of the selector into the interfaces (e.g., make selector 44030 part of interface G 44020 and interface H 44040) without exceeding the scope of the disclosed UX technologies.

5.3.1.4 Switching Core

One embodiment of master UX 42010 employs a switching core, such as switching core 44010, to deliver packets to UTs and other (slave) UXs. In particular, in response to packets from an MX, one embodiment of switching core 44010 either “conditionally broadcasts” the packets to the slave UXs or delivers the packets to the UTs via interface G 44020 based on color information, partial address information or a combination of these two types of information. On the other hand, in response to packets from UT D 42090 and UT L 42210, one embodiment of switching core 44010 either relays the packets to another (slave) UX or an MX, depending on whether or not the destination of the packets is a UT that HGW 42000 supports.

The “conditional broadcasting” mentioned above refers to packet delivery by master UX 42010 to multiple slave UXs, such as slave UX A 42020 and slave UX B 42030 as shown in FIGS. 42a or slave UX A 42020, slave UX B 42030, slave UX C 42040 and slave UX D 42050 as shown in FIG. 42b, if switching core 44010 detects certain conditions. For example, for the configuration shown in FIG. 42a, if one embodiment of switching core 44010 determines that a packet that it receives is not for master UX 42010 to forward to its directly connected UTs (e.g., UT D 42090 and UT L 42210) but is for a UT that HGW 42000 supports, switching core 44010 then makes a copy of the received packet and delivers the received packet and the duplicated packet to slave UX A 42020 and slave UX B 42030, respectively.

On the other hand, for the configuration shown in FIG. 42b, if switching core 44010 receives a packet from an MX and recognizes that the received packet is not for master UX 42010 to forward to its directly connected UTs (e.g., UT D 42090 and UT L 42210), switching core 44010 places the received packet on common bus element 42190. If switching core 44010 receives a packet from a UT directly connected to master UX 42010 (e.g., UT D 42090) and recognizes that the received packet is not destined for another directly connected UT (e.g., UT L 42210) but is for a UT that HGW 42000 supports, switching core 44010 also places the received packet on common bus element 42190. If switching core 44010 receives a packet from common bus element 42190 and recognizes that the received packet is not for master UX 42010 to forward to its directly connected UTs (e.g., UT D 42090 and UT L 42210) but is for a UT that HWG 42000 supports, switching core 44010 leaves the received packet on common bus element 42190.

One embodiment of master UX 42010 in HGW 42000 includes a local memory subsystem, which contains a list of the partial network addresses of all the UTs that HGW 42000 supports, and a local processing engine (which can be part of the switching core of the UX) that performs the tasks in block 45000 and the task of verifying whether an MP packet is for a UT that HGW 42000 supports. An alternative embodiment of a UX relies on UT(s) that it directly manages to provide for storage and/or processing of this UT list. In other words, switching core 44010 of master UX 42010 can either retrieve the list from UT D 42090 and perform the aforementioned tasks or request UT D 42090 to perform the aforementioned tasks on its behalf.

If master UX 42010 determines that the received packet is neither for any of the UTs that it directly manages nor any of the UTs that HGW 42000 supports, master UX 42010 sends the received packet to an MX.

A switching core in a slave UX operates in a similar fashion as switching core 44010, except that it neither directly receives packets from an MX nor does it directly deliver packets to an MX. Using slave UX B 42030 in FIG. 42a as an illustration, if its switching core determines that a packet from slave UX C 42040 is not for slave UX B 42030 to forward to its directly connected UTs (e.g., UT G 42100 and UT K 42200), the switching core broadcasts the packet to slave UX D 42050 and master UX 42010. To avoid loops, a UX does not broadcast the packet to the previous sender of the packet (e.g., slave UX C 42040). On the other hand, if the switching core of slave UX B 42030 receives a packet from UT G 42100, the switching core may 1) forward the packet to an MX through master UX 42010; 2) forward the packet to another UX (e.g., slave UX D 42050); or 3) deliver the packet to another UT that is directly connected to slave UX B 42030 (e.g., UT K 42200).

For the configuration shown in FIG. 42b, if the switching core of slave UX B 42030 receives a packet from UT G 42100, the switching core may either place the received packet on common bus element 42190 or deliver the packet to another UT that is directly connected to slave UX B 42030 (e.g., UT K 42200).

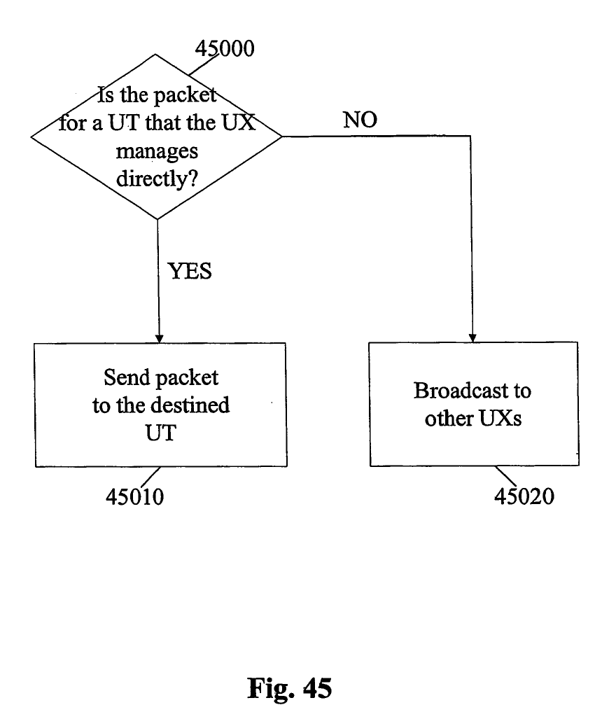

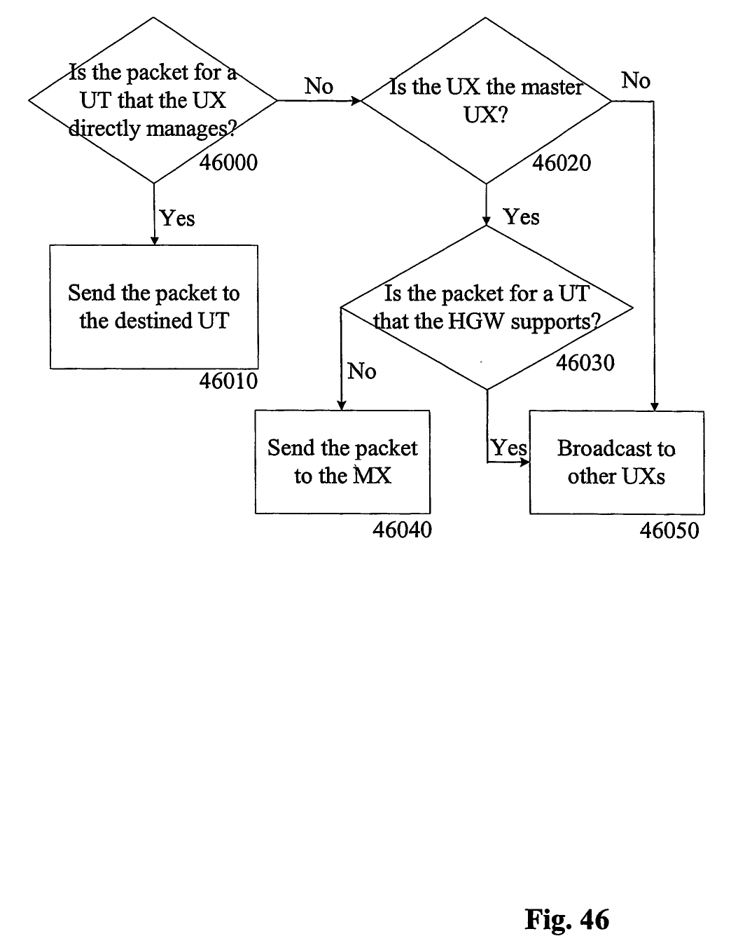

FIG. 45 illustrates a flow chart of one process that one embodiment of switching core 44010 follows in response to “downstreaming” packets (e.g., packets from interface I 44000 or from interface H 44040), whereas FIG. 46 illustrates a flow chart in response to “upstreaming” packets (e.g., packets from interface G 44020). However, if packets from interface H 44040 are destined for UTs that are governed by another HGW, they are considered to be “upstreaming packets”.

One embodiment of master UX 42010 physically separates upstreaming traffic and downstreaming traffic so that its switching core 44010 can easily differentiate between a downstreaming packet and an upstreaming packet. In particular, master UX 42010 reserves some of its ports to receive upstreaming packets. As a result, when switching core 44010 receives a packet from one of the designated upstreaming ports, it recognizes that the packet is an upstreaming packet. Otherwise, switching core 44010 recognizes that the packet is a downstreaming packet. It will be apparent to a person of ordinary skill in the art to apply other traffic-direction-differentiation approaches without exceeding the scope of the disclosed switching core technologies.

The following examples use UT D 42090, UT G 42100, UT 142170 and UT 1450 as shown in either FIG. 42a or FIG. 42b and FIG. 1d to further explain the illustrated flow charts in FIGS. 45 and 46. For clarity, the examples assume certain implementation details. However, it will be apparent to a person of ordinary skill in the art that switching core 44010 is not limited to these details. The details include:
The assigned network addresses of the aforementioned UTs follow network address format 9000 (FIG. 9a).
HGW 42000 corresponds to HGW 1200 in FIG. 1d, except that the illustrated
HGW 42000 supports more UTs than the illustrated HGW 1200.
Master UX 42010 connects to an MX, such as MX 1180. Slave UX B 42030 and slave UX C 42040 communicate with MX 1180 through master UX 42010. Therefore, UT D 42090, UT G 42100 and UT 142170 share the same partial addresses in nation subfield 9040, city subfield 9050, community subfield 9060, OX subfield 9070, and UX subfield 9080 as shown in FIG. 9a. In other words, suppose UT D 42090 includes the following information in its assigned network address:
   Nation subfield 9040: 1
   City subfield 9050: 23
   Community subfield 9060: 100
   OX subfield 9070: 11
   UX subfield 9080: 1
   UT subfield 9090: 15
Then, the assigned network addresses of UT G 42100 and UT 142170 would contain the same information as UT D 42090, except for the partial address in UT subfield 9090.
In addition, because UT 1450 as shown in FIG. 1d connects to a different HGW and a different MX than the aforementioned UTs of HGW 1200, UT 1450 contains different information in OX subfield 9070 and possibly in UX subfield 9080 and UT subfield 9090.
A portion of the assigned network address of UT 1450 is 1/23/100/12/6/9 (nation subfield 9040/city subfield 9050/community subfield 9060/OX subfield 9070/UX subfield 9080/UT subfield 9090).
A portion of the assigned network address of UT A 42110 is 1/23/100/11/1/6.
A portion of the assigned network address of UT B 42120 is 1/23/100/11/1/2.
A portion of the assigned network address of UT C 42130 is 1/23/100/11/1/3.
A portion of the assigned network address of UT G 42100 is 1/23/100/11/1/8.
A portion of the assigned network address of UT 142170 is 1/23/100/11/1/5.
A portion of the assigned network address of UT L 42210 is 1/23/100/1/1/7.
A portion of the assigned network address of UT K 42200 is 1/23/100/11/1/9.
A portion of the assigned network address of master UX 42010 is 1/23/100/11/1.

When switching core 44010 receives a packet from MX 1180 via interface I 44000 (“packet_from_MX”), it performs a bit-wise partial-address comparison in block 45000. Specifically, suppose DA field 5010 (FIG. 5) of packet_from_MX contains the assigned network address of UT D 42090. Switching core 44010 compares the UT subfield 9090 of the DA of packet_from_MX to the UT subfield 9090 of the assigned network address of UT D 42090. Because the UT subfields match in this example, switching core 44010 proceeds to block 45010 to transmit packet_from_MX to UT D 42090 using the partial address in UT subfield 9090, which is “15”.

However, if packet_from_MX contains the assigned network address of UT G 42100, the partial address comparison in block 45000 would indicate a mismatch and switching core 44010 proceeds to broadcast the packet to other UXs in block 45020. More particularly, UT subfields 9090 of the assigned network addresses of UT D 42100 and UT L 42210 are “15” and “7”, respectively. Because the content in UT subfield 9090 of the DA of packet_from_MX is “8”, switching core 44010 recognizes that the packet is not for any of the UTs that master UX 42010 directly manages (i.e., UT D 42090 and UT L 42210 here), and broadcasts the packet to other slave UXs in HGW 42000 in block 45020.

In a configuration such as that shown in FIG. 42a, switching core 44010 broadcasts packet_from_MX by directing the packet and a duplicate of the packet to the slave UXs that are directly connected to master UX 42010 (i.e., slave UX A 42020 and slave UX B 42030 here). When slave UX A 42020 receives packet_from_MX, its switching core follows the process shown in FIG. 45, where its partial address comparison of the UT subfields in block 45000 would indicate a mismatch, because the DA of packet_from_MX is for UT G 42100 and not for any of the UTs that slave UX A 42020 directly manages (i.e., UT A 42110, UT B 42120 and UT C 42130 here). As noted above, because in one embodiment of HGW 42000, a UX does not broadcast the packet to the previous sender of the packet, slave UX A 42020 does not send packet_from_MX back to master UX 42010.

As for slave UX B 42030, its switching core would find a match in block 45000, because the DA of packet from_MX is for one of the UTs that slave UX B 42030 directly manages, UT G 42100. Then the switching core of slave UX B 42030 sends packet_from_MX to UT G 42100 according to the partial address of “8” in UT subfield 9090 in block 45010.

If HGW 42000 adopts a configuration such as that shown in FIG. 42b, instead of duplicating packet_from_MX, switching core 44010 places the packet on common bus element 42190. Switching core 44010 and switching cores of slave UXs examine packets from common bus element 42190. The switching core that directly manages the UT with a UT subfield that matches the UT partial address subfield of the packet forwards the packet to the destination UT and removes the packet from common bus element 42190.

One embodiment of a UX in HGW 42000 includes a local memory subsystem, which contains a list of the partial network addresses of the UTs that the UX supports, and a local processing engine (which can be part of the switching core of the UX) that performs the tasks in block 45000. An alternative embodiment of a UX relies on UT(s) that it directly manages to provide for storage and/or processing of this UT list. In other words, the switching core of slave UX B 42030 can either retrieve the list from UT G 42100 and perform the tasks in block 45000 or request UT G 42100 to perform the tasks in block 45000 on its behalf.

Because packet_from_MX is a downstreaming packet, if none of the UXs in HGW 42000 is able to deliver the packet to a UT (because the discussed UT subfield 9090 comparisons fail for every UX in HGW 42000), master UX 42010 may instruct the last UX in HGW 42000 that performs the tasks in block 45000 to discard the packet. Alternatively, master UX 42010 may send an error notification up to the governing SGW.

When any of the UXs in HGW 42000 receives a packet from a UT (“packet_from_UT”), the UX determines whether packet_from_UT is for a UT that the UX directly manages in block 46000 (FIG. 46). For example, if slave UX C 42040 receives packet_from_UT from UT J 42180, slave UX C 42040 checks whether the packet is for either UT H 42160 or UT 142170. Slave UX C 42040 then either delivers packet_from_UT to one of slave UX C's directly connected UTs in block 46010 or verifies whether the receiving UX is the master UX of HGW 42000 in block 46020. As in this case, because the receiving UX (slave UX C 42040 here) is not the master UX of HGW 42000, slave UX C 42040 broadcasts the packet to the other UXs (e.g., via slave UX B 42030 in the configuration of FIG. 42a or via common bus element 42190 in the configuration of FIG. 42b). However, if the receiving UX is master UX 42010, master UX 42010 checks whether packet_from_UT is for any of the UTs that HGW 42000 supports in block 46030. As noted above, master UX 42010 maintains a list of the UTs that HGW 42000 supports. If the check fails to identify a UT to receive packet_from_UT, master UX 42010 in block 46040 sends the packet to the MX that has a direct connection to HGW 42000. The MX, in turn, sends the packet to the SGW governing the source UT (UT J 42180 in this example). Thus, if HGW 42000 corresponds to HGW 1200 (FIG. 1d, master UX 42010 forwards packet_from_UT to MX 1180, which sends the packet to SGW 1160. On the other hand, if the check indicates that packet_from_UT is for a UT that HGW 42000 supports, master UX 42010 broadcasts the packet to the other UXs that are not the previous senders of the packet to master UX 42010 in block 46050.

In addition to the aforementioned packet delivery functionality, one embodiment of switching core 44010 of master UX 42010 also establishes a maximum bandwidth for HGW 42000. Specifically, even though HGW 42000 can contain any number of slave UXs in this embodiment, if switching core 44010 determines that the total requested bandwidth of the UTs, which are connected to the UXs, exceeds the established maximum bandwidth, switching core 44010 invokes certain protective measures to ensure the continued and proper operation of HGW 42000. Some examples of the protective measures include, without limitation, preventing additional UTs from connecting to HGW 42000, where these additional connections delay packet distribution from the UXs to the UTs.

It will be apparent to a person of ordinary skill in the art to combine or divide the illustrated blocks of a UX in FIG. 44 without exceeding the scope of the disclosed HGW technologies. For example, switching core 44010 can be divided into a general processing engine, which manages resources of HGW 42000 (e.g., maintaining traffic flow in HGW 42000 within the discussed maximum bandwidth), and a packet forwarding engine, which forwards packets towards appropriate destinations (e.g., comparing partial addresses and forwarding packets based on partial addresses). A person of ordinary skill can also distribute the functionality of master UX 42010 discussed above to other UXs in HGW 42000.

5.3.2 User Terminal (“UT”)

An HGW, such as HGW 42000 as shown in FIGS. 42a and 42b, is capable of supporting distinct types of UTs. Some exemplary UTs include, without limitation, a personal computer (“PC”), a telephone, an intelligent home appliance (“IHA”), an interactive game box (“IGB”), a set-top box (“STB”), a teleputer, a home server system, media storage, or any other device used by an end user to send or receive multimedia data over a network.

A PC and a telephone are well-known in the art. An IHA generally refers to an appliance that has decision making capabilities. For instance, a smart-air-conditioner is an IHA that automatically adjusts its cold air output according to changes in room temperature. Another example is a smart meter reading system that automatically reads a water meter at a certain time each month and sends the meter information to the water supplier. An IGB generally refers to a game console that operates online games, such as StarCraft Battle Chest (a game produced by Blizzard Entertainment Company), and allows its user to interact (e.g., play) with other users on a network. A home server system can manage other UTs in HGW 42000 or provide intranet services among the UTs in HGW 42000. For example, if UT D 42090 is a home server system, UT D 42090 may provide a user of UT C 42130 with a program menu to allow the user to access shared resources, such as a database, in UT E 42140.

A teleputer generally refers to a single apparatus that can process both MP packets and non-MP packets, such as IP packets. An MP-STB combines voice, data, and video (either static or streaming) information for its user(s) and provides its user(s) access to both the MP network and non-MP networks, such as the Internet. Media storage can store a large amount of video, audio, and multimedia programs. It can be implemented with, without limitation, disk drives, flash memories, and SDRAMs. Subsequent Teleputer, MP-STB, and Media Storage sections will further describe these three types of UTs.

It should be noted that these distinct types of UTs that an MP network supports have different bandwidth requirements. For example, an IHA may be a low-speed device that utilizes a bandwidth of several kilobits (“KB”) per second. On the other hand, an IGB, an MP-STB, a teleputer, a home server system, and media storage may be high speed devices that utilize bandwidths in the range of several million bits to hundreds of millions of bits per second.

5.3.2.1 Teleputer

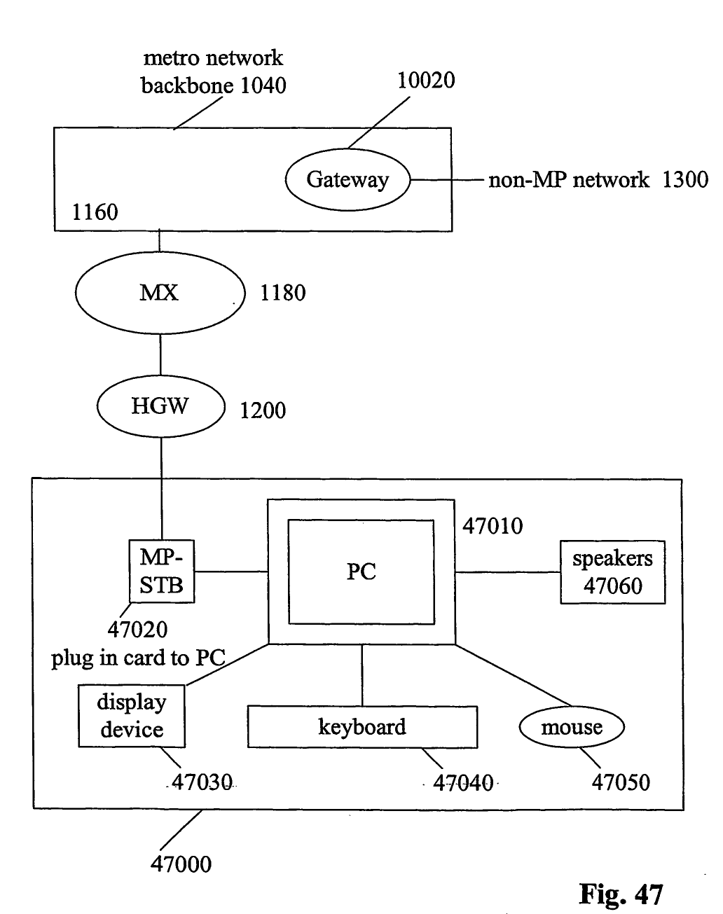

A teleputer is capable of running both MP and IP. FIG. 47 illustrates a block diagram of one embodiment of a general purpose teleputer, teleputer 47000. Teleputer 47000 also corresponds to UT 1400 in FIG. 1d.

Specifically, teleputer 47000 includes MP-STB 47020 and PC 47010. PC 47010 contains conventional output devices such as, without limitation, display device 47030 and speakers 47060, and conventional input devices such as, without limitation, keyboard 47040 and mouse 47050. One embodiment of MP-STB 47020 is a plug-in card that plugs into PC 47010 and processes packets that it receives from HGW 1200. If the received packet is an MP packet, MP-STB 47020 processes the packet and sends the results to PC 47010 for output. Otherwise, MP-STB 47020 prepares (e.g., decapsulates) the received MP-encapsulated packet for PC 47010 to process. In addition, a user of teleputer 47000 can operate keyboard 47040, mouse 47050, or other input devices not shown in FIG. 47 to cause transmission of MP packets or MP-encapsulated non-MP packets, such as MP-encapsulated IP packets, from teleputer 47000 to metro MP network 1000.

More particularly, one embodiment of teleputer 47000 transmits and receives MP packets or MP-encapsulated packets that conform to the format of MP packet 5000 as shown in FIG. 5. When teleputer 47000 receives a packet from HGW 1200 (“packet_for_teleputer”), DA field 5010 of the packet contains the assigned network address of teleputer 47000. For illustration purposes, this assigned network address follows the format of network address 9000 (FIG. 9a). Upon receipt of packet_for_teleputer, MP-STB 47020 examines MP subfield 9030 of the network address in DA field 5010 of the packet to determine whether the packet is an MP packet or contains a non-MP packet in its payload field 5050. For an MP packet, MP-STB 47020 processes the packet and sends the processed results to PC 47010 for output. For an MP-encapsulated packet, MP-STB 47020 retrieves (and reassembles if necessary) the non-MP packet, such as an IP packet, from payload field 5050 of packet_for_teleputer and sends the retrieved non-MP packet to PC 47010 for processing.

Furthermore, one embodiment of PC 47010 supports both MP applications and non-MP applications. For instance, an MP application can be a software program, which is stored on PC 47010, that allows a user of teleputer 47000 to request an MTPS session. The subsequent Media Telephony Service section will further elaborate on the operation details of an MTPS session. A non-MP application can be an Internet browser, which allows a user of teleputer 47000 to request web pages from a web server on non-MP network 1300. Therefore, if the user invokes an MTPS session, PC 47010 generates and sends MP packets to MP-SIB 47020, which passes the packets to HGW 1200. If the user instead invokes an Internet browser, PC 47010 generates and sends IP packets to MP-STB 47020, which encapsulates the IP packets in payload fields 5050 of MP-encapsulated packets and sends these MP-encapsulated packets to gateway 10020. As has been discussed in the Gateway section above, one embodiment of gateway 10020 decapsulates the MP-encapsulated packets from teleputer 47000 and sends the resulting non-MP packets, such as IP packets, to non-MP network 1300, such as the Internet.

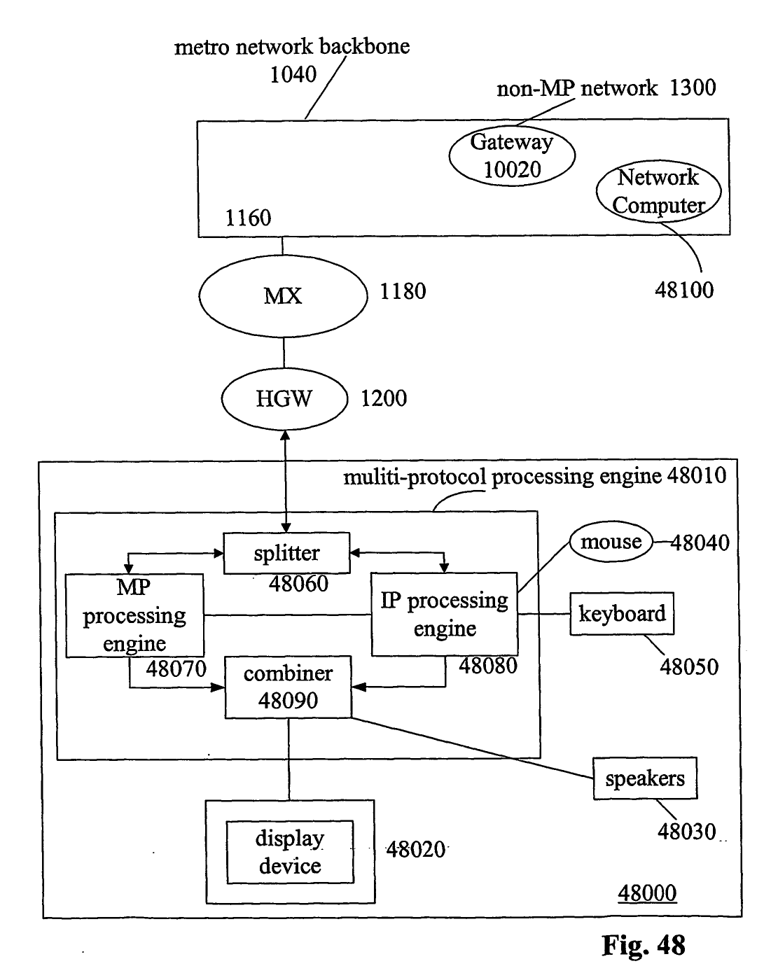

FIG. 48 illustrates a block diagram of one embodiment of a special purpose teleputer, teleputer 48000. Teleputer 48000 does not include a PC but instead includes customized multi-protocol processing engine 48010, conventional output devices such as, without limitation, display device 48020 and speakers 48030, and conventional input devices such as, without limitation, mouse 48040 and keyboard 48050. One embodiment of multi-protocol processing engine 48010 further contains splitter 48060, MP processing engine 48070, IP processing engine 48080 and combiner 48090.

In response to packet_for_teleputer, splitter 48060 is mainly responsible for relaying appropriate packets to MP processing engine 48070 and IP processing engine 48010. Analogous to the above discussion on teleputer 47000, one embodiment of splitter 48060 determines whether packet_for_teleputer is an MP packet or contains a non-MP packet in its payload field 5050 by inspecting particular bit subfield(s) of the network address in DA field 5010 of the packet. If the network address follows the format of network address 9000 (FIG. 9a), splitter 48060 inspects MP subfield 9030. For an MP packet, splitter 48060 relays the packet to MP processing engine 48070. For an MP-encapsulated packet, splitter 48060 retrieves (and reassembles if necessary) the non-MP packet, such as an IP packet, from payload field 5050 of packet_for_teleputer and sends the retrieved IP packet to IP processing engine 48080 for processing.

One embodiment of MP processing engine 48070 is responsible for retrieving data from payload field 5050 of an MP packet and sending the retrieved data to combiner 48090. Similarly, one embodiment of IP processing engine 48080 is responsible for retrieving data from the IP packet and also sending the retrieved data to combiner 48090. One embodiment of combiner 48090 then arranges the data from MP processing engine 48070 and IP processing engine 48080 into data formats that can be used by output devices of teleputer 48000, such as display device 48020 and speakers 48030. Display device 48080 and/or speakers 48030 then playback these arranged data.

One embodiment of multi-protocol processing engine 48010 is a standalone system, which contains the functionality of the discussed splitter 48060, MP processing engine 48070, IP processing engine 48080 and combiner 48090. This standalone multi-protocol processing engine 48010 also has common input and output ports and interfaces for input and output devices. Furthermore, one embodiment of IP processing engine 48080 is a diskless processing system with a limited amount of memory. This IP processing engine 48080 relies on network computer 48100, which may be one of the server systems in server group 10010 (FIG. 10), to perform the functions of IP processing engine 48080. In some instances, network computer 48100 can dictate processing tasks for IP processing engine 48080 by loading the memory of the engine with instructions to execute special purpose application software.

In the illustrated embodiment of multi-protocol processing engine 48010 in FIG. 48, IP processing engine 48080 is also responsible for handling input requests from a user of teleputer 48000. Thus, if the user requests an MP-supported service (e.g., an MTPS session) via an IP browser (e.g., Microsoft® Internet Explorer), IP processing engine 48080 communicates the request to MP processing engine 48070 using well-known mechanisms (e.g., inter-process messages and control signals), which then responds to the request by generating and sending MP packets to splitter 48060. Splitter 48060 then passes along the packets to HGW 1200. On the other hand, if the user requests access to the Internet, IP processing engine 48080 generates and sends IP packets to splitter 48060, which encapsulates the IP packets in payload fields 5050 of MP-encapsulated packets and sends these MP-encapsulated packets to gateway 10020. As has been discussed in the Gateway section above, one embodiment of gateway 10020 decapsulates the MP-encapsulated packets from teleputer 48000 and sends the resulting non-MP packets, such as IP packets, to non-MP network 1300, such as the Internet.

It will be apparent to one of ordinary skill in the art to practice the disclosed teleputer technologies without being limited to the implementation details of the embodiments discussed above. For instance, multi-protocol processing engine 48010 as shown in FIG. 48 can include processing engines that handle protocols other than MP and IP.

5.3.2.2 MP Set-top Box (“MP-STB”)

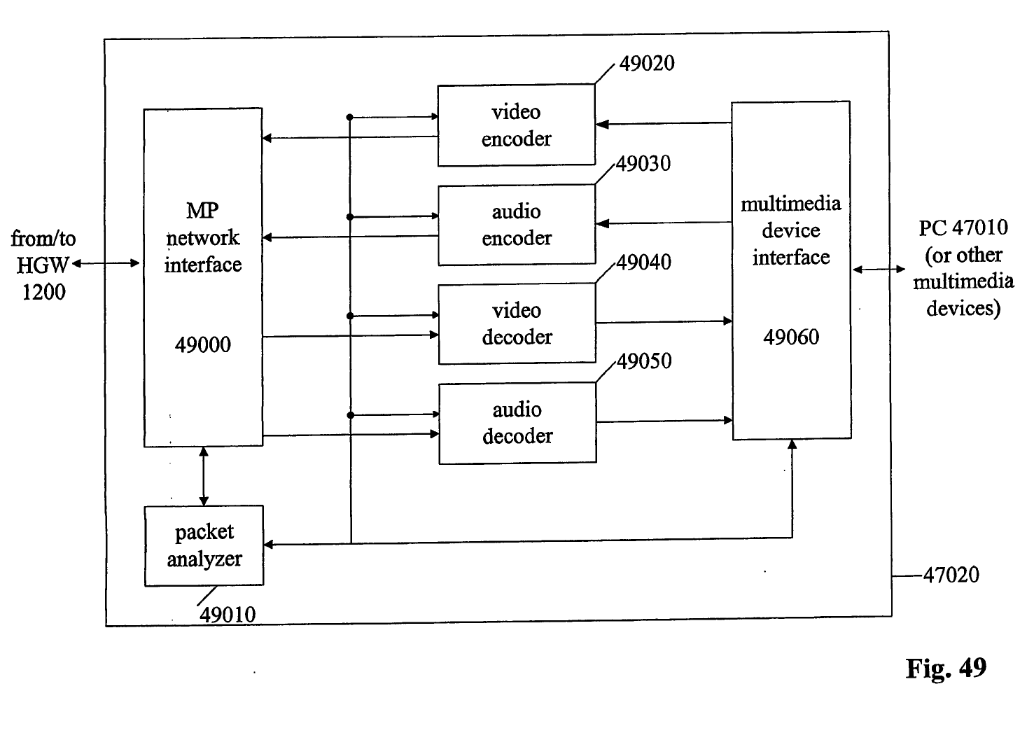

FIG. 49 illustrates a block diagram of one embodiment of MP-STB 47020, as shown in FIG. 47. An MP-STB is capable of processing downstreaming traffic from an HGW, such as HGW 1200, to output devices, such as display device 47030 and speakers 47060 and upstreaming traffic from multimedia devices, such as PC 47010, to HGW 1200 simultaneously.

An exemplary embodiment of MP-STB 47020 contains MP network interface 49000, packet analyzer 49010, video encoder 49020, video decoder 49040, audio encoder 49030, audio decoder 49050 and multimedia device interface 49060. In particular, MP network interface 49000 serves as a signal converter between two types of signals such as, without limitation, between fiber optic signals and electric signals. Although multimedia device interface 49060 can similarly serve as a signal converter, it frequently converts between one form of an electric signal to another form of the same signal. For example, in FIG. 47, if MP-STB 47020 does not hook up to PC 47010 but instead connects to an analog television, multimedia device interface 49060 then converts electric signals in digital format from MP-STB 47020 to electric signals in analog format for the television, and vice versa

One embodiment of packet analyzer 49010 is responsible for analyzing packets that come from the interfaces of MP-STB 47020. In one implementation, these packets follow the format of MP packet 5000 as shown in FIG. 5. For illustration purposes, the assigned network address of teleputer 47000 (FIG. 47) follows the format of network address 9000 (FIG. 9a). One embodiment of packet analyzer 49010 inspects MP subfield 9030 of the network address in DA field 5010 of a packet that MP-STB 47020 receives to determine whether the packet is an MP packet or is an MP-encapsulated packet that contains a non-MP packet in its payload field 5050. PC 47010 may use the analyses of packet analyzer 49010 to process the packets from MP-STB 47020. For example, PC 47010 may include a processing module that specifically handles MP packets and a separate processing module that handles MP-encapsulated packets.

Moreover, packet analyzer 49010 also inspects data type subfield 9020 to determine the data type of the packets that come through MP network interface 49000 (“packet_from_MP_network_interface”) and multimedia device interface 49060 (“packet_from_multimedia_device_interface”). If packet analyzer 49010 establishes that data type subfield 9020 indicates packet_from_Mp_network_interface contains video data (e.g., static or streaming video), it invokes video decoder 49040 to process the packet. Similarly, if packet analyzer 49010 establishes that packet_from_multimedia_device_interface contains video data, it invokes video encoder 49020 to process the packet. For audio data, packet analyzer 49010 invokes audio decoder 49050 and audio encoder 49030 in an analogous manner to the invocation of video decoders and video encoders, respectively.

If a packet contains signaling information, packet analyzer 49010 is responsible for responding to the packet for MP-STB 47020. For example, if teleputer 47000 receives a packet that requests state information (e.g., current capacity or availability) from server group 10010 (FIG. 10), packet analyzer 49010 of MP-STB 47020 responds by sending a packet that includes the requested state information back to server group 10010 through MP network interface 49000. Similarly, if teleputer 47000 receives a packet that requests set up of an MTPS session through multimedia device interface 49060, packet analyzer 49010 passes along the setup request towards server group 10010.

A STB can send and/or receive streams of audio and/or video data packets. These data packets can contain audio information, video information, or a combination of audio and video information.

For a STB that sends and receives separate audio data packet streams and video data packet streams, the STB preserves lip synchronization by matching the audio and video data streams. Specifically, for outgoing packets, video encoder 49020 of STB 47020 places “time-stamps” on the packets containing video data and sends these packets towards their destinations asynchronously. Similarly, audio encoder 49030 of STB 47020 places time-stamps on the packets containing audio data and sends these packets towards their destinations asynchronously. For incoming packets, video decoder 49040 and audio decoder 49050 of STB 47020 use time-stamps on the incoming packets to synchronize the received video stream and audio stream.

On the other hand, for an STB that sends and receives packets containing a combination of audio data and video data, the STB has one set of audio encoder and video encoder (instead of two sets as shown in FIG. 49) and one set of audio decoder and video decoder (instead of two sets as shown in FIG. 49). This STB preserves lip synchronization by maintaining the transmission sequence and the arrival sequence of the packets.

5.3.2.3 Media Storage

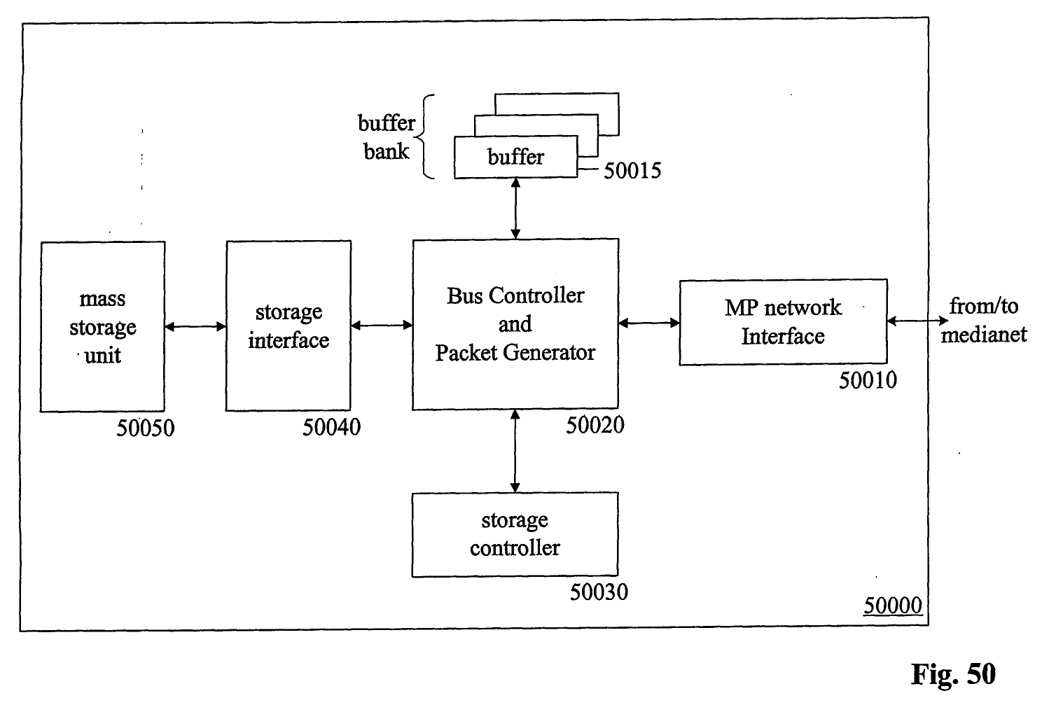

Media storage mainly provides a cost-effective storage solution on an MP network to store media data. FIG. 50 illustrates a block diagram of one embodiment of media storage, media storage 50000. In FIG. 1d, media storage 50000 can correspond to media storage 1140 that resides within SGW 1120, or media storage 50000 can correspond to a UT. Specifically, media storage 50000 includes, without limitation, MP network interface 50010, buffer bank 50015, bus controller and packet generator (“BCPG”) 50020, storage controller 50030, storage interface 50040 and mass storage unit 50050.

MP network interface 50010 serves as a signal converter between two types of signals such as, without limitation, fiber optic signals and electrical signals. Storage interface 50040 serves as a communication channel between BCPG 50020 and mass storage unit 50050. Some examples of storage interface 50040 include, without limitation, SCSI, IDE and ESDI. Storage controller 50030 mainly controls how packets received from MP network interface 50010 are saved to mass storage unit 50050 and how packets are sent from mass storage unit 50050 to destinations on an MP network through MP network interface 50010. BCPG 50020 is responsible for distributing packets that it receives to buffer bank 50015, storage controller 50030 and mass storage unit 50050. BCPG 50020 is also responsible for sending out packets via MP network interface 50010 and for generating packets in response to query packets from server group 10010 (FIG. 10). Mass storage unit 50050 can be, without limitation, a hard disk, flash memory, or SDRAM.

Media storage 50000 maintains a channel for each user that it supports. For example, if media storage 50000 manages traffic flow of 100 megabytes per second (“MB/s”) and if each user that it supports occupies 5 MB/s of traffic flow, then media storage 50000 maintains 20 channels. In other words, media storage 50000 in this scenario is able to process packets from 20 users simultaneously.

In addition, one embodiment of buffer bank 50015 includes two types of buffers, send buffers (“SBs”) and receive buffers (“RBs”). SBs temporarily store outgoing packets (i.e., packets that BCPG 50020 sends to an MP network via MP network interface 50010), and RBs temporarily store incoming packets (i.e., packets that BCPG 50020 receives from an MP network via MP network interface 50010). In one implementation, each channel discussed above corresponds to two SBs (e.g., SBₐ and SB_{b}) and two RBs (e.g., RBₐ and RB_{b}). However, it will be apparent to a person of ordinary skill in the art to associate a different number of SBs and/or RBs with a channel without exceeding the scope of the disclosed media storage technologies.

The network address of media storage 50000 follows the format of network address 9100 (FIG. 9b). Partial address subfield 9170 contains a specific bit pattern (e.g., “0001”) that indicates the network address is for a media storage device directly connected to an EX, and component number subfield 9180 contains a number that identifies media storage 50000. To identify program XYX on media storage 50000, payload field 5050 includes a number that represents program XYZ.

Although the preceding media storage discussions involve specific implementation details, it will be apparent to a person of ordinary skill in the art to implement media storage devices without the details and yet still remain within the scope of the disclosed media storage technologies. For example, media storage may not reside within an SGW and may be a UT. The network address for such a media storage device may follow the format of network address 7000 (FIG. 7). The program that resides in such a media storage device can be addressed by special bit sequence(s) in payload field 5050.

6. Operational Examples

This section discusses details of how some exemplary multimedia services operate on an MP network.

6.1 Media Telephony Service (“MTPS”)

6.1.1 MTPS Between Two UTs That Depend on a Single Service Gateway

MTPS enables one UT to conduct one or more sessions of video and/or audio conferencing with another UT. FIGS. 53a and 53b illustrate time sequence diagrams of one MTPS session between two UTs that depend on a single SGW, such as UT 1380 and UT 1450 (FIG. 1d).

For illustration purposes, UT 1380 requests a call to UT 1450. UT 1380 is thus the “calling party”, and UT 1450 is the “called party”. MX 1180 is the “calling party Mx” and MX 1240 is the “called party MX”. Call processing server system 12010 that resides in server group 10010 of SGW 1160 (FIG. 12) manages packet exchanges between the calling party and the called party. When an SGW dedicates a call processing server system to manage MTPS sessions, the dedicated call processing server system is referred to as the “MTPS server system”. One embodiment of SGW 1160 includes multiple call processing server systems 12010 and dedicates each one of these server systems to facilitate a particular type of multimedia service.

The following discussions primarily explain how these parties interact with one another in three stages of an MTPS session: call setup, call communication and call clear-up.

6.1.1.1 Call Setup

1. The calling party, such as UT 1380, initiates a call by sending MTPS request 53000 to the MTPS server system via an EX in SGW 1160 and via the calling party MX 1180. MTPS request 53000 is an MP control packet, which includes the network address of the calling party and the user address of the called party. As discussed in the Logical Layer section above, a calling party typically does not know the network address of the called party. Instead, the calling party relies on the server group in an SGW to map a user address to a network address. In addition, the calling party and the called party acquire MP network information (e.g., the network address of the MTPS server system) for carrying out an MTPS session from network management server system 12030 of server group 10010 (FIG. 12).
2. Upon receipt of the MTPS request 53000, the MTPS server system executes the MCCP procedures (discussed in the Server Group section above) to determine whether to allow the calling party to proceed.
3. The MTPS server system acknowledges the request of the calling party by issuing MTPS request response 53010, which is an MP control packet that contains the result of the MCCP procedures.
4. Then, the MTPS server system sends MTPS setup packets 53020 and 53030 to the calling party and the called party, respectively. MTPS setup packets 53020 and 53030 are MP control packets, which contain the network addresses of the calling party and the called party and the allowed call traffic flow (e.g., bandwidth) of the requested MTPS session. Also, these packets include color information, which directs the calling party MX, such as MX 1180, and the called party MX, such as MX 1240, to set up the ULPFs in the MXs. This process of updating a ULPF is detailed in the Middle Switch section above.
5. The calling party and the called party acknowledge MTPS setup packets 53020 and 53030 by sending MTPS setup response packets 53040 and 53050, respectively, back to the MTPS server system. MTPS setup response packets are MP control packets.
6. After the MTPS server system receives the MTPS setup response packets, it begins to collect usage information for the MTPS session (e.g., the duration or the traffic of the session).
   6.1.1.2 Call Communication
1. The calling party begins to send data 53060 to the called party via the calling party MX, the EX in the SGW (SGW 1160), and the called party MX. Data 53060 are MP data packets. The ULPF of the calling party MX then performs ULPF checks, which are detailed in the Middle Switch section above, to determine whether to allow the data packets to reach SGW 1160. Here, the logical links that the data packets pass through between the calling party and the EX in the SGW (SGW 1160) that governs the calling party are the bottom-up logical links, whereas the logical links that the data packets pass through between the EX in the SGW (SGW 1160) that governs the called party and the called party are the top-down logical links.
2. Similarly, the ULPF of called party MX performs ULPF checks on the data packets of data 53070 from the called party. For data packets being sent from the called party to the calling party, the logical links that the data packets pass through between the called party and the EX in the SGW (SGW 1160) that governs the called party are the bottom-up logical links, whereas the logical links that the data packets pass through between the EX in the SGW (SGW 1160) that governs the calling party and the calling party are the top-down logical links.
3. The MTPS server system sends MTPS maintain packets 53080 and 53090 to the calling party and the called party occasionally during the call communication stage. The MTPS maintain packet is an MP control packet, which the MTPS server system deploys to collect call connection status information (e.g., error rate and number of packets lost) of the parties in an MTPS session.
4. The calling party and the called party acknowledge the MTPS maintain packet by sending MTPS maintain response packets 53100 and 53110 to the MTPS server. The MTPS maintain response packet is an MP control packet, which contains the requested call connection status information (e.g., error rate, number of packets lost).
5. Based on MTPS maintain response packets 53100 and 53110, the MTPS server system may modify the MTPS session. For instance, if the error rate of the session exceeds a tolerable threshold, the MTPS server system may notify the parties and terminate the session.
   6.1.1.3 Call Clear-up

The calling party, the called party, or the MTPS server system can initiate call clear-up.

6.1.1.3.1 Calling Party Initiated Call Clear-up

1. The calling party sends MTPS clear-up 53120, which is an MP control packet, to the MTPS server system. In response, the MTPS server system sends MTPS clear-up response 53130, which is also an MP control packet, to the calling party and sends MTPS clear-up 53125 to the called party. In one implementation, MTPS clear-up 53125 contains the same information as MTPS clear-up 53120. In addition, the MTPS server system stops collecting usage information for the session (e.g., the duration or the traffic of the session) and reports the collected usage information to an accounting server system, such as accounting server system 12040 of server group 10010 in SGW 1160 (FIG. 12).
2. After receiving MTPS clear-up 53120, the calling party MX and the called party MX reset the parameters (e.g., permissible DA, SA, traffic flow and data content) of their respective ULPFs back to their default values.
3. When the calling party receives MTPS clear-up response 53130 from MTPS server system, the calling party terminates its involvement in the MTPS session.
4. The called party notifies the MTPS server system via MTPS clear-up response 53140 that it has terminated its involvement in the MTPS session.
   6.1.1.3.2 MTPS Server System Initiated Call Clear-up

As mentioned above, one embodiment of the MTPS server system may initiate the call clear-up when it detects unacceptable communication conditions (e.g., excessive number of dropped packets, excessive error rate, and/or excessive number of missing MTPS maintain response packets).
1. The MTPS server system sends MTPS clear-up packets 53150 and 53160, which are MP control packets, to the calling party and the called party, respectively. In response, the calling party and the called party send back MTPS clear-up responses 53170 and 53180, which are also MP control packets, to the MTPS server system and effectively terminate the MTPS session. The MTPS server system stops collecting usage information for the session (e.g., the duration or the traffic of the session) when it sends out the MTPS clear-up packets. The MTPS server system reports the collected usage information to a local accounting server system, such as accounting server system 12040 of server group 10010 in SGW 1160 (FIG. 12).
2. The calling party MX and the called party MX reset their respective ULPFs when they receive MTPS clear-ups 53150 and 53160.
   6.1.1.3.3 Called Party Initiated Call Clear-up
1. The called party sends MTPS clear-up 53190, an MP control packet, to the MTPS server system, which further sends MTPS clear-up 53195 to the calling party. In response, the calling party sends back MTPS clear-up response 53210, also an MP control packet, to the MTPS server system and effectively terminates the MTPS session. Upon receipt of MTPS clear-up 53190, the MTPS server system also sends MTPS clear-response 53220 to the called party, stops collecting usage information for the session (e.g., the duration or the traffic of the session) and reports the collected usage information to a local accounting server system, such as accounting server system 12040 of server group 10010 in SGW 1160 (FIG. 12).
2. The calling party MX and the called party MX reset their respective ULPFs when they receive MTPS clear-up 53190.
   6.1.2 MTPS Between Two UTs That Depend on Two Service Gateways

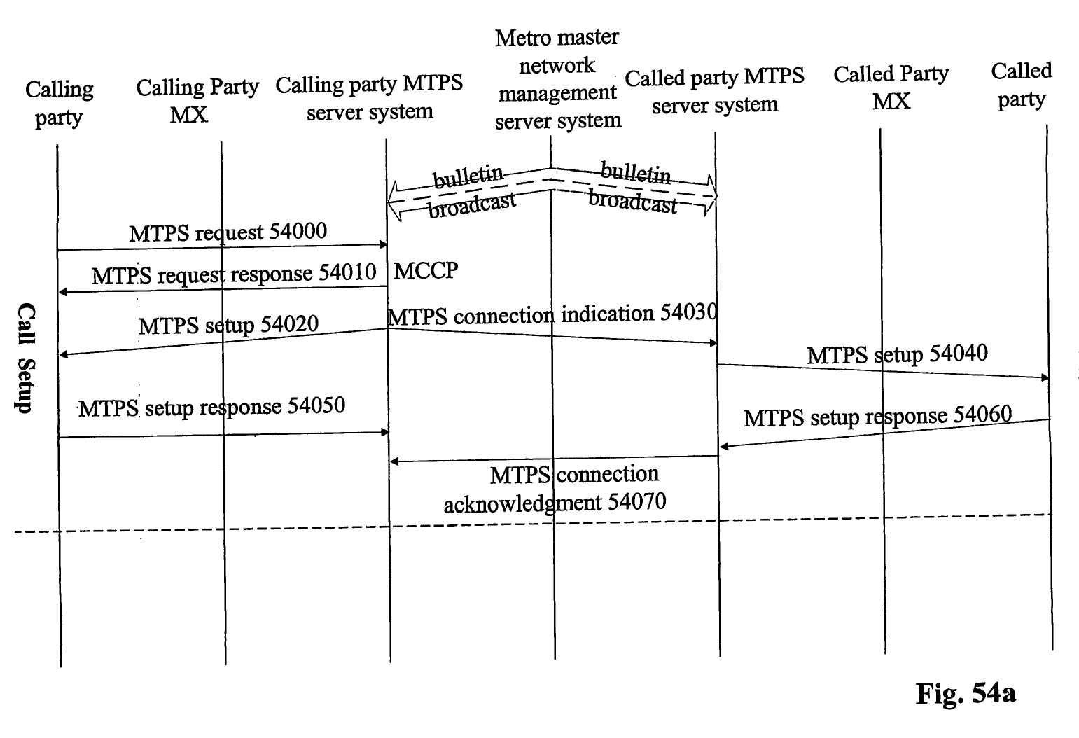

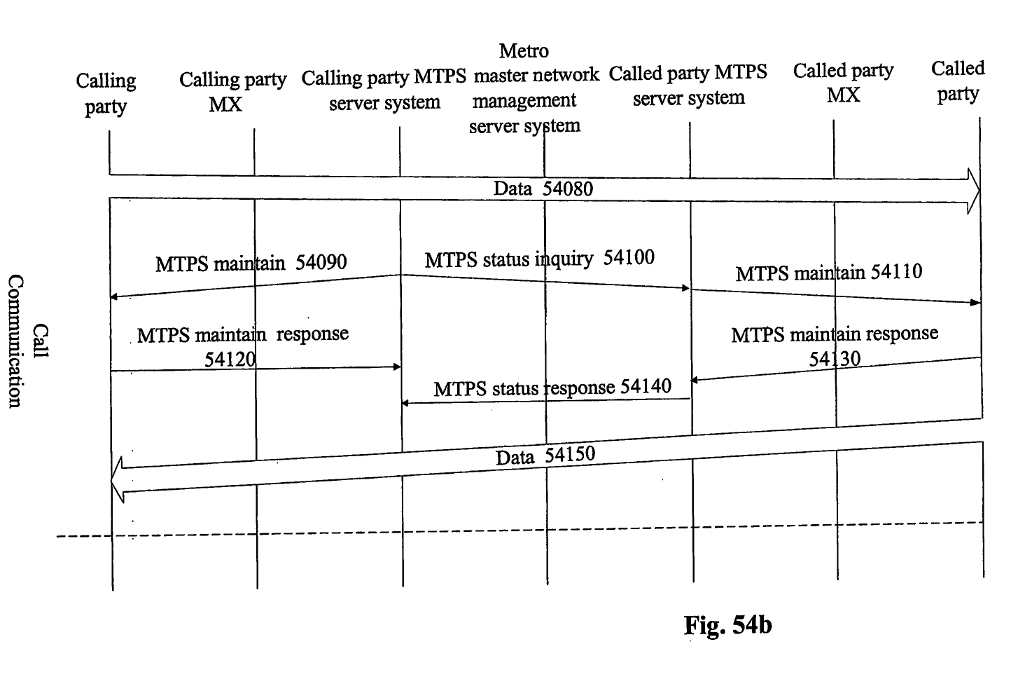

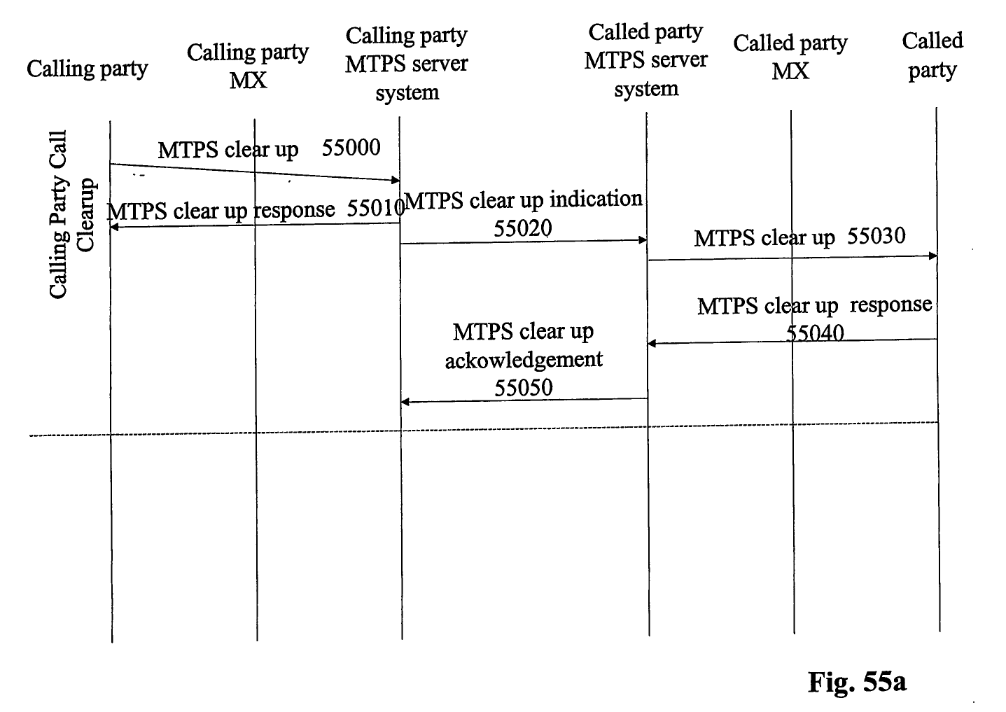

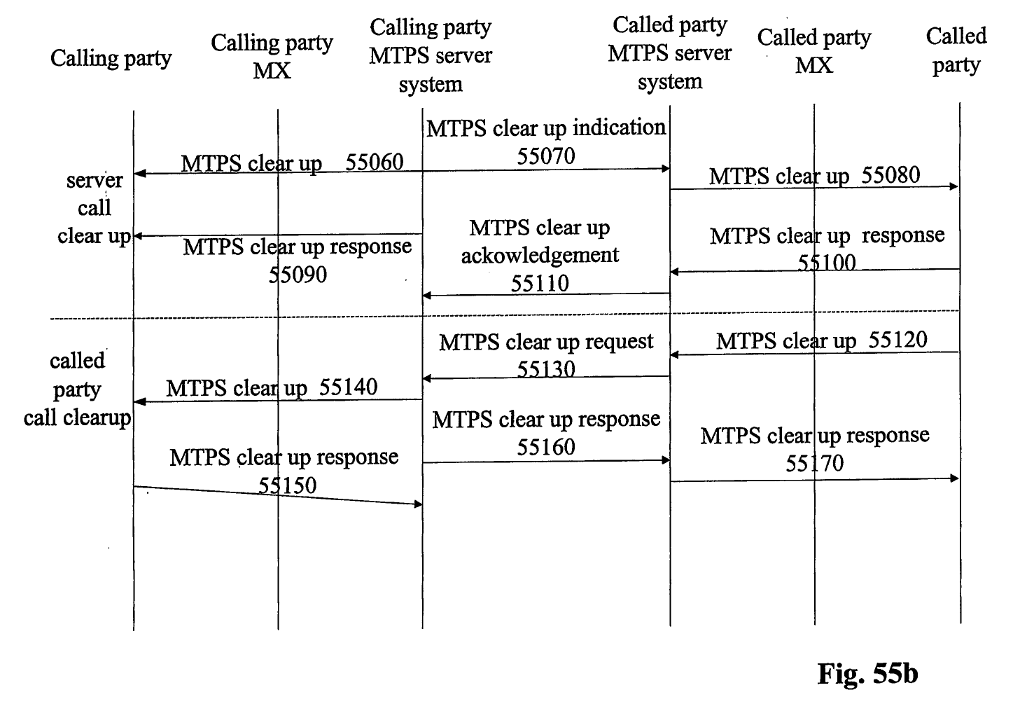

FIGS. 54a, 54b, 55a, and 55b illustrate time sequence diagrams of one session of MTPS between two UTs that depend on two SGWs, such as UT 1380 and UT 1320 as shown in FIG. 1d. For illustration purposes, UT 1380 requests a call to UT 1320. UT 1380 is thus the “calling party”, and UT 1320 is the “called party”. MX 1180 is the “calling party MX” and MX 1080 is the “called party MX”. Call processing server system 12010 that resides in server group 10010 of SGW 1160 is the “calling party call processing server system”. Similarly, the call processing server system that resides in SGW 1060 is the “called party call processing server system”. When an SGW dedicates a call processing server system to manage MTPS sessions, the dedicated call processing server system is referred to as the “MTPS server system”. SGW 1060 and SGW 1160 may include a multiple number of call processing server systems 12010 and dedicate each one of these server systems to facilitate a particular type of multimedia service.

In addition, assuming SGW 1160 serves as the metro master network manager for MP metro network 1000, network management server system 12030 that resides in server group 10010 of SGW 1160 is the “metro master network management server system”.

The following discussions primarily explain how these parties interact with one another in three stages of an MTPS session: call setup, call communication and call clear-up.

6.1.2.1 Call Setup

1. One embodiment of metro master network management server system (network management server system 12030 in SGW 1160 in this example) occasionally broadcasts information concerning network resources to the server systems on MP metro network 1000, such as the calling party MTPS server system and the called party MTPS server system. The network resources information can include, without limitation, the network addresses of the server systems on MP metro network 1000, the current traffic flows on MP metro network 1000 and available bandwidth and/or capacity of the server systems on MP metro network 1000.
2. As the server systems receive the broadcast information from the metro master network management server system, they extract and maintain certain information from the broadcast. For example, because the calling party MTPS server system is interested in contacting the called party MTPS server system, the calling party MTPS server system retrieves the network address of the called party MTPS server system from the broadcast.
3. The calling party, such as UT 1380, initiates a call by sending MTPS request 54000 to the calling party MTPS server system via an EX in SGW 1160 and via calling party MX, such as MX 1180. MTPS request 54000 is an MP control packet, which includes the network address of the calling party and the user address of the called party. As discussed in the Logical Layer section above, a calling party typically does not know the network address of the called party. Instead, the calling party relies on the server group in an SGW to map a user address (which the calling party knows) to a network address. In addition, the calling party and the called party acquire MP network information (e.g., the network addresses of the MTPS server systems) for carrying out an MTPS session from the network management server systems of the server groups in SGW 1160 and SGW 1060, respectively.
4. Upon receipt of the MTPS request 54000, the calling party MTPS server system executes the MCCP procedures as discussed in the Server Group section above to determine whether to allow the calling party to proceed.
5. The calling party MTPS server system acknowledges the request of the calling party by issuing MTPS request response 54010, which is an MP control packet that contains the result of the MCCP procedures.
6. Then, the calling party MTPS server system sends MTPS setup packet 54020 and MTPS connection indication 54030 to the calling party and the called party MTPS server system, respectively. The setup packet and the connection indication packet are MP control packets, which contain, without limitation, the network addresses of the calling party and the called party and the allowed call traffic flow (e.g., bandwidth) of the requested MTPS session.
7. The called party MTPS server system sends MTPS setup packet 54040 to the called party. Both setup packets to the calling party and the called party include color information, which directs the calling party MX, such as MX 1180, and the called party MX, such as MX 1080, to set up the ULPFs in the MXs. This process of updating a ULPF is detailed in the Middle Switch section above.
8. The calling party and the called party acknowledge MTPS setup packets 54020 and 54040 by sending MTPS setup response packets 54050 and 54060 back to their respective MTPS server systems. MTPS setup response packets are MP control packets.
9. Upon receipt of MTPS setup response packet 54060, the called party MTPS server system notifies the calling party MTPS server system to proceed with the MTPS session by sending it MTPS connection acknowledgment 54070. Moreover, after the calling party MTPS server system receives MTPS setup response packet 54050 and MTPS connection acknowledgment 54070, it begins to collect usage information for the MTPS session (e.g., the duration or the traffic of the session).

Although this aforementioned MTPS call setup process generally applies to the call setup between two UTs that are governed by two SGWs in different MP metro networks (but within the same MP nationwide network), the call setup between two UTs in different MP metro networks may involve additional setup procedures. As an illustration, suppose UT 1320 (governed by SGW 1060 in MP metro network 1000) requests a call to a UT in MP metro network 2030, the two UTs are governed by two SGWs in different MP metro networks (1000 and 2030) but within the same MP nationwide network 2000. Also, in this illustration, SGW 2060 serves as the metro master network manager for MP metro network 2030. SGW 1020 serves as the nationwide master network manager for MP nationwide network 2000. SGW 2020 serves as the global master network manager for MP global network 3000.

Because the two UTs and the two SGWs governing the UTs are in different MP metro networks, when the calling party MTPS server system in SGW 1060 asks the server systems (e.g., address mapping server system, network management server system and accounting server system) in SGW 1060 to perform the MCCP procedures, these server systems may not have the requisite information (e.g., mapping relationship, resource information, and accounting information) to carry out the MCCP procedures. As a result, the server systems in SGW 1060 requests assistance (e.g., to obtain the requisite information or to locate the requisite information) from the server systems in the metro master network manager (SGW 1160 in this example). If the server systems in metro master network manager are unable to either obtain or locate the requisite information, the server systems request assistance from the server systems in the nationwide master network manager (SGW 1020 here). Analogously, if the nationwide master network manager still lacks access to the requisite information, the nationwide master network manager consults with the global master network manager (SGW 2020 here).

For example, one embodiment of the network management server system in SGW 1060 maintains resource information (e.g., capacity usage) only for MP-compliant components that are governed by SGW 1060. Thus, when this network management server system is asked to approve an MTPS request to communicate with a UT in MP metro network 2030 during the MCCP procedures, the network management server system in SGW 1060 does not have the requisite resource information (i.e., the capacity usage information along the transmission path from UT 1320 and the UT in MP metro network 2030) to perform the task. The network management server system in SGW 1060 then asks the network management server system in SGW 1160 for assistance.

The network management server system in SGW 1160 is referred to as the “metro master network management server system” for MP metro network 1000. In one implementation, this metro master network management server system has access to the resource information that only the network management server systems within MP metro network 1000 oversee. Because the MTPS request is to communicate with a UT in another MP metro network, the metro master network management server system lacks the requisite resource information to approve or disapprove the request. The metro master network management server system then asks the network management server system in the nationwide master network manager (SGW 1020) for assistance.

This network management server system in SGW 1020 is referred to as the “nationwide master network management server system” for MP nationwide network 2000. In one implementation, this nationwide master network management server system has access to the resource information that only the metro master network management server systems and the network management server systems in the metro access SGWs (e.g., SGW 2050 and SGW 2070) within MP nationwide network 2000 oversee. In this example, the nationwide master network management server system has the resource information from both the metro master network management server systems in SGW 1160 and SGW 2060 (i.e., the capacity usage information for MP metro network 1000 and MP metro network 2030). The nationwide master network management server system also has the resource information from the metro access SGWs (i.e. the capacity usage information among SGWs 1020, 2050, and 2070). The nationwide master network management server system thus has the requisite resource information to approve or disapprove the request. The nationwide master network management server system in SGW 1020 then sends its response to the metro master network management server system in SGW 1160, which in turn, sends the response to the network management server system in SGW 1060.

This described process applies to other types of server systems (e.g., addressing mapping server systems and accounting server systems) in one MP metro network when they handle service requests for destination hosts in another MP metro network. Although the preceding example describes exemplary exchanges between an SGW and a metro master network manager and between a metro master network manager and a nationwide master network manager using specific details, it will be apparent to a person of ordinary skill in the art to implement other mechanisms to facilitate the inter-MP-metro-network service requests without the details and yet still remain within the scope of the disclosed MTPS technologies.

Moreover, the aforementioned process similarly applies to the handling of service requests between or among hosts in MP nationwide networks. Using the network management server systems in the MCCP procedures as an illustration, if an MTPS service request is for a destination host in another MP nationwide network (e.g., MP nationwide network 3030), the nationwide master network management server system in MP nationwide network 2000 does not have the requisite information to approve or disapprove a service request and asks the network management server system (also referred to as the “global master network management server system”) in the global master network manager (SGW 2020) for assistance. The global master network management server system in SGW 2020 then sends its response to the nationwide master network management server system in SGW 1020, which in turn, sends the response to the metro master network management server system in SGW 1160, which in turn, sends the response to the network management server system in SGW 1060.

This described process applies to other types of server systems (e.g., addressing mapping server systems and accounting server systems) in one MP nationwide network when they handle service requests for destination hosts in another MP nationwide network. It will also be apparent to a person of ordinary skill in the art to apply the disclosed process for handling inter-MP-metro-network MTPS requests and inter-MP-nationwide-network MTPS requests to other types of MP services (e.g., MD, MM, MB, and MT).

6.1.2.2 Call Communication

As noted above, in this example, UT 1380 is the calling party, and UT 1320 is the called party in the following call communication discussions. MX 1180 is the calling party MX and MX 1080 is the called party MX.
1. The calling party begins to send data 54080 to the called party via the calling party MX, the EXs in the SGWs governing the calling party MX and the called party MX, and the called party MX. Data 54080 are MP data packets. The ULPF of the calling party MX then performs ULPF checks, which are detailed in the Middle Switch section above, to determine whether to allow the data packets to reach SGW 1160. Here, the logical links that the data packets pass through between the calling party and the EX in the SGW (SGW 1160) that governs the calling party are the bottom-up logical links, whereas the logical links that the data packets pass through between the EX in the SGW (SGW 1060) that governs the called party and the called party are the top-down logical links. Also, as described in the Logical Layer section above, the EX in SGW 1160 looks in a routing table (which can be calculated off-line) to direct the data packets towards the EX in SGW 1060.
2. Similarly, the ULPF of called party MX performs ULPF checks on the data packets of data 54150 from the called party. For data packets being sent from the called party to the calling party, the logical links that the data packets pass through between the called party and the EX in the SGW (SGW 1060) that governs the called party are the bottom-up logical links, whereas the logical links that the data packets pass through between the EX in the SGW (SGW 1160) that governs the calling party and the calling party are the top-down logical links. The EX in SGW 1060 also looks in a routing table to direct the data packets towards the EX in SGW 1160.
3. The calling party MTPS server system sends MTPS maintain packet 54090 and MTPS status inquiry 54100 to the calling party and the called party MTPS server system occasionally throughout the call communication stage. The called party MTPS server system further sends MTPS maintain packet 54110 to the called party. MTPS maintain packets 54090 and 54110 and MTPS status inquiry 54100 are MP control packets that are deployed to collect call connection status information (e.g., error rate and/or number of packets lost) of the parties in an MTPS session.
4. The calling party and the called party acknowledge the MTPS maintain packets by sending MTPS maintain response packets 54120 and 54130 to their respective MTPS server systems. MTPS maintain response packet is an MP control packet, which contains the requested call connection status information (e.g., error rate and/or number of packets lost).
5. After receiving MTPS maintain response packet 54130, the called party MTPS server system passes along the requested information from the called party to the calling party MTPS server system through MTPS status response 54140.
6. Based on MTPS maintain response packets 54120 and MTPS status response 54140, the calling party MTPS server system may modify the MTPS session. For instance, if the error rate of the session exceeds a tolerable threshold, the calling party MTPS server system may notify the parties and terminate the session.

This aforementioned MTPS call communication process generally applies to the MTPS call communication process between two UTs that are governed by two SGWs in different MP metro networks but within the same MP nationwide network. For example, if UT 1320 (governed by SGW 1060 in MP metro network 1000) sends MP data packets to a UT in MP metro network 2030, the two UTs are governed by two SGWs in different MP metro networks (1000 and 2030) but within the same MP nationwide network 2000. As discussed in the Logical Layer section above, the transmission between the EXs in the SGWs governing the calling party (SGW 1060 in MP metro network 1000) and the SGW governing the called party in MP metro network 2030 may involve metro access SGWs (e.g., 1020 and 2050). Specifically, the EX in SGW 1060 looks in a routing table to direct data packets towards the EX in metro access SGW 1020, which, in turn, looks into a routing table to direct the data packets towards the EX in metro access SGW 2050, which also looks into a routing table to direct the data packets towards the EX in the SGW governing the called party in MP metro network 2030.

Moreover, this MTPS call communication process between two UTs that are in two different MP metro networks similarly applies to the MTPS call communication between two UTs that are in two different MP nationwide networks. For example, if UT 1320 (governed by SGW 1060 in MP nationwide network 2000) sends MP data packets to a UT in MP nationwide network 3030, the transmission between the EXs in the SGWs governing the calling party (SGW 1060 in MP nationwide network 2000) and the SGW governing the called party in MP nationwide network 3030 may involve nationwide access SGWs (e.g., 2020 and 3040). Specifically, the EX in SGW 1060 directs data packets towards the EX in metro access SGW 1020, which, in turn, directs the data packets towards the EX in nationwide access SGW 2020. The EX in nationwide access SGW 2020 directs the data packets towards the EX in nationwide access SGW 3040, which directs the data packets towards the EX in SGW governing the called party in MP nationwide network 3030 via an appropriate metro access SGW.

It will be apparent to a person of ordinary skill in the art to apply the disclosed process for handling inter-MP-metro-network MTPS call communication and inter-MP-nationwide-network call communication to other types of MP services (e.g., MD, MM, MB, and MT).

6.1.2.3 Call Clear-up

The calling party, the called party, the calling party MTPS server system, or the called party MTPS server system can initiate call clear-up. As noted above, UT 1380 is the calling party, UT 1320 is the called party, MX 1180 is the calling party MX, and MX 1080 is the called party MX in this example.

6.1.2.3.1 Calling Party Initiated Call Clear-up

1. The calling party sends MTPS clear-up 55000, which is an MP control packet, to the calling party MTPS server system. In response, the calling party MTPS server system acknowledges the clear-up request by sending MTPS clear-up response 55010 to the calling party and notifies the called party MTPS server system of the request through MTPS clear-up indication 55020.
2. After receiving MTPS clear-up indication 55020, the called party MTPS server system sends MTPS clear-up 55030 to the called party.
3. The calling party MX and the called party MX reset their respective ULPFs when they receive MTPS clear-up 55000 and MTPS clear-up 55030.
4. The called party acknowledges the clear-up request from the called party MTPS server system through MTPS clear-up response 55040. Then the called party MTPS server system sends MTPS clear-up acknowledgment 55050 to the calling party MTPS server system.
5. Upon receipt of MTPS clear-up 55000, the calling party MTPS server system stops collecting usage information for the session (e.g., the duration or the traffic of the session) and reports the collected usage information to a local accounting server system, such as accounting server system 12040 of server group 10010 in SGW 1160 (FIG. 12).
6. When the calling party receives MTPS clear-up response 55010 from the calling party MTPS server system, the calling party terminates the MTPS session.
7. The called party notifies the called party MTPS server system of its termination of the MTPS session with MTPS clear-up response 55040.
   6.1.2.3.2 MTPS Server System Initiated Call Clear-up

As mentioned above, one embodiment of either a calling party or called party MTPS server system may initiate the call clear-up when it detects unacceptable communication conditions (e.g., excessive number of dropped packets, excessive error rate, and/or excessive number of missing MTPS maintain response packets). Similarly, the metro master network management server system may also terminate a call when it detects intolerable communication conditions among the SGWs.
1. For illustration purposes, assume the calling party MTPS server system initiates the call clear-up. To initiate call clear-up, the calling party MTPS server system sends MTPS clear-up 55060 and MTPS clear-up indication 55070, which are MP control packets, to the calling party and the called party MTPS server system, respectively. In response, the calling party sends back MTPS clear-up response 55090 to the calling party MTPS server system and effectively terminates the MTPS session. Also, the called party MTPS server system sends MTPS clear-up 55080 to the called party. The calling party MTPS server system stops collecting usage information for the session (e.g., the duration or the traffic of the session) when it sends out MTPS clear-up 55060 and MTPS clear-up indication 55070. The calling party MTPS server system also reports the collected usage information to a local accounting server system, such as accounting server system 12040 of server group 10010 in SGW 1160 (FIG. 12).
2. The calling party MX and the called party MX reset their respective ULPFs when they receive MTPS clear-ups 55060 and 55080.
3. After receiving MTPS clear-up response 55100, the called party MTPS server system sends MTPS clear-up acknowledgment 55110 to the calling party MTPS server system.
4. After the calling party MTPS server system receives both MTPS clear-up acknowledgment 55110 and MTPS clear-up response 55090, it terminates the session.

Analogous procedures apply if the called party MTPS server system initiates the call clear-up.

6.1.2.3.3 Called Party Initiated Call Clear-up

1. The called party initiates the clear-up by sending MTPS clear-up 55120 to the called party MTPS server system, which then sends MTPS clear-up request 55130 to the calling party MTPS server system. The calling party MTPS server system stops collecting usage information for the session (e.g., the duration or the traffic of the session) and reports collected usage information to a local accounting server system of the server group in SGW 1160.
2. Then the calling party MTPS server system sends MTPS clear-up 55140 to the calling party and sends MTPS clear-up response 55160 to the called party MTPS server system.
3. Upon receipt of MTPS clear-up response 55160, the called party MTPS server system terminates the session and sends MTPS clear-up response 55170 to the called party.
4. The calling party MX and the called party MX reset their respective ULPFs when they receive MTPS clear-ups 55140 and 55120.

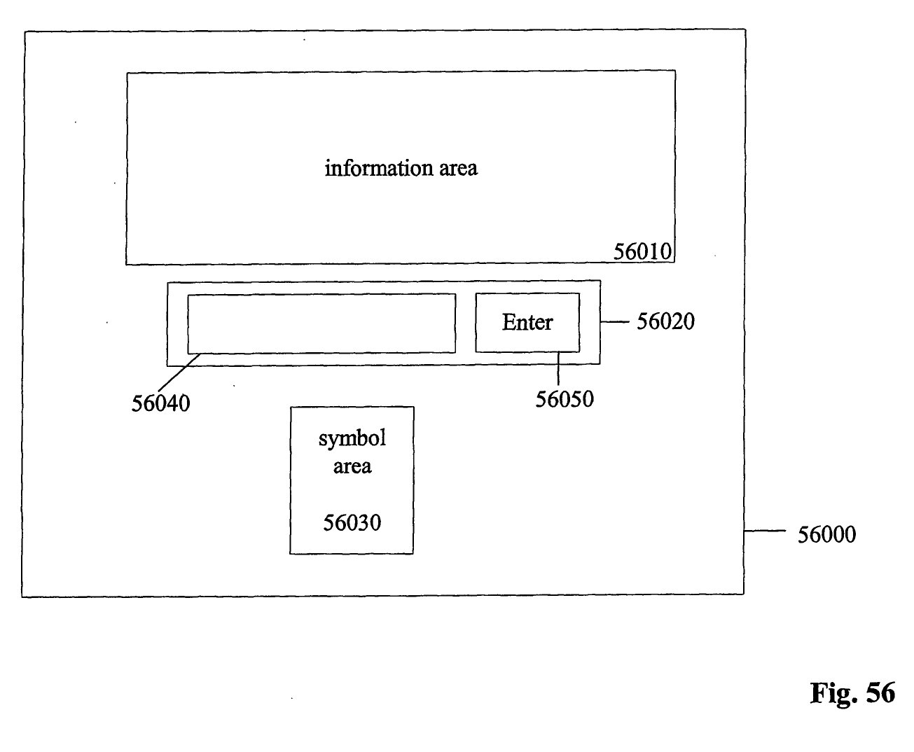

A user requests the aforementioned MTPS service through a graphical user interface on a UT. FIG. 56 illustrates a service window that one embodiment of the graphical user interface supports, such as service window 56000. The user navigates through service window 56000 to initiate an MTPS session. Specifically, service window 56000 includes a number of display areas, such as, without limitation, information area 56010, input area 56020 and symbol area 56030. Information area 56010 displays relevant MTPS session information (e.g., connection status, procedural instructions). Input area 56020 contains items such as, without limitation, textual/numeric entry block 56040 and enter button 56050. Symbol area 56030 displays items such as, without limitation, icons, logos and intellectual property information (e.g., patent information, copyright notices, and/or trademark information).

As an illustration, suppose user A wishes to conduct an MTPS session with user B and the UT that user A uses (such as UT 1380 in FIG. 1d) displays “Please enter user B number” in information area 56010 and sounds an off-hook dial tone. User A types in user B's number (i.e., user B's user address) in textual/numeric block 56040 and then clicks on enter button 56050. As user A enters each individual digit, UT 1380 optionally plays back the Dual-Tone Multi-Frequency (“DTMF”) tones that correspond to the digits. After the entry of user B's number, UT 1380 displays “Please wait” in information area 56010, eliminates input area 56020, temporarily mutes the audio output of UT 1380 and displays “Mute” in information area 56010. Alternatively, UT 1380 displays an icon that indicates mute in symbol block 56030. For example, the icon can be a picture of a speaker device in a circle but with a line drawn across the circle.

If user B is already in an MTPS session with another party, UT 1380 displays “User B is busy” in information area 56010 and sounds a busy tone. If user B does not answer, UT 1380 displays “User B is not answering” in information area 56010 and sounds a warning tone to remind user A to try later. If user B refuses to participate in the requested MTPS session, UT 1380 displays “User B refuses to accept your call” in information area 56010 and also sounds a warning tone to remind user A to try later. If the paying party of the requested MTPS session (either user A or user B) has an overdue balance with the network operator, which offers the requested MTPS service, UT 1380 displays “Cannot complete the call at this time. Please contact your service provider immediately” in information area 56010 and sounds a warning tone to remind the user to settle his or her account soon. If SGW 1160 cannot locate user B, UT 1380 either displays. “User B not found” or “The number dialed does not exist” in information area 56010 and sounds a warning tone to remind user A to verify the accuracy of his or her entered information. If the MP network is busy, UT 1380 displays “Network is busy” in information area 56010 and sounds a busy tone.

However, if the requested MTPS session is successfully established, UT 1380 plays back audio information from user B and optionally displays images from user B in service window 56000. It will be apparent to a person of ordinary skill in the art to implement the user interface without all the details discussed above. For example, service window 56000 can include additional display areas, merge the discussed three areas into fewer distinct areas or have no distinct display areas at all. Also, the displayed textual information concerning the status of the requested MTPS session can have different wordings (e.g., instead of “User B refuses to accept your call”, UT 1380 can display “Call refused”) and different appearances (e.g., use of various fonts, font sizes, colors).

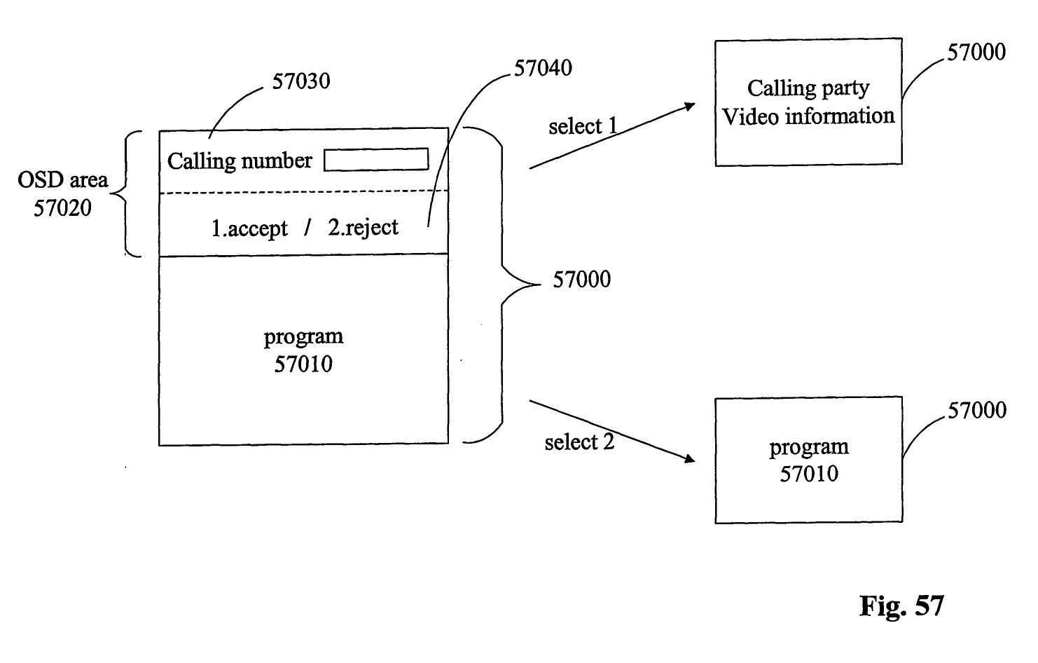

The user interface discussed above can also guide a user to accept an MTPS session request. Using the same example of user A attempting to establish an MTPS session with user B, FIG. 57 illustrates a series of windows that user B navigates through to respond to the request. For illustration purposes, assuming user B is watching program 57010 (e.g., a movie) that is being played on the display device of UT 1320 when UT 1320 receives user A's request:
UT 1320 then displays user A's information, such as calling number 57030, and choices that user B has, such as accept/reject area 57040, in On Screen Display (“OSD”) area 57020. OSD area 57020 overlays program 57010 in service window 57000.
If user B chooses to accept, UT 1320 plays audio information from user A and optionally displays video information from user A in service window 57000. If user B chooses to reject, UT 1320 removes OSD 57020 and reverts the entire display area of service window 57000 back to program 57010.

It will be apparent to a person of ordinary skill in the art to implement the disclosed user interface without the specific details (e.g., positioning of OSD 57020, presentation of the user choices, use of a single display window) of the illustrated examples. It will also be apparent to a person of ordinary skill in the art that the disclosed user interface can be used for many other types of multimedia services (e.g., MD, MM, MB, and MT)

6.2 Media on Demand (“MD”)

6.2.1 MD Between Two MP-compliant Components That Depend on a Single Service Gateway

MD enables a UT to obtain video and/or audio information from an MP-compliant component, such as media storage. In one configuration, the media storage resides in an SGW (“SGW media storage”), such as media storage 1140 in SGW 1120. In an alternative configuration, the media storage is one of the UTs that connect to an HGW, such as UT 1450.

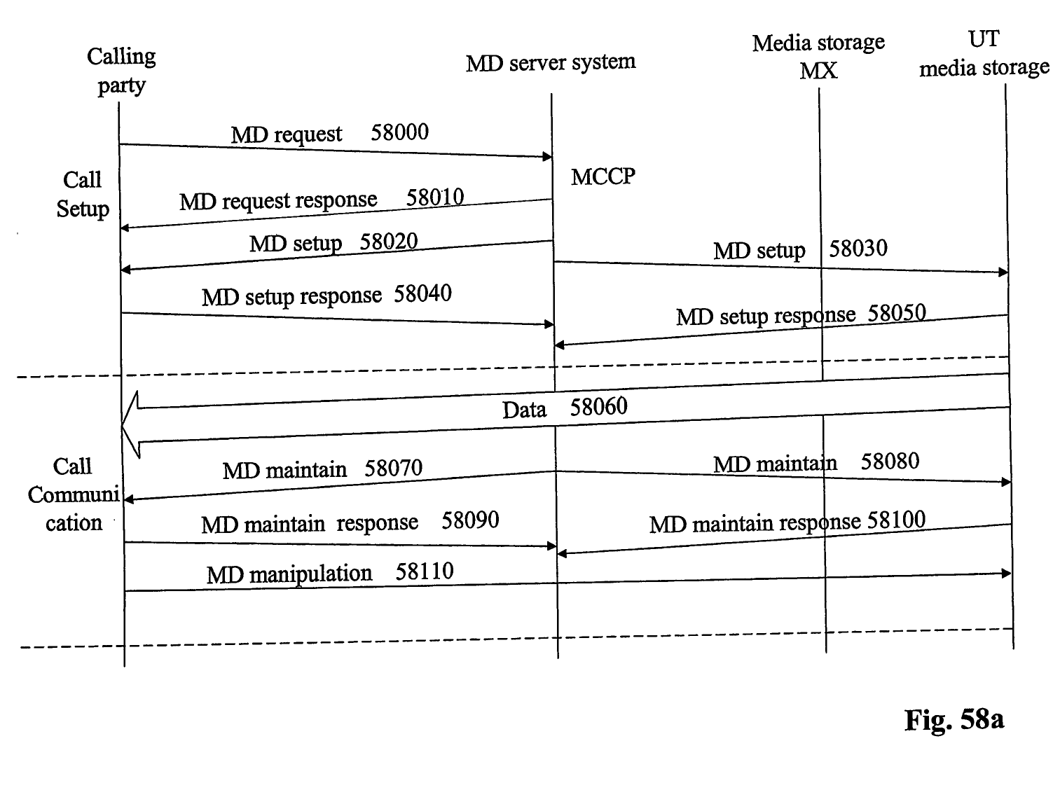

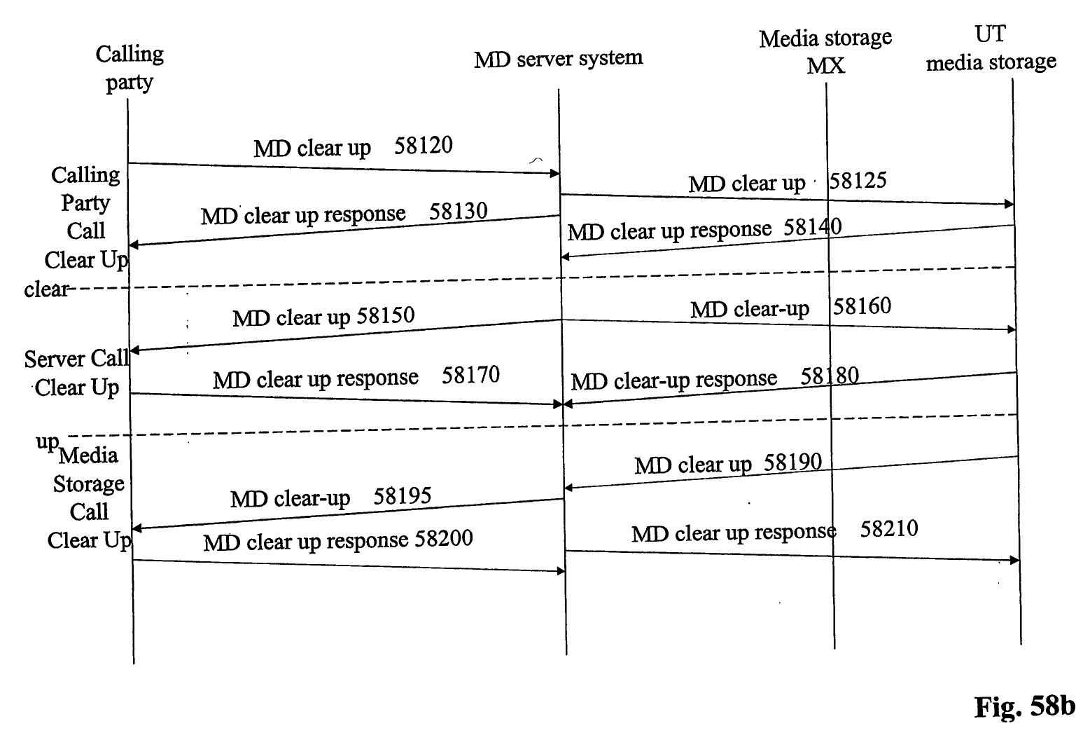

FIGS. 58a and 58b illustrate time sequence diagrams of one session of M between two UTs that depend on a single SGW, such as UT 1380 and UT 1450. For illustration purposes, UT 1380 requests a MD session from UT 1450. UT 1380 is thus the “calling party.” UT 1450 is the UT media storage”, and MX 1240 is the “media storage MX”.

An “MD server system” refers to a dedicated server system that manages MD sessions. The MD server system can be, without limitation, either call processing server system 12010 that resides in server group 10010 of SGW 1160 (FIG. 12) or a home server system that supports HGW 1200.

The following discussions primarily explain how the calling party, UT media storage, and MD server system in an SGW interact with one another in three stages of an MD session: call setup, call communication and call clear-up.

6.2.1.1 Call Setup

1. The calling party, such as UT 1380, sends MD request 58000 to the MD server system in an SGW (such as SGW 1160). MD request 58000 is an MP control packet, which includes the network address of the calling party and the user address of the UT media storage. Because the calling party typically does not know the network address of the UT media storage, the calling party relies on the server group in an SGW to map UT media storage's user address to its corresponding network address (not shown in FIG. 58a). In addition, the calling party and the UT media storage acquire MP network information (e.g., the network address of the MD server system) for carrying out an MD session from network management server system 12030 of server group 10010 (FIG. 12).
2. Upon receipt of the MD request 58000, the MD server system executes the MCCP procedures (as discussed in the Server Group section) above to determine whether is to allow the calling party to proceed.
3. The MD server system acknowledges the request of the calling party by issuing MD request response 58010, which is an MP control packet that contains the result of the MCCP procedures.
4. Then, the MD server system sends MD setup packets 58020 and 58030 to the calling party and the UT media storage, respectively. MD setup packet 58030 is sent to the UT media storage via the media storage MX. MD setup packets 58020 and 58030 are MP control packets, which contain the network addresses of the calling party and the media storage and the allowed call traffic flow (e.g., bandwidth) of the requested MD session. These packets further include color information, which directs the media storage MX, such as MX 1240, to set up the ULPFs in the MXs. This process of updating an ULPF is detailed in the Middle Switch section above.
5. The calling party and the UT media storage acknowledge MD setup packets 58020 and 58030 by sending MD setup response packets 58040 and 58050, respectively, back to the MD server system. MD setup response packets are MP control packets.
6. After the MD server system receives the MD setup response packets, it begins to collect usage information for the MD session (e.g., the duration or the traffic of the session).

The preceding call setup description for UT media storage also applies to SGW media storage but with the following modifications:

If the MD server system sends MD setup packet 58030 to media storage 1140, MD setup packet 58030 bypasses the media storage MX and reaches the SGW media storage via the EX in SGW 1120. In one implementation, the EX in SGW 1120 includes an ULPF. The MD setup packets from the MD server system set up this ULPF.

6.2.1.2 Call Communication

1. After setting up the requested MD session, the media storage (either SGW media storage or UT media storage) begins to send data to the calling party. For example, as shown in FIG. 58a, the UT media storage sends data 58060, which are MP data packets, to the calling party. Also, the media storage MX, such as MX 1240, performs ULPF checks, which are detailed in the Middle Switch section above, to determine whether to allow the data packets to reach SGW 1160 through the MX.
2. The MD server system sends MD maintain packets 58070 and 58080, which are MP control packets, to the calling party and the UT media storage from time to time throughout the call communication stage. The MD server system deploys these MP control packets to collect call connection status information (e.g., error rate, number of packets lost) of the parties in an MD session.
3. The calling party and the UT media storage acknowledge the MD maintain packets by sending MD maintain response packets 58090 and 58100 to the MD server system. MD maintain response packet is an MP control packet, which contains the requested call connection status information (e.g., error rate and number of packets lost). Based on MD maintain response packets 58090 and 58100, the MD server system may modify the MD session. For instance, if the error rate of the session exceeds a tolerable threshold, the MD server system may notify the calling party and terminate the session.
4. At any point during the call communication stage, the calling party can control the media storage via the MP network. Specifically, the calling party can send MD manipulation 58110, an MP inband-signaling data packet, to the UT media storage. This data packet contains control information in its payload field 5050 that causes the media storage, without limitation, to forward, rewind, pause, or playback its stored content.
   6.2.1.3 Call Clear-up

The calling party, the MD server system, or the media storage can initiate call clear-up.

6.2.1.3.1 Calling Party Initiated Call Clear-up

1. The calling party sends MD clear-up 58120, which is an MP control packet, to the MD server system. In response, the MD server system sends MD clear-up response 58130, which is also an MP control packet, to the calling party and sends MD clear-up 58125 via the media storage MX to the UT media storage. In addition, the MD server system stops collecting usage information for the session (e.g., the duration or the traffic of the session) and reports the collected usage information to a local accounting server system, such as accounting server system 12040 of server group 10010 in SGW 1160 (FIG. 12). Alternatively, for pay-per-view service, the MD server system simply reports to accounting server system 12040 that the MD service was provided.
2. For UT media storage, the media storage MX resets its ULPF when it receives MD clear-up 58125. Similarly for SGW media storage, the EX in the SGW would also reset its ULPF (if the EX includes an ULPF) after the EX receives a clear-up packet from the MD server system to the SGW media storage.
3. After the calling party receives MD clear-up response 58130 from the MD server system and after the MD server system receives MD clear-up response 58140 from the UT media storage, the MD session is terminated.
   6.2.1.3.2 MD Server System Initiated Call Clear-up

One embodiment of the MD server system may initiate the call clear-up when it detects unacceptable communication conditions (e.g., excessive number of dropped packets, excessive error rate, or excessive number of missing MD maintain response packets).
1. The MD server system sends MD clear-ups 58150 and 58160, which are MP control packets, to the calling party and the UT media storage, respectively. In response, the calling party and the UT media storage send back MD clear-up responses 58170 and 58180, which are also MP control packets, to the MD server system to terminate the MD session. The MD server system stops collecting usage information for the session (e.g., the duration or the traffic of the session) when it sends out the MD clear-up packets. The MD server system also reports the collected usage information to a local accounting server system, such as accounting server system 12040 of server group 10010 in SGW 1160 (FIG. 12).
2. For UT media storage, the media storage MX resets its respective ULPF when it receives MD clear-up 58160. Similarly for SGW media storage, the EX in the SGW would also reset its ULPF (if the EX includes an ULPF) after the EX receives a clear-up packet from the MD server system to the SGW media storage.
   6.2.1.3.3 Media Storage Initiated Call Clear-up
1. The media storage sends MD clear-up 58190, an MP control packet, to the MD server system via the media storage MX. The MD server system further sends MD clear-up 58195 to the calling party. In response, the calling party sends back MD clear-up response 58200, also an MP control packet, to the MD server system to terminate the MD session. Upon receipt of MD clear-up 58190, the MD server system sends MD clear-response 58210 to the UT media storage, stops collecting usage information for the session (e.g., the duration or the traffic of the session) and reports the collected usage information to a local accounting server system, such as accounting server system 12040 of server group 10010 in SGW 1160 (FIG. 12).
2. For UT media storage, the media storage MX resets its respective ULPF when it receives MD clear-up 58190. Similarly for SGW media storage, the EX in the SGW would also reset its ULPF (if the EX includes an ULPF) after the EX receives a clear-up packet from the MD server system to the SGW media storage.
   6.2.2 MD Between Two MP-Compliant Components That Depend on Two Service Gateways

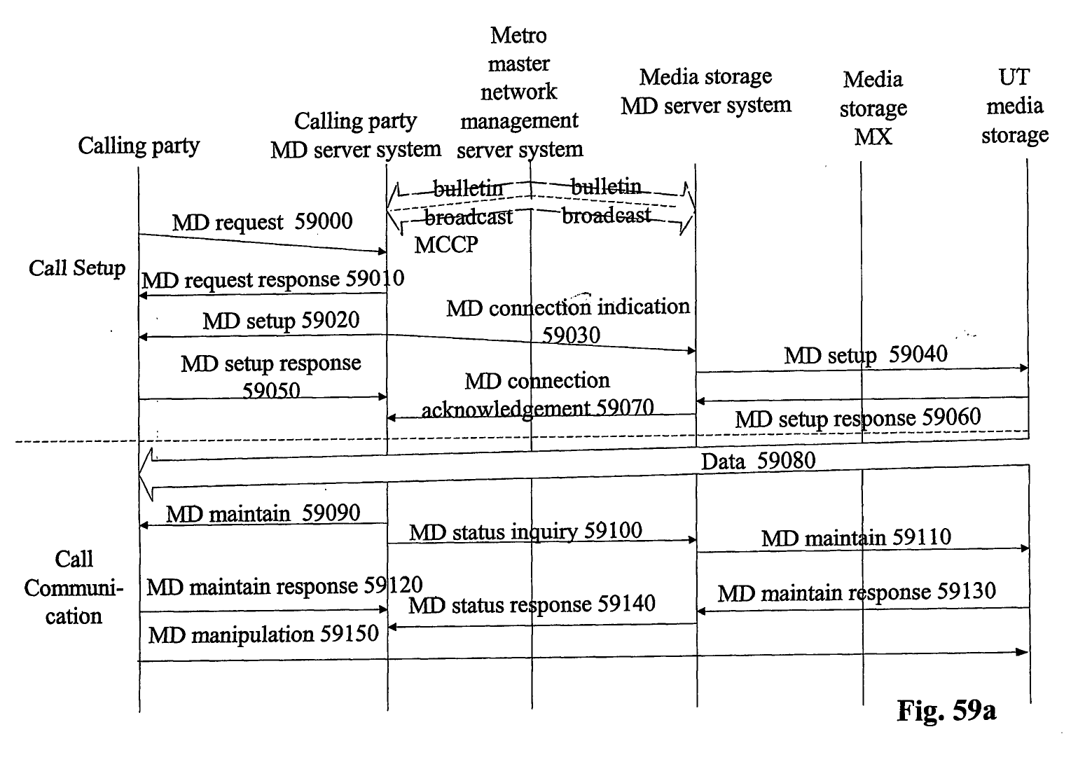

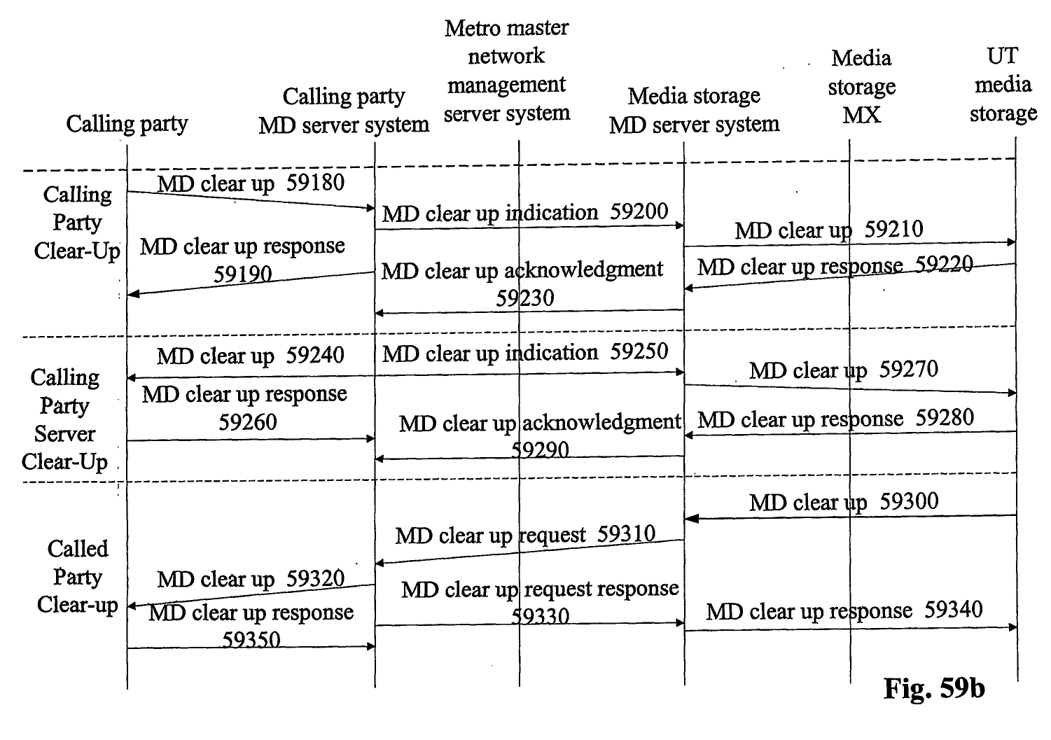

FIGS. 59a and 59b illustrate time sequence diagrams of one MD session between two MP-compliant components that depend on two SGWs, such as UT 1380 and UT 1320 as shown in FIG. 1d. For illustration purposes, UT 1380 is the “calling party” and UT 1320 is the “UT media storage”. MX 1180 is the “calling party MX”, and MX 1080 is the “media storage MX”. It should be noted that if UT 1380 instead requests an MD session with an SGW media storage (e.g., media storage 1140), then the session does not involve a media storage MX, but would involve the EX of SGW 1120.

Call processing server system 12010 that resides in server group 10010 of SGW 1160 is the “calling party call processing server system”. Similarly, the call processing server system that resides in SGW 1060 is the “media storage call processing server system”. When an SGW dedicates a call processing server system to manage MD sessions, the dedicated call processing server system is referred to as the “MD server system”. One embodiment of SGW 1060 and one embodiment of SGW 1160 include a multiple number of call processing server systems and dedicate each one of these server systems to facilitate a particular type of multimedia service.

In addition, assuming SGW 1160 serves as the metro master network manager for MP metro network 1000, network management server system 12030 that resides in server group 10010 of SGW 1160 is the metro master network management server system. The following discussions primarily explain how mentioned parties interact with one another in three stages of an MD session: call setup, call communication and call clear-up.

6.2.2.1 Call Setup

1. One embodiment of metro master network management server system from time to time broadcasts information concerning network resources to the server systems on MP metro network 1000, such as calling party MD server system and the media storage MD server system. The network resource information can include, without limitation, the network addresses of server systems, the current traffic flows on MP metro network 1000 and available bandwidth and/or capacity of the server systems on MP metro network 1000.
2. As the server systems receive the network resource information from the metro master network management server system, they extract and maintain certain information from the broadcast. For example, because the calling party MD server system is interested in contacting the media storage MD server system, the calling party MD server system retrieves the network address of the media storage MD server system from the broadcast.
3. The calling party, such as UT 1380, initiates a call by sending MD request 59000 to the calling party MD server system via calling party MX, such as MX 1180. MD request 59000 is an MP control packet, which includes information of the network address of the calling party and the user address of the UT media storage. As discussed in Logical Layer section above, a calling party typically does not know the network address of the UT media storage, but knows the user address of the UT media storage. Instead, the calling party relies on the server group in an SGW to map the user address of the UT media storage to a corresponding network address. In addition, the calling party and the UT media storage acquire MP network information (e.g., the network addresses of the calling party MD server system and the media storage MD server system) for carrying out an MD session from the network management server systems of the server groups in SGW 1160 and SGW 1060, respectively.
4. Upon receipt of MD request 59000, the calling party MD server system executes the MCCP procedures as discussed in the Server Group section above to determine whether to allow the calling party to proceed.
5. The calling party MD server system acknowledges the request of the calling party by issuing MD request response 59010, which is an MP control packet that contains the result of the MCCP procedures.
6. Then, the calling party MD server system sends MD setup packet 59020 to the calling party via the calling party MX and MD connection indication 59030 to the media storage MD server system, respectively. The setup packet and the connection indication are MP control packets, which contain the network addresses of the calling party and the UT media storage and the allowed call traffic flow (e.g., bandwidth) of the requested MD session.
7. The media storage MD server system sends MD setup packet 59040 to the UT media storage via the media storage MX. The setup packet includes color information, which directs the calling party MX, such as MX 1180, and the media storage MX, such as MX 1080, to set up the ULPFs in the MXs. This process of updating an ULPF is detailed in the Middle Switch section above.
8. The calling party and the UT media storage acknowledge MD setup packets 59020 and 59040, respectively, by sending MD setup response packets 59050 and 59060 back to their respective MD server systems. MD setup response packets are MP control packets.
9. Upon receipt of MD setup response packet 59060, the media storage MD server system notifies the calling party MD server system to proceed with the MD session by sending it MD connection acknowledgment 59070. Moreover, after the calling party MD server system receives MD setup response packet 59050 and MD connection acknowledgment 59070, it begins collect usage information for the MD session (e.g., the duration or the traffic of the session).

If the calling party and the media storage reside either in different MP metro networks (but within the same nationwide network) or in different MP nationwide networks, the aforementioned MD setup stage includes additional inter-MP-metro-network or inter-MP-nationwide-network handling procedures analogous to the procedures discussed in the MTPS call setup section above.

6.2.2.2 Call Communication

1. The UT media storage begins to send data 59080 to the calling party via the media storage MX, the EXs in the SGWs governing the media storage MX and the calling party MX, and the calling party MX. Data 59080 are MP data packets. The ULPF of the media storage MX then performs ULPF checks, which are detailed in the Middle Switch section above, to determine whether to allow the data packets to reach SGW 1060. The logical links that the data packets pass through between the UT media storage and the EX in the SGW (SGW 1060) that governs the UT media storage are the bottom-up logical links, whereas the logical links that the data packets pass through between the EX in the SGW (SGW 1160) that governs the calling party and the calling party are the top-down logical links. Also, as described in the Logical Layer section above, the EX in SGW 1060 looks in a routing table (which can be calculated off-line) to direct the data packets towards the EX in SGW 1160.
2. The calling party MD server system sends MD maintain packet 59090 and MD status inquiry 59100 to the media storage MD server system from time to time throughout the call communication stage. The media storage MD server system further sends MD maintain packets 59110 to UT media storage. MD maintain packets 59090 and 59110 are MP control packets, which are deployed to collect call connection status information (e.g., error rate and number of packets lost) of the parties in an MD session.
3. The calling party and the UT media storage acknowledge the MD maintain packets by sending MD maintain response packets 59120 and 59130 to their respective MD server systems via their respective MXs. MD maintain response packet is an MP control packet, which contains the requested call connection status information (e.g., error rate, number of packets lost).
4. After receiving MD maintain response packet 59130, the media storage MD server system passes along the requested information from the UT media storage to the calling party MD server system through MD status response 59140.
5. Based on MD maintain response packets 59120 and MD status response 59140, the calling party MD server system may modify the MD session. For instance, if the error rate of the session exceeds a tolerable threshold, the calling party MD server system may notify the parties and terminate the session.
6. At any point during the call communication stage, the calling party can control the media storage via the MP network. Specifically, the calling party can send MD manipulation 59150, an MP inband-signaling data packet, to the UT media storage. This data packet contains control information in its payload field 5050 that causes the media storage, without limitation, to forward, rewind, pause, or playback its stored content.

If the calling party and the media storage reside either in different MP metro networks (but within the same nationwide network) or in different MP nationwide networks, the aforementioned MD call communication stage includes additional inter-MP-metro-network or inter-MP-nationwide-network packet forwarding procedures analogous to the procedures discussed in the MTPS call setup section above.

6.2.2.3 Call Clear-up

The calling party, the calling party MD server system, the media storage MD server system, or the media storage can initiate call clear-up.

6.2.2.3.1 Calling Party Initiated Call Clear-Up

1. The calling party sends MD clear-up 59180, which is an MP control packet, to the calling party MD server system. In response, the calling party MD server system acknowledges the clear-up request by sending MD clear-up response 59190 to the calling party and notifies the media storage MD server system of the request through MD clear-up indication 59200. Also, the calling party MD server system stops collecting usage information for the session (e.g., the duration or the traffic of the session) and reports the collected usage information to a local accounting server system, such as accounting server system 12040 of server group 10010 in SGW 1160 (FIG. 12). Alternatively, for pay-per-view services, the calling party MD server system simply reports to accounting server system 12040 that the MD service was provided.
2. After receiving MD clear-up indication 59200, the media storage MD server system sends MD clear-up 59210 to the UT media storage via the media storage MX.
3. For a UT media storage, the media storage MX reset its ULPF when it receives MD clear-up 59210. Similarly for SGW media storage, the EX in the SGW would also reset its ULPF (if the EX includes an ULPF) after the EX receives a clear-up packet from the MD server system to the SGW media storage.
4. The UT media storage acknowledges the clear-up request from the media storage MD server system by sending MD clear-up response 59220 via the media storage MX to media storage MD server system. Then the media storage MD server system sends MD clear-up acknowledgment 59230 to the calling party MD server system.
5. When the calling party receives MD clear-up response 59190 from the calling party MD server system, the calling party terminates the MD session.
   6.2.2.3.2 MD Server System Initiated Call Clear-Up

One embodiment of an MD server system may initiate the call clear-up when it detects unacceptable communication conditions (e.g., excessive number of dropped packets, excessive error rate, excessive number of missing MD maintain response packets, and/or MD status response packets). Similarly, the metro master network management server system may also terminate a call when it detects intolerable communication conditions among the SGWs.
1. For illustration purposes, assuming the calling party MD server system initiates the call clear-up, it sends MD clear-up 59240 and MD clear-up indication 59250, which are MP control packets, to the calling party and the media storage MD server system, respectively. In response, the calling party sends back MD clear-up response 59260 to the calling party MD server system and effectively terminates the MD session. Also, the media storage MD server system sends MD clear-up 59270 to the UT media storage via the media storage MX. The calling party MD server system stops collecting usage information for the session (e.g., the duration or the traffic of the session) when it sends out the MD clear-up and MD clear-up indication packets. The calling party MD server system reports the collected usage information to a local accounting server system, such as accounting server system 12040 of server group 10010 in SGW 1160 (FIG. 12).
2. For a UT media storage, the media storage MX resets its respective ULPF when it receives MD clear-up 59270. Similarly for SGW media storage, the EX in the SGW would also reset its ULPF (if the EX includes an ULPF) after the EX receives a clear-up packet from the MD server system to the SGW media storage.
3. After receiving MD clear-up response 59280, the media storage MD server system sends MD clear-up acknowledgment 59290 to the calling party MD server system.
4. After the calling party MD server system receives both MD clear-up acknowledgment 59290 and MD clear-up response 59260, it terminates the session.

Analogous procedures apply if the media storage MD server system initiates the call clear-up.

6.2.2.3.3 UT Media Storage Initiated Call Clear-up

1. The UT media storage initiates clear-up by sending MD clear-up 59300 to the media storage MD server system via the media storage MX, which then sends MD clear-up request 59310 to the calling party MD server system. The calling party MD server system stops collecting usage information for the session (e.g., the duration or the traffic of the session) and reports the collected usage information to local accounting server system 12040 of server group 10010 in SGW 1160.
2. Then the calling party MD server system sends MD clear-up 59320 to the calling party and sends MD clear-up request response 59330 to the media storage MD server system.
3. Upon receipt of MD clear-up request response 59330, the media storage MD server system terminates the session and sends MD clear-up response 59340 to the UT media storage via the media storage MX.
4. For a UT media storage, the media storage MX resets its respective ULPF when it receives MD clear-up response 59340. Similarly for SGW media storage, the EX in the SGW would also reset its ULPF (if the EX includes an ULPF) after the EX receives a clear-up packet from the MD server system to the SGW media storage.
5. The calling party responds to MD clear-up 59320 by terminating its participation in the MD session and sending the calling party MD server system MD clear-up response 59350.
   6.3 Media Multicast (“MM”)
   6.3.1 MM Among Multiple UTs That Depend on a Single Service Gateway

MM enables one UT to communicate real-time multimedia information with multiple other UTs. The party that initiates an MM session is referred to as the “calling party,” and the parties that accept the calling party's invitations to participate in the MM session are referred to as the “called parties”. In some instances, an MM session may involve a “meeting informer,” who receives a request from the calling party to initiate an MM session and passes along information about the MM session to the potential MM session invitees. A meeting informer can be, without limitation, a server system in server group 10010 of SGW 1160 (FIG. 10) or a UT (e.g., as a home server system) connected to HGW 1200 (FIG. 1d).

For illustration purposes, the aforementioned parties depend on one SGW, such as SGW 1160. In this example, UT 1380 requests an MM session with UTs 1400 and 1420 initially, and then adds UT 1450 during the call. UT 1380 is thus the “calling party”. UT 1400 is “called party 1”, UT 1450 is “called party 2”, and UT 1420 is “called party 3.” In one implementation, UT 1360 is the “meeting informer.” The “calling party MX” here refers to MX 1180. In addition, the “MM server system” refers to a dedicated server system that manages MM sessions. In particular, the MM server system can be call processing server system 12010 that resides in server group 10010 of SGW 1160 (FIG. 12). The following discussions primarily explain how these parties interact with one another in four stages of an MM session: called party member establishment, call setup, call communication, and call clear-up.

6.3.1.1 Called Party Member Establishment

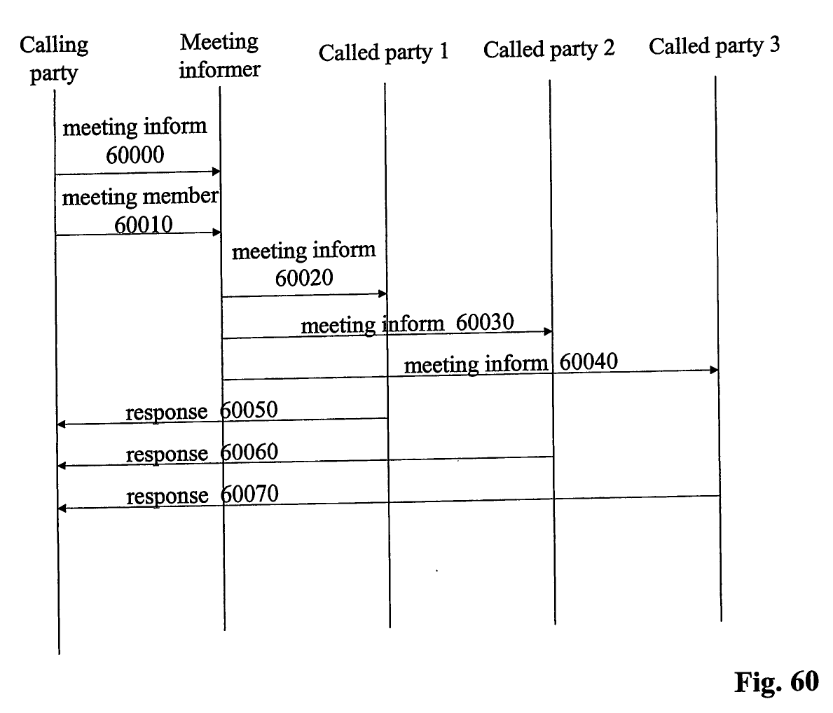

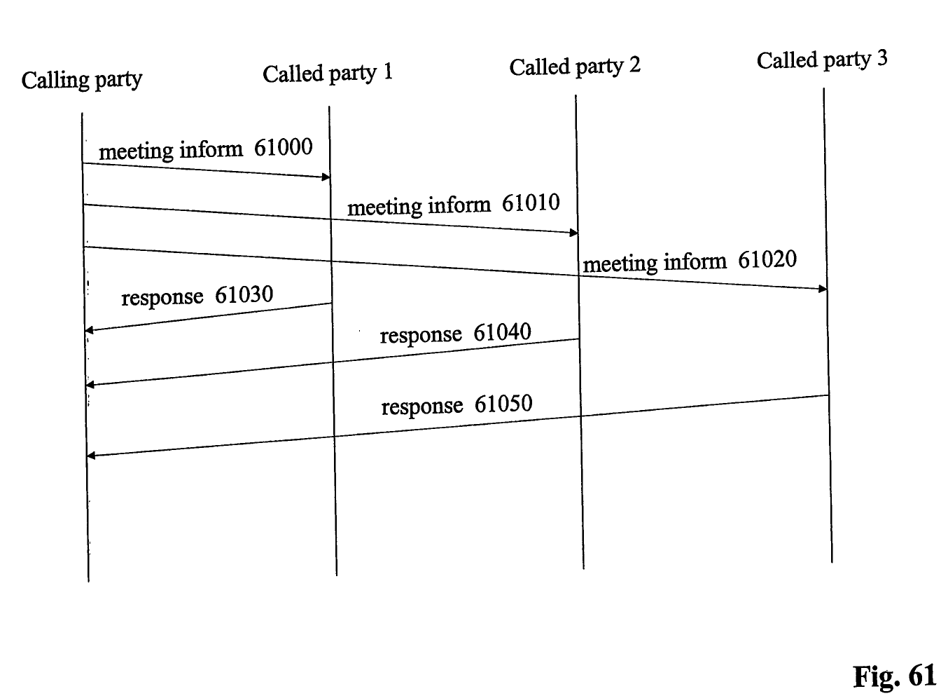

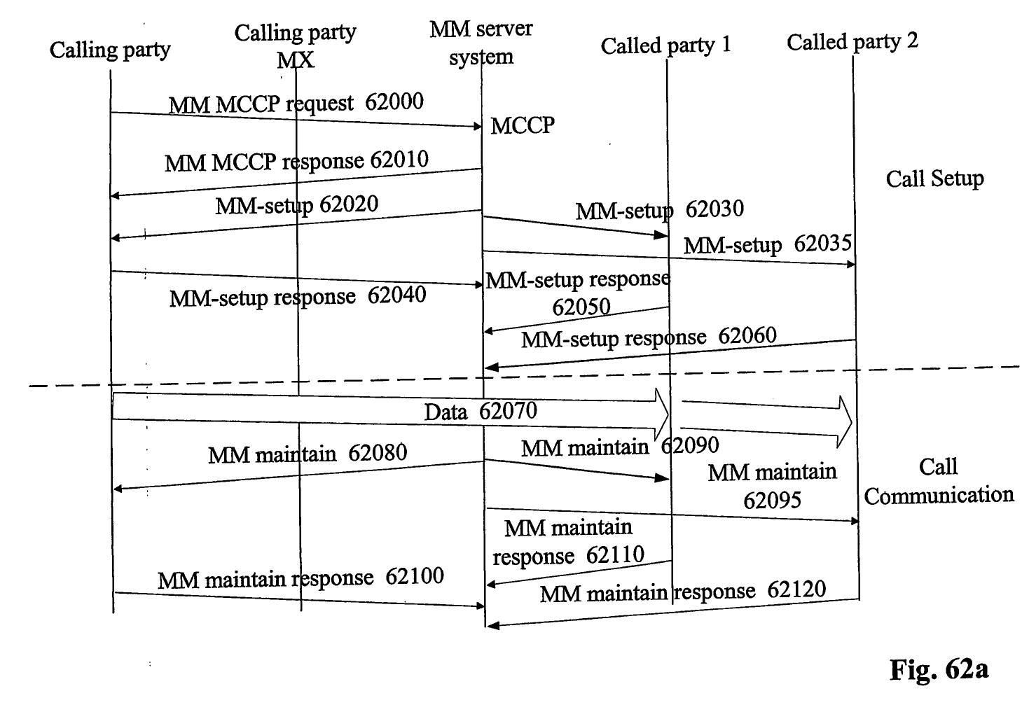

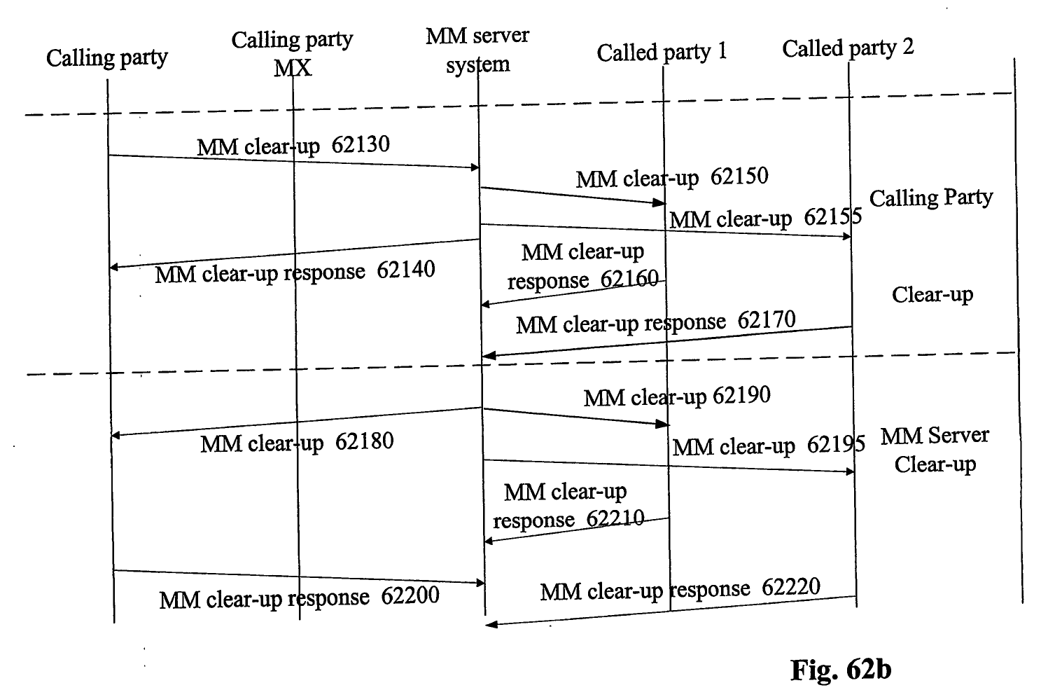

FIGS. 61 and 62 illustrate two ways to establish the membership of the called parties in an MM session. One implementation involves a meeting informer (FIG. 60), and the other does not (FIG. 61).

According to FIG. 60:
1. The calling party sends relevant meeting information (e.g., time, topic and subject matter of the meeting) in meeting inform 60000 and a list of the invited called parties (e.g., the user addresses of the invited called parties) in meeting member 60010 to the meeting informer. Meeting inform 60000 and meeting member 60010 are both MP control packets.
2. The meeting informer sends the user addresses to server group 10010 to obtain the corresponding network addresses.
3. Based on the network addresses of the invited called parties, the meeting informer distributes the information in meeting inform 60000 to the invited called parties via meeting inform packets 60020, 60030 and 60040.
4. The invited called parties can either agree to join the MM session or reject the invitation via responses 60050, 60060 and 60070. These responses are also MP control packets.

Alternatively, FIG. 61 illustrates the process of establishing the membership of the called parties in an MM session without involving a meeting informer. In particular:
1. The calling party sends meeting inform packets 61000, 61010 and 61020, which are MP control packets, to the invited called parties.
2. The invited called parties respond with response packets 61030, 61040 and 61050, which are also MP control packets, back to the calling party to indicate their intentions to participate in the MM session.

Though two membership establishment processes have been discussed, it will be apparent to one of ordinary skill in the art to use other mechanisms to set up the called party membership in an MP network. For instance, the membership can be established of fine via means such as, without limitation, telephone, telegram, facsimile and face-to-face conversation.

6.3.1.2 Call Setup

FIGS. 62a and 62b illustrate one call setup process for establishing an MM session. Specifically:
1. The calling party, such as UT 1380, sends MM MCCP request 62000 to MM server system via calling party MX, such as MX 1180.
2. In response, the MM server system performs the requested MCCP, which is discussed in the Server Group section above and also discussed in subsequent paragraphs, to determine whether to allow the calling party to proceed further and returns the MCCP outcome to the calling party via MM MCCP response 62010. Both MM MCCP request 62000 and MM MCCP response 62010 are MP control packets.
3. The MM server system sends MM setup packets 62020, 62030 and 62035, which are MP control packets that contain the network addresses of the called parties in DA field 5010 of the packets and a reserved session number in payload field 5050 as shown in FIG. 5. Packet 62020 goes to the calling party via the EX in SGW 1160 and MX 1180. Packets 62030 and 62035 go to called parties 1 and 2 via the EX in SGW 1160 and either MX 1180 (for UT 1400) or MX 1240 (for UT 1450).
4. After receiving MM setup packets 62020, 62030 and 62035, the EX in SGW 1160, the calling party MX, such as MX 1180, and MX 1240 update their LTs according to the color information as discussed in the Edge Switch section and the Middle Switch section above. The MXs further forward the packets to the HGWs, such as HGW 1200 and 1260, according to the partial address information in the packets.
5. When the calling party MX, such as MX 1180, receives the MM-setup packet 62020, it also sets up its ULPF as discussed in the Middle Switch section above.
6. The calling party and the called parties respond to the MM-setup packets with MM-setup responses 62040, 62050 and 62060.

Also, it should be noted that if MM MCCP response packet 62010 indicates a failure of the requested operation, the MM session would terminate without any further processing. On the other hand, if MM MCCP response packet 62010 indicates that the requested operation is approved but one of the MM setup responses 62040, 62050 and 62060 indicates a setup failure, the MM session would continue absent the party that indicates the setup failure. Alternatively, if the MM session requires all parties to be present and if one of the mentioned response packets indicates a setup failure, then the MM session would terminate without any further processing.

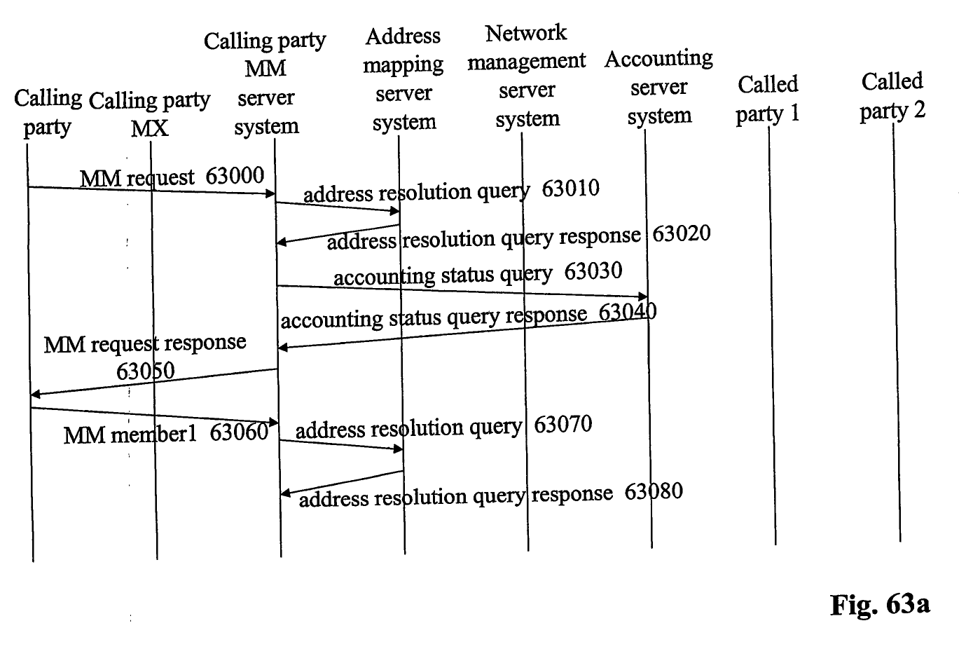

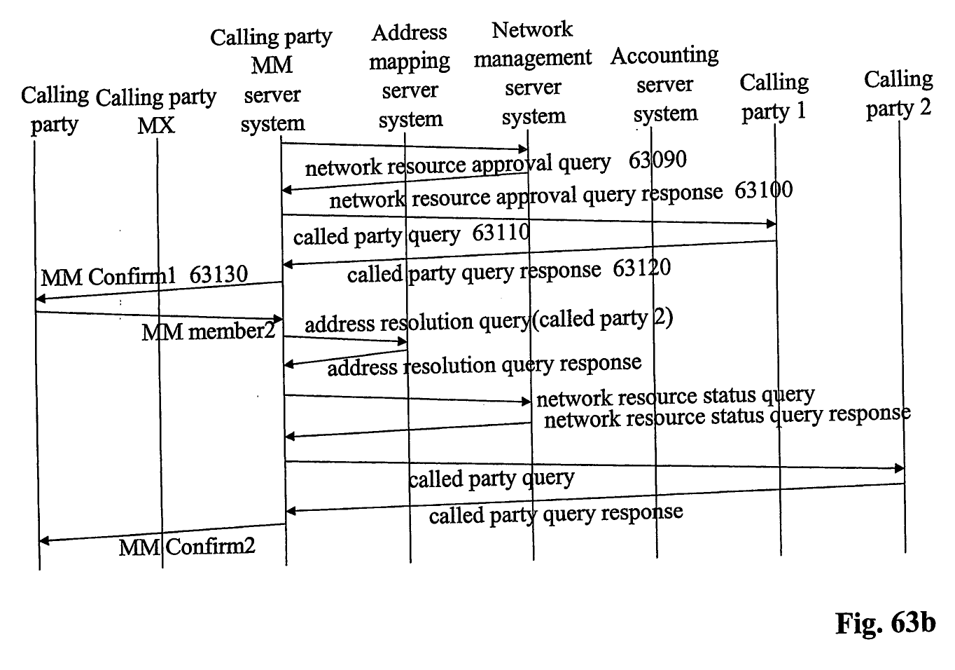

FIGS. 63a and 63b illustrate one MCCP procedure that involves multiple server systems in a server group of an SGW, such as calling party MM server system (e.g., call processing server system 12010 (FIG. 12) that is dedicated to MM operations), address mapping server system (e.g., address mapping server system 12020), network management server system (e.g., network management server system 12030) and accounting server system (e.g., accounting server system 12040).
1. The calling party sends MM request 63000 to the calling party MM server system. Because the MM session takes place under one SGW, such as SGW 1160, the calling party MM server system also serves the called parties. MM request 63000, which is an MP control packet, contains the user address of the payer of the MM session and the network addresses of the calling party and the MM server system. The calling party learns of its own network address and the network address of the calling party MM server system through NIDP as discussed in the Server Group section.
2. After receiving MM request 63000 from the calling party, the calling party MM server system sends address resolution query 63010, which contains the user address of the payer and the network address of the address mapping server system, to the address mapping server system. The calling party MM server system obtains the network address of the address mapping server system also via NIDP.
3. The address mapping server system maps the user address of the payer to the network address of the payer and returns the network address of the payer to the calling party MM server system via address resolution query response 63020.
4. The calling party MM server system sends accounting status query 63030, which contains the network addresses of the payer and the accounting server system, to the accounting server system.
5. The accounting server system responds to the calling party MM server system with the accounting status of the payer via accounting status query response 63040.
6. The calling party MM server system sends MM request response 63050 to the calling party. In one implementation, this response informs the calling party whether or not to proceed with the MM session.
7. If the calling party is allowed to proceed, the calling party sends MM member 1 63060, which contains the user address of called party 1, to the calling party MM server system.
8. The calling party MM server system sends address resolution query 63070, which contains the user address of called party 1, to the address mapping server system.
9. The address mapping server system returns the network address of called party 1 via address resolution query response 63080.
10. The calling party MM server system sends network resource approval query 63090, which contains the network addresses of called party 1 and called party 2, to the network management server system.
11. Based on the resource information that the network management server system has, the network management server system either approves or disapproves the calling party's request to establish an MM session with called party 1 and called party 2. Also, one embodiment of the network management server system maintains a pool of available session numbers to assign to a requested MM session among the UTs that it governs. Specifically, if the network management server system assigns a particular session number to the requested MM session, the assigned number becomes “reserved” and becomes unavailable until the requested MM session is terminated. The network management server system sends its call admission determination and its reserved session number to the calling party MM server system via network resource approval query response 63100.
12. If the network management server system approves the calling party's request, the calling party MM server system sends called party query 63110 to called party 1.
13. Called party 1 responds to the calling party MM server system with called party query response 63120. In one implementation, this query response informs the calling party MM server system of the participation status of called party 1.
14. The calling party MM server system then passes along the response of called party 1 to the calling party via MM confirm 1 63130.
15. For multiple called parties, such as called party 2, steps 7-14 discussed above are repeated.

The aforementioned MCCP terminates automatically if certain conditions fail. For example, if the accounting status of the payer is not available, the calling party MM server system informs the calling party and effectively terminates MCCP. It will be apparent to a person with ordinary skills in the art to implement the discussed MCCP without the specific details and yet still remain within the scope of the disclosed MCCP technologies. Also, although a network management server system is responsible for reserving session numbers in the preceding discussions, it will be apparent to a person of ordinary skill in the art to use other server systems (e.g., a call processing server system) to carry out the session number reservation tasks without exceeding the scope of the disclosed MP MM technologies.

6.3.1.3 Call Communication

FIG. 62a illustrates an exemplary call communication process in an MM session. Specifically:
1. The calling party, such as UT 1380, sends data 62070, which are MP data packets, to the called parties, such as UT 1400, UT 1420 and UT 1450. In one implementation, these packets contain the same DAs, because the network addresses used during the call communication stage of an MM session follow the network address format as shown in FIG. 9c. More particularly, because these MP data packets travel within an MP metro network, such as MP metro network 1000, data type subfield 9220, MP subfield 9230, nation subfield 9240 and city 9250 in these data packets contain the same information. In addition, since each multicast session corresponds to a session number and the data packets in the same multicast session correspond to one color information (i.e., MM data color), session number subfield and general color subfield 6090 in these data packets also contain the same information.
2. The calling party MX, such as MX 1180, then performs the ULPF checks, which are detailed in the Middle Switch section above, on these data packets.
3. If a data packet fails any of the ULPF checks, the calling party MX discards the packet. Alternatively, the MX calling party MX may forward the packet to a designated UT to track the transmission failure rate from the calling party to the called parties.
4. During the transfer of data 62070, the MM server system occasionally sends MM maintain packets 62080, 62090 and 62095 to the calling party, called party 1 and called party 2, respectively. MM maintain packets 62080, 62090 and 62095 are MP control packets that contain the same DAs (i.e., the same partial address information and the same session number) as the MM setup packets 62020, 62030 and 62035, respectively.
5. As has been discussed in the Edge Switch, Middle Switch and User Switch sections above, the switches along the transmission path of the MM session update their LTs according to the MM maintain packets.
6. The calling party and the called parties respond to the MM maintain packets with MM maintain response packets 62100, 62110 and 62120, respectively. If any of these response packets indicates a failure or a rejection to the MM maintain packet, the party that indicates the failure or rejection shifts into the subsequently discussed clear-up stage of the MM session.
7. When the MM server system receives the first MM maintain response packet from the calling party, such as MM maintain response 62100, the MM server system begins to calculate accounting-related parameters of the MM session (e.g., traffic flow and duration of the MM session). In one implementation of a server group, either the MM server system or the network management server system can establish these accounting-related parameters and the associated policies for tracking the parameters
   In one implementation, if the number of missing MM maintain response packets from the calling party and the called parties exceed a pre-determined threshold, the MM server system shifts the MM session into the subsequently discussed call clear-up stage.

Although the above example illustrates half-duplex data communication from a calling party to multiple called parties in an MM session, it will be apparent to a person of ordinary skill in the art to use the discussed technologies to achieve full-duplex data communication in an MM session. In one embodiment, if one of the mentioned called parties wishes to transmit data to the other parties in the MM session, this called party can request another MM session and invite the same parties to participate. As a result, the calling party and the called party in effect achieve full-duplex data communication even though they transmit their data packets using different session numbers. Alternatively, true full-duplex (i.e., the calling party and the called parties can both transmit data simultaneously using the same session number) data communication can be achieved using procedures analogous to those illustrated in FIG. 62a and discussed above. However, to ensure that the security in full-duplex communication is not compromised, the MM server system sets up the ULPFs of both the calling party MX and the called party MXs.

During the call communication stage of an MM session, a new called party can be added to the session, an existing called party can be removed from the session and the identities of the participants in the session can be queried.

6.3.1.3.1 Adding a New Called Party

If a called party, such as called party 3, wants to join an existing MM session, the called party first informs the calling party. Then the calling party follows a process as shown in FIG. 64 to add called party 3 to the MM session. Specifically:
1. The calling party, such as UT 1380, sends MM member 64000 to the MM server system. MM member 64000 is an MP control packet, which indicates a request to add called party 3, such as UT 1420, and the user addresses of the payer of the MM session and called party 3.
2. The MM server system performs MCCP as shown in FIGS. 63a and 63b to determine whether to grant the calling party's request.
3. The MM server system responds with MM confirm 64010, which indicates the results of MCCP.
4. If the MM server system grants the calling party's request, the MM server system then sends MM setup packets 64020 and 64030 to the calling party via the calling party MX and to called party 3 via the called party 3 MX, respectively. The MM setup packets are MP control packets, which set up the LTs of the switches along the transmission path.
5. In response to MM setup packet 64020, the calling party MX, such as MX 1180, also performs ULPF setup.
6. In response to the MM setup packets, the calling party and called party 3 respond with MM setup response packets 64040 and 64050, respectively.

After adding called party 3, called party 3 begins to receive the MM data packets from the calling party.

6.3.1.3.2 Removing an Existing Called Party

If the calling party (e.g., UT 1380) wants to terminate the participation of a called party, such as called party 2 (e.g., UT 1450), in an ongoing MM session, an exemplary process for doing so is shown in FIG. 64. Specifically:
1. The calling party sends MM member 64060 to the MM server system. MM member 64060 is an MP control packet, which contains the user address of called party 2 and the request to remove called party 2. The MM server system either maintains the network address of called party 2 after setting up this ongoing MM session or obtains the network address by consulting with the address mapping server system.
2. The MM server system sends the calling party MM confirm 64070, which is an MP control packet that confirms the removal of called party 2 from the MM session. MM confirm 64070 also resets some parameters of the ULPF in the calling party MX (e.g., the ULPF does not filter based on the SA of called party 2).

After called party 2 is removed from the MM session, one embodiment of the MM server system stops sending MM maintain packets containing called party 2 information. As a result, the MP-compliant switches along the transmission reset the entries of their LTs that are associated with called party 2 back to some default values. For example, suppose cell 37000 of the LT in the calling party MX corresponds to the call status of called party 2. The LT resets cell 37000 back to its default value, 0.

If called party 2 instead requests its own removal, the removal process discussed above generally applies, except that called party 2 sends MM member 64060 to the MM server system instead.

6.3.1.3.3 Querying an MM Member

A called party in an ongoing MM session can query the MM server system about other members in the MM session during the call communication phase. Specifically:
1. Called party 1 sends MM member query 64080 to the MM server system to determine whether another party, such as called party 2, is a member of the MM session. MM member query 64080 is an MP control packet, which contains the user address of called party 2.
2. The MM server system then responds with the MM member query response 64090, which is also an MP control packet that contains an answer to the query. In one embodiment, the MM server system searches through a table that contains status information of called party 2 (e.g., membership information of called party 2 in an ongoing MM session) for the answer. If the table is organized using the network address of called party 2, the MM server system consults with an address mapping server system to obtain the network address of called party 2 before searching through the table. On the other hand, if the table is organized using the user address of called party 2, the MM server system can use the user address of called party 2 to search through the table.
   6.3.1.4 Call Clear-Up

The calling party or the MM server system can initiate call clear-up. FIG. 62b illustrate exemplary processes that the calling party and the server system follow:

6.3.1.4.1 Calling Party Initiated Call Clear-Up

1. The calling party, such as UT 1380, sends MM clear-up 62130 to the MM server system, which resides in the server group of SGW 1160.
2. The MM server system then stops collecting usage information for the session (e.g., the duration or the traffic of the session) and reports the collected usage information to a local accounting server system, such as accounting server system 12040 in server group 10010 of SGW 1160 (FIG. 12).
3. The MM server system sends MM clear-up response 62140 via the calling party MX to the calling party and MM clear-up 62150 and 62155 to called parties 1 and 2 via the called party MX(s). MM clear-up response 62140 contains the color information that invokes the calling party MX, such as MX 1180, to perform ULPF clear-up as discussed in the Middle Switch section above.
4. In response to MM clear-up 62150 and 62155, the called parties send MM clear-up responses 62160 and 62170 to the MM server system.
5. In one embodiment, if the MP-compliant switches along the transmission path of an MM session do not receive the MM maintain packets after a predetermined amount of time, the entries in the LTs of the switches that are relevant to the MM session are reset back to their default values.
   6.3.1.4.2 MM Server System Initiated Call Clear-up
1. The MM server system sends MM clear-up 62180, 62190, and 62195 to the calling party, called party 1, and called party 2, respectively. Then the MM server system stops collecting usage information for the session (e.g., the duration or the traffic of the session) and reports the collected usage information to a local accounting server system, such as accounting server system 12040 of server group 10010 in SGW 1160 (FIG. 12).
2. MM clear-up 62180 is an MP control packet, which contains the color information that invokes the calling party MX, such as MX 1180, to perform the ULPF clear-up as discussed in the Middle Switch section above.
3. The calling party and the called parties respond to the MM clear-up packets with MM clear-up responses 62200, 62210 and 62220.
   6.3.2 MM Among Multiple MP-Compliant Components That Depend on Multiple Service Gateways

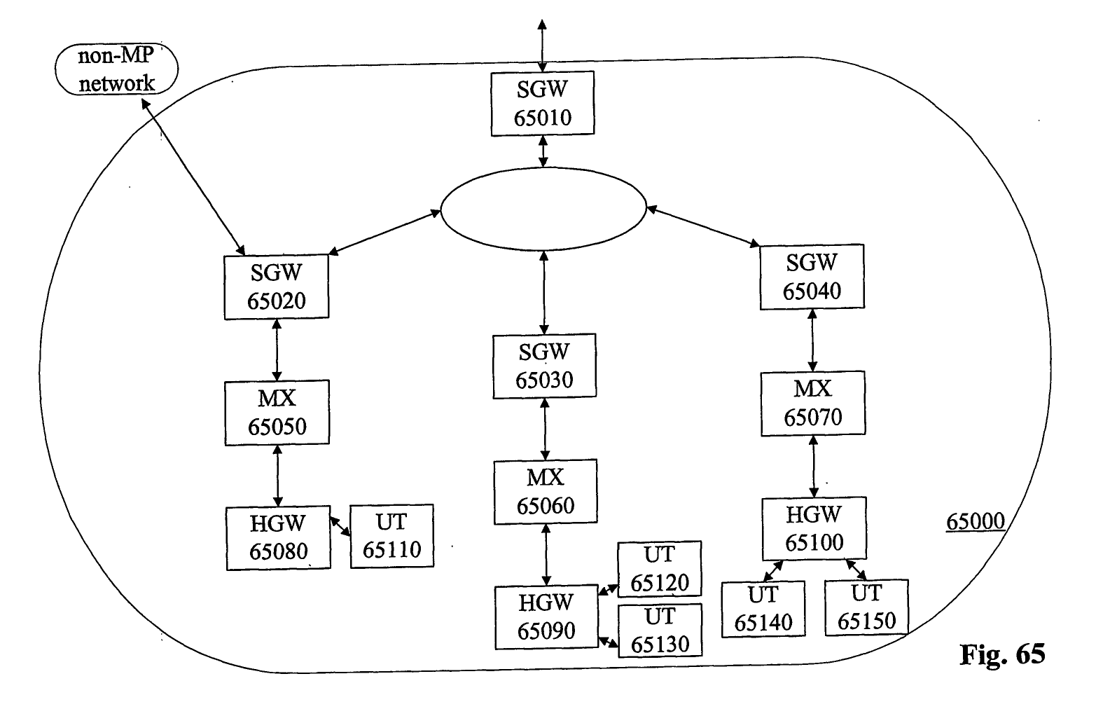

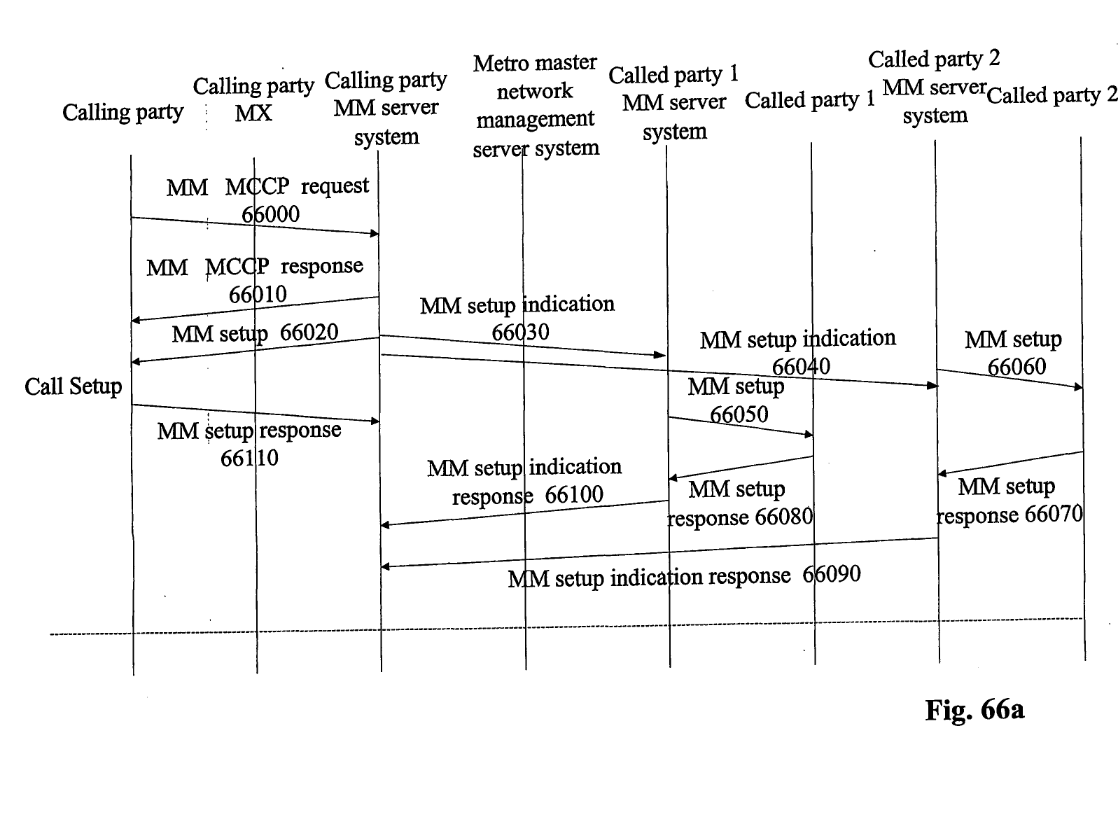

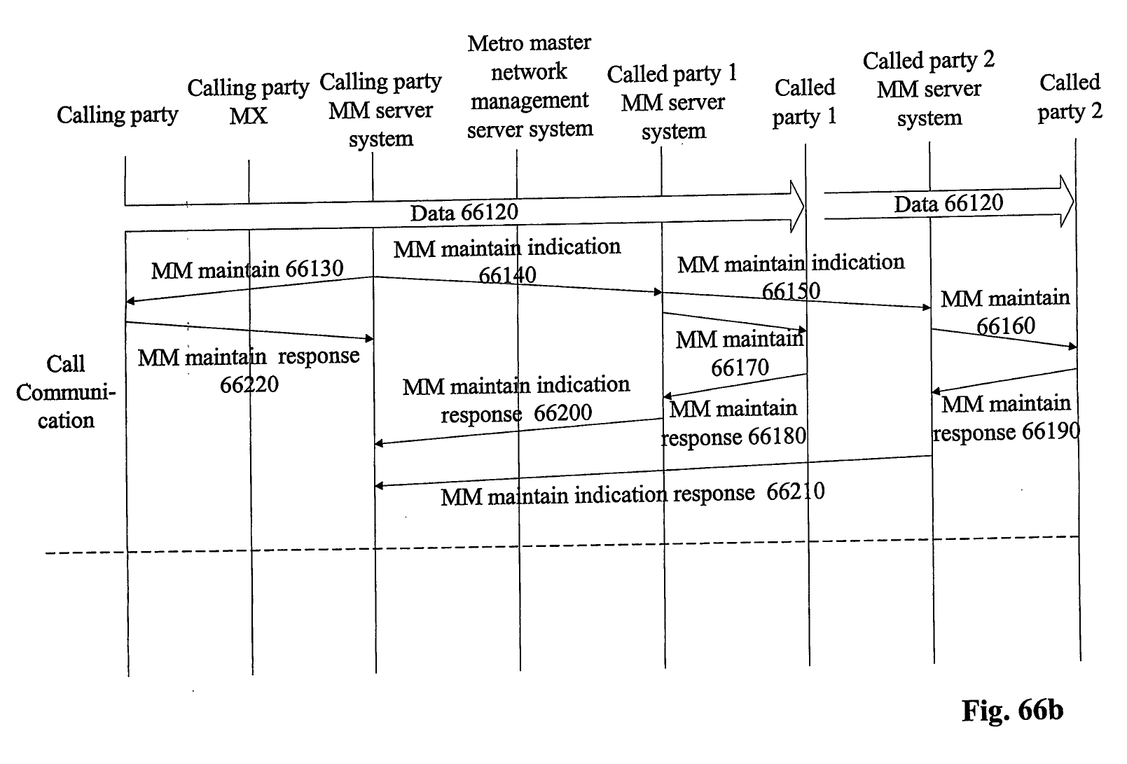

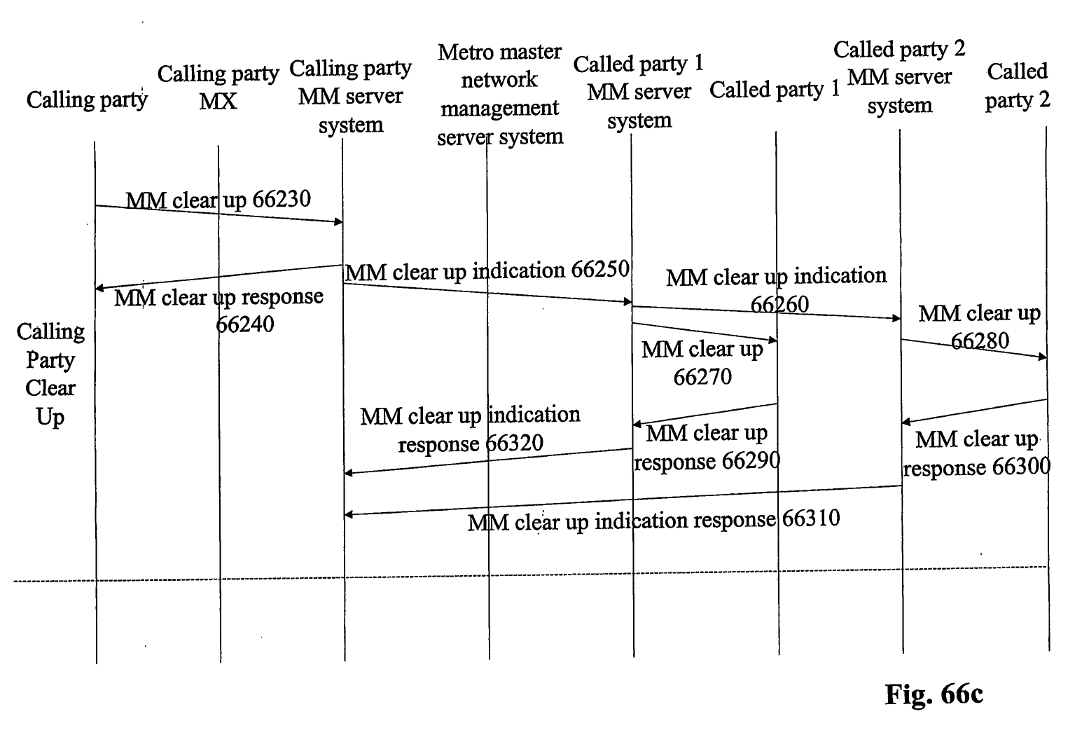

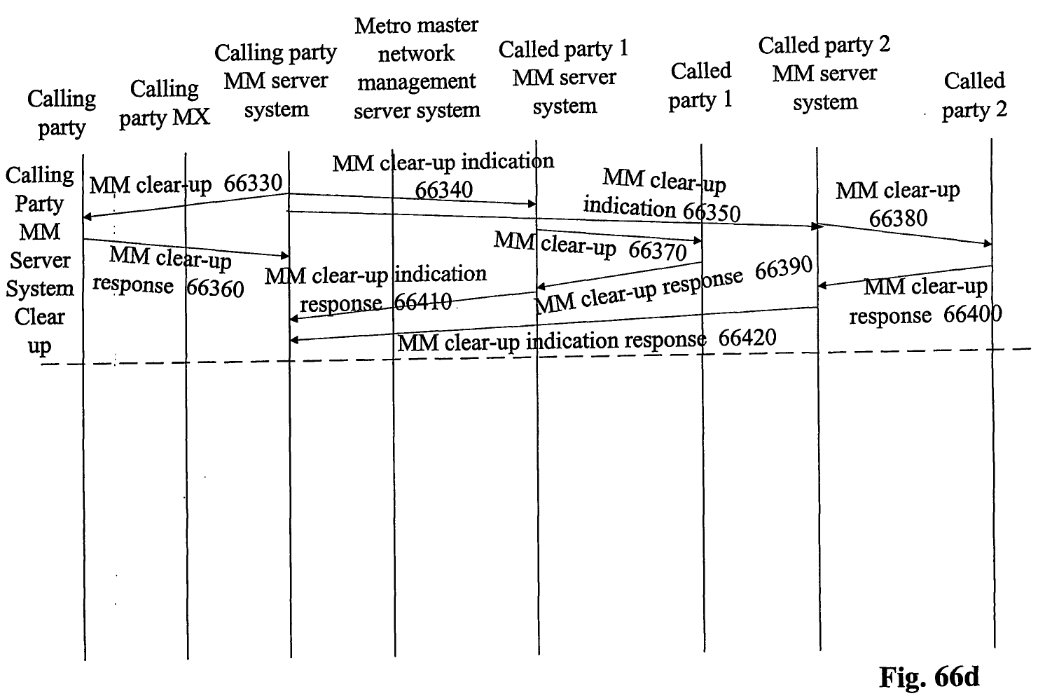

FIGS. 66a, 66b, 66c, and 66d illustrate time sequence diagrams of one MM session among multiple MP-compliant components that depend on multiple service gateways within an MP metro network For illustration purposes, UT 65110 that resides in MP metro network 65000 as shown in FIG. 65 initiates an MM session and is thus the “calling party”. UTs 65120, 65130, 65140, and 65150 are the “called parties.” For convenience, UT 65120 is referred to as “called party 1”, and UT 65140 is referred to as “called party 2”. MX 65050 is the “calling party Mx”.

Similar to call processing server system 12010 that resides in server group 10010 of SGW 1160, the call processing server system that resides in the server group of SGW 65020 is referred to as the “calling party call processing server system”. The call processing server systems that reside in SGW 65030 and SGW 65040 are the “called party 1 call processing server system” and the “called party 2 call processing server system”, respectively. When an SGW dedicates a call processing server system to manage MM sessions, the dedicated call processing server system is also referred to as the “MM server system”. In this implementation of MP metro network 65000; SGW 65020, SGW 65030 and SGW 65040 include a multiple number of dedicated server systems (e.g., MM server system, network management server system, address mapping server system, accounting server system) in their server groups.

In addition, assuming SGW 65020 serves as the metro master network manager for MP metro network 65000, the network management server system that resides in the server group of SGW 65020 is the metro master network management server system. The following discussions primarily explain how these components interact with one another in four stages of an MM session: called party member establishment, call setup, call communication and call clear-up.

6.3.2.1 Called Party Member Establishment

The procedures here are the same as the procedures discussed above for establishing the membership of the called parties that depend on a single service gateway. Moreover, as discussed in the Media Telephony Service section above, if an address mapping server system does not have the requisite address mapping information to map a user name or a user address to a network address, the address mapping server system consults with its metro master address mapping server system. If the metro master address mapping server system also lacks the requisite address mapping information, the metro master address mapping server system consults with its nationwide master address mapping server system. If the nationwide master address mapping server system still lacks the requisite address mapping information, the nationwide master address mapping server system consults with its global master address mapping server system.

6.3.2.2 Call Setup

NIDP

In an MM session that involves a number of UTs within a single SGW, the network management server system of the SGW is responsible for collecting and distributing relevant network information (e.g., the network addresses of individual server systems in the server group of the SGW and the participating UTs) to the UTs. This information collection and distribution procedure is referred to as “NIDP” and is further detailed in the Server Group section above.

On the other hand, for an MM session that involves multiple SGWs within an MP metro network, NIDP involves a metro master network management server system. Using MP metro network 65000 as shown in FIG. 65 as an illustration, the metro master network management server system that resides in SGW 65020 sends network resource query packets to other network management server systems in the MP metro network (e.g., network management server systems that reside in SGW 65030 and 65040). The queried network management server systems report the status of the network resources that they manage to the metro master network management server system.

The metro master network management server system also distributes selected information to carry out the MM session, such as, without limitation, the network addresses of the accounting server system, the address mapping server system, and the call processing server system in the metro master network manager (i.e., SGW 65020) and its own network address to the SGWs in MP metro network 65000 and the participants of the MM session.

Similarly, for an MM session that involves multiple SGWs that reside in different MP metro networks but within the same MP nationwide network, NIDP involves a nationwide master network management server system. Using MP nationwide network 2000 as shown in FIG. 2 as an illustration, the nationwide master-network management server system that resides in SGW 1020 sends network resource query packets to other network management server systems in the MP nationwide network (e.g., the network management server systems that reside in metro access SGWs 2050 and 2070 and also the network management server systems that reside in the metro master network managers of MP metro networks 1000, 2030 and 2040). The queried network management server systems report the status of the network resources that they manage to the nationwide master network management server system.

The nationwide master network management server system also distributes selected information to carry out the MM session, such as, without limitation, the network addresses of the accounting server system, the address mapping server system, and the call processing server system in the nationwide master network manager (i.e., SGW 1020) and its own network address to the SGWs in MP nationwide network 2000 and the participants of the MM session.

Moreover, for an MM session that involves multiple SGWs that reside in different MP nationwide networks, NIDP involves a global master network management server system. Using MP nationwide network 3000 as shown in FIG. 3 as an illustration, the global master network management server system that resides in SGW 2020 sends network resource query packets to other network management server systems in the MP global network (e.g., the network management server systems that reside in nationwide access SGWs 3040 and 3050 and also the network management server systems that reside in the metro nationwide network managers of MP nationwide networks 2000, 3030 and 3060). The queried network management server systems report the status of the network resources that they manage to the global master network management server system.

The global master network management server system also distributes selected information to carry out the MM session, such as, without limitation, the network addresses of the accounting server system, the address mapping server system, and the call processing server system in the global master network manager (i.e., SGW 2020) and its own network address to the SGWs in MP global network 3000 and the participants of the MM session.

MCCP

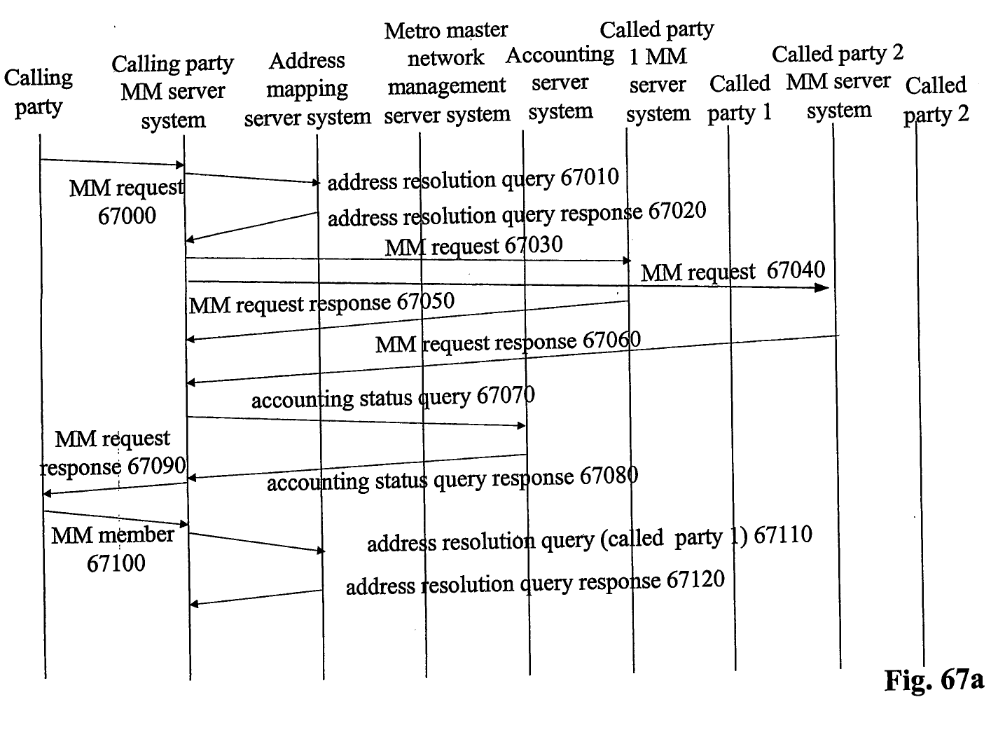

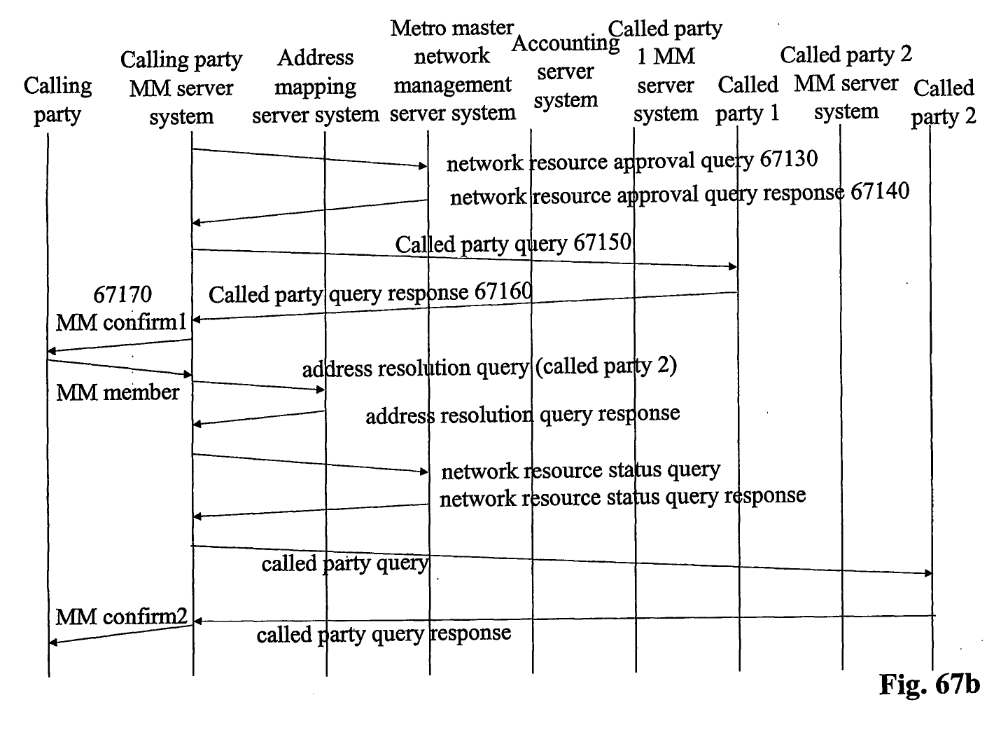

FIGS. 67a and 67b illustrate one process of MCCP that involves multiple SGWs within MP metro network 65000 in an MM session, such as SGW 65020, SGW 65030 and SGW 65040.
1. The calling party sends MM request 67000 to the calling party MM server system (e.g., the MM server system that resides in SGW 65020). MM request 67000 is an MP control packet, which contains the user addresses of the payer of the MM session and the called parties (e.g., UT 65120, UT 65130, UT 65140 and UT 65150) and the network addresses of the calling party (e.g., UT 65110) and the calling party MM server system. The calling party learns of its own network address and the network address of the calling party MM server system through NIDP as discussed above and in the Server Group section.
2. After receiving MM request 67000 from the calling party, the calling party MM server sends address resolution query 67010, which contains the user addresses of the payer, the called parties and the network address of the address mapping server system, to the address mapping server system. (The calling party MM server system previously obtains the network address of the address mapping server system, also via NIDP.)
3. The address mapping server system maps the user address of the payer to the network address of the payer and returns the network address of the payer to the calling party MM server system via address resolution query response 67020.
4. The calling party MM server system obtains the network addresses of called party 1 server system and called party 2 server system via NIDP and via the metro master network management server system as discussed above.
5. The calling party MM server system sends MM requests 67030 and 67040 to called party 1 MM server system and called party 2 MM server system, respectively.
6. After receiving the MM requests, the called party MM server systems check with their network manager server systems (i.e., the network management server systems that reside in SGW 65030 and SGW 65040) whether resources (e.g., bandwidth usage that SGW 65030 and SGW 65040 manage and monitor) are sufficient to carry out the requested MM session. Then, the called party 1 and called party 2 MM server systems respond with MM request responses 67050 and 67060, respectively.
7. Assuming the called party MM server systems have sufficient resources to carry out the requested MM session, the calling party MM server system then sends accounting status query 67070, which contains the network addresses of the payer and the accounting server system, to the accounting server system.
8. The accounting server system responds to the calling party MM server system with the accounting status of the payer via accounting status query response 67080.
9. The calling party MM server system sends MM request response 67090 to the calling party. In one implementation, this response informs the calling party whether it can proceed with the MM session.
10. If the calling party is allowed to proceed, the calling party sends MM member 1 67100, which contains the user address of called party 1, to the calling party MM server system. The calling party learns of the user address of called party 1 in the aforementioned called party member establishment phase.
11. The calling party MM server system sends address resolution query 67110, which contains the user address of called party 1, to the address mapping server system.
12. The address mapping server system returns the network address of called party 1 via address resolution query response 67120.
13. The calling party MM server system sends network resource approval query 67130, which contains the network addresses of called party 1 and called party 2, to the calling party network management server system, which is also the metro master network management server system in this example.
14. Based on the resource information that the metro master network management server system has, the metro master network management server system either approves or disapproves the calling party's request to establish an MM session with called party 1 and called party 2. Also, one embodiment of the metro master network management server system maintains a pool of available session numbers to assign to a requested MM session among the SGWs that it governs. Specifically, if the metro master network management server system assigns a particular session number to the requested MM session, the assigned number becomes “reserved” and becomes unavailable until the requested MM session is terminated. The metro master network management server system sends its call admission determination and its reserved session number to the calling party MM server system via network resource approval query response 67140.
15. If the metro master network management server system approves the calling party's request, the calling party MM server system sends called party query 67150 to called party 1.
16. Called party 1 responds to the calling party MM server system with called party query response 67160. In one implementation, this query response informs the calling party MM server system of the participation status of called party 1.
17. The calling party MM server system then passes along the response of called party 1 to the calling party via MM confirm 1 67170.
18. For multiple called parties, such as called party 2, steps 10-17 discussed above are repeated.

Although the preceding discussions generally also apply to MM sessions that involve SGWs residing in different MP metro networks (but within the same MP nationwide network) or involve SGWs residing in different MP nationwide networks, the MCCP procedures for such inter-MP-metro-network or inter-MP-nationwide-network MM sessions may involve additional steps. As discussed in the Media Telephony Service section above, if the metro master network management server system lacks the requisite resource information to approve or disapprove the requested service and/or lacks the authority to reserve a session number, the metro master network management server system consults with the nationwide master network management server system. If the nationwide master network management server system still lacks the requisite resource information and/or authority, the master network management server system consults with the global master network management server system.

The aforementioned MCCP terminates automatically if certain conditions fail. For example, if the accounting status of the payer is not available, the calling party MM server system informs the calling party and effectively terminates MCCP. It will be apparent to a person of ordinary skill in the art to implement the discussed MCCP without the specific details and yet still remain within the scope of the disclosed MCCP technologies. Also, although a network management server system is responsible for reserving session numbers in the preceding discussions, it will be apparent to a person of ordinary skill in the art to use other server systems (e.g., a call processing server system) to carry out the session number reservation tasks without exceeding the scope of the disclosed MP MM technologies.

For clarity, the subsequent call setup section condenses the MCCP procedure discussed above to two stages in FIG. 66a: the calling party sends MM MCCP request 66000 to the calling party MM server system, and the calling party MM server system responds with MM MCCP response 66010 to the calling party.

FIG. 66a illustrates one call setup process for establishing an MM session among multiple SGWs. Specifically:
1. The calling party, such as 65110 as shown in FIG. 65, sends MM MCCP request 66000 to MM server system in an SGW, such as SGW 65020, via calling party MX, such as MX 65050.
2. In response, the MM server system performs the requested MCCP, which is discussed above and in the Server Group section, to determine whether to allow the calling party to proceed further and returns the MCCP outcome to the calling party via MM MCCP response 66010. Both MM MCCP request 66000 and MM MCCP response 66010 are MP control packets.
3. The calling party MM server system sends MM setup packet 66020 (via calling party MX 65050), MM setup indication 66030 (via the EX in SGW 65020 and called party 1 MM server system) and MM setup indication 66040 (via called party 2 MM server system) to the calling party, called party 1 MM server system and called party 2 MM server system, respectively. MM setup packet 66020 and MM setup indication 66030 and 66040 are MP control packets. The MM setup packet contains the network address of the calling party in DA field 5010 of the packet and the reserved session number in payload field 5050 as shown in FIG. 5. On the other hand, the MM setup indication packet contains the network address of the called party MM server system in DA field 5010 of the packet and the network address of the called parties and the reserved session number in payload field 5050.
4. After receiving MM setup packet 66020, the EX in SGW 65020 and the calling party MX, such as MX 65020, update their LTs according to the color information and the partial address information in the packet, as discussed in the Edge Switch section and the Middle Switch section above. The MX further forwards the MM setup packet to the HGWs, such as HGW 65080, according to the color information and the partial address information in the packets.
5. After receiving MM setup indications 66030 and 66040, the called party MM server systems send MM setup packets 66050 and 66060 to the called parties.
6. For MM setup packets 66050 and 66060 that the called party MM server systems send to the called parties, the EXs in SGW 65030 and SGW 65040 and the MXs, such as MX 65060 and 65070, and the UXs in the HGWs, such as HGW 65090 and 65100, update their LTs according to the color information and the partial address information in the MM setup packets.
7. In response to the MM setup packets, called party 1 and called party 2 send MM setup response packets 66080 and 66070, respectively, to their MM server systems.
8. The called party MM server systems then sends MM setup indication responses 66090 and 66100, which are MP control packets that indicate the participation status (e.g., whether the called parties are available) of the called parties, to the calling party MM server system.
9. When the calling party MX, such as MX 65050, receives the MM setup packet 66020, it also sets up its ULPF as discussed in the Middle Switch section above.
10. The calling party responds to the MM setup packet with MM setup response packet 66110.

Also, it should be noted that if response packet 66010 indicates a failure of the requested operation, the MM session would terminate without any further processing. On the other hand, if response packet 66010 indicates that the requested operation is approved but one of 66070, 66080, 66090 and 66100 indicates a setup failure, the MM session would continue absent the party that indicates the setup failure. Alternatively, if the MM session requires all parties to be present and if one of the mentioned response packets indicates a setup failure, then the MM session would terminate without any further processing.

6.3.2.3 Call Communication

FIG. 66b illustrates an exemplary call communication process among three SGWs within an MP metro network in an MM session. Specifically:
1. The calling party, such as UT 65110, sends data 66120, which are MP data packets, to called party 1 and called party 2, such as UT 65120 and 65140.
2. The calling party MX, such as MX 65050, performs the ULPF checks as described in the Middle Switch section above, on these data packets.
3. If a data packet fails any of the ULPF checks, the calling party MX discards the packet. Alternatively, the MX calling party MX may forward the packet to a designated UT to track the transmission failure rate from the calling party to the called parties.
4. In one implementation, when data 66120 arrive at the EX of SGW 65030 or SGW 65040, the EX may change the session number in DA field 5010 of these data packets before forwarding the data packets towards their destinations. The possible session number change is discussed in the Edge Switch section.
5. During the transfer of data 66120, the calling party MM server system occasionally sends MM maintain 66130 to the calling party and MM maintain indications 66140 and 66150 to the called party 1 MM server system and the called party 2 MM server system, respectively. MM maintain 66130 and MM maintain indications 66140 and 66150 are MP control packets, which contain the same DAs as the MM setup packet 66020 and MM setup indications 66030 and 66040, respectively.
6. As has been discussed in the Edge Switch, Middle Switch and User Switch sections above, after receiving the MM maintain packets, the switches along the transmission path of the MM session either preserve or update their LTs to ensure that the call communication process of the MM session continues.
7. When the MM maintain indication packets come to the called party MM server systems, these server systems further send out MM maintain 66170 and 66160 to called party 1 and called party 2, respectively.
8. The called parties respond by sending MM maintain responses 66180 and 66190 back to their respective called party MM server systems.
9. The called party MM server systems then send MM maintain indication responses 66200 and 66210 to the calling party MM server system. If any of these responses indicates a failure or a rejection to the MM maintain packet, the party that indicates the failure or rejection shifts into the subsequently discussed clear-up stage of the MM session.
10. When the calling party MM server system receives the first MM maintain response packet from the calling party, such as MM maintain response 66220, the calling party MM server system begins to measure usage parameters of the MM session (e.g., traffic flow and duration of the MM session). In one implementation of a server group, either the MM server system or the network management server system can establish these accounting-related parameters and the associated policies for tracking the parameters.
11. In one implementation, if the number of missing MM maintain response packets from the calling party and the called parties exceed a pre-determined threshold, the calling party MM server system shifts the MM session into the subsequently discussed call clear-up stage.

The preceding description of the call communication of an MM session among multiple SGWs within an MP metro network also applies to MM sessions that involve SGWs that reside in different MP metro networks (but within the same MP nationwide network) and/or different MP nationwide networks.

Although the above example illustrates half-duplex data communication in an MM session, it will be apparent to a person of ordinary skill in the art to use the discussed technologies to achieve full-duplex data communication in an MM session. In one embodiment, if one of the mentioned called parties wishes to transmit data to the other parties in the MM session, this called party can request another MM session and invite the same parties to participate. As a result, the calling party and the called party in effect achieve full-duplex data communication even though they transmit their data packets using different session numbers. Alternatively, true full-duplex (i.e., the calling party and the called parties can both transmit data simultaneously using the same session number) data communication can be achieved using procedures analogous to those illustrated in FIG. 66b and discussed above. However, to ensure that the security in full-duplex communication is not compromised, the MM server system sets up the ULPFs of both the calling party MX and the called party MXs.

During the call communication stage of an MM session, a new called party can be added to the session, an existing called party can be removed from the session, and/or the identities of the participants in the session can be queried. These procedures in an MM session that involves multiple SGWs are analogous to the procedures discussed above for an MM session that involves a single SGW and need not be repeated here.

6.3.2.4 Call Clear-Up

The calling party and the MM server system can initiate call clear-up. FIGS. 66c and 66d illustrate exemplary processes that the calling party and the MM server system follow:

6.3.2.4.1 Calling Party Initiated Call Clear-Up

1. The calling party, such as UT 65110, sends MM clear-up 66230 to the calling party MM server system, which resides in the server group of SGW 65020.
2. The calling party MM server system stops collecting usage information for the session (e.g., the duration or the traffic of the session) and reports the collected usage information to a local accounting server system, such as the accounting server system that resides in the server group of SGW 65020.
3. The calling party MM server system sends MM clear-up response 66240 to the calling party and MM clear-up indications 66250 and 66260 to the called party MM server systems. MM clear-up response 66240 contains the color information that invokes the calling party MX, such as MX 65050, to perform ULPF clear-up as discussed in the Middle Switch section above.
4. In response to the MM clear-up indications, the called party MM server systems send MM clear-up 66270 and 66280 to called party 1 and called party 2, respectively.
5. The called parties then respond by sending MM clear-up responses 66290 and 66300 back to their respective MM server systems. The called party MM server systems then inform the calling party MM server system of the status of the called parties' clear-up process via MM clear-up indication responses 66310 and 66320.
6. In one embodiment, because the MP-compliant switches along the transmission path of an MM session do not receive the MM maintain packets for a predetermined amount of time, the entries in the LTs of the switches that are used in the MM session are reset back to their default values.
   6.3.2.4.2 MM Server System Initiated Call Clear-Up
1. The calling party MM server system sends MM clear up 66330 to the calling party and sends the MM clear up indications 66340 and 66350 to called party 1 and called party 2 MM server systems, respectively. Also, the calling party MM server system stops collecting usage information for the session (e.g., the duration or the traffic of the session) and reports the collected usage information to a local accounting server system, such as the accounting server system that resides in the server group of SGW 65020.
2. MM clear-up 66330, an MP control packet, contains color information that invokes the calling party MX, such as MX 65050, to perform the ULPF clear-up as discussed in the Middle Switch section above.
3. In response to MM clear-up 66330, the calling party sends MM clear up response 66360 to the calling party MM server system.
4. When the called party MM server systems receive the MM clear-up indication packets, the server systems release the allocated resources for the MM session (e.g., make the session number available for subsequent MM sessions) and send MM clear-up's 66370 and 66380 to called party 1 and called party 2, respectively.
5. In response, the called parties send MM clear up responses 66390 and 66400 to their respective MM server systems.
6. The called party MM server systems then inform the calling party MM server system of the status of the called parties' clear-up process via MM clear-up indication responses 66410 and 66420.
   6.4 Media Broadcast Service (“MB”)

The MB service is a type of multicast service that enables UTs to receive content from an MB program source. (See the Definitions section above.) An MB program source (either live or stored) can either reside in an MP network or non-MP network 1300 (FIG. 1(d)). An MB program source that resides in an MP network generates and transmits MP packets to the EXs of SGWs, whereas the MB program source that resides in non-MP network 1300 generates and transmits non-MP packets to SGW 1160. The gateway of SGW 1160 then places the non-MP packets in MP-encapsulated packets before forwarding the MP-encapsulated packets to the EX of SGW 1160. These MP packets and MP-encapsulated packets include color information that indicates the packets are MB packets.

One embodiment of a server group in an SGW includes an MB program source server system, which configures, inspects and manages the aforementioned MB program sources. For instance, the MB program source server system sends an error packet to the call processing server system of the server group when it detects errors from an MB program source. It will be apparent to a person of ordinary skill in the art to embed the functionality of the MB program source server system in the call processing server system without exceeding the scope of the disclosed MB technologies.

6.4.1 MB Between Two MP-Compliant Components That Depend on a Single Service Gateway

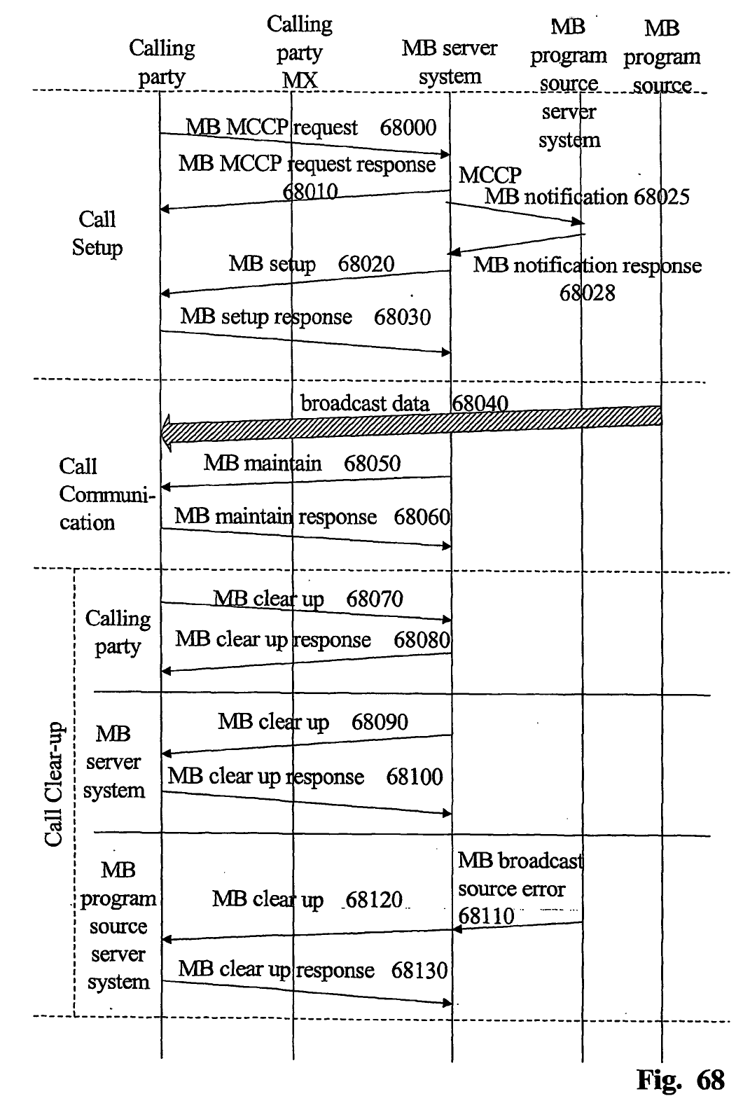

FIG. 68 illustrates a time sequence diagram of one session of MB between a UT and an MB program source within a single SGW, such as UT 1420 (FIG. 1d) and the SGW media storage (not shown in FIG. 10) in SGW 1160.

For illustration purposes, UT 1420 requests stored media programs from the SGW media storage. UT 1420 is thus the “calling party”, the SGW media storage is the “MB program source”, and the EX (i.e., EX 10000) in SGW 1160 is both the “calling party EX” and the “called party EX”. In this example, MX 1180 serves as both the “calling party MX” and the “called party Mx”. Call processing server system 12010, which resides in server group 10010 of SGW 1160 (FIG. 12), manages packet exchanges between the calling party and the MB program source. The “MB server system” refers to a dedicated call processing server system that manages and carries out MB sessions.

The following discussions primarily explain how these parties interact with one another in three stages of an MB session: call setup, call communication and call clear-up.

6.4.1.1 Call Setup

1. The calling party, such as UT 1420, initiates a call by sending MB MCCP request 68000 to the MB server system via the EX in SGW 1160, such as EX 10000, and via the calling party MX, such as MX 1180. The MB MCCP request 68000 is an MP control packet, which includes the network addresses of the calling party and the MB server system and the user address of the MB program source. As discussed in the Logical Layer section above, a calling party typically does not know the network address of the MB program source. Instead, the calling party relies on the server group in an SGW to map a user address to a network address. In addition, the calling party and the MB program source acquire MP network information (e.g., the network address of the MB server system) for carrying out an MB session from network management server system 12030 of server group 10010 (FIG. 12) via the NIDP process as discussed in the Server Group section and the Media Multicast section above.
2. Upon receipt of the MB MCCP request 68000, the MB server system executes the MCCP procedures (discussed in the Server Group section and the Media Multicast section above) to determine whether to allow the calling party to proceed.
3. The MB server system acknowledges the request of the calling party by sending MB request response 68010 to the calling party via the calling party MX, which is an MP control packet that contains the result of the MCCP procedures.
4. If the result indicates that the MB server system can proceed with the requested MB session, the MB server system also notifies the MB program source server system via MB notification 68025.
5. The MB program source server system responds to the MB server system via MB notification response 68028.
6. The MB server system sends MB setup packet 68020 to the calling party via the calling party MX. MB setup packet 68020 is an MP control packet that contains the network addresses of the calling party and the MB program source and the allowed call traffic flow (e.g., bandwidth) of the requested MB session. Also, this packet includes a reserved session number and relevant color information (e.g., MB setup color), which directs the EX in SGW 1160, such as EX 10000, and calling party MX, such as MX 1180, and a UX in HGW 1200, to update their LTs. The process of updating an LT is detailed in the Edge Switch and the Middle Switch sections above. Further more, in one implementation, MB setup packet 68020 packet sets up the ULPF in EX 10000.
7. The calling party acknowledges MB setup packet 68020 by sending MB setup response packet 68030 back to the MB server system via the calling party MX. MB setup response packet 68030 is an MP control packet.
8. After the MB server system receives the MB setup response packet, it begins to collect usage information for the MB session (e.g., the duration or the traffic of the session).
   6.4.1.2 Call Communication
1. After setting up the LTs in the switches that are involved in the MB session, the calling party can begin to receive broadcast data 68040. Broadcast data 68040 are MP data packets, which include specific color information (which indicates the packets are MB-data-colored packets) and the reserved session number. In addition, the ULPF of the EX in SGW 1160, such as EX 10000, examines broadcast data 68040 before allowing these MP data packets to reach the calling party.
2. The MB server system sends MB maintain 68050 to the calling party occasionally during the call communication stage. MB maintain 68050 is an MP control packet, which one embodiment of the MB server system uses to manage the LTs. Alternatively, the MB server system may use the MB maintain packet to collect call connection status information (e.g., error rate and number of packets lost) of the calling party in an MB session.
3. The calling party acknowledges the MB maintain 68050 by sending MB maintain response 68060 to the MB server system via the calling party MX. MB maintain response 68060 is an MP control packet, which contains the requested call connection status information.
4. Based on MB maintain response 68060, the MB server system may repeat items 2 and 3 above from time to time. Otherwise, the MB server system may modify the MB session. For instance, if the error rate of the MB session exceeds a tolerable threshold, the MB server system may notify the calling party and terminate the session.
   6.4.1.3 Call Clear-Up

The calling party and the MB server system can initiate call clear-up. In addition, when the aforementioned MB program source server system detects errors from an MB program source, it notifies the MB server system to initiate call clear-up.

6.4.1.3.1 Calling Party Initiated Call Clear-Up

1. The calling party sends MB clear-up 68070, which is an MP control packet, to the MB server system via the calling party MX.
2. In response, the MB server system sends MB clear-up response 68080, which is also an MP control packet, to the calling party via the calling party MX. In addition, the MB server system stops collecting usage information for the session (e.g., the duration or the traffic of the session) and reports the collected usage information to a local accounting server system, such as accounting server system 12040 of server group 10010 in SGW 1160 (FIG. 12).
3. The switches that are involved in the MB session, such as MX 1180, reset their LTs when they receive MB clear-up response 68080.
4. When the calling party receives MB clear-up response 68080 from MB server system via the calling party MX, the calling party terminates its involvement in the MB session. Other calling parties that have set up a connection to the MB program source can continue to receive broadcast data 68040.
   6.4.1.3.2 MB Server System Initiated Call Clear-Up

One embodiment of the MB server system may initiate the call clear-up when it detects unacceptable communication conditions (e.g., excessive number of dropped packets, excessive error rate, or excessive number of missing MB maintain response packets).
1. The MB server system sends MB clear-up 68090, which is an MP control packet, to the calling party via the calling party MX. Also, the MB server system stops collecting usage information for the session (e.g., the duration or the traffic of the session) and reports the collected usage information to a local accounting server system, such as accounting server system 12040 of server group 10010 in SGW 1160 (FIG. 12).
2. The switches that are involved in the MB session, such as MX 1180, reset their LTs after they receive MB clear-up 68090.
3. Subsequently, the calling party sends back MB clear-up response 68100, which is also an MP control packet, to the MB server system via the calling party MX and effectively terminates this MB session for this calling party. Other calling parties that have set up a connection to the MB program source can continue to receive broadcast data 68040.
   6.4.1.3.3 MB Program Source Server System Initiated Call Clear-Up

When the MB program source server system detects unacceptable communication conditions (e.g., the MB program source power is off accidentally), it notifies the MB server system to terminate the MB session.
1. MB program source server system sends MB program source error 68110, which is an MP control packet that contains the network address of the MB program source and the error code generated by the MB program source, to the MB server system.
2. Subsequently, the MB server system follows the aforementioned process in the “MB server system initiates call clear-up” section above. Specifically, the MB server system sends MB clear-up 68120 to the calling party via the calling party MX, and the calling party responds with MB clear-up response 68130.
   6.4.2 MB Between Two MP-Compliant Components That Depend on Two Service Gateways

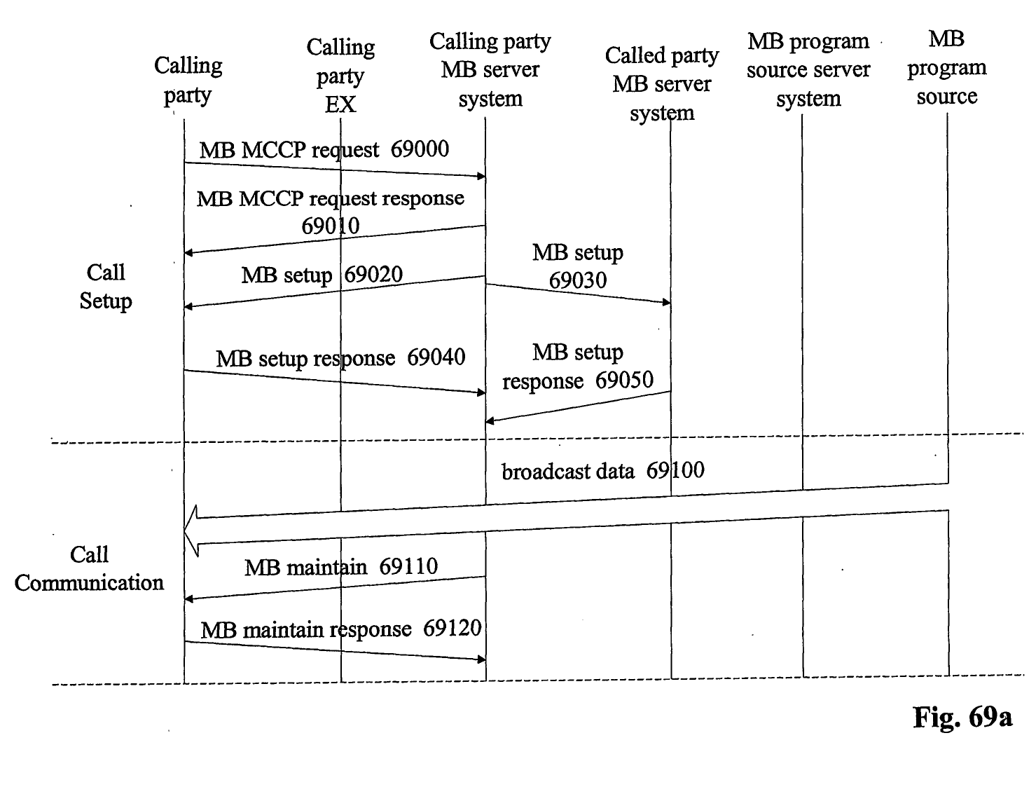

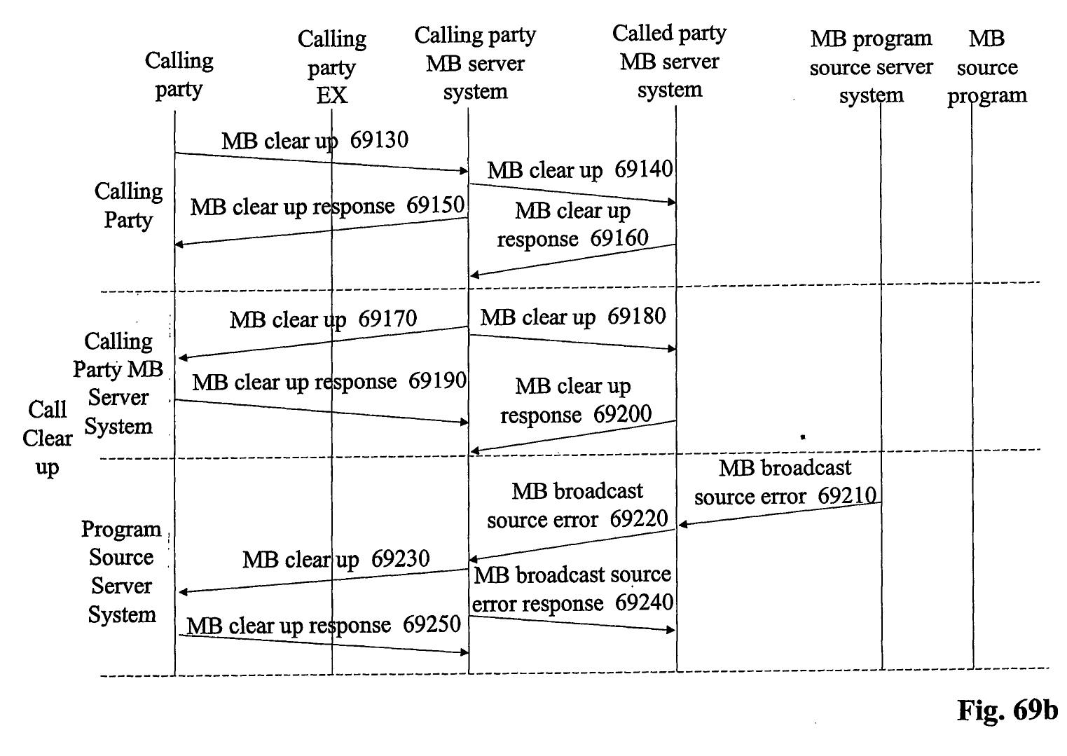

FIGS. 69a and 69b illustrate time sequence diagrams of one session of MB between a UT and an MB program source that involve two SGWs, such as UT 1320 as shown in FIG. 1d and the SGW media storage (not shown in FIG. 10) in SGW 1160. For illustration purposes, UT 1320 requests media programs from the SGW media storage. UT 1320 is thus the “calling party”, and the SGW media storage is the “MB program source” or the “called party”. The EX in SGW 1060 is the “calling party EX”, and MX 1080 is the “calling party Mx”. The EX in SGW 1160 is the “called party EX”, and MX 1180 is the “called party MX”. The call processing server system that resides in the server group of SGW 1060 is referred to as the “calling party call processing server system”, and the call processing server system that resides in SGW 1160 is the “called party call processing server system”. When an SGW dedicates a call processing server system to manage and carry out MB sessions, the dedicated call processing server system is referred to as an “MB server system”. The MB program source server system that also resides in the server group of SGW 1060 configures, inspects and manages the MB program source discussed above.

As noted above, the functionality of the called party MB server system may combine with the functionality of the MB program source server system. However, it should be noted that the two server systems have different functions. For example, when the requested MB service ends after the MB call clear-up stage, one embodiment of the called party MB server system terminates its involvement in the requested MB session and may remain idle until it receives another MB service request. On the other hand, even when a particular MB session terminates for one user, one embodiment of the program source server system continues to manage the program source for other MB sessions that are still ongoing.

Although SGW 1160 serves as the metro master network manager for MP metro network 1000 in most of the examples in this disclosure, SGW 1060 is the metro master network manager for the example below. The network management server system that resides in server group of SGW 1060 is thus the metro master network management server system.

The following discussions primarily explain how these parties interact with one another in three stages of an MB session: call setup, call communication and call clear-up.

6.4.2.1 Call Setup

1. The calling party, such as UT 1320, initiates a call by sending MB MCCP request 69000 to the calling party MB server system via the calling party EX and via the calling party MX, such as MX 1080. The MB MCCP request 69000 is an MP control packet, which includes the network addresses of the calling party and the calling party MB server system and the user address of the MB program source. As discussed in the Logical Layer section above, a calling party typically does not know the network address of the called party (i.e., the MB program source here). Instead, the calling party relies on the server group in an SGW to map a user address to a network address. In addition, the calling party and the called party obtain MP network information (e.g., the network addresses of the MB server systems) to carry out an MB session from the network management server systems of the server groups in SGW 1060 and SGW 1160 via the NIDP process (discussed in the Server Group section and the Media Multicast section above), respectively.
2. Upon receipt of the MB MCCP request 69000, the calling party MB server system executes the MCCP procedures (discussed in the Server Group section and the Media Multicast section above) to determine whether to allow the calling party to proceed.
3. The calling party MB server system acknowledges the request of the calling party by sending MB request response 69010, which is an MP control packet that contains the result of the MCCP procedures, to the calling party via the calling party MX.
4. Then, the calling party MB server system sends MB setup packet 69020 and MB setup packet 69030 to the calling party and called party MB server systems, respectively. MB setup packet 69020 and MB setup packet 69030 are MP control packets that contain the network addresses of the calling party and the called party and the allowed call traffic flow (e.g., bandwidth) of the requested MB session.
5. Also, these MP setup packets include a reserved session number and color information, which directs the switches involved in the MB session (e.g., EX 10000 in SGW 1160, the EX in SGW 1060, MX 1080, and a UX in HGW 1100) to update their LTs. The process of updating an LT is detailed in the Edge Switch and the Middle Switch sections above. In addition, MB setup packet 69030 also sets up the ULPF in the called party EX, such as the EX in SGW 1160.
6. The calling party acknowledges MB setup packet 69020 by sending MB setup response packet 69040 back to the calling party MB server system via the calling party MX. The called party MB server system responds with MB setup response packet 69050 to the calling party MB server system. MB setup response packet 69040 and MB setup response packet 69050 are MP control packets.
7. After receiving the MP setup response packets, the calling party MB server system begins to collect usage information for the MB session (e.g., the duration or the traffic of the session).

Although the preceding discussions generally also apply to MB sessions that involve SGWs residing in different MP metro networks (but within the same MP nationwide network) or involve SGWs residing in different MP nationwide networks, the MCCP procedures for such inter-MP-metro-network or inter-MP-nationwide-network MB sessions may involve additional steps. As discussed in the Media Telephony Service section above, if the metro master network management server system lacks the requisite resource information to approve or disapprove the requested service and/or lacks the authority to reserve a session number, the metro master network management server system consults with the nationwide master network management server system. If the nationwide master network management server system still lacks the requisite resource information and/or authority, the master network management server system consults with the global master network management server system.

6.4.2.2 Call Communication

1. After setting up the LTs in the switches that are involved in the MB session, the calling party can begin to receive broadcast data 69100. Broadcast data 69100 are MP data packets that contain color information (which indicates the packets are MB-data-colored packets) and the reserved session number. In addition, the ULPF of the EX in SGW 1160, such as EX 10000, examines broadcast data 69100 before allowing these MP data packets to reach the calling party.
2. The calling party MB server system sends MB maintain 69110 to the calling party occasionally during the call communication stage. MB maintain 69110 is an MP control packet, which one embodiment of the MB server system uses to manage the LTs. Alternatively, the MB server system may use the MB maintain packet to collect call connection status information (e.g., error rate and number of packets lost) of the calling party in an MB session.
3. The calling party acknowledges the MB maintain 69110 by sending MB maintain response 69120 to the calling party MB server. MB maintain response 69120 is an MP control packet, which contains the requested call connection status information.
4. Based on MB maintain response 69120, the MB server system may repeat items 2 and 3 above occasionally. Otherwise, the MB server system may modify the MB session. For instance, if the error rate of the session exceeds a tolerable threshold, the calling party MB server system may notify the calling party and terminate the session.

The preceding description of the call communication of an MB session among multiple SGWs within an MP metro network also applies to MB sessions that involve SGWs that reside in different MP metro networks (but within the same MP nationwide network) and/or different MP nationwide networks.

6.4.2.3 Call Clear-Up

The calling party, the calling party MB server system, and the called party MB server system can initiate call clear-up. In addition, when the MB program source server system detects errors from the MB program source, it notifies the calling party MB server system to initiate call clear-up.

6.4.2.3.1 Calling Party Initiated Call Clear-Up

1. The calling party sends MB clear-up 69130, which is an MP control packet, to the calling party MB server system via the calling party MX. In addition, the MB server system stops collecting usage information for the session (e.g., the duration or the traffic of the session) and reports the collected usage information to a local accounting server system, such as the accounting server system of the server group in SGW 1060 (FIG. 12).
2. The calling party MB server system sends MB clear-up 69140 to the called party MB server system. It also sends MB clear-up response 69150 to the calling party via the calling party MX.
3. The switches involved in the MB session, such as MX 1080, the EX in SGW 1160, and the EX in SGW 1060, reset their LTs when they receive MB clear-up responses 69150 and 69160. Also, MB clear-up response 69160 also resets the ULPF in the EX of SGW 1160.
4. When the calling party receives MB clear-up response 69150 from the calling party MB server system, the calling part terminates its involvement in the MB session.
5. When the calling party MB server system receives MB clear-up response 69160 from the called party MB server system, it terminates the MB session.
   6.4.2.3.2 Calling party MB Server System Initiated Call Clear-Up

One embodiment of the calling party MB server system may initiate the call clear-up when it detects unacceptable communication conditions (e.g., excessive number of dropped packets, excessive error rate, or excessive number of missing MB maintain response packets).
1. The calling party MB server system sends MB clear-up 69170 to the calling party via the calling party MX and MB clear-up 69180 to the called party MB server systems, respectively. In addition, the calling party MB server system stops collecting usage information for the session (e.g., the duration or the traffic of the session) and reports the collected usage information to a local accounting server system, such as the accounting server system of the server group in SGW 1060.
2. The switches that are involved in the MB session, such as MX 1080, the EX in SGW 1160, and the EX in SGW 1060, reset their LTs when they receive MB clear-up 69170 and 69180. Also, MB clear-up 69180 also resets the ULPF in the EX of SGW 1160.
3. In response, the calling party sends back MB clear-up response 69190, which is also an MP control packet, to the calling party MB server system and effectively terminates its involvement in this MB session. Similarly, the called party MB server system sends MB clear-up response 69200 to the calling party MB server system.
4. When the calling party MB server system receives the MB clear-up response 69190 and MB clear-up 69200, it terminates the MB session.

The preceding discussions also apply to a clear-up that a called party MB server system initiates.

6.4.2.3.3 MB Program Source Server System Initiated Call Clear-Up

When the MB program source server system detects unacceptable communication conditions (e.g., the MB program source power is turned off accidentally), it notifies the called party MB server system to terminate the MB session.
1. MB program source Server sends MB program source error 69210, which is an MP control packet and contains the network address of the MB program source and the error code generated by the MB program source, to the called party MB server system.
2. Subsequently, the called party MB server system sends MB program source error 69220 to the calling party MB server system.
3. After the calling party MB server system receives the MB program source error 69220, it stops collecting usage information for the session (e.g., the duration or the traffic of the session) and reports the collected usage information to a local accounting server system, such as accounting server system of server group in SGW 1060 FIG. 12). The calling party MB server system may also direct the EX in SGW 1060 to reset its LT.
4. The calling party MB server sends MB clear-up 69230 to the calling party via the calling party MX. This packet resets the LTs of the switches that are involved in the MB session. Then the calling party MB server system sends MB program source error response 69240 to the called party MB server system.
5. The calling party sends an MB clear-up response 69250 to the calling party MB server system. When the calling party MB server system receives this MB clear-up response 69250, it terminates the MB session.
   6.5 Media Transfer Service (“MT”)
   6.5.1 MT Between Two MP-Compliant Components That Depend on a Single Service Gateway

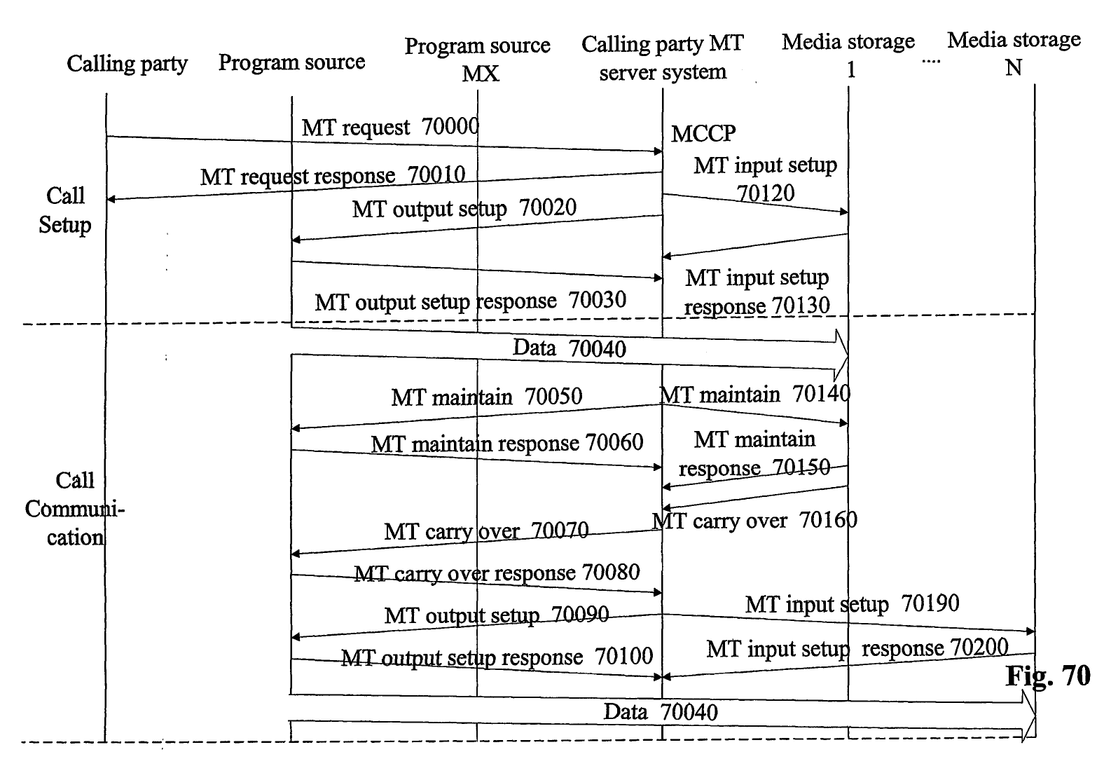

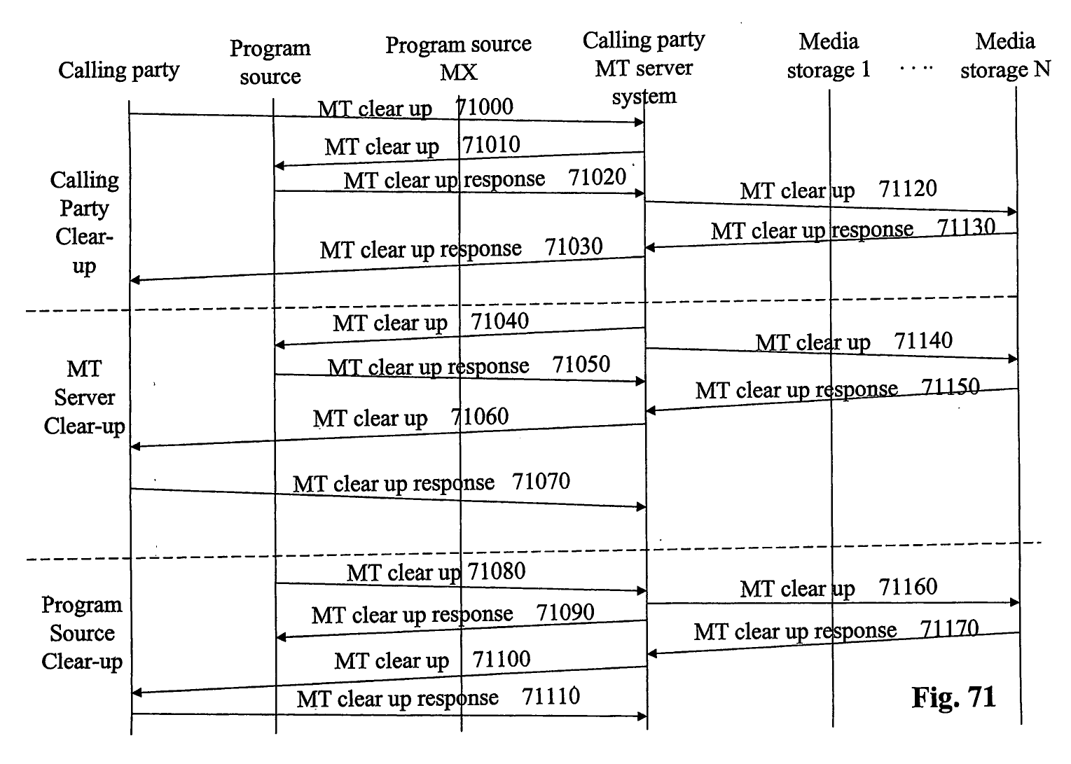

MT enables a program source to deliver media programs (live or stored) to an MP-compliant component, such as media storage, and enables the MP-compliant component to store the delivered programs. In one configuration, this media storage resides in an SGW as discussed in the Service Gateway section above and is referred to as SGW media storage. Alternatively, the media storage can be one of the UTs that connects to an HGW, such as UT 1400 (FIG. 1d). Such media storage is referred to as UT media storage. Because one media storage device may not have sufficient storage to store all the media programs that the program source provides, an MT session often involves multiple media storage devices. FIGS. 70 and 71 illustrate time sequence diagrams of one session of MT between a program source and a number of UT media storage devices, such as media storage 1 to N (e.g., UT 1400, 1380, 1360 and 1340).

For illustration purposes, the calling party is a UT that requests the MT service, such as UT 1420. The program source is a television studio that generates and places live programming on MP metro network 1000 via UT 1450. The “MT server system” refers to a server system that manages MT sessions. In particular, the calling party MT server system can be, without limitation, either call processing server system 12010 that resides in server group 10010 of SGW 1160 (FIG. 12) or a home server system that supports HGW 1200.

The following discussions primarily explain how these parties interact with one another in three stages of an MT session: call setup, call communication and call clear-up.

6.5.1.1 Call Setup

1. The calling party, such as UT 1420, sends MT request 70000 to the calling party MT server system. MT request 70000 is an MP control packet, which includes the network addresses of the calling party and the MT server system and the user addresses of the program source and media storage devices 1 to N. Because the calling party typically does not know the network addresses of the program source and the media storage devices, the calling party relies on the server group in an SGW to map the user addresses to network addresses. In addition, the calling party and the media storage devices acquire relevant MP network information (e.g., the network address of the MT server system) to carry out an MT session from network management server system 12030 of server group 10010 (FIG. 12).
2. Upon receipt of the MT request 70000, the calling party MT server system executes the MCCP procedures (discussed in the Server Group section above) to determine whether to allow the calling party to proceed.
3. The calling party MT server system acknowledges the request of the calling party by issuing MT request response 70010, which is an MP control packet that contains the result of the MCCP procedures.
4. Then, the calling party MT server system sends MT output setup 70020 to the program source to instruct the program source to deliver its media programs to the media storage devices. Also, the calling party MT server system sends MT input setup 70120 to one of the media storage devices, such as media storage 1, to instruct media storage 1 to store the media programs. MT output setup 70020 and MT input setup 70120 are MP control packets, which contain the network addresses of the program source and media storage 1 and the allowed call traffic (e.g., bandwidth) of the requested MT session. These packets further include color information, which directs program source MX, such as MX 1240, to perform the ULPF checks on the MP packets from UT 1450, as discussed in the Middle Switch section above.
5. Media storage 1 sends MT input setup response 70130 to the calling party MT server system, after it receives the MT input setup 70120. Also, the program source responds to MT output setup 70020 with MT output setup response 70030. These MT setup response packets are MP control packets.
6. The calling party MT server system begins to collect usage information for the MT session (e.g., the duration or the traffic of the session) after it receives MT input setup response 70130 and MT output setup response 70030.
   6.5.1.2 Call Communication
1. After the calling party MT server system approves the requested connections between the program source and the media storage devices, the program source sends data, such as data 70040 as shown in FIG. 70, to the media storage 1 via the program source MX (e.g, MX 1240), the EX in SGW 1160, MX 1180, and HGW 1200. Data 70040 are MP data packets. Also, the program source MX, such as MX 1240, performs ULPF checks, which are detailed in the Middle Switch section above, to determine whether to allow these data packets to reach SGW 1160 and subsequently to reach the media storage devices. The logical links that the data packets pass through between the program source and the EX in the SGW (SGW 1160) that governs the program source are the bottom-up logical links, whereas the logical links that the data packets pass through between the EX in the SGW (SGW 1160) that governs the media storage device(s) and the media storage device(s) are the top-down logical links.
2. The calling party MT server system sends the MT maintain packet 70050 to the program source and sends MT maintain packet 70140 to the media storage 1 occasionally during the MT call communication stage. MT maintain packets 70050 and 70140 are MP control packets. One embodiment of the calling party MT server system deploys these packets to collect call connection status information (e.g., error rate and number of packets lost) of the parties in an MT session.
3. The program source and media storage 1 acknowledge the MT maintain packets with MT maintain response packets 70060 and 70150, respectively, to the calling party MT server system. These responses report the call connection status of the established MT session. Based on MT maintain response packets 70060 and 70150, the calling party MT server system may modify the MT session. For instance, if the error rate of the session exceeds a tolerable threshold, the calling party MT server system may notify the calling party and terminate the session.
4. During the MT call communication stage, if media storage 1 detects that it may exhaust its available storage, it informs the calling party MT server system via MT carry over 70160. The calling party MT server system informs the program source of the carry over condition via MT carry over 70070. Carry over 70070 and 70160 are both MP control packets, which contain, without limitation, the network addresses of the next available media storage devices. In one implementation, media storage devices 1 to N keep track of the network addresses of other available media storage devices. For instance, if the order of filling up the media storage devices is sequential (i.e., first fill up media storage 1, then media storage 2, and media storage 3), media storage 1 has the network address of media storage 2, and media storage 2 has the network address of media storage 3.
5. The program source sends MT carry over response 70080 to the calling party MT server system after its receipt of MT carry over 70070. The response informs the calling party MT server system that the program source is ready to send data 70040 to the next media storage device.
6. Upon receipt of MT carry over response 70080 from the program source, the calling party MT server system sends MT output setup 70090 and MT input setup 70190 to the program source and the next available media storage device (media storage N), respectively. The program source and media storage N then respond to the calling party MT server system with MT output setup response 70100 and MT input setup response 70200, respectively.
7. Then the program source sends data 70040 to media storage N.
   6.5.1.3 Call Clear-Up

The calling party, the calling party MT server system, or the program source can initiate the call clear-up.

6.5.1.3.1 Calling Party Initiated Call Clear-Up

1. The calling party sends MT clear-up 71000 to the calling party MT server system, which sends MT clear up 71010 to the program source, notifies media storage N of the call clear-up with MT clear-up 71120. Though not shown in FIG. 71, the calling party MT server system also sends other MT clear-up packets to the other media storage devices (e.g., media storage 1). The program source responds by sending MT clear-up response 71020, and the media storage devices respond by sending MT clear-up response packets (e.g., 71130) to the calling party MT server system. The calling party MT server system then sends MT clear-up response 71030 to the calling party. In addition, the calling party MT server system stops collecting usage information for the session (e.g., the duration or the traffic of the session) and reports the collected usage information to local accounting server system 12040 of server group 10010 in SGW 1160 (FIG. 12). If the program source delivers media programs via an HGW, such via UT 1450, the program source MX, such as MX 1240, resets its ULPF when it receives MT clear-up 71010.
2. After the program source sends MT clear-up response 71020 to the calling party MT server system, the MT server system terminates the MT session.
3. Alternatively, when media storage N responds to the calling party MT server system with MT clear-up response 71130 and the other media storage devices also respond with their clear-up responses, the MT server system also terminates the MT session.
4. After the calling party receives the MT clear up response 71030, the calling party terminates its involvement in the MT session.
   6.5.1.3.2 MT Server System Initiated Call Clear-Up

One embodiment of an MT server system may initiate the call clear-up when it detects unacceptable communication conditions (e.g., excessive number of dropped packets, excessive error rate, or excessive number of missing MT maintain response packets).
1. The calling party MT server system sends MT clear-up 71040, 71140 and 71060 to the program source via the program source MX, media storage N and the calling party, respectively. Though not shown in FIG. 71, the calling party MT server system also sends other MT clear-up packets to the other media storage devices (e.g., media storage 1). After sending out the clear-up packets above, the calling party MT server system terminates the MT session, stops collecting usage information for the session (e.g., the duration or the traffic of the session) and reports the collected usage information to local accounting server system 12040 of server group 10010 in SGW 1160 (FIG. 12). If the program source delivers media programs via an HGW, such via UT 1450, the program source MX, such as MX 1240, resets its ULPF when it receives MT clear-up 71040.
   6.5.1.3.3 Program Source Initiated Call Clear-Up

A program source may initiate the call clear-up under a number of situations. For example, if a program source finishes transmitting the requested data, the program source may initiate the call clear-up. In another example, if a program source learns of failures at some of media storage devices 1 to N, the program source may also initiate the call clear-up.
1. The program source sends MT clear-up 71080 via program source MX to the calling party MT server system, which responds by sending MT clear-up packets (e.g., 71160) to media storage devices (e.g., media storage N) and also notifying the program source and the calling party of the clear-up request with MT clear-up response 71090 and MT clear-up 71100, respectively. Upon receipt of MT clear-up 71080, the calling party MT server system stops collecting usage information for the session (e.g., the duration or the traffic of the session) and reports the collected usage information to local accounting server system 12040 of server group 10010 in SGW 1160 (FIG. 12). If the program source delivers media programs via an HGW, such as UT 1450, the program source MX, such as MX 1240, resets its ULPF when it receives MT clear-up response 71090.
2. After the calling party responds to the calling party MT server system with MT clear-up response 71110, it terminates its involvement in the MT session. Similarly, after the media storage devices (e.g., media storage N) responds to the calling party MT server system with MT clear-up response packets (e.g., MT clear-up response 71170), it also terminates its involvement in the MT session.
   6.5.2 MT Between Two MP-Compliant Components That Depend on Two Service Gateways

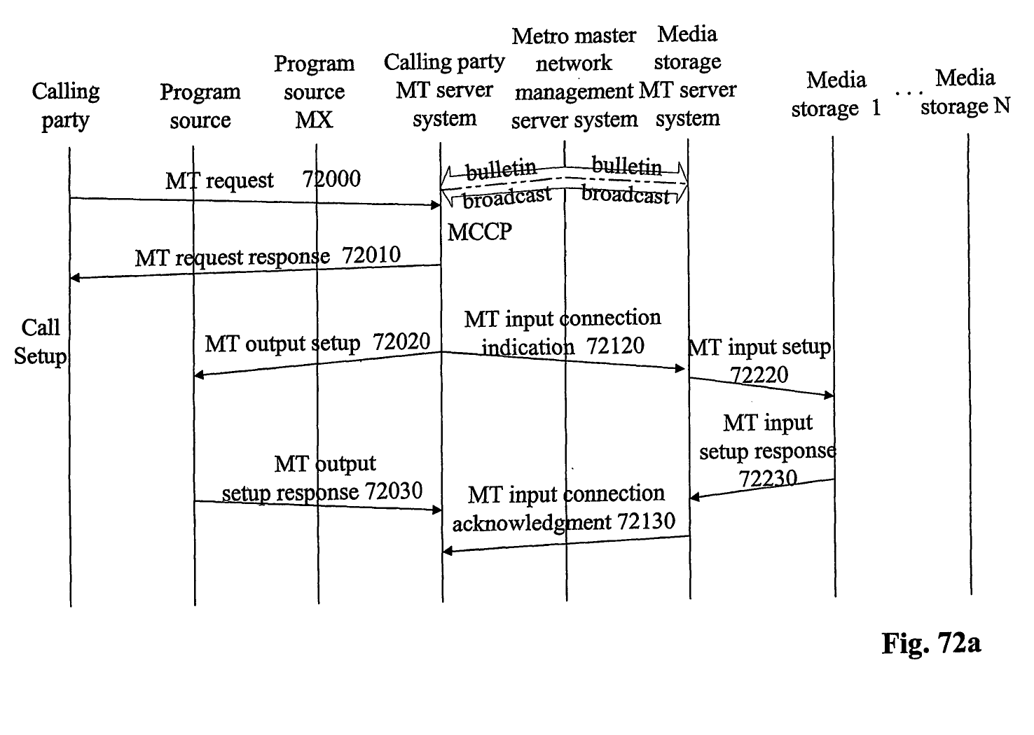

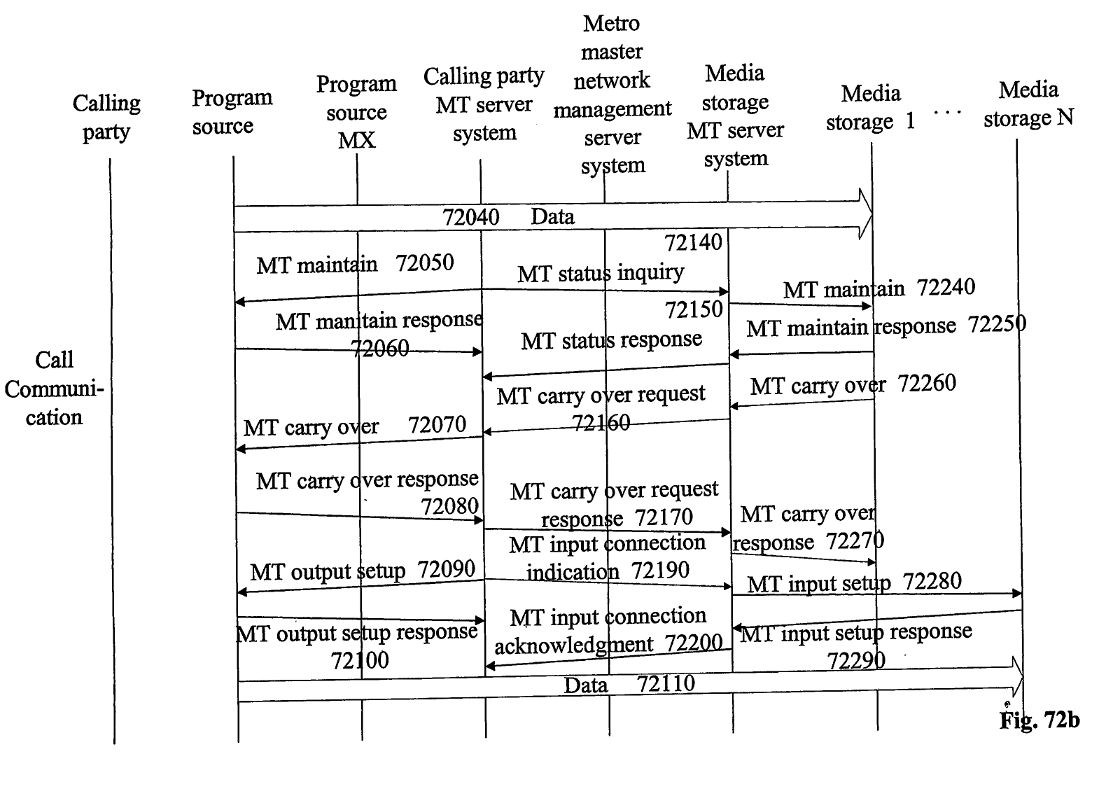

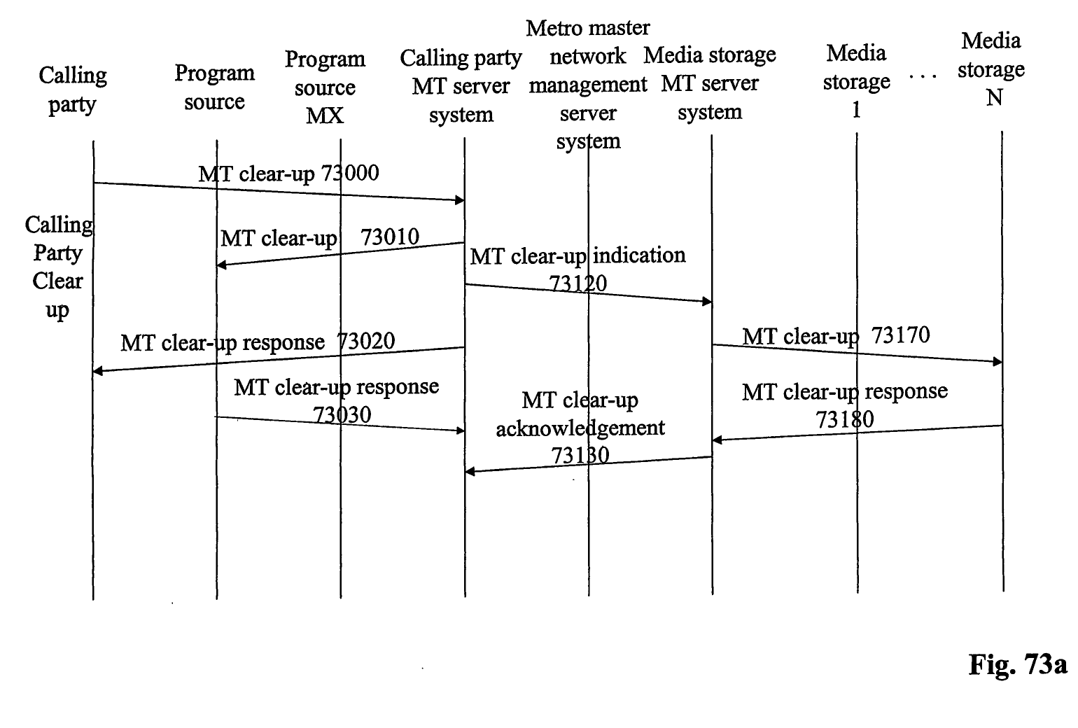

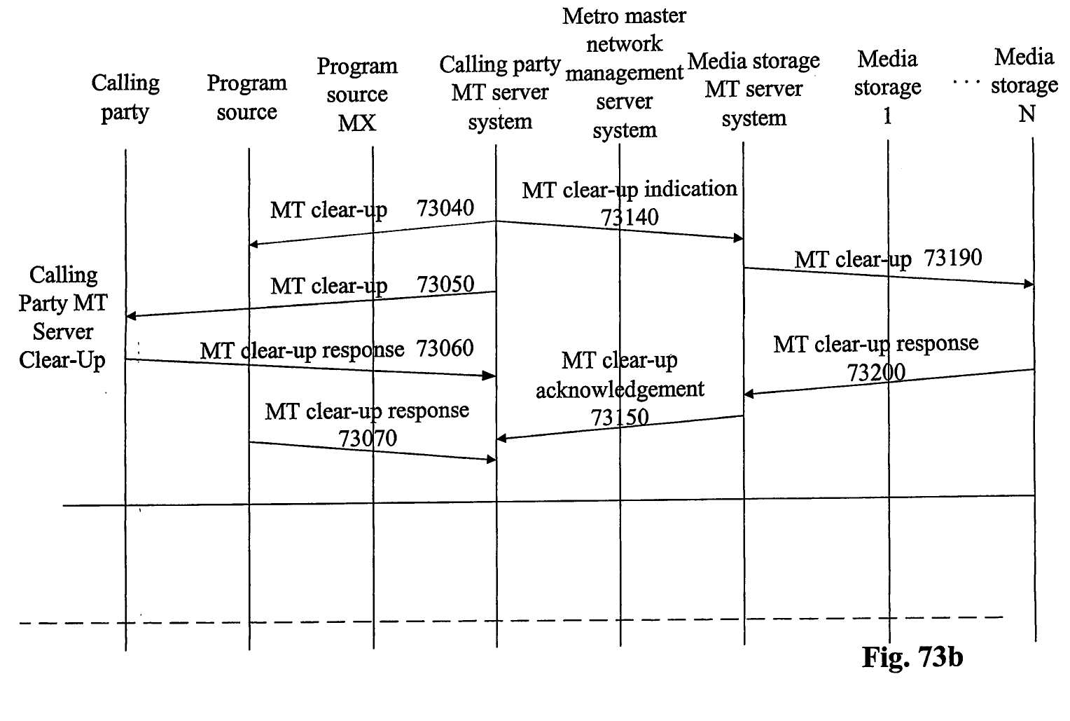

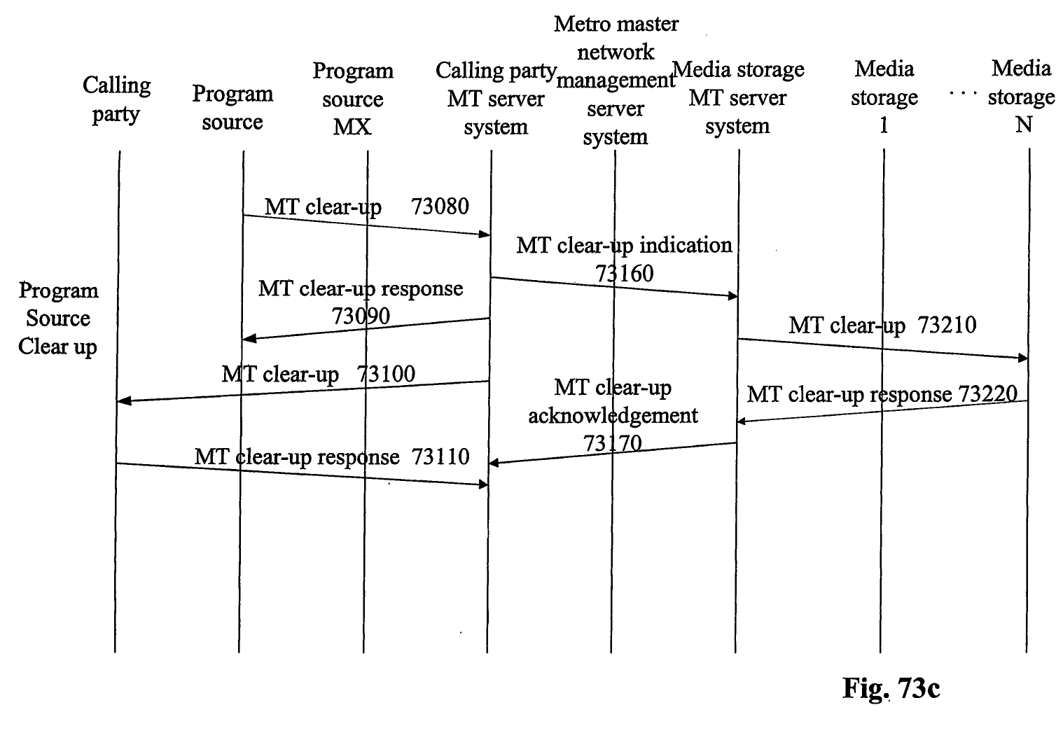

FIGS. 72a, 72b, 73a, 73b, and 73c illustrate time sequence diagrams of one MT session between two MP-compliant components that depend on two SGWs, such as UT media storage 1400 and media storage 1140 that resides in SGW 1120 as shown in FIG. 1d. For illustration purposes, UT 1420 requests a media transfer session from UT media storage 1400 to media storage 1140. Thus, UT 1420 is the “calling party,” media storage 1400 is the “program source”, and MX 1180 is the “program source MX”. One embodiment of media storage 1140 refers to a collection of media storage devices, such as media storage devices 1 to N.

Call processing server system 12010 that resides in server group 10010 of SGW 1160 is the “calling party call processing server system”. Similarly, the call processing server system that resides in SGW 1120 is the “media storage call processing server system”. When an SGW dedicates a call processing server system to manage MT sessions, the dedicated call processing server system is referred to as the “MT server system”. One embodiment of SGW 1120 and one embodiment of SGW 1160 include a multiple number of call processing server systems and dedicate each one of these server systems to facilitate a particular type of multimedia service.

In addition, if SGW 1160 serves as the metro master network manager for MP metro network 1000 (FIG. 1d), network management server system 12030 that resides in server group 10010 of SGW 1160 is then the metro master network management server system.

The following discussions primarily explain how these parties interact with one another in three stages of an MT session: call setup, call communication and call clear-up.

6.5.2.1 Call Setup

1. One embodiment of a metro master network management server system occasionally broadcasts network resource information to the server systems on MP metro network 1000, such as the calling party MT server system and the media storage MT server system. The network resource information can include, without limitation, the current traffic flows on MP metro network 1000 and available bandwidth and/or capacity of the server systems on MP metro network 1000.
2. As the server systems receive the broadcast information from the metro master network management server system, they extract and maintain certain information from the broadcast. For example, because the calling party MT server system is interested in contacting the media storage MT server system, it retrieves the network address of the media storage MT server system from the broadcast.
3. The calling party, such as UT 1420, initiates a call by sending MT request 72000 to the media storage MT server system via an EX in SGW 1160 and via calling party MX, such as MX 1180. MT request 72000 is an MP control packet, which includes the network addresses of the calling party and the calling party MT server system and the user addresses of the program source and media storage devices 1 to N. As discussed in the Logical Layer section above, a calling party typically does not know the network address of the program source and the media storage devices. Instead, the calling party relies on the server group in an SGW to map a user address to a network address. In addition, the calling party and the media storage devices acquire MP network information (e.g., the network addresses of the calling party MT server system and the media storage MT server system) for carrying out an MT session from the network management server systems of the server groups in SGW 1160 and SGW 1120, respectively.
4. Upon receipt of the MT request 72000, the calling party MT server system executes the MCCP procedures (discussed in the Server Group section above) to determine whether to allow the calling party to proceed.
5. The calling party MT server system acknowledges the request of the calling party by issuing MT request response 72010, which is an MP control packet that contains the result of the MCCP procedures.
6. Then, the calling party MT server system sends MT output setup 72020 and MT input connection indication 72120 to the program source and the media storage MT server system, respectively. The setup packets and the connection indication packets are MP control packets, which contain, without limitation, the network addresses of the calling party, the media storage devices, the media programs in the program source and the allowed call traffic flow (e.g., bandwidth) of the requested MT session. MT output setup 72020 instructs the program source to place media programs on metro MP network 1000 and also includes color information that directs the program source MX, such as MX 1180 to set up its ULPF. This process of updating an ULPF is detailed in the Middle Switch section above.
7. After receiving MT input connection indication 72120, the media storage MT server system then sends MT input setup 72220 to media storage 1. This input setup packet instructs media storage 1 to store the media programs from the program source.
8. The program source and media storage device 1 acknowledge the MT setup packets by sending MT output setup response 72030 and MT input setup response 72230 back to their respective MT server systems. These MT setup response packets are MP control packets.
9. Upon receipt of MT input setup response 72230, the media storage MT server system notifies the calling party MT server system to proceed with the MT session by sending it MT input connection acknowledgment 72130. Moreover, after the calling party MT server system receives MT output setup response 72030 and MT input connection acknowledgment 72130, it begins to collect usage information for the MT session (e.g., the duration or the traffic of the session).

If the program source and the media storage devices reside either in different MP metro networks (but within the same nationwide network) or in different MP nationwide networks, the aforementioned MT setup process includes additional inter-MP-metro-network or inter-MP-nationwide-network handling procedures analogous to the procedures discussed in the MTPS call setup section above.

6.5.2.2 Call Communication

1. The program source begins to send data 72040 to the media storage devices via the program source MX, the EX in SGW 1160, and the EX in SGW 1120. Data 72040 are MP data packets. The ULPF of the program source MX performs ULPF checks, which are detailed in the Middle Switch section above, to determine whether to allow the data packets to reach SGW 1160. The logical links that the data packets pass through between the program source and the EX in the SGW (SGW 1160) that governs the program source are the bottom-up logical links, whereas the logical links that the data packets pass through between the EX in the SGW (SGW 1120) that governs the media storage device(s) and the media storage device(s) are the top-down logical links. Also, as described in the Logical Layer section above, the EX in SGW 1160 looks in a routing table (which can be calculated off-line) to direct the data packets towards the EX in SGW 1120.
2. The calling party MT server system sends MT maintain packet 72050 and MT status inquiry 72140 to the program source and the media storage MT server system occasionally during the call communication stage. The media storage MT server system further sends MT maintain 72240 to media storage 1. In one implementation, MT maintain packets 72050 and 72240 and MT status inquiry 72140 are MP control packets that are deployed to collect call connection status information (e.g., error rate and number of packets lost) of the parties in an MT session.
3. The program source and media storage 1 acknowledge the MT maintain packets by sending MT maintain response packets, such as 72060 and 72250, to their respective MT server systems. An MT maintain response packet is an MP control packet that contains the requested call connection status information.
4. After receiving MT maintain response packet 72250, the media storage MT server system passes along the call connection status information from the media storage devices to the calling party MT server system using MT status response 72150.
5. Based on MT maintain response packet 72060 and MT status response 72150, the calling party MT server system may modify the MT session. For instance, if the error rate of the session exceeds a tolerable threshold, the calling party MT server system may notify the parties and terminate the session.
6. If media storage 1 detects that it may exhaust its available storage capacity, media storage 1 sends MT carry over 72260, which is an MP control packet, to the media storage MT server system.
7. Upon receipt of MT carry over 72260, the media storage MT server system sends MT carry over request 72160 to the calling party MT server system. MT carry over request 72160 is an MP control packet, which asks the calling party MT server system to issue MT carry over 72070 that directs the program source to send data 72040 to the next available media storage device.
8. Upon receipt of MT carry over response 72080 from the program source, the calling party MT server system sends MT carry over request response 72170 to the media storage MT server system. MT carry over request response 72170 is an MP control packet that contains information such as, without limitation, the network address of the next available media storage device.
9. The media storage MT server system further relays the information contained in MT carry over request response 72170 to the media storage devices via MT carry over response 72270.
10. Media storage 1 extracts and maintains the network address of the next available media storage from MT carry over response 72270. In one implementation, the maintenance of this network address serves as a “connecting point” between media storage 1 and the next available media storage (e.g., media storage N). For example, if a portion of a particular media program is stored in media storage 1 and the rest of the program is stored in media storage N, this “connecting point” allows the entire media program to be played back in its proper sequence.
11. The calling party MT server system then sends MT output setup 72090 to the program source via the program source MX to instruct the program source to deliver MP data packets to the next available media storage device. The calling party MT server system also sends MT input connection indication 72190 (which includes the network address of the next available media storage) to the media storage MT server system. The media-storage MT server system instructs the next available media storage to store MP data packets from the program source using MT input setup 72280.
12. MT output setup 72090 is an MP control packet, which directs the program source MX to perform the ULPF checks on data 72110. The program source responds to MT output setup 72090 with MT output setup response 72100.
13. The next available media storage sends MT input setup response 72290 back to the media storage MT server system, which further relays the information in the setup response to the calling party MT server system via MT input connection acknowledgment 72200.
14. The procedures in items 6-13 are repeated until the transfer of the entire media program(s) from the program source to the media storage devices is completed.

If the program source and the media storages reside either in different MP metro networks (but within the same nationwide network) or in different MP nationwide networks, the aforementioned MT call communication process includes additional inter-MP-metro-network or inter-MP-nationwide-network packet forwarding procedures analogous to the procedures discussed in the MTPS call communication section above.

6.5.2.3 Call Clear-Up

The calling party, the calling party MT server system, the media storage MT server system, or the program source can initiate call clear-up.

6.5.2.3.1 Calling Party Initiated Call Clear-Up

1. The calling party sends MT clear-up 73000, which is an MP control packet, to the calling party MT server system. In response, the calling party MT server system acknowledges the clear-up request by sending MT program source clear-up 73010 to the program source via the program source MX, sending MT clear-up response 73020 to the calling party, and notifying the media storage MT server system of the request through MT clear-up indication 73120. The calling party MT server system also stops collecting usage information for the session (e.g., the duration or the traffic of the session) and reports the collected usage information to a local accounting server system, such as accounting server system 12040 of server group 10010 in SGW 1160 (FIG. 12).
2. After receiving MT clear-up indication 73120, the media storage MT server system sends MT clear-up packets (e.g., 73170) to the media storage devices.
3. The program source MX resets its ULPF when it receives MT program source clear-up 73010.
4. The program source sends MT clear-up response 73030 to the calling party MT server system as an acknowledgment of MT program source clear-up 73010 and terminates its involvement in the MT session.
5. The media storage devices acknowledge the clear-up requests from the media storage MT server system through MT clear-up response packets (e.g., 73180). Then the media storage MT server system sends MT clear-up acknowledgment 73130 to the calling party MT server system.
   6.5.2.3.2 MT Server System Initiated Call Clear-Up

One embodiment of an MT server system may initiate the call clear-up when it detects unacceptable communication conditions (e.g., excessive number of dropped packets, excessive error rate, or excessive number of missing MT maintain response packets or MT status response packets).
1. For illustration purposes, assume the calling party MT server system initiates the call clear-up. It sends MT clear-up 73040 via the program source MX, MT clear-up 73050, and MT clear-up indication 73140, which are MP control packets, to the program source, the calling party and the media storage MT server system, respectively. In response, the calling party sends back MT clear-up response 73060 to the calling party MT server system and effectively terminates the MT session. Also, the media storage MT server system sends MT clear-up packets (e.g., 73190) to the media storage devices (e.g., media storage N).
2. The program source MX resets its ULPF when it receives MT clear-up 73040.
3. After receiving MT clear-up response packets from the media storage devices (e.g., 73200 from media storage N), the media storage MT server system sends MT clear-up acknowledgment 73150 to the calling party MT server system.
4. The calling party MT server system stops collecting usage information for the session (e.g., the duration or the traffic of the session) and terminates the session when it sends out MT clear-up 73040, MT clear-up 73050 and MT clear-up indication 73140. The MT server system also reports the collected usage information to a local accounting server system, such as accounting server system 12040 of server group 10010 in SGW 1160 (FIG. 12).

Analogous procedures apply if the media storage MT server system initiates the call clear-up.

6.5.2.3.3 Program Source Initiated Call Clear-Up

A program source may initiate the call clear-up under a number of situations. For example, if a program source finishes transmitting the requested data, the program source may initiate the call clear-up. In another example, if a program source learns of failures at some of media storage devices 1 to N, the program source may also initiate the call clear-up.
1. The program source initiates the clear-up by sending MT clear-up 73080 to the calling party MT server system via the program source MX. In turn, the calling party MT server system sends MT clear-up response 73090 back to the program source, MT clear-up 73100 to the calling party, and MT clear-up indication 73160 to the media storage MT server system. In addition, the calling party MT server system stops collecting usage information for the session (e.g., the duration or the traffic of the session) and terminates the session. The MT server system also reports the collected usage information to a local accounting server system, such as accounting server system 12040 of server group 10010 in SGW 1160 (FIG. 12).
2. The program source MX resets its ULPF when it receives MT clear-up response 73090.
3. In response to MT clear-up 73100, the calling party sends MP clear-up response 73110 to the calling party MT server system.
4. Upon receipt of MT clear-up indication 73160, the media storage MT server system sends MT clear-up packets (e.g., 73210) to the media storage devices (e.g., media storage N). The media storage devices then send MT clear-up response packets (e.g., 73220) to the media storage MT server system, which sends MT clear-up acknowledgment 73170 to calling party MT server system.

The various embodiments described above should be considered as merely illustrative of the present invention and not in limitation thereof. They are not intended to be exhaustive or to limit the invention to the forms disclosed. Those skilled in the art will readily appreciate that still other variations and modifications may be practiced without departing from the general spirit of the invention set forth herein. Therefore, it is intended that the present invention be defined by the claims which follow:

1. A method for transmitting data, comprising:
forwarding asynchronously a packet of multimedia data through a plurality of logical links in a packet-switched network using a datagram address in said packet, wherein
said plurality of logical links forms a transmission path between a source node and a destination node,
prior to said forwarding, a node in said network approves said forwarding based on measured usage of resources along said plurality of logical links,
address information in partial address subfields of said datagram address self-directs said packet through a plurality of top-down logical links, said plurality of top-down logical links being a subset of said plurality of logical links, and
said packet remains unchanged as it is transferred along multiple links in said plurality of logical links.

2. The method of claim 1, wherein said forwarding does not use the Internet Protocol.

3. A system for transmitting data, comprising:
a packet-switched network including a plurality of logical links; and
a plurality of data packets passing asynchronously through said plurality of logical links, each of said packets comprising
a header field including a datagram address containing a plurality of partial address subfields, wherein address information in said partial address subfields self-directs said packet through a plurality of top-down logical links, said plurality of top-down logical links being a subset of said plurality of logical links,
and a payload field containing multimedia data;
wherein said plurality of logical links forms a transmission path between a source node and a destination node,
prior to said passing, a node in said network approves said passing based on measured usage of resources along said plurality of logical links, and
each of said packets remains unchanged as it is transferred along multiple links in said plurality of logical links.

4. The system of claim 3, wherein said packet-switched network does not use the Internet Protocol to pass said plurality of data packets through said plurality of logical links.

5. A data structure for a packet, comprising:
a header field containing a datagram address containing a plurality of partial address subfields, wherein
address information in said partial address subfields self-directs said packet through a plurality of top-down logical links that forms a subset of a plurality of logical links in a packet-switched network;
and a payload field containing multimedia data;
wherein said plurality of logical links forms a transmission path between a source node and a destination node,
said packet is forwarded asynchronously through said plurality of logical links, prior to said forwarding, a node in said network approves said forwarding based on measured usage of resources along said plurality of logical links, and
said packet remains unchanged as it is transferred along multiple links in said plurality of logical links.

6. The data structure of claim 5, wherein said packet-switched network does not use the Internet Protocol.

7. A computer readable medium containing executable program instructions for transmitting data through a network, which when executed cause said network to:
forward asynchronously a packet of multimedia data through a plurality of logical links in a packet-switched network using a datagram address in said packet, wherein
said plurality of logical links forms a transmission path between a source node and a destination node,
prior to said forwarding, a node in said network approves said forwarding based on measured usage of resources along said plurality of logical links,
address information in partial address subfields of said datagram address self-directs said packet through a plurality of top-down logical links, said plurality of top-down logical links being a subset of said plurality of logical links, and
said packet remains unchanged as it is transferred along multiple links in said plurality of logical links.

8. The computer readable medium of claim 7, wherein said forwarding does not use the Internet Protocol.

9. A method for transmitting data, comprising:
forwarding a packet of multimedia data through a plurality of logical links in a packet-switched network using a datagram address in said packet,
wherein address information in partial address subfields of said datagram address self-directs said packet through a plurality of top-down logical links, said plurality of top-down logical links being a subset of said plurality of logical links, and said packet remains unchanged as it is transferred along multiple links in said plurality of logical links.

10. The method of claim 9, wherein said plurality of logical links forms a transmission path between a source node and a destination node.

11. The method of claim 9, wherein said forwarding does not use the Internet Protocol.

12. The method of claim 9, wherein said forwarding occurs at wirespeed.

13. The method of claim 9, wherein said forwarding uses forwarding tables calculated off-line.

14. The method of claim 9, wherein said forwarding does not use real-time routing table calculations.

15. The method of claim 9, wherein said forwarding occurs asynchronously.

16. The method of claim 9, wherein said forwarding is facilitated by information in said datagram address about the type of service that the packet is providing.

17. The method of claim 9, wherein said packet has a length that is different from the length of another packet of multimedia data that is forwarded in said network.

18. The method of claim 9, wherein said packet remains unchanged as it is forwarded along a majority of Links in said plurality of logical links.

19. The method of claim 9, wherein said packet has no “time-to-live” data.

20. The method of claim 9, wherein said packet is transferred along a majority of links in said plurality of logical links without using routing calculations.

21. The method of claim 9, wherein said multimedia data includes data for telephony.

22. The method of claim 9, wherein said multimedia data includes data for media on demand.

23. The method of claim 9, wherein said multimedia data includes data for multicast.

24. The method of claim 9, wherein said multimedia data includes data for broadcast.

25. The method of claim 9, wherein said multimedia data includes data for transfer.

26. The method of claim 9, wherein said multimedia data is displayed on a user terminal.

27. The method of claim 26, wherein said user terminal is a set top box that provides access to both MediaNetwork Protocol and non-MediaNetwork Protocol networks.

28. The method of claim 26, wherein said user terminal is a teleputer that processes both MediaNetwork Protocol and non-MediaNetwork packets.

29. The method of claim 9, wherein said multimedia data is stored on a home server.

30. The method of claim 9, wherein said multimedia data is stored in a mass storage unit.

31. The method of claim 9, wherein said packet-switched network includes a plurality of non-peer-to-peer user terminals.

32. The method of claim 9, wherein said packet-switched network includes a plurality of non-peer-to-peer middle switches.

33. The method of claim 9, wherein said packet-switched network includes a plurality of non-peer-to-peer home gateways.

34. The method of claim 9, wherein said packet-switched network automatically configures a node when said node is added to said network.

35. The method of claim 34, wherein said automatic configuration includes checking the node identification number.

36. The method of claim 9, wherein said packet-switched network approves said forwarding prior to said forwarding.

37. The method of claim 36, wherein said approval is based on measured usage of resources along said plurality of logical links.

38. The method of claim 37, wherein said approval is on a per-session basis.

39. The method of claim 9, wherein a node in said packet-switched network approves said forwarding prior to said forwarding.

40. The method of claim 39, wherein said approval is based on measured usage of resources along said plurality of logical links.

41. The method of claim 40, wherein said approval is on a per-session basis.

42. The method of claim 9, wherein said packet-switched network includes servers that distribute network information to a plurality of switches in said network.

43. The method of claim 42, wherein said network information includes bandwidth usage for a plurality of switches in said network.

44. The method of claim 42, wherein said network information is distributed using bulletin packets.

45. The method of claim 9, wherein said packet-switched network verifies an account of a paying party prior to forwarding said packet.

46. The method of claim 9, wherein said packet-switched network measures, collects, and stores usage data.

47. The method of claim 46, wherein said usage data includes accounting data.

48. The method of claim 9, wherein said packet-switched network regulates the flow of packets.

49. The method of claim 48, wherein said network regulates the flow of packets by adding packets.

50. The method of claim 48, wherein said network regulates the flow of packets by holding back packets.

51. The method of claim 9, wherein said packet-switched network contains a server group that includes a plurality of server systems, wherein each server system performs a specialized task.

52. The method of claim 9, wherein said packet-switched network filters said packet.

53. The method of claim 52, wherein said filter criteria are established on a per session basis.

54. The method of claim 52, wherein said filter criteria include a source address in said packet.

55. The method of claim 52, wherein said filter criteria include a destination address in said packet.

56. The method of claim 52, wherein said filter criteria include a traffic flow parameter.

57. The method of claim 52, wherein said filter criteria include data content information.

58. The method of claim 9, wherein said datagram address binds a node to a network attachment point and remains with said network attachment point if said node is changed.

59. The method of claim 9, wherein said datagram address contains partial address subfields that correspond to a network topology that leads to a network attachment point.

60. The method of claim 9, wherein said datagram address remains associated with a network attachment point when a node attached to said point is changed.

61. A system for transmitting data, comprising:
a packet-switched network including a plurality of logical links; and
a plurality of data packets passing through said plurality of logical links, each of said packets comprising
a header field including a datagram address containing a plurality of partial address subfields, wherein address information in said partial address subfields self-directs said packet through a plurality of top-down logical links, said plurality of top-down logical links being a subset of said plurality of logical links,
and a payload field containing multimedia data,
wherein each of said packets remains unchanged as it is transferred along multiple links in said plurality of logical links.

62. The system of claim 61, wherein said plurality of logical links forms a transmission path between a source node and a destination node.

63. The system of claim 61, wherein said passing through does not use the Internet Protocol.

64. The system of claim 61, wherein said passing through occurs at wirespeed.

65. The system of claim 61, wherein said passing through uses forwarding tables calculated off-line.

66. The system of claim 61, wherein said passing through does not use real-time routing table calculations.

67. The system of claim 61, wherein said passing through occurs asynchronously.

68. The system of claim 61, wherein said passing through is facilitated by information in said datagram address about the type of service that the packet is providing.

69. The system of claim 61, wherein said packets have a variable length.

70. The system of claim 61, wherein said packets remain unchanged as they are forwarded along a majority of links in said plurality of logical links.

71. The system of claim 61, wherein said packets have no “time-to-live” data.

72. The system of claim 61, wherein said packets are transferred along a majority of links in said plurality of logical links without using routing calculations.

73. The system of claim 61, wherein said multimedia data includes data for telephony.

74. The system of claim 61, wherein said multimedia data includes data for media on demand.

75. The system of claim 61, wherein said multimedia data includes data for multicast.

76. The system of claim 61, wherein said multimedia data includes data for broadcast.

77. The system of claim 61, wherein said multimedia data includes data for transfer.

78. The system of claim 61, wherein said multimedia data is displayed on a user terminal.

79. The system of claim 78, wherein said user terminal is a set top box that provides access to both MediaNetwork Protocol and non-MediaNetwork Protocol networks.

80. The system of claim 78, wherein said user terminal is a teleputer that processes both MediaNetwork Protocol and non-MediaNetwork packets.

81. The system of claim 61, wherein said multimedia data is stored on a home server.

82. The system of claim 61, wherein said multimedia data is stored in a mass storage unit.

83. The system of claim 61, wherein said packet-switched network includes a plurality of non-peer-to-peer user terminals.

84. The system of claim 61, wherein said packet-switched network includes a plurality of non-peer-to-peer middle switches.

85. The system of claim 61, wherein said packet-switched network includes a plurality of non-peer-to-peer home gateways.

86. The system of claim 61, wherein said packet-switched network automatically configures a node when said node is added to said network.

87. The system of claim 86, wherein said automatic configuration includes checking the node identification number.

88. The system of claim 61, wherein said packet-switched network approves said passing through prior to said passing through.

89. The system of claim 88, wherein said approval is based on measured usage of resources along said plurality of logical links.

90. The system of claim 89, wherein said approval is on a per-session basis.

91. The system of claim 61, wherein a node in said packet-switched network approves said passing through prior to said passing through.

92. The system of claim 91, wherein said approval is based on measured usage of resources along said plurality of logical links.

93. The system of claim 92, wherein said approval is on a per-session basis.

94. The system of claim 61, wherein said packet-switched network includes servers that distribute network information to a plurality of switches in said network.

95. The system of claim 94, wherein said network information includes bandwidth usage for a plurality of switches in said network.

96. The system of claim 94, wherein said network information is distributed using bulletin packets.

97. The system of claim 61, wherein said packet-switched network verifies an account of a paying party prior to forwarding said packets.

98. The system of claim 61, wherein said packet-switched network measures, collects, and stores usage data.

99. The system of claim 98, wherein said usage data includes accounting data.

100. The system of claim 61, wherein said packet-switched network regulates the flow of packets.

101. The system of claim 100, wherein said network regulates the flow of packets by adding packets.

102. The system of claim 100, wherein said network regulates the flow of packets by holding back packets.

103. The system of claim 61, wherein said packet-switched network contains a server group that includes a plurality of server systems, wherein each server system performs a specialized task.

104. The system of claim 61, wherein said packet-switched network filters said packets based on a set of filter criteria.

105. The system of claim 104, wherein said filter criteria are established on a per session basis.

106. The system of claim 104, wherein said filter criteria include a source address in said packets.

107. The system of claim 104, wherein said filter criteria include a destination address in said packets.

108. The system of claim 104, wherein said filter criteria include a traffic flow parameter.

109. The system of claim 104, wherein said filter criteria include data content information.

110. The system of claim 61, wherein said datagram address binds a node to a network attachment point and remains with said network attachment point if said node is changed.

111. The system of claim 61, wherein said datagram address contains partial address subfields that correspond to a network topology that leads to a network attachment point.

112. The system of claim 61, wherein said datagram address remains associated with a network attachment point when a node attached to said point is changed.

113. A data structure for a packet, comprising:
a header field containing a datagram address containing a plurality of partial address subfields, wherein address information in said partial address subfields self-directs said packet through a plurality of top-down logical links that forms a subset of a plurality of logical links in a packet-switched network;
and a payload field containing multimedia data,
wherein said packet remains unchanged as it is transferred along multiple links in said plurality of logical links in said network.

114. The data structure of claim 113, wherein said packet is forwarded through said plurality of logical links, which forms a transmission path between a source node and a destination node in said network.

115. The data structure of claim 113, wherein said packet is forwarded through said network without using the Internet Protocol.

116. The data structure of claim 113, wherein said packet is forwarded through said network at wirespeed.

117. The data structure of claim 113, wherein said packet is forwarded through said network using forwarding tables calculated off-line.

118. The data structure of claim 113, wherein said packet is forwarded through said network without using real-time routing table calculations.

119. The data structure of claim 113, wherein said packet is forwarded through said network asynchronously.

120. The data structure of claim 113, wherein said packet is forwarded through said network and said forwarding is facilitated by information in said datagram address about the type of service that the packet is providing.

121. The data structure of claim 113, wherein said packet has a length that is different from the length of another packet of multimedia data that is forwarded in said network.

122. The data structure of claim 113, wherein said packet remains unchanged as it is forwarded along a majority of links in said plurality of logical links in said network.

123. The data structure of claim 113, wherein said packet has no “time-to-live” data.

124. The data structure of claim 113, wherein said packet is transferred along a majority of links in said plurality of logical links in said network without using routing calculations.

125. The data structure of claim 113, wherein said multimedia data includes data for telephony.

126. The data structure of claim 113, wherein said multimedia data includes data for media on demand.

127. The data structure of claim 113, wherein said multimedia data includes data for multicast.

128. The data structure of claim 113, wherein said multimedia data includes data for broadcast.

129. The data structure of claim 113, wherein said multimedia data includes data for transfer.

130. The data structure of claim 113, wherein said multimedia data is displayed on a user terminal.

131. The data structure of claim 130, wherein said user terminal is a set top box that provides access to both MediaNetwork Protocol and non-MediaNetwork Protocol networks.

132. The data structure of claim 130, wherein said user terminal is a teleputer that processes both MediaNetwork Protocol and non-MediaNetwork packets.

133. The data structure of claim 113, wherein said multimedia data is stored on a home server.

134. The data structure of claim 113, wherein said multimedia data is stored in a mass storage unit.

135. The data structure of claim 113, wherein said packet-switched network includes a plurality of non-peer-to-peer user terminals.

136. The data structure of claim 113, wherein said packet-switched network includes a plurality of non-peer-to-peer middle switches.

137. The data structure of claim 113, wherein said packet-switched network includes a plurality of non-peer-to-peer home gateways.

138. The data structure of claim 113, wherein said packet-switched network automatically configures a node when said node is added to said network.

139. The data structure of claim 138, wherein said automatic configuration includes checking the node identification number.

140. The data structure of claim 113, wherein said packet-switched network approves forwarding said packet through said plurality of logical links in said network prior to forwarding said packet.

141. The data structure of claim 140, wherein said approval is based on measured usage of resources along said plurality of logical links.

142. The data structure of claim 141, wherein said approval is on a per-session basis.

143. The data structure of claim 113, wherein a node in said packet-switched network approves forwarding said packet through said plurality of logical links in said network prior to said forwarding.

144. The data structure of claim 143, wherein said approval is based on measured usage of resources along said plurality of logical links.

145. The data structure of claim 144, wherein said approval is on a per-session basis.

146. The data structure of claim 113, wherein said packet-switched network includes servers that distribute network information to a plurality of switches in said network.

147. The data structure of claim 146, wherein said network information includes bandwidth usage for a plurality of switches in said network.

148. The data structure of claim 146, wherein said network information is distributed using bulletin packets.

149. The data structure of claim 113, wherein said packet-switched network verifies an account of a paying party prior to forwarding said packet.

150. The data structure of claim 113, wherein said packet-switched network measures, collects, and stores usage data.

151. The data structure of claim 150, wherein said usage data includes accounting data.

152. The data structure of claim 113, wherein said packet-switched network regulates the flow of packets.

153. The data structure of claim 152, wherein said network regulates the flow of packets by adding packets.

154. The data structure of claim 152, wherein said network regulates the flow of packets by holding back packets.

155. The data structure of claim 113, wherein said packet-switched network contains a server group that includes a plurality of server systems, wherein each server system performs a specialized task.

156. The data structure of claim 113, wherein said packet-switched network filters said packet based on a set of filter criteria.

157. The data structure of claim 156, wherein said filter criteria are established on a per session basis.

158. The data structure of claim 156, wherein said filter criteria include a source address in said packet.

159. The data structure of claim 156, wherein said filter criteria include a destination address in said packet.

160. The data structure of claim 156, wherein said filter criteria include a traffic flow parameter.

161. The data structure of claim 156, wherein said filter criteria include data content information.

162. The data structure of claim 113, wherein said datagram address binds a node to a network attachment point and remains with said network attachment point if said node is changed.

163. The data structure of claim 113, wherein said datagram address contains partial address subfields that correspond to a network topology that leads to a network attachment point.

164. The data structure of claim 113, wherein said datagram address remains associated with a network attachment point when a node attached to said point is changed.

165. A computer readable medium containing executable program instructions for transmitting data through a network, which when executed cause said network to:
forward a packet of multimedia data through a plurality of logical links in a packet-switched network using a datagram address in said packet,
wherein address information in partial address subfields of said datagram address self-directs said packet through a plurality of top-down logical links, said plurality of top-down logical links being a subset of said plurality of logical links, and said packet remains unchanged as it is transferred along multiple links in said plurality of logical links.

166. The computer readable medium of claim 165, wherein said plurality of logical links forms a transmission path between a source node and a destination node.

167. The computer readable medium of claim 165, wherein said forwarding does not use the Internet Protocol.

168. The computer readable medium of claim 165, wherein said forwarding occurs at wirespeed.

169. The computer readable medium of claim 165, wherein said forwarding uses forwarding tables calculated off-line.

170. The computer readable medium of claim 165, wherein said forwarding does not use real-time routing table calculations.

171. The computer readable medium of claim 165, wherein said forwarding occurs asynchronously.

172. The computer readable medium of claim 165, wherein said forwarding is facilitated by information in said datagram address about the type of service that the packet is providing.

173. The computer readable medium of claim 165, wherein said packet has a length that is different from the length of another packet of multimedia data that is forwarded in said network.

174. The computer readable medium of claim 165, wherein said packet remains unchanged as it is forwarded along a majority of links in said plurality of logical links.

175. The computer readable medium of claim 165, wherein said packet has no “time-to-live” data.

176. The computer readable medium of claim 165, wherein said packet is transferred along a majority of links in said plurality of logical links without using routing calculations.

177. The computer readable medium of claim 165, wherein said multimedia data includes data for telephony.

178. The computer readable medium of claim 165, wherein said multimedia data includes data for media on demand.

179. The computer readable medium of claim 165, wherein said multimedia data includes data for multicast.

180. The computer readable medium of claim 165, wherein said multimedia data includes data for broadcast.

181. The computer readable medium of claim 165, wherein said multimedia data includes data for transfer.

182. The computer readable medium of claim 165, wherein said multimedia data is displayed on a user terminal.

183. The computer readable medium of claim 182, wherein said user terminal is a set top box that provides access to both MediaNetwork Protocol and non-MediaNetwork Protocol networks.

184. The computer readable medium of claim 182, wherein said user terminal is a teleputer that processes both MediaNetwork Protocol and non-MediaNetwork packets.

185. The computer readable medium of claim 165, wherein said multimedia data is stored on a home server.

186. The computer readable medium of claim 165, wherein said multimedia data is stored in a mass storage unit.

187. The computer readable medium of claim 165, wherein said packet-switched network includes a plurality of non-peer-to-peer user terminals.

188. The computer readable medium of claim 165, wherein said packet-switched network includes a plurality of non-peer-to-peer middle switches.

189. The computer readable medium of claim 165, wherein said packet-switched network includes a plurality of non-peer-to-peer home gateways.

190. The computer readable medium of claim 165, wherein said packet-switched network automatically configures a node when said node is added to said network.

191. The computer readable medium of claim 190, wherein said automatic configuration includes checking the node identification number.

192. The computer readable medium of claim 165, wherein said packet-switched network approves said forwarding prior to said forwarding.

193. The computer readable medium of claim 192, wherein said approval is based on measured usage of resources along said plurality of logical links.

194. The computer readable medium of claim 193, wherein said approval is on a per-session basis.

195. The computer readable medium of claim 165, wherein a node in said packet-switched network approves said forwarding prior to said forwarding.

196. The computer readable medium of claim 195, wherein said approval is based on measured usage of resources along said plurality of logical links.

197. The computer readable medium of claim 196, wherein said approval is on a per-session basis.

198. The computer readable medium of claim 165, wherein said packet-switched network includes servers that distribute network information to a plurality of switches in said network.

199. The computer readable medium of claim 198, wherein said network information includes bandwidth usage for a plurality of switches in said network.

200. The computer readable medium of claim 199, wherein said network information is distributed using bulletin packets.

201. The computer readable medium of claim 165, wherein said packet-switched network verifies an account of a paying party prior to forwarding said packet.

202. The computer readable medium of claim 165, wherein said packet-switched network measures, collects, and stores usage data.

203. The computer readable medium of claim 202, wherein said usage data includes accounting data.

204. The computer readable medium of claim 165, wherein said packet-switched network regulates the flow of packets.

205. The computer readable medium of claim 204, wherein said network regulates the flow of packets by adding packets.

206. The computer readable medium of claim 204, wherein said network regulates the flow of packets by holding back packets.

207. The computer readable medium of claim 165, wherein said packet-switched network contains a server group that includes a plurality of server systems, wherein each server system performs a specialized task.

208. The computer readable medium of claim 165, wherein said packet-switched network filters said packet based on a set of filter criteria.

209. The computer readable medium of claim 208, wherein said filter criteria are established on a per session basis.

210. The computer readable medium of claim 208, wherein said filter criteria include a source address in said packet.

211. The computer readable medium of claim 208, wherein said filter criteria include a destination address in said packet.

212. The computer readable medium of claim 208, wherein said filter criteria include a traffic flow parameter.

213. The computer readable medium of claim 208, wherein said filter criteria include data content information.

214. The computer readable medium of claim 165, wherein said datagram address binds a node to a network attachment point and remains with said network attachment point if said node is unchanged.

215. The computer readable medium of claim 165, wherein said datagram address contains partial address subfields that correspond to a network topology that leads to a network attachment point.

216. The computer readable medium of claim 165, wherein said datagram address remains associated with said network attachment point when a node attached to said point is changed.

217. A system for transmitting data, comprising:
a packet-switched network including a plurality of logical links;
a plurality of control packets passing through said plurality of logical links, each of
said control packets comprising:
a first datagram address that contains a plurality of partial address subfields, wherein address information in said partial address subfields self-directs said control packet through a plurality of top-down logical links, said plurality of top-down logical links being a subset of said plurality of logical links; and
a plurality of data packets passing through said plurality of logical links, each of said data packets comprising:
a second datagram address that contains a second color subfield, wherein color information in said second color subfield determines a packet delivery mechanism for said system to forward said data packet.

218. The system of claim 217, wherein said packet-switched network further comprising:
a network backbone;
a service gateway, coupled to said network backbone;
a tiered switching element, coupled to said service gateway;
a home gateway, coupled to said tiered switching element; and
a user terminal, coupled to said home gateway.

219. The system of claim 218, wherein said service gateway governs resources of a sub-network within said packet switched network.

220. The system of claim 219, wherein said service gateway further comprising:
an edge switch, coupled to said network backbone; and
a server group, coupled to said edge switch.

221. The system of claim 220, wherein said service gateway further comprising a gateway, which is coupled to said edge switch and coupled to a network other than said packet-switched network.

222. The system of claim 220, wherein said service gateway further comprising a media storage device, coupled to said edge switch.

223. The system of claim 220, wherein said server group further comprising a plurality of server systems, each capable of processing tasks independently from the other.

224. The system of claim 223, wherein each of said server systems performs a dedicated task.

225. The system of claim 220, wherein the capabilities of said server group include:
establishing a network topology of said sub-network;
assigning available network addresses to ports of said sub-network;
binding devices that are attached to said ports to said available network addresses that are assigned to said ports;
communicating with said devices; and
manipulating data traffic on said sub-network.

226. The system of claim 225, wherein said server group authenticates identification information of said devices before binding said available network addresses that are assigned to said ports to said devices.

227. The system of claim 225, wherein said server group
collects resource information from said devices; and
distributes resource information of said subnetwork to said devices.

228. The system of claim 225, wherein said server group sets up resources between a requesting device and a destination device for a requested service if said server group approves said requested service.

229. The system of claim 228, wherein said server group approves said requested service if
said requesting device and said destination device are eligible to have said requested service performed; and
said resources between said requesting device and said destination device are available to perform said requested service.

230. The system of claim 229, wherein said server group examines an account of a paying party to determine said eligibility.

231. The system of claim 229, wherein said server group reserves an available session number if said requested service is for a multipoint communication session.

232. The system of claim 229, wherein said server group configures said sub-network with entry criteria for upstreaming packets.

233. The system of claim 220, wherein said edge switch further comprising:
a packet distributor, and
a switching core, coupled to said packet distributor, wherein said switching core further includes
a partial address routing engine, coupled to said packet distributor;
a color filter, coupled to said partial address routing engine; and
a delay element, coupled to said color filter, said partial address routing engine, and said packet distributor.

234. The system of claim 233, wherein
said delay element stores a packet that said edge switch receives for a period of time, during which said color filter directs said partial address routing engine to process a datagram address in said packet according to color information in a color subfield of said datagram address; and
said partial address routing engine causes said packet distributor to forward said packet.

235. The system of claim 234, wherein said partial address routing engine
asserts a plurality of first control signals based on information in a first lookup table for said packet distributor to forward said packet if said color information indicates a multipoint communication session; and
asserts a plurality of second control signals based on information in said partial address subfields for said packet distributor to forward said packet if said color information indicates a unicast communication session.

236. The system of claim 235, wherein said partial address routing engine maintains reserved session numbers and mapped session numbers in a second lookup table.

237. The system of claim 233, wherein said color filter is capable of directly responding to a requesting device on said packet-switched network with said control packet.

238. The system of claim 235, wherein said packet distributor further comprising:
at lease one distributor,
a buffer bank, coupled to said distributor; and
at least one controller, coupled to said buffer bank and said tiered switching element.

239. The system of claim 238, wherein
said distributor directs said packet to a portion of said buffer bank in response to said plurality of first control signals and said plurality of second control signals; and
said controller regulates the flow of said packet from said portion of said buffer bank to said tiered switching element.

240. The system of claim 218, wherein said tiered switching element further comprising:
a switching core; and
a uplink packet filter, coupled to said switching core.

241. The system of claim 240, wherein said uplink packet filter filters upstreaming packets based on a set of filter criteria.

242. The system of claim 241, wherein said uplink packet filter regulating the flow of said upstreaming packets by adding packets.

243. The system of claim 240, wherein said switch core further comprising:
a packet distributor,
a partial address routing engine, coupled to said packet distributor,
a color filter, coupled to said partial address routing engine and said uplink packet filter; and
a delay element, coupled to said color filter and said packet distributor.

244. The system of claim 243, wherein
said delay element stores a packet that said tiered switching element receives for a period of time, during which said color filter directs said partial address routing engine to process a datagram address in said packet according to color information in a color subfield of said datagram address; and
said partial address routing engine causes said packet distributor to forward said packet.

245. The system of claim 244, wherein said partial address routing engine
asserts a plurality of first control signals based on information in a first lookup table for said packet distributor to forward said packet if said color information indicates a multipoint communication session; and
asserts a plurality of second control signals based on information in said partial address subfields for said packet distributor to forward said packet if said color information indicates a unicast communication session.

246. The system of claim 245, wherein said partial address routing engine maintains reserved session numbers and mapped session numbers in a second lookup table.

247. The system of claim 245, wherein said packet distributor further comprising:
at lease one distributor;
a buffer bank, coupled to said distributor, and
at least one controller, coupled to said buffer bank and said home gateway.

248. The system of claim 247, wherein
said distributor directs said packet to a portion of said buffer bank in response to said plurality of first control signals and said plurality of second control signals; and
said controller regulates the flow of said packet from said portion of said buffer bank to said home gateway.

249. The system of claim 218, wherein said home gateway further comprising:
a master user switch; and
a plurality of slave user switches, coupled to said master user switch.

250. The system of claim 249, wherein said server group assigns a network address to said master user switch after said master user switch physically connects to said tiered switching element.

251. The system of claim 249, wherein said master user switch establishes a maximum bandwidth that said home gateway supports.

252. The system of claim 249, wherein said master user switch allocates bandwidth to said user terminal that is coupled to said home gateway.

253. The system of claim 249, wherein said master user switch has a dedicated upstreaming port and a dedicated downstreaming port.

254. The system of claim 253, wherein each of said plurality of slave user switches has a dedicated upstreaming port and a dedicated downstreaming port.

255. The system of claim 254, wherein said master user switch broadcasts a packet on said downstreaming port to said plurality of slave user switches if said packet is destined for a user terminal that one of said plurality of slave user switches directly manages.

256. The system of claim 254, wherein one of said plurality of slave user switches forwards a packet on said upstreaming port to said master user switch if said packet is destined for said tiered switching element.

257. The system of claim 256, wherein one of said plurality of slave user switches broadcasts said packet on said upstreaming port to the rest of said plurality of slave user switches if said packet is destined for a user terminal that one of the rest of said plurality of slave user switches directly manages.

258. A method for conducting a communication session, comprising:
forwarding a control packet through a plurality of logical links in a connection-oriented, packet-switched network using a first datagram address in said control packet, wherein
address information in first partial address subfields of said first datagram address self-directs said control packet through a plurality of top-down logical links, said plurality of top-down logical links being a subset of said plurality of logical links; and
forwarding a data packet through said plurality of logical links in said network using a second datagram address in said data packet, wherein
color information in a second color subfield of said second datagram address determines a packet delivery mechanism for caring out said forwarding of said data packet.

259. The method of claim 258, further comprising:
modifying resources along said plurality of logical links based on a session number in said control packet and said address information in said first partial address subfields, if color information in a first color subfield of said first datagram address indicates a multipoint communication mode.

260. The method of claim 259, wherein said resources further comprising lookup tables in devices along said plurality of logical links.

261. The method of claim 259, further comprising:
reserving said session number for the duration of said communication session; and
reserving a mapped session number if said session number is unavailable.

262. The method of claim 261, wherein said control packet includes said session number and said mapped session number.

263. The method of claim 258, wherein said packet delivery mechanism further comprising:
using address information in second partial address subfields of said second datagram address to self-direct said data packet through said plurality of top-down logical links, if said color information in said second color subfield indicates a uni cast mode.

264. The method of claim 258, further comprising:
selectively blocking upstreaming packets based on entry criteria information in said control packet.

265. The method of claim 264, further comprising:
regulating the flow of said upstreaming packets by adding packets.

266. The method of claim 258, further comprising:
requesting connection-related information of said communication session from resources along said plurality of logical links with said control packet at a first time interval; and
distributing said connection-related information to said resources with said control packet at a second time interval.

267. The method of claim 266, wherein said packet delivery mechanism further comprising:
directing said data packet through said plurality of logical links according to information that said resources maintain, if said color information in said second color subfield indicates a multipoint communication mode.

268. The method of claim 267, wherein said resources maintain said information in lookup tables.

269. A method for setting up a communication session, comprising:
forwarding a single control packet through a plurality of logical links in a connection-oriented, packet-switched network using a datagram address in said single control packet, wherein
address information in partial address subfields of said datagram address self-directs said control packet through a plurality of top-down logical links, said plurality of top-down logical links being a subset of said plurality of logical links; and
modifying resources along said plurality of logical links.

270. A method for terminating a communication session, comprising:
forwarding a single control packet through a plurality of logical links in a connection-oriented, packet-switched network using a datagram address in said single control packet, wherein
address information in partial address subfields of said datagram address self-directs said control packet through a plurality of top-down logical links, said plurality of top-down logical links being a subset of said plurality of logical links; and
modifying resources along said plurality of top-down logical links.

271. A method for transmitting data, comprising:
forwarding a packet of Multimedia data through a plurality of logical links in a packet-switched network using a datagram address in a header field of said packet, wherein
said datagram address operates as both a data link layer address and a network layer address; and
said datagram address contains instructions that can invoke resources along said plurality of logical links to carry out said forwarding.

272. The method of claim 271, wherein said resources further comprising devices along said plurality of logical links.

273. The method of claim 272, wherein said datagram address includes:
unicast mode instructions that invoke said devices to direct said packet through said plurality of logical links with address information in partial address subfields of said datagram address.

274. The method of claim 272, wherein said datagram address includes:
multipoint communication mode instructions that invoke said devices to direct said packet through said plurality of logical links with information that said devices maintain.

275. The method of claim 274, wherein said information that said devices maintain includes a session number and address information in partial address subfields of said datagram address.

276. The method of claim 275, further comprising:
reserving said session number for the duration of said communication session; and
reserving a mapped session number if said session number is unavailable.

277. A system for transmitting data, comprising:
a packet-switched network including a plurality of logical links;
a plurality of packets passing through said plurality of logical links, each of said packets comprising:
a datagram address in a header field of said packet, wherein
said datagram address operates as both a data link layer address and a network layer address; and
said datagram address contains instructions that can invoke resources along said plurality of logical links to forward said packet.

278. A computer readable medium containing executable program instructions for conducting a communication session, which when executed cause:
a connection-oriented, packet-switched network to forward a control packet through a plurality of logical links of said network using a first datagram address in said control packet, wherein
address information in first partial address subfields of said first datagram address self-directs said control packet through a plurality of top-down logical links, said plurality of top-down logical links being a subset of said plurality of logical links; and
forward a data packet through said plurality of logical links in said network using a second datagram address in said data packet, wherein
color information in a second color subfield of said second datagram address determines a packet delivery mechanism for carrying out said forwarding of said data packet.

279. The computer readable medium of claim 278, which when said executable program instructions are executed, cause said network to modify resources along said plurality of logical links based on a session number in said control packet and said address information in said first partial address subfields, if color information in a first color subfield of said first datagram address indicates a multipoint communication mode.

280. The computer readable medium of claim 279, wherein said resources further comprising lookup tables in devices along said plurality of logical links.

281. The computer readable medium of claim 279, which when said executable program instructions are executed, cause said network to
reserve said session number for the duration of said communication session; and
reserve a mapped session number if said session number is unavailable.

282. The computer readable medium of claim 281, wherein said control packet includes said session number and said mapped session number.

283. The computer readable medium of claim 278, wherein said packet delivery mechanism further comprising:
using address information in second partial address subfields of said second datagram address to self-direct said data packet through said plurality of top-down logical links, if said color information in said second color subfield indicates a unicast mode.

284. The computer readable medium of claim 278, which when said executable program instructions are executed, cause said network to selectively block upstreaming packets based on entry criteria information in said control packet.

285. The computer readable medium of claim 284, which when said executable program instructions are executed, cause said network to regulate the flow of said upstreaming packets by adding packets.

286. The computer readable medium of claim 278, which when said executable program instructions are executed, cause said network to
request connection-related information of said communication session from resources along said plurality of logical links with said control packet at a first time interval; and
distribute said connection-related information to said resources with said control packet at a second time interval.

287. The computer readable medium of claim 286, wherein said packet delivery mechanism further comprising:
directing said data packet through said plurality of logical links according to information that said resources maintain, if said color information in said second color subfield indicates a multipoint communication mode.

288. The computer readable medium of claim 287, wherein said resources maintain said information in lookup tables.

289. The system of claim 217, wherein a component of said packet-switched network modify resources that said component manages according to a session number in said control packet and said address information in said first partial address subfields, if color information in a first color subfield of said first datagram address indicates a multipoint communication mode.

290. The system of claim 289, wherein said packet-switched network further comprising:
a service gateway, which
reserves said session number for the duration of said communication session; and
reserves a mapped session number if said session number is unavailable.

291. The system of claim 290, wherein said control packet includes said session number and said mapped session number.

292. The system of claim 217, wherein said packet delivery mechanism further comprising:
using address information in second partial address subfields of said second datagram address to self-direct said data packet through said plurality of top down logical links, if said color information in said second color subfield indicates a unicast mode.

293. The system of claim 217, wherein said packet-switched network further comprising:
a tiered switching element, which selectively blocks upstreaming packets based on entry criteria information in said control packet.

294. The system of claim 293, wherein said tiered switching element regulates the flow of said upstreaming packets by adding packets.

295. The system of claim 217, wherein said packet-switched network further comprising:
a service gateway, which
requests connection-related information of said communication session from resources along said plurality of logical links with said control packet at a first time interval; and
distributes said connection-related information to said resources with said control packet at a second time interval.

296. The system of 295, wherein said packet delivery mechanism further comprising:
directing said data packet through said plurality of logical links according to information that said resources maintain, if said color information in said second color subfield indicates a multipoint communication mode.

297. The system of claim 296, wherein said resources maintain said information in lookup tables.

298. The system of claim 277, wherein said packet-switched network further includes devices along said plurality of logical links.

299. The system of claim 298, wherein said datagram address includes:
unicast mode instructions that invoke said devices to direct said packet through said plurality of logical links with address information in partial address subfields of said datagram address.

300. The system of claim 298, wherein said datagram address includes:
multipoint communication mode instructions that invoke said devices to direct said packet through said plurality of logical links with information that said devices maintain.

301. The system of claim 300, wherein said information that said devices maintain includes a session number and address information in partial address subfields of said datagram address.

302. The system of claim 301, wherein said packet-switched network further comprising a service gateway, which
reserves said session number for the duration of said communication session; and
reserves a mapped session number if said session number is unavailable.

303. A computer readable medium containing executable program instructions for conducting a communication session, which when executed cause:
a packet-switched network to
forward a packet of multimedia data through a plurality of logical links in said packet-switched network using a datagram address in a header field of said packet, wherein
said datagram address operates as both a data link layer address and a network layer address; and
said datagram address contains instructions that can invoke resources along said plurality of logical links to direct said packet.

304. The computer medium of claim 303, wherein said packet-switched network further includes devices along said plurality of logical links.

305. The computer medium of claim 304, wherein said datagram address includes:
unicast mode instructions that invoke said devices to direct said packet through said plurality of logical links with address information in partial address subfields of said datagram address.

306. The computer medium of claim 304, wherein said datagram address includes:
multipoint communication mode instructions that invoke said devices to direct said packet through said plurality of logical links with information that said devices maintain.

307. The computer medium of claim 306, wherein said information that said devices maintain includes a session number and address information in partial address subfields of said datagram address.

308. The computer readable medium of claim 307, which when said executable program instructions are executed, cause said packet-switched network to
reserve said session number for the duration of said communication session; and
reserve a mapped session number if said session number is unavailable.

309. A data structure for a packet, comprising:
a header field containing a datagram address that operates as both a data link layer address and a network layer address in a packet-switched network,
wherein said datagram address contains instructions that can invoke resources along a plurality of logical links in said packet-switched network to forward said packet.

310. The data structure of claim 309, wherein said packet-switched network further includes devices along said plurality of logical links.

311. The data structure of claim 310, wherein said datagram address includes:
unicast mode instructions that invoke said devices to direct said packet through said plurality of logical links with address information in partial address subfields of said datagram address.

312. The data structure of claim 310, wherein said datagram address includes:
multipoint communication mode instructions that invoke said devices to direct said packet through said plurality of logical links with information that said devices maintain.

313. The data structure of claim 312, wherein said information that said devices maintain includes a session number and address information in partial address subfields of said datagram address.
